(19) United States
(12) Patent Application Publication
(10) Pub. No.: US 2002/0147603 A1
(43) Pub. Date: Oct. 10, 2002

(54) Electronic systems and methods for dispute management

(75) Inventors: William K. Slate II, Philadelphia, PA (US); John C. Emmert JR., Garden City, NY (US); Richard W. Naimark, Plainsboro, NJ (US); Francesco Rossi, Newburgh, NY (US); Debi Miller Moore, Charlotte, NC (US); Gerald Strathmann, Beverly, MA (US); Cynthia Rumney, Plano, TX (US); Joseph Williams, New York, NY (US); Interna Khutorsky, Fort Lee, NJ (US); Oggy Doytchinov, Port Washington, NY (US); Douglas W. Crisman, Princeton, NJ (US); Robert S. Zvlowski, Hillsborough, NJ (US); Charles B. Kreitzburg, Princeton Junction, NJ (US); Jodi Green, New York, NY (US); Richard D. Bailey, Yonkers, NY (US); Daniel R. Vasileniuc, High Point, NC (US); Morton Mease, Hoffman Estates, IL (US)

Correspondence Address: FISH & NEAVE, 1251 AVENUE OF THE AMERICAS, 50TH FLOOR, NEW YORK, NY, 10020-1105, US

(73) Assignee: American Arbitration Association

(21) Appl. No.: 09/990,402

(22) Filed: Nov. 21, 2001

Related U.S. Application Data
(60) Provisional application No. 60/252,226, filed on Nov. 21, 2000.
(60) Provisional application No. 60/305,215, filed on Jul. 12, 2001.

(51) Int. Cl. G06F 17/60

(52) U.S. Cl. 705/1

(57) ABSTRACT

Electronic systems and methods for providing dispute management in a dispute management application are described.

This application claims the benefit of U.S. provisional patent application Nos. 60/252,226, filed Nov. 21, 2000 and 60/305,215, filed Jul. 12, 2001.

### BACKGROUND OF THE INVENTION

This invention relates to electronic systems and methods for dispute management. More particularly, this invention relates to electronic systems and methods with advanced user interfaces and advanced features for dispute management.

Typically, a wide range of disputes are often resolved by arbitration or mediation. Arbitration is a procedure in which a dispute is submitted by agreement of disputing parties to an arbitrator or to several arbitrators who give a decision on the dispute that is binding on the disputing parties. Typically, once disputing parties freely agree to submit a dispute to arbitration, a party cannot withdraw from the arbitration. Mediation, however, is a procedure in which a neutral intermediary, the mediator, endeavors, at the request of the parties to a dispute, to assist them in reaching a mutually satisfactory settlement of the dispute. The mediator typically does not have any power to impose a settlement on the parties. Mediation is typically also voluntary in the sense that either party may, if it so chooses, abandon the mediation at any stage prior to the signing of an agreed settlement.

However, conventional arbitration and mediation processes are deficient in a number of respects. The communications process between a claimant, a respondent, and a case manager is time consuming and prone to causing delays in the process. Due to such delays, the time required to resolve a dispute may become inordinately long.

Further, in the world of electronic commerce, personal relationships between buyers and sellers may be more abstract and the risk of misinterpretation may be much greater than in traditional face-to-face transactions. Sellers and buyers may wish to think through, in advance, what can go wrong and to address these issues in their agreements in order to minimize their risks of disruption or failure.

Therefore, it would be desirable to provide a dispute management application that provides users with advanced features for dispute management.

It would also be desirable to provide a dispute management application that guides users through dispute resolution processes.

It would further be desirable to provide a dispute management application that assists users in preventing disputes.

### SUMMARY OF THE INVENTION

This and other objects of the invention are accomplished in accordance with the principles of the present invention by providing users with electronic features for dispute management. Various embodiments and features of the present invention are described, for example, in U.S. provisional patent application Nos. 60/252,226, filed Nov. 21, 2000, and 60/305,215, filed Jul. 12, 2001, which are hereby incorporated by reference herein in their entireties.

A dispute management application is provided that provides users with dispute management features in an advanced user interface. In some embodiments, for example, the dispute management application may provide arbitration services. Arbitration services may allow one or more neutral arbitrators to consider evidence from disputing parties and render a decision. For example, when parties have a dispute, they may access an on-line list of potential arbitrators and either agree to use a particular arbitration or participate in a selection process to determine the arbitrator. An arbitrator may be appointed by, for example, a case manager. The parties may be provided with a schedule for the submission of arguments, evidence, replies, and any other suitable information related to the dispute resolution process. The arbitrator may provide a decision on the dispute.

In some embodiments, the dispute management application may provide documents-only arbitration services. Documents-only arbitration is typically defined as a form of arbitration in which disputing parties present their evidence and arguments solely by documents. A neutral arbitrator reviews the documents and renders a decision. For example, when parties have a dispute, they may access an on-line list of potential arbitrators and either agree to use or participate in a selection process to determine the arbitrator. If desired, an arbitrator may be appointed. Some embodiments may provide the disputing parties with a schedule for the submission of arguments, evidence, replies, and any other suitable information in document format. The arbitrator may view the documents and provide a decision on the dispute.

In some embodiments, the dispute management application may provide mediation-related features. Mediation services may be used to allow parties to work together with the aid of a neutral facilitator (e.g., a mediator). One particular type of mediation service is on-call mediation. On-call mediation is typically defined as a type of mediation that allows disputing parties to access mediators' availability through an online calendar. These mediators are typically available on short notice to address pressing disputes. For example, when parties have a dispute, they may access an on-line calendar of mediators' availabilities. The disputing parties (i.e., a claimant and a respondent) may agree to a mediator through a scheduling interface. Upon selecting a mediator and a time slot, the parties may be provided with contact information and a schedule for submitting any documentation. Mediators may be notified of their selection and the time slot may be removed from the online calendar. If the mediator accepts the case, the disputing parties may be notified. In some embodiments, dates and other information may be automatically published for information that is due before the meeting with the mediator.

In some embodiments, the dispute management application allows a user, such as a case manager, to interact with the disputing parties. A case manager may assist in guiding the disputing parties through a dispute resolution process.

In some embodiments, the dispute management application may provide users with online resources relating to dispute management. The dispute management application may provide users with access to books, periodicals, pamphlets, manuscripts, and articles relating to dispute management.

In some embodiments, the dispute management application may provide users with discussion areas, such as peer groups. These peer groups may provide users with an area to discuss issues, solutions, industry trends, or any other suitable topic. In some embodiments, a user may create a user profile, such as a peer group profile. Such a profile may assist in bringing together like peers.

In some embodiments, the dispute management application may provide users with mediator calendars. Users may desire to review mediator availabilities for on-call mediation cases where immediate resolution is desirable. In some embodiments, the dispute management application may allow a user to search through mediator calendars by date or by mediator.

In some embodiments, the dispute management application may guide disputing parties in understanding resolution options and aid them in selecting the most appropriate mechanism for solving their dispute. In some embodiments, the dispute management application may allow a user to create a dispute management profile.

In some embodiments, in an effort to preserve relationships and promote the continuity of business, the dispute management application may provide users with suggestions for minimizing damages and preserving relationships during a dispute or before a dispute arises. The dispute management application may perform a trend analysis by, for example, sifting through databases or monitoring received communications. The dispute management application may search for patterns of activity based on either criteria stored in memory, user inputs, or as determined by the dispute management application to be anomalous or suspicious.

### BRIEF DESCRIPTION OF THE DRAWINGS

The above and other objects and features of the present invention will be apparent upon consideration of the following detailed description, taken in conjunction with the accompanying drawings, in which like reference characters refer to like parts throughout, and in which:

FIGS. 1 and 2 are illustrative on-line and non-on-line arrangements, respectively, for a dispute management system in accordance with some embodiments of the present invention.

FIG. 3 illustrates a generalized arrangement for the access devices of FIG. 1 and the personal computers of FIG. 2, in accordance with various embodiments of the present invention.

FIG. 4 is a generalized flowchart of an illustrative method for providing features for dispute management, in accordance with various embodiments of the present invention.

FIG. 5 is a flowchart of an illustrative method for providing users with options relating to dispute management, in accordance with various embodiments of the present invention.

FIG. 6 is a flowchart of an illustrative method for providing users with displays relating to filing a claim using a case filing application, in accordance with various embodiments of the present invention.

FIG. 7 is a flowchart of an illustrative method for providing users with displays relating to filing a claim using the dispute management application, in accordance with various embodiments of the present invention.

FIG. 8 is a flowchart of an illustrative method for providing users with advanced options relating to dispute management, in accordance with various embodiments of the present invention.

FIG. 9 is a flowchart of an illustrative method for providing users with options relating to a library, in accordance with various embodiments of the present invention.

FIG. 10 is a flowchart of an illustrative method for providing users with options relating to directories, in accordance with various embodiments of the present invention.

FIG. 11 is a flowchart of an illustrative method for providing users with options relating to cases, in accordance with various embodiments of the present invention.

FIG. 12 is a generalized flowchart of an illustrative method for providing users with features relating to In-Person Arbitration, in accordance with various embodiments of the present invention.

FIGS. 13-14D are flowcharts of illustrative methods for providing users with features relating to Documents-Only Arbitration, in accordance with various embodiments of the present invention.

FIG. 15A-15C are flowcharts of illustrative methods for providing users with features relating to On-Call Mediation, in accordance with various embodiments of the present invention.

FIG. 16 is a generalized flowchart of an illustrative method for providing users with features relating to In-Person Mediation, in accordance with various embodiments of the present invention.

FIG. 17 is a flowchart of an illustrative method for providing users with options relating to peer groups, in accordance with various embodiments of the present invention.

FIG. 18 is a flowchart of an illustrative method for providing users with options relating to mediator calendars, in accordance with various embodiments of the present invention.

FIG. 19 is a flowchart of an illustrative method for providing users with options relating to the user's account, in accordance with various embodiments of the present invention.

FIG. 20 is a flowchart of an illustrative method for guiding users in understanding dispute resolution mechanisms and the selection of the mechanism, in accordance with various embodiments of the present invention.

FIG. 21 is a flowchart of an illustrative method for providing users with feedback, in accordance with various embodiments of the present invention.

FIG. 22 is a flowchart of an illustrative method for providing users with features relating to International dispute management, in accordance with various embodiments of the present invention.

FIGS. 23-26 show illustrative displays that may be displayed by a dispute management application for providing a user with non-subscriber options for dispute management, in accordance with various embodiments of the present invention.

FIG. 27 shows an illustrative logon display that may be displayed by a dispute management application in response to a user indicating a desire to log in, in accordance with various embodiments of the present invention.

FIG. 28 shows an illustrative display that may be displayed by a dispute management application for providing a user with advanced options relating to dispute management, in accordance with various embodiments of the present invention.

FIGS. 29-38 show illustrative displays that may be displayed by a dispute management application for providing a user with options relating to a library, in accordance with various embodiments of the present invention.

FIGS. 39-42 show illustrative displays that may be displayed by a dispute management application for providing a user with options relating to directories, in accordance with various embodiments of the present invention.

FIGS. 43-46 show alternative illustrative displays that may be displayed in response to a user indicating a desire to login or create an account, in accordance with various embodiments of the present invention.

FIGS. 47-52 show illustrative displays that may be displayed in response to a user indicating a desire to file a claim, in accordance with various embodiments of the present invention.

FIGS. 53-104 show alternative illustrative displays that may be displayed in response to a user indicating a desire to file a claim, in accordance with various embodiments of the present invention.

FIGS. 105-111 show illustrative displays that may be displayed in response to a user indicating a desire to file a claim through a case filing application, in accordance with various embodiments of the present invention.

FIGS. 112-127 show illustrative displays that may be displayed in response to a user indicating a desire to access a particular case, in accordance with various embodiments of the present invention.

FIGS. 128-135 show illustrative displays that may be displayed in response to a user indicating a desire to access a particular case, in accordance with various embodiments of the present invention.

FIGS. 136-150 show illustrative displays that may be displayed in response to a user indicating a desire to access a particular case, in accordance with various embodiments of the present invention.

FIGS. 151-160 show illustrative displays that may be displayed in response to a user indicating a desire to access a particular case, in accordance with various embodiments of the present invention.

FIGS. 161-169 show illustrative displays that may be displayed in response to a user indicating a desire to access a particular case, in accordance with various embodiments of the present invention.

FIGS. 170-180 show illustrative displays that may be displayed by a dispute management application for providing a user with options relating to peer groups, in accordance with various embodiments of the present invention.

FIGS. 181-183 show illustrative displays that may be displayed by a dispute management application for providing a user with options relating to mediator calendars, in accordance with various embodiments of the present invention.

FIGS. 184-186 show illustrative displays that may be displayed by a dispute management application for providing a user with options relating to user profiles, in accordance with various embodiments of the present invention.

FIGS. 187-211 show illustrative displays that may be displayed by a dispute management application for providing a user with dispute management features, in accordance with various embodiments of the present invention.

### DETAILED DESCRIPTION OF THE INVENTION

The present invention is primarily described herein in terms of a dispute management application. It will be understood that the dispute management application may be any suitable, software, hardware, or combination thereof configured or programmed to implement the features of the present invention. The dispute management application may be located at a central location (e.g., a central server), or may be distributed across different locations (e.g., a network).

In some embodiments, the dispute management application may include client-side software, hardware, or both. For example, the dispute management application may encompass one or more Web-pages or Web-page portions (e.g., via any suitable encoding, such as XML, Cold Fusion, etc.).

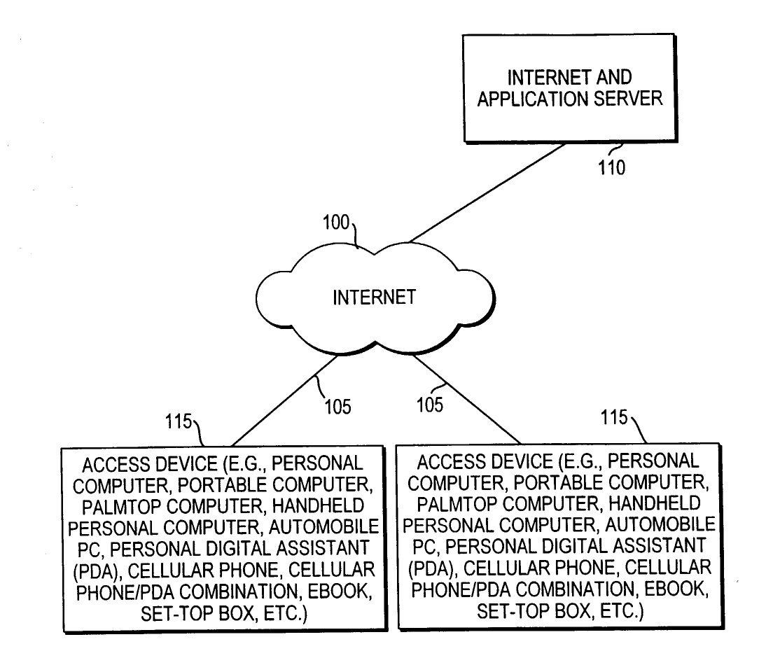

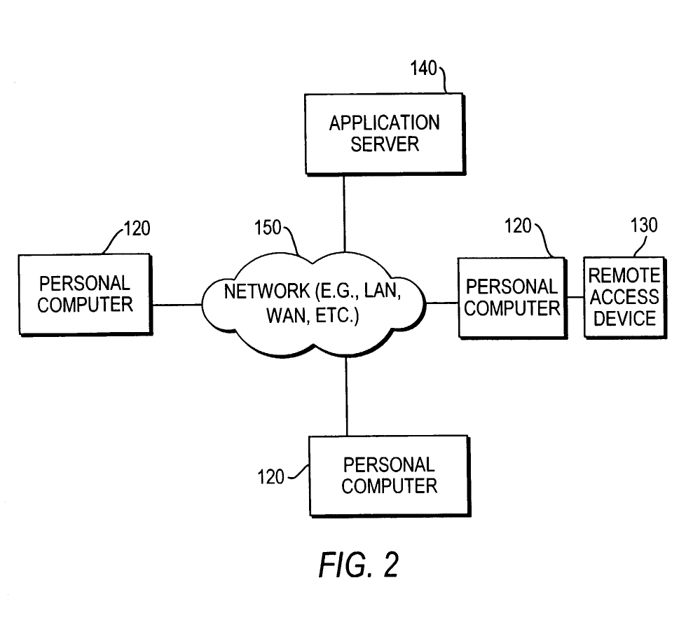

The systems and methods of the present invention may be implemented using any suitable communications network. For example, non-on-line client/server or peer-to-peer based approaches or, preferably, an on-line approach, may be used. If desired, a combination of these approaches may be used. Illustrative on-line and non-on-line based arrangements for a dispute management application system are shown in FIGS. 1 and 2, respectively. In the illustrative on-line arrangement of FIG. 1, access devices 115 may be connected via links 105 to Internet 100. Access devices 115 may include any device or combination of devices suitable for providing Internet access to a user of the system. Access devices may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, ebook, set-top box (e.g., a Web TV enabled set-top box), or other device suitable for providing Internet access. Although the dispute management application is described herein as being implemented on access devices, the dispute management application may be implemented on any suitable platform (e.g., personal computer, palmtop computer, laptop computer, personal digital assistant, cellular phone, etc.) to provide such features.

Internet and application server 110 may be any server suitable for providing access to the dispute management application. Internet and application server 110 may, for example, provide one or more pages to access devices 115 using one or more suitable protocols (e.g., the HyperText Transfer Protocol (HTTP) and Transmission Control Protocol/Internet Protocol (TCP/IP)). The pages may be defined using, for example, any suitable markup language (e.g., HyperText Markup Language (HTML), Dynamic HyperText Markup Language (DHTML), pages defined using the Extensible Markup Language (XML), JavaServer Pages (JSP), Active Server Pages (ASP), or any other suitable approaches). The pages may include scripts, computer code, or subsets of computer code, that define mini-programs (e.g., Perl scripts, Java applets, Enterprise JavaBeans (EJB), or any other suitable approaches). The dispute management application may be designed using suitable modular approaches such as, for example, Java 2 Platform—Enterprise Edition (J2EE), Component Object Model (COM), Distributed Component Object Model (DCOM), or any other suitable approach.

Internet and application server 110 may run a database engine suitable for maintaining a database of user and dispute management information such as, for example, Microsoft SQL Server, Oracle 8i, or any other suitable database engine. In some embodiments, user and dispute management information may be organized and maintained as peer groups, by, for example, the code provided by PeerIQ, Inc., a Delaware corporation having a place of business in Hoffman Estates, Illinois. In practice, features of Internet and application server 110 may be integrated into a single server, or may be distributed across multiple servers that are interconnected via Internet 100 or another communications network (e.g., an Ethernet LAN).

Links 105 may include any transmission medium suitable for providing Internet access to access devices 115. Links 105 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or suitable combination of such links. Different links 105 may be of different types depending on, for example, the particular type of access devices 115.

Any protocol or protocol stack suitable for supporting communications between access devices 115 and Internet and application server 110 over links 105 based on the particular device 115 and link 105 may be used. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

FIG. 2 shows another illustrative arrangement for the dispute management system of the present invention. In the client/server arrangement of FIG. 2, personal computers 120 (sometimes also referred to herein as access devices) are interconnected via network 150 to application server 140. Application server 140 may be any server suitable for providing dispute management features. Application server 140 may, for example, maintain a database of user and dispute management information. Application server 140 may run a suitable database engine such as, for example, Microsoft SQL Server, Oracle 8i, or any other suitable database engine. In practice, the features of application server 140 may be integrated into a single server, or may be distributed across multiple servers that are interconnected via network 150.

Network 150 may be any suitable local area network (LAN), wide area network (WAN), or other suitable network. Personal computers, and their interconnection via networks, are well known. Personal computers 120 may run suitable e-mail, HTTP, or other clients and client applications for providing users with access to the features of the system. In still another suitable approach, personal computers 120 may run suitable Internet browsers to provide users with access to the Internet via an Internet server (not shown). If desired, one or more personal computers 120 may be accessed by remote access device 130 to provide remote access to users to the system. Remote access device 130 may be any suitable device, such as a personal computer, personal digital assistant, cellular phone, or other device with remote access capabilities.

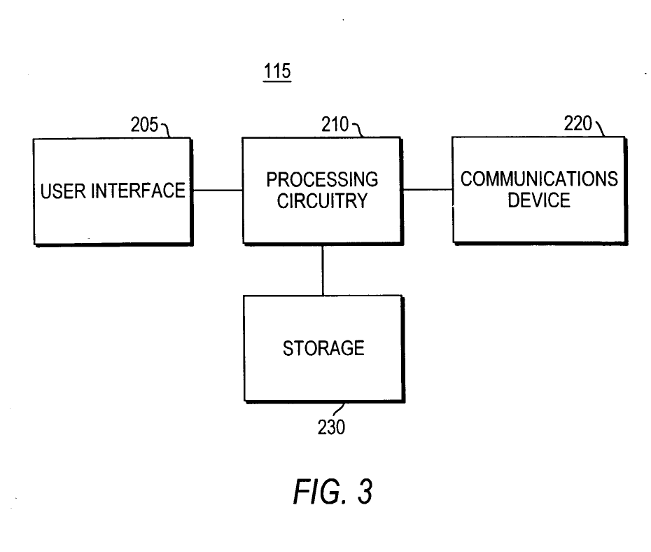

FIG. 3 shows an illustrative, generalized arrangement for the access devices 115 of FIG. 1 and the personal computers 120 of FIG. 2. Access devices 115 may have, for example, user interface 205, processing circuitry 210, communications device 220, and storage 230. User interface 205 may be any suitable input device, output device, or combination thereof. User interface 205 may include, for example, a pointing device, keyboard, touch-pad, touch screen, pen stylus, voice recognition system, mouse, trackball, cathode ray tube (CRT) monitor, liquid crystal display (LCD), voice synthesis processor and speaker, or any other suitable user input or output device. Processing circuitry 210 may include any suitable processor, such an Intel Pentium® microprocessor or group of processors, and other suitable circuitry (e.g., input/output (I/O) circuitry, direct memory access (DMA) circuitry, etc.). Communications device 220 may be any device suitable for supporting communications over links 105. Communications device 220 may include, for example, a modem (e.g., any suitable analog or digital standard, cable, or cellular modem), network interface card (e.g., an Ethernet card, token group card, etc.), wireless transceiver (e.g., an infrared, radio, or other suitable analog or digital transceiver), or other suitable communications device. Storage 230 may be any suitable memory, storage device, or combination thereof, such as RAM, ROM, flash memory, a hard disk drive, etc.

The dispute management application of the present invention may be implemented using application software that runs primarily on access device 115, internet and application server 110, or any suitable combination thereof.

In a personal-computer-based system, a user may access the dispute management application by browsing to an Internet web site or a site on a private network. In another embodiment, dispute management applications based on cellular telephones or the like may be launched by selecting an appropriate on-screen menu option presented on the display of the cellular telephone.

For purposes of brevity and clarity, and not by way of limitation, the dispute management application of the present invention is primarily described herein in conjunction with the use of a personal-computer-based system. It will be understood that this is merely an illustrative embodiment of the present invention, and that any other suitable access device or combination of access devices may be used.

As used herein, a “user” may be any suitable party or its representative, neutral, case manager, arbitrator, claimant, respondent, or other party, that has access to the system. Sometimes users are involved in disputes and sometimes may be referred to herein as “disputing parties.”

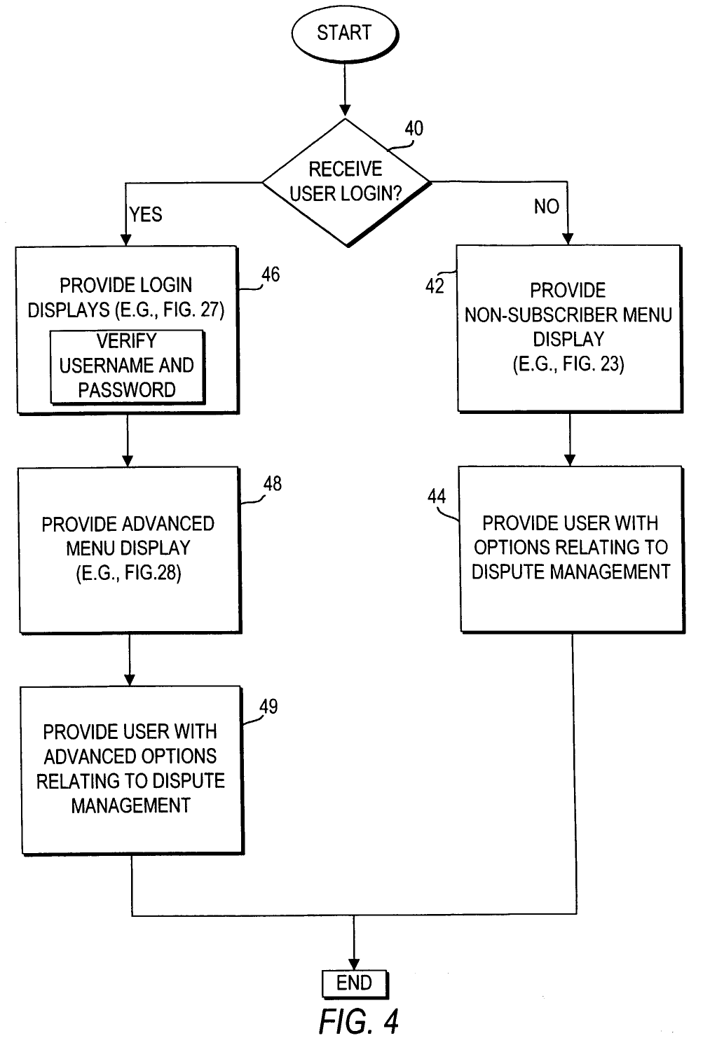

FIGS. 4-22 are flowcharts of illustrative methods for providing dispute management features in accordance with various embodiments of the present invention. In practice, the steps shown in FIGS. 4-22 are only illustrative and may be performed in any suitable order. In practice, there may be additional steps or some of the steps may be deleted.

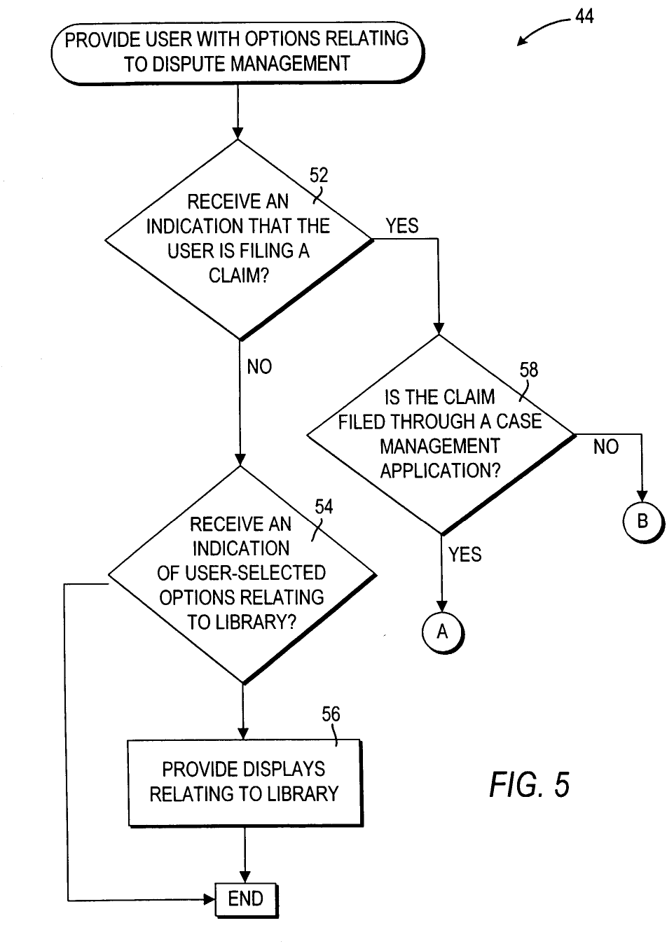

FIG. 4 shows a generalized flowchart of illustrative steps involved in providing features for dispute management in a dispute management application. At step 40, the dispute management application determines if a user login has been received. When a user login has not been received, the dispute management application may provide the user with a non-subscriber menu display (as shown in FIG. 4) at step 42. The menu display may provide the user with access to information about the system provider's services, access to information about the system provider, or perform any other suitable function. The menu display may also provide the user with other content (e.g., advertisements, messages, graphics, etc.). At step 44, the dispute management application may provide the user with options relating to dispute management. Such options may include, for example, filing a claim, accessing the library, or any other suitable option. An illustrative method for providing the user with options relating to dispute management is shown below in FIG. 5.

FIG. 5 is a flowchart of illustrative steps involved in providing options relating to dispute management. At step 52, the dispute management application may determine whether the dispute management application has received an indication that the user is filing a claim. For example, the dispute management application may determine whether the user has selected a “file a claim” button.

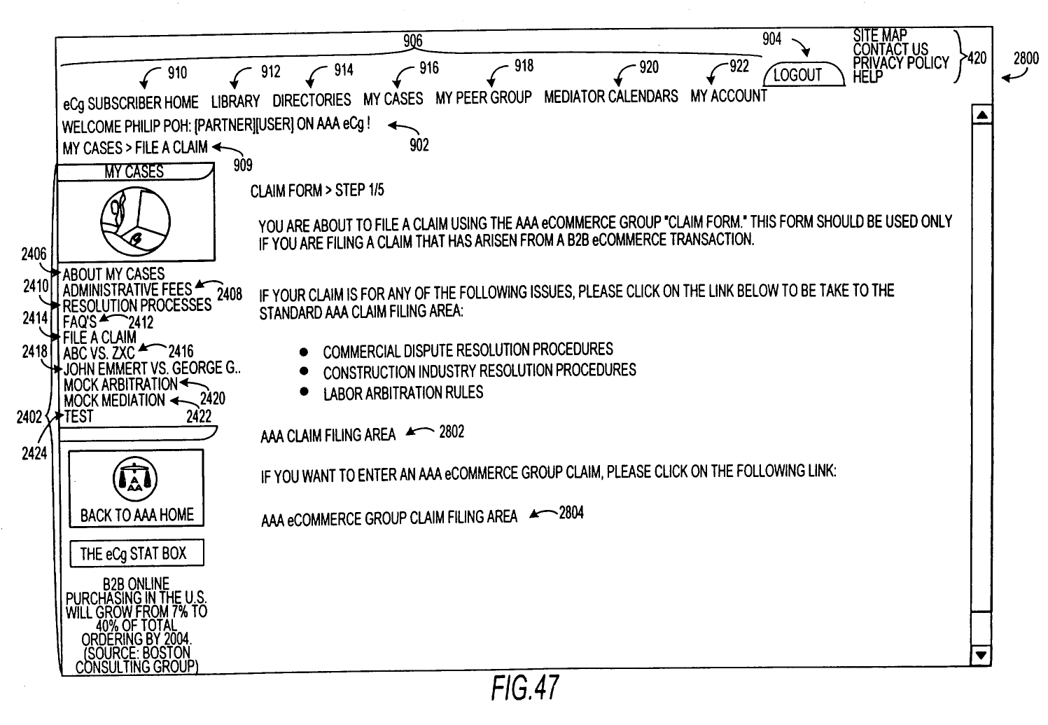

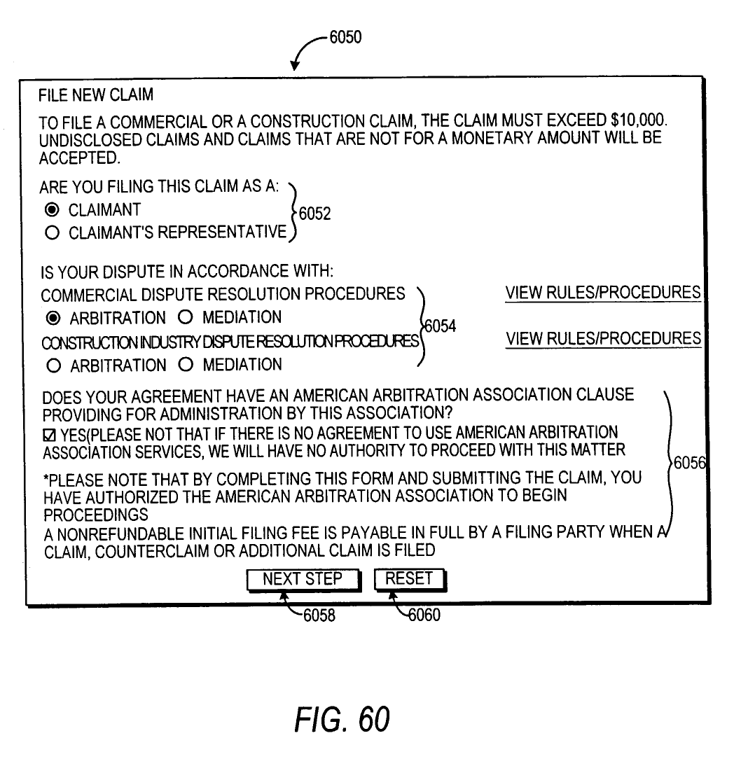

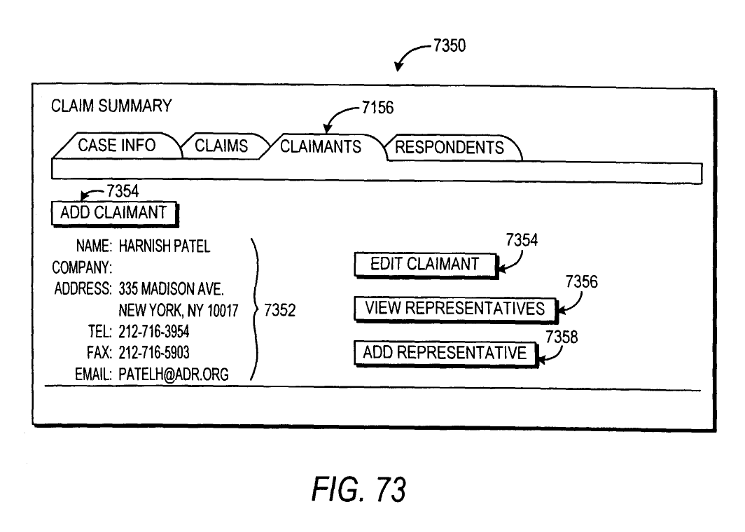

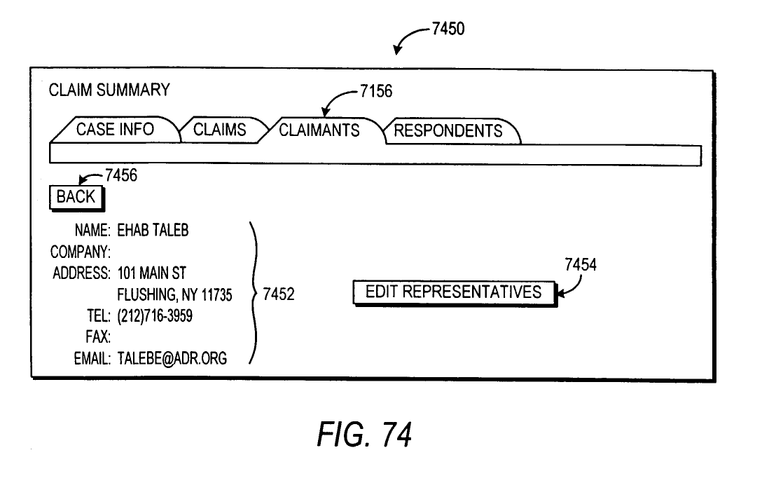

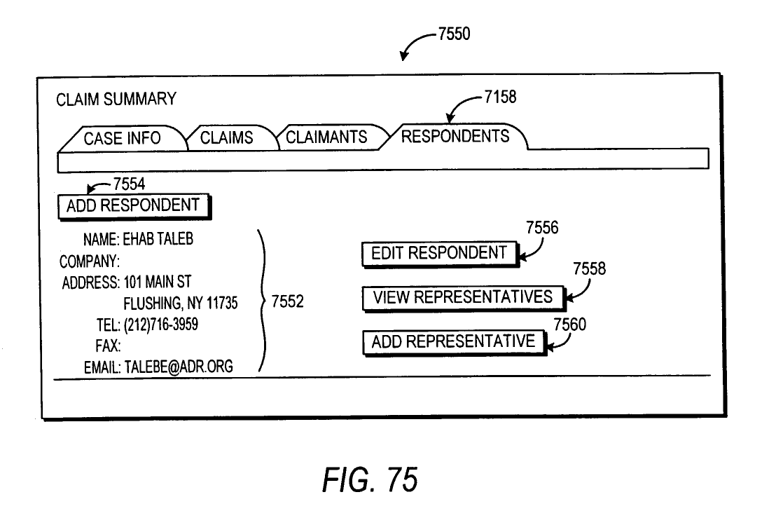

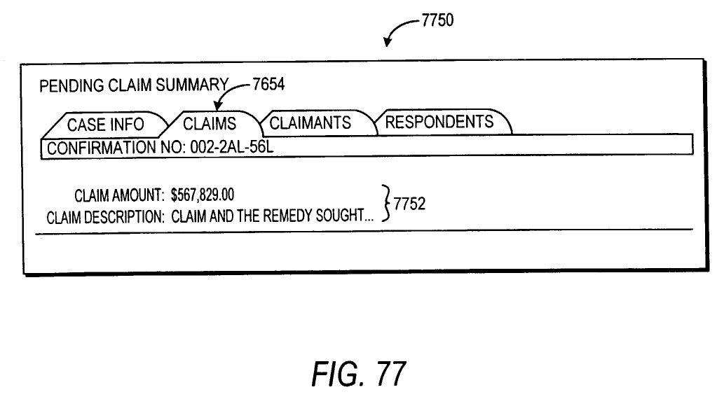

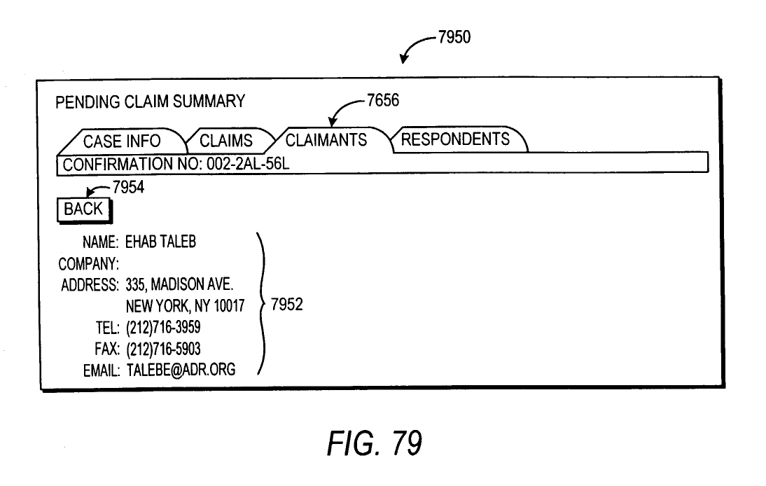

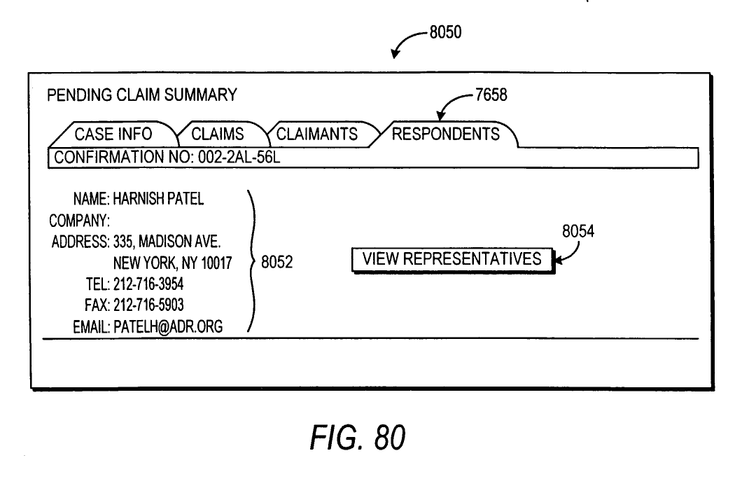

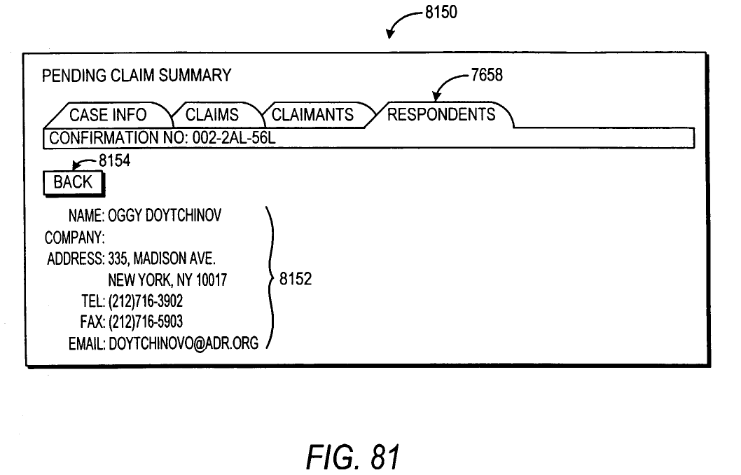

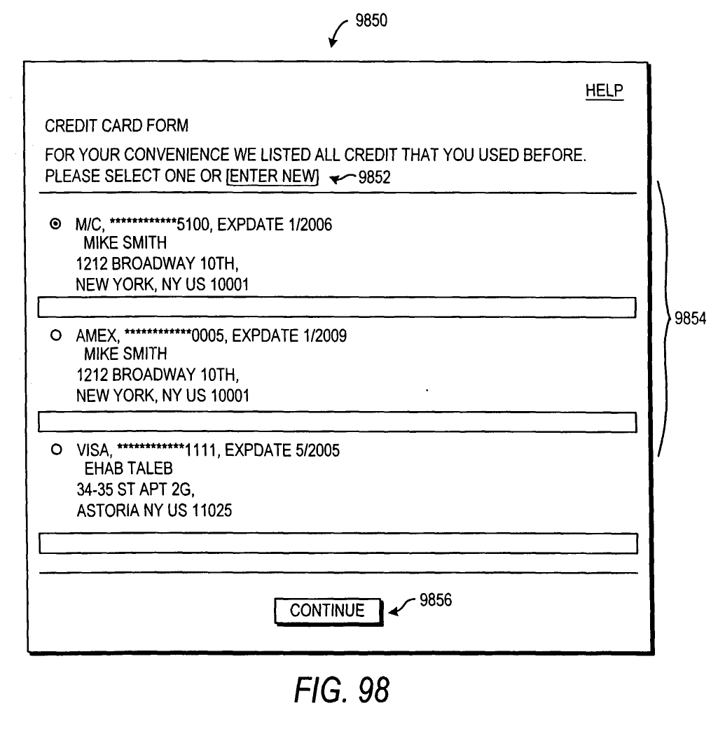

As discussed below, two illustrative embodiments for filing a claim are shown in FIGS. 47-52 and FIGS. 60-104. As shown below, FIGS. 47-52 show an illustrative user interface for providing users with various dispute management features. An alternative illustrative user interface shown in FIGS. 60-104 may also provide users with various dispute management features. Regardless of how the user interfaces are provided, the user is provided with illustrative dispute management features. While the two embodiments are described separately, their features may be combined in any suitable way, modified in accordance with the other approaches, or performed instead of or in addition to the features of the approaches. For example, and not by way of limitation, the graphical user interfaces of some of the approaches may be combined with the display regions of other approaches. Any other suitable combination, substitution or exchange of features between the interface approaches described herein, or with any other suitable interface approach, may be used.

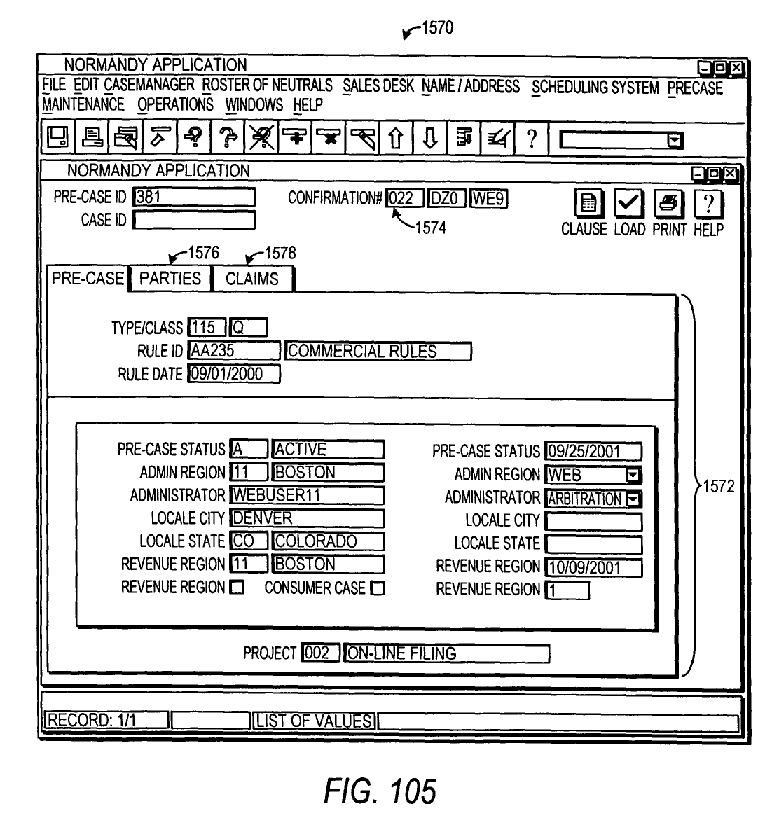

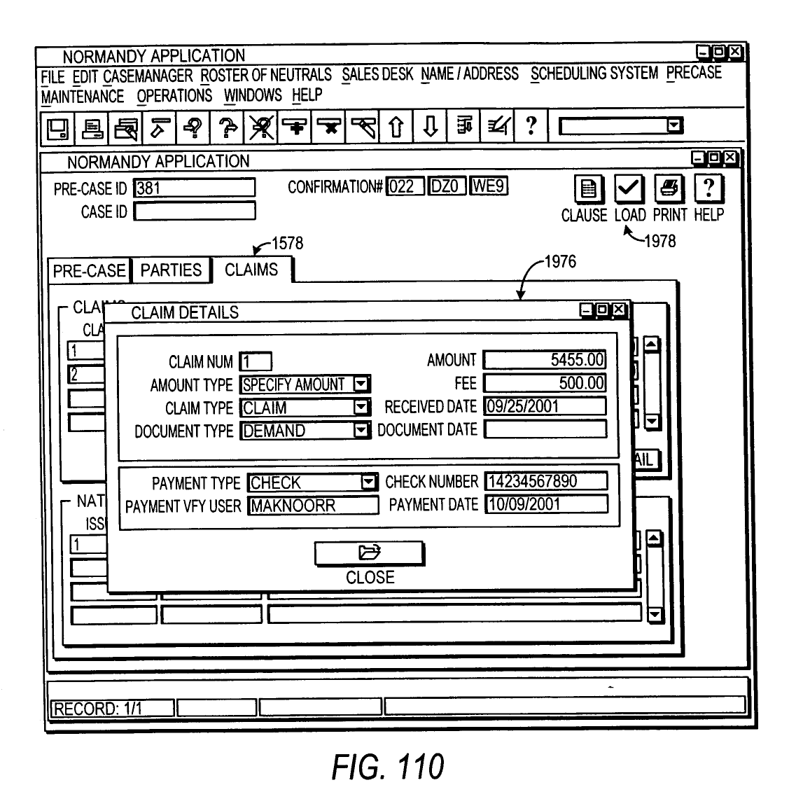

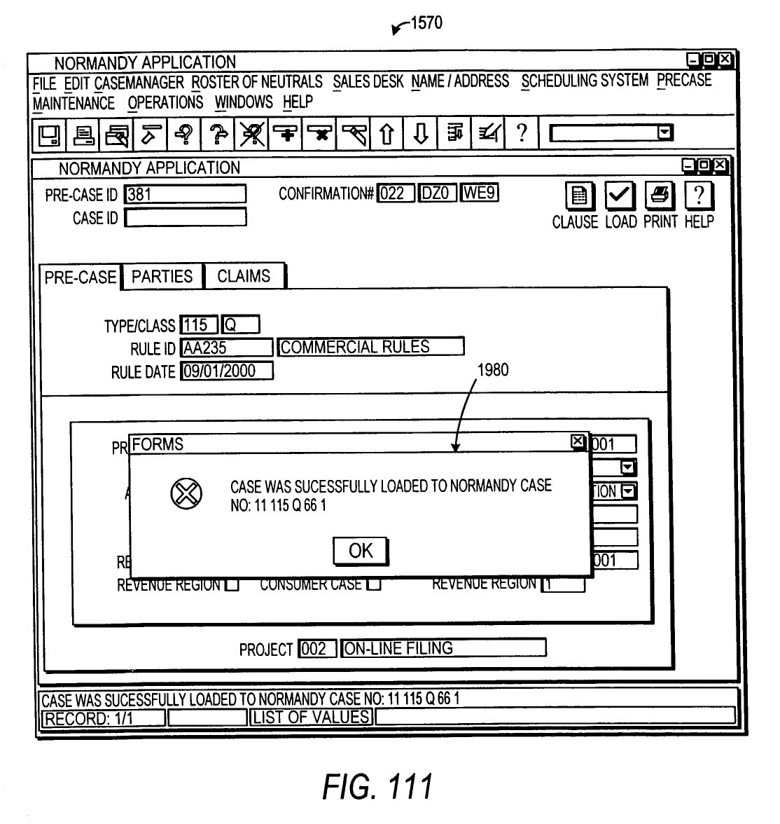

In some embodiments, the dispute management application may allow users to use a “pre-filing” approach by implementing a case filing application. For example, a user may input information, such as claim-related information (e.g., claimant information, respondent information, claim amount, type of claim, etc.) into a case filing application when the user is determining whether to file the claim (“pre-file” the claim). In response to an indication from the user to file the claim, the claim filing application may communicate the inputted or “pre-filed” information to the dispute management application. In some embodiments, the inputted information may be populated throughout the dispute management application such that the user may not be required to re-enter information. Illustrative displays and features for an illustrative case filing application are shown in FIGS. 105-111 and described in the accompanying text. Illustrative user interfaces and features for case filing and case management applications are also described in U.S. provisional patent application No.______ (Attorney Docket No. AAA-004 Prov.), filed Nov. 21, 2001, which is hereby incorporated by reference herein in its entirety.

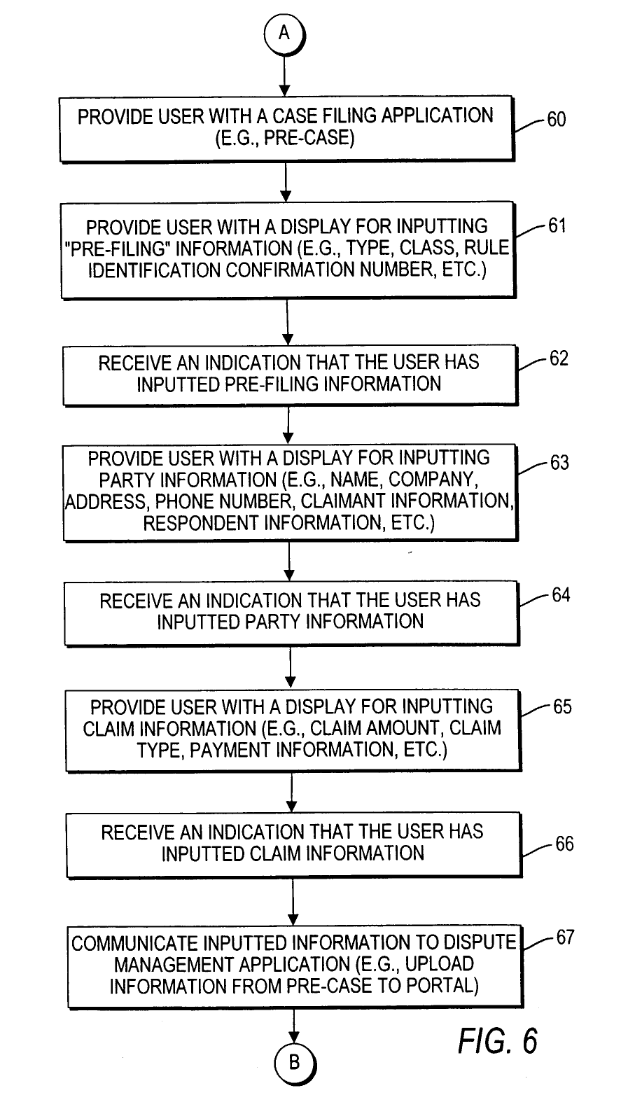

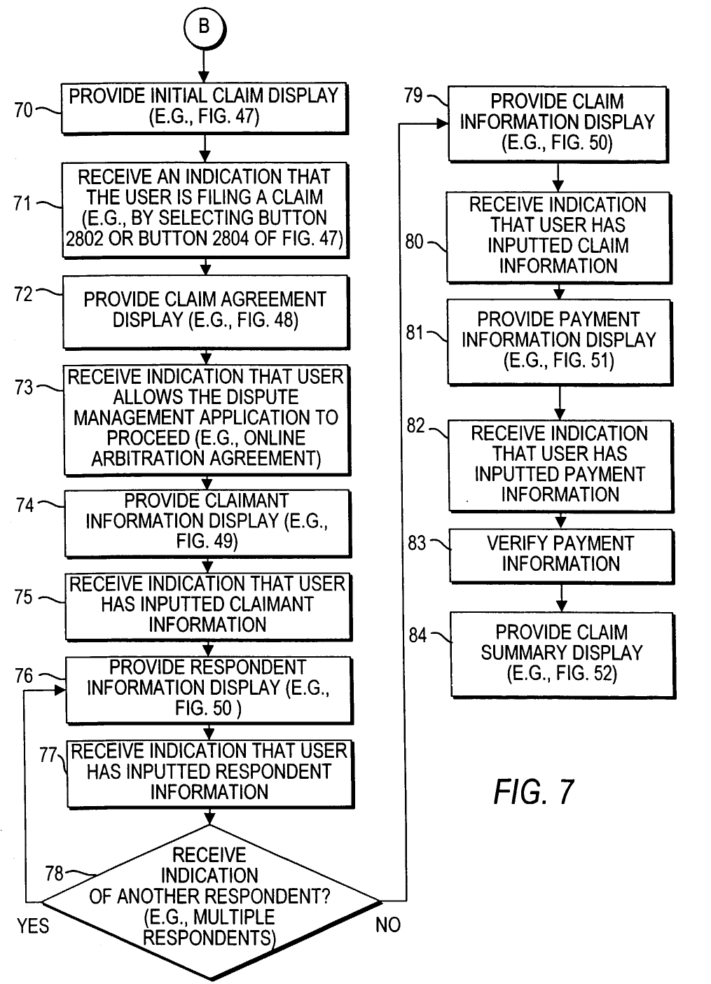

In response to receiving an indication that the user is filing a claim, the dispute management application may determine if the claim was filed through a case filing application. An illustrative method for providing the user with displays relating to filing a claim using a case filing application are discussed below in FIG. 6. In some embodiments, the dispute management application may provide illustrative user interfaces in response to a user that has filed the claim through a case filing application or in response to an indication from a user to file a claim through the dispute management application. An illustrative method for providing the user with displays relating to filing a claim using the dispute management application are discussed below in FIG. 7.

FIG. 6 is a flowchart of an illustrative method for providing displays relating to filing a claim using a case filing application or a case filing portion of the dispute management application. Illustrative user interfaces and features for a case filing application are shown in FIGS. 105-111 and described in the accompanying text. In response to the user filing a claim through a case filing application, the dispute management application or any other suitable application may transfer the user to a case filing application at step 60. At step 61, the case filing application may provide the user with an illustrative display for inputting “pre-filing” information. Pre-filing information may include, for example, a case identification number, the status of the case, a rule identification number, a confirmation number, or any other suitable information related to filing a case.

In response to the case filing application receiving an indication that the user has inputted the pre-case information (step 62), the case management application may provide the user with a display for inputting party information at step 63. Party information may include, for example, claimant information (e.g., name, company, address, telephone numbers of the claimant, etc.), respondent information (e.g., name, company, address, telephone numbers of the respondent, etc.), information on the representative of the claimant, information on the representative of the respondent, or any other suitable party information. In response to the case filing application receiving an indication that the user has inputted party information (step 64), the case filing application may provide the user with a display for inputting claim information. Claim information may include the amount of the claim, the type of claim (e.g., on-call mediation, in-person mediation, in-person arbitration, documents-only arbitration), the fees associated with the claim, the nature of the dispute (e.g., breach of contract), or any other suitable claim information.

In response to the case filing application receiving an indication that the user has inputted the claim information (step 66), the case filing application may communicate the inputted information to the dispute management application at step 67. For example, the case filing application may store the submitted information in a database on Internet and application server 110. Internet and application server 110 may run a database engine suitable for maintaining a database of user and dispute management information such as, for example, Microsoft SQL Server, Oracle 8i, or any other suitable database engine. In response to an indication that the user is accessing the dispute management application with, for example, a computer, Internet and application server 110 may upload the information into the dispute management application (e.g., populate Oracle forms with submitted information).

FIG. 7 is a flowchart of an illustrative method for providing users with displays relating to filing a claim using the dispute management application. In response to receiving inputted information from a case filing application or receiving an indication that the user is filing a claim through the dispute management application, the dispute management application may provide the user with an initial claim display (e.g., FIGS. 47 and 60) at step 70.

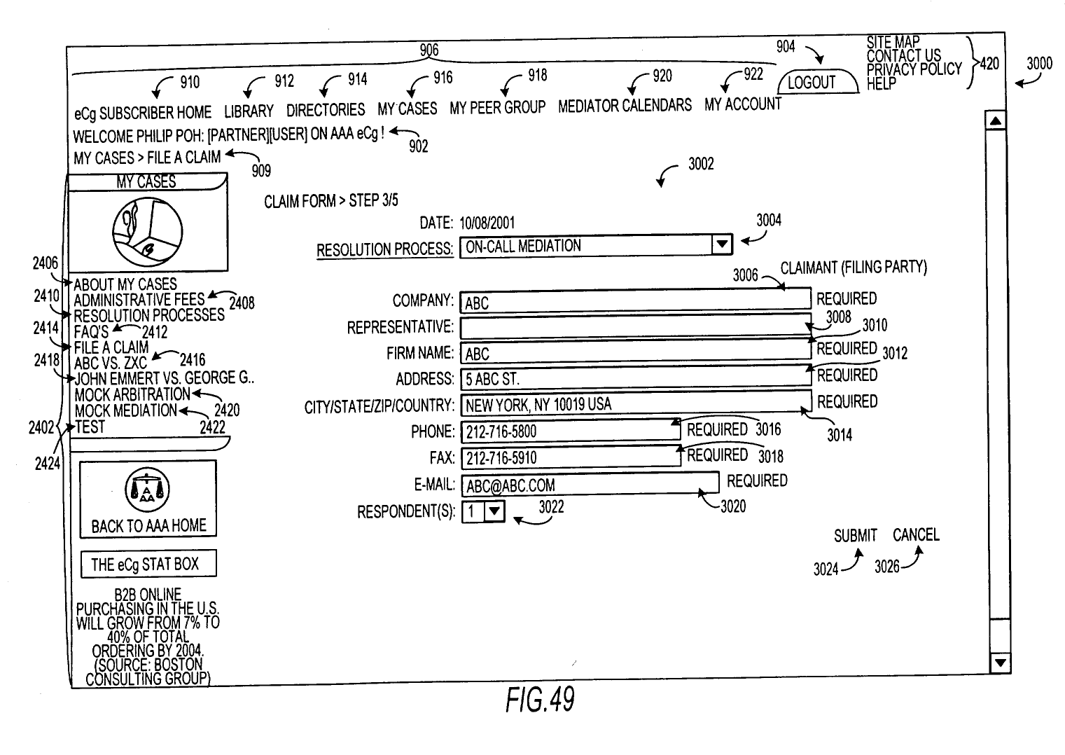

In some embodiments, the information inputted through the case filing application may populate the user interfaces of the dispute management application. For example, in response to a user accessing a claimant information display (e.g., FIG. 49), the particular text fields corresponding to the claimant information may be populated such that the user may not re-enter the claimant information. Although described as the dispute management application sometimes populating the text fields of the dispute management application, the dispute management application may populate any suitable user interface, such as, for example, push buttons, check boxes, radio buttons, drop-down menus or lists, input fields or text boxes, or any other suitable graphical user interface construct.

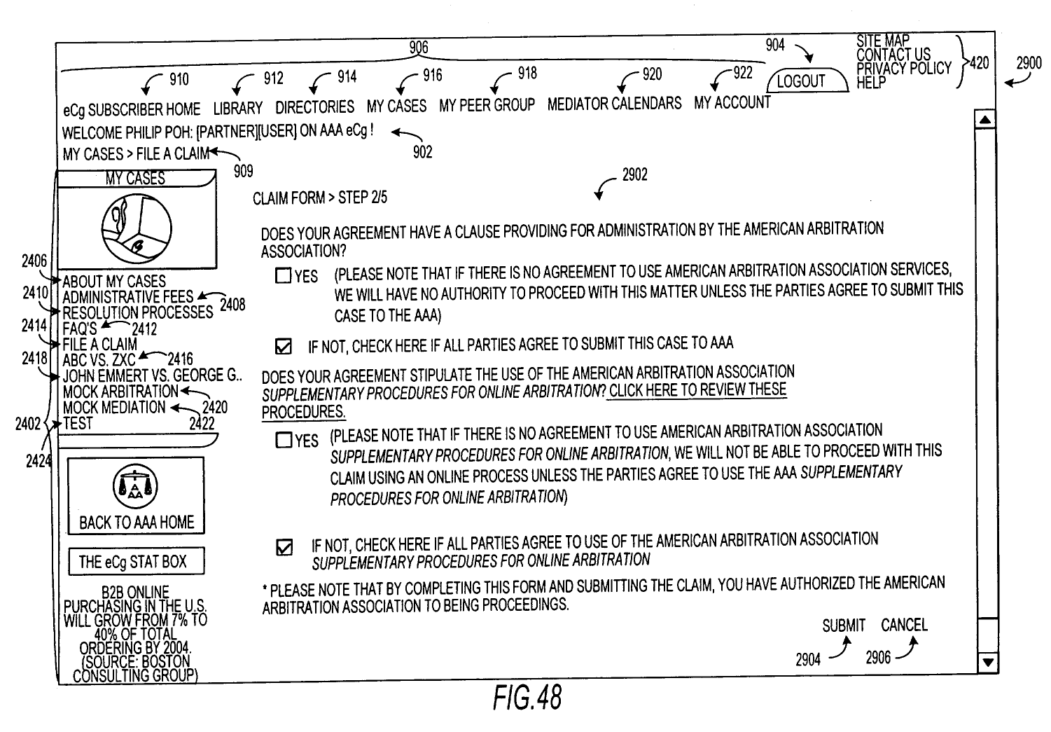

At step 71, the dispute management application may receive an indication that the user is filing a claim. For example, the user may select an “AAA eCommerce group Claim Filing Area” button 2804 (FIG. 47). In response to receiving the indication, the dispute management application may provide the user with a claim agreement display (e.g., FIG. 48) at step 72. Claim agreement display may query the user with multiple questions, such as “Does your agreement have a clause providing for administration by the American Arbitration Association?” or “Does your agreement stipulate the use of the American Arbitration Association Supplementary Procedures for Online Arbitration?” However, any other suitable query may be made, such as, for example, “Do you agree to submit this case to the American Arbitration Association?”

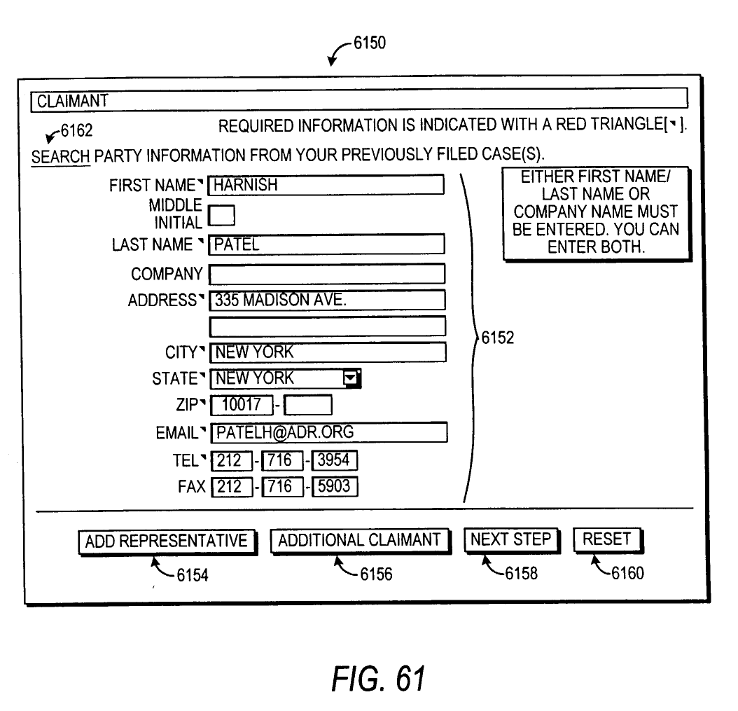

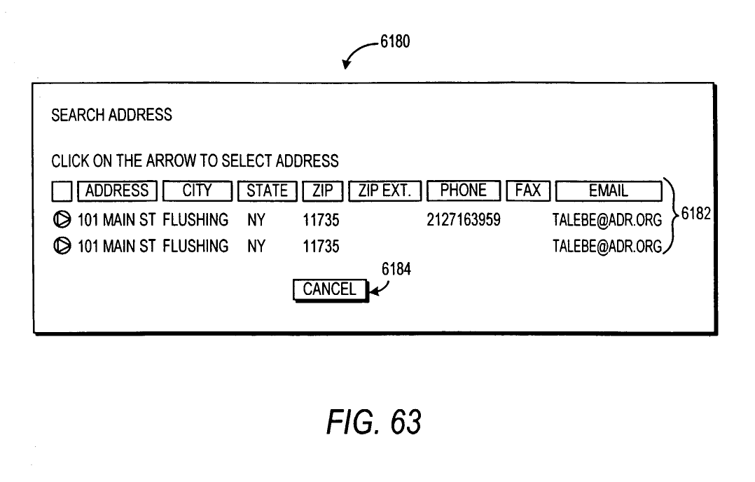

In response to receiving an indication that the user responded to the queries (step 73), the dispute management application may provide the user with a claimant information display, such as the illustrative claimant information display shown in FIGS. 49 and 61 (step 74). In response to receiving an indication that the user has inputted the claimant information (step 75), the dispute management application may provide the user with a respondent information display, such as the illustrative respondent information display shown in FIGS. 50 and 63. Claimant and respondent information may include, for example, name, address, company name, representative, phone numbers, e-mail addresses, resolution process, number of respondents, nature of the dispute, relief sought, or any other suitable information.

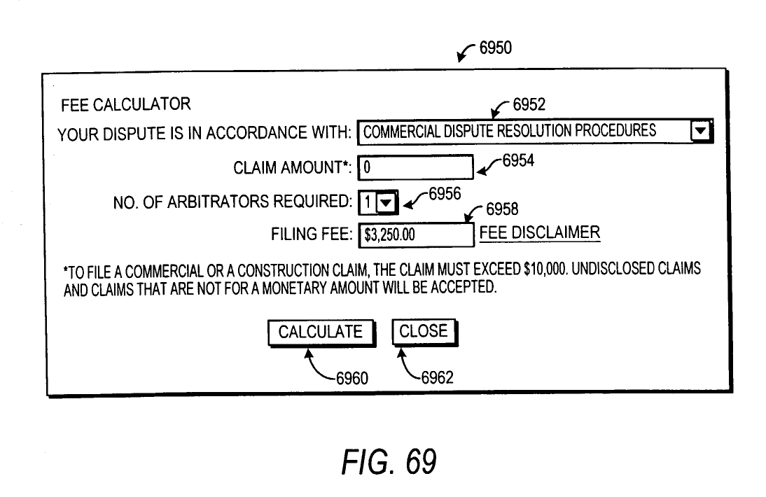

In response to receiving an indication that the user has inputted the respondent information (step 77), the dispute management application may determine whether there are multiple respondents at step 78. Whether the claimant-user indicated that there are multiple respondents, the dispute management application may return to step 76. When the user has completed inputting respondent information, the dispute management application may provide the user with a claim information display at step 79. For example, illustrative claim information displays are shown in FIGS. 50 and 69 and are described in the accompanying text. The dispute management application may allow the user to input claim information, such as an identification number, the nature of the dispute, the relief sought, or any other suitable claim information.

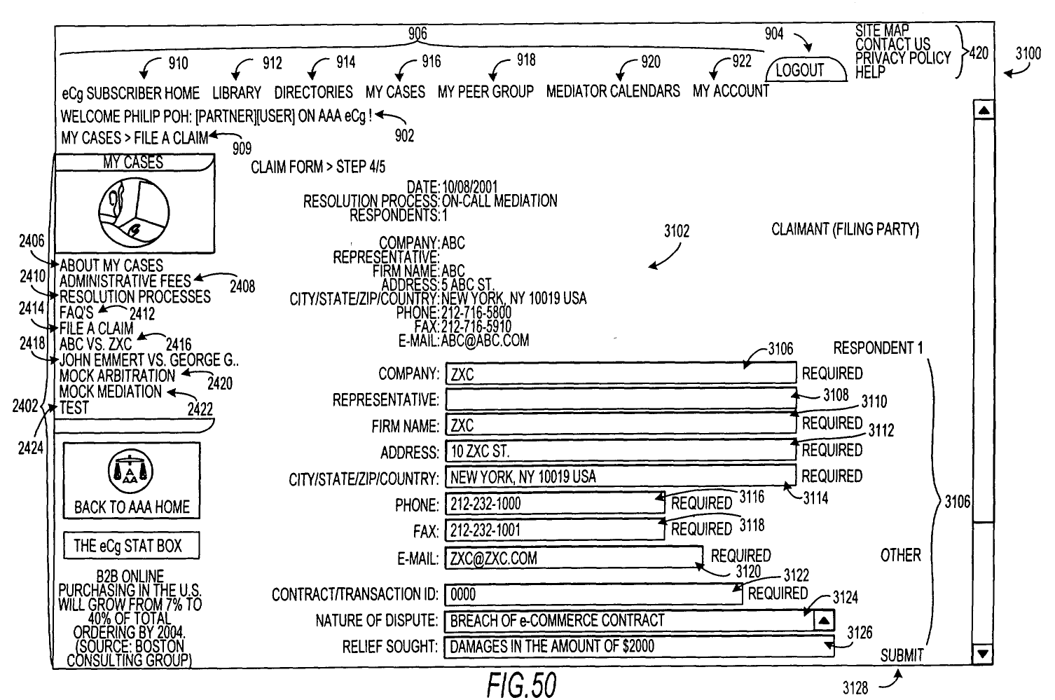

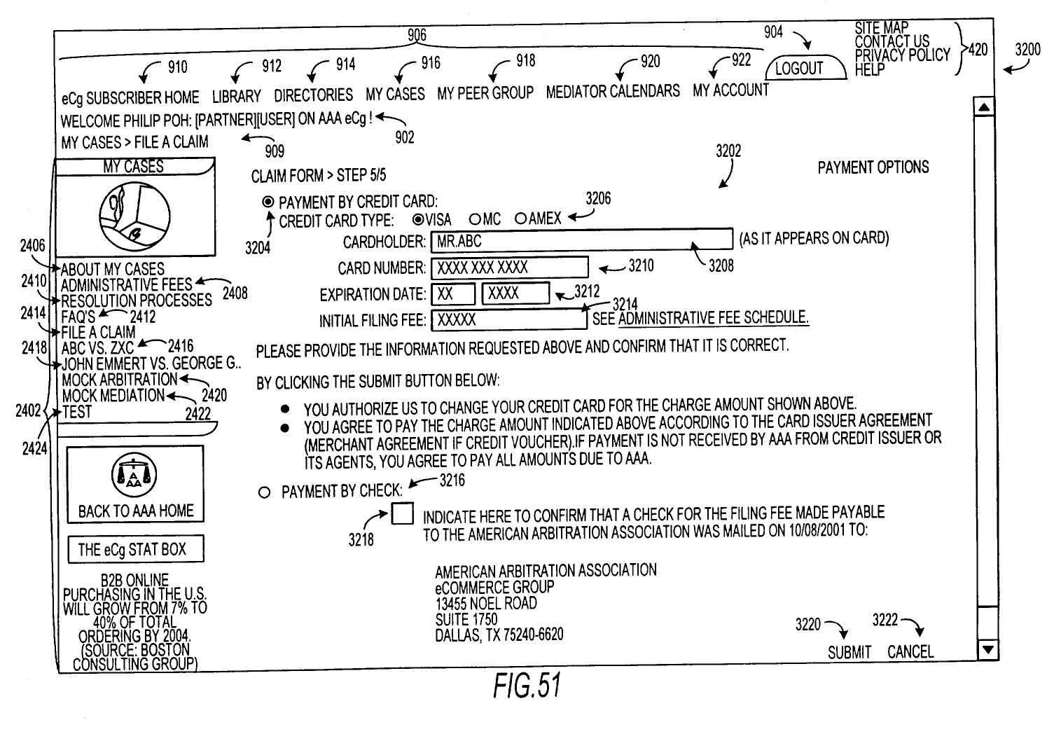

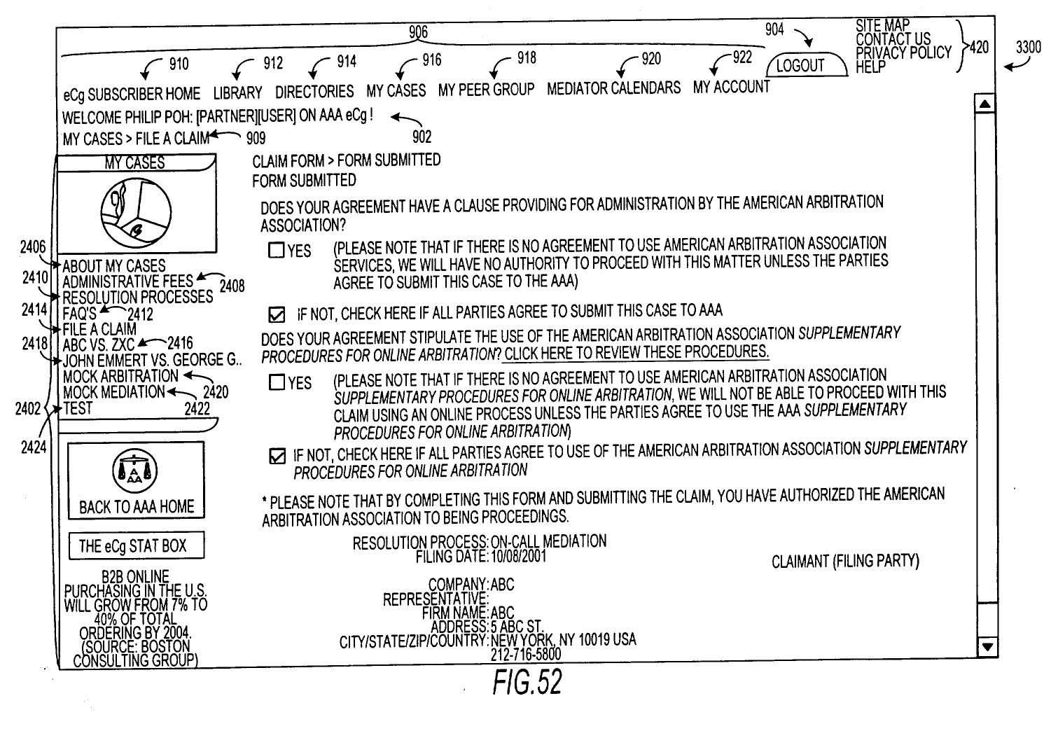

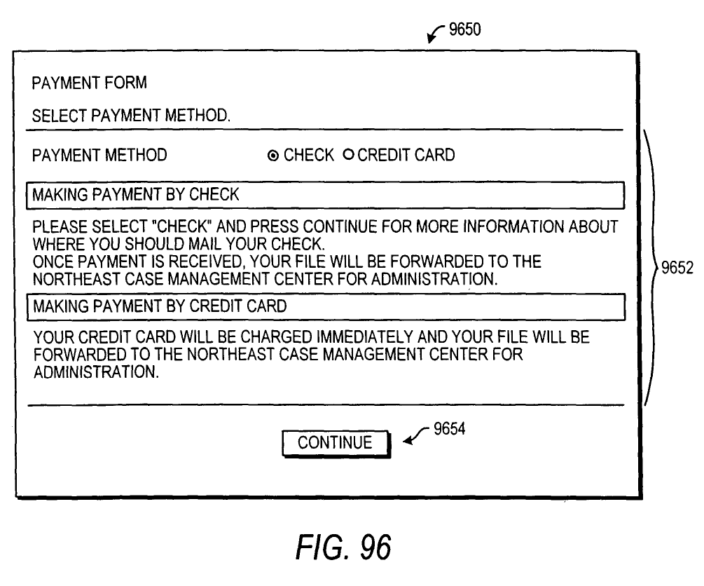

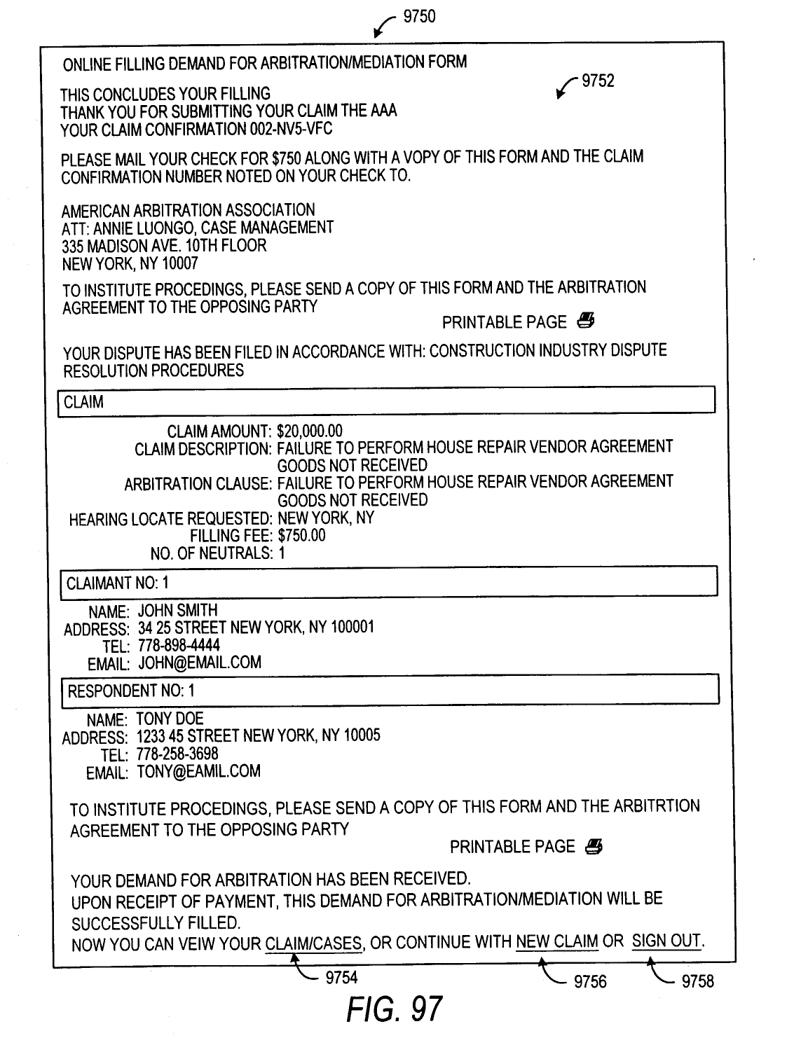

In response to receiving an indication that the user has inputted the claim information (step 80), the dispute management application may provide the user with a payment information display, such as, for example, the illustrative payment information displays shown in FIGS. 51 and 96 and are described in the accompanying text. The payment information display may allow the user to input payment information, such as credit card information. The dispute management application may also allow the user to indicate a payment by check. In response to the user inputting payment information (step 82), the dispute management application may verify the payment information at step 83. At step 84, upon verifying the payment information, the dispute management application may provide the user with a claim summary display (e.g., FIGS. 52 and 97). The claim summary display may include a verification of the submitted information.

Referring back to FIG. 4, if the dispute management application receives an indication that the user is logging in, the dispute management application may provide login displays to the user at step 46. The dispute management application may receive an indication by, for example, the user selecting a “login” button. Login displays may, for example, include interfaces, such as text fields, so that the user may input a username and a password. In some embodiments, the login display may allow a user to indicate that the user has forgotten his or her password, allow a user to register with the dispute management application, or perform any other suitable function. At substep 47, the dispute management application may verify the username and password in response to the user inputting the username and password.

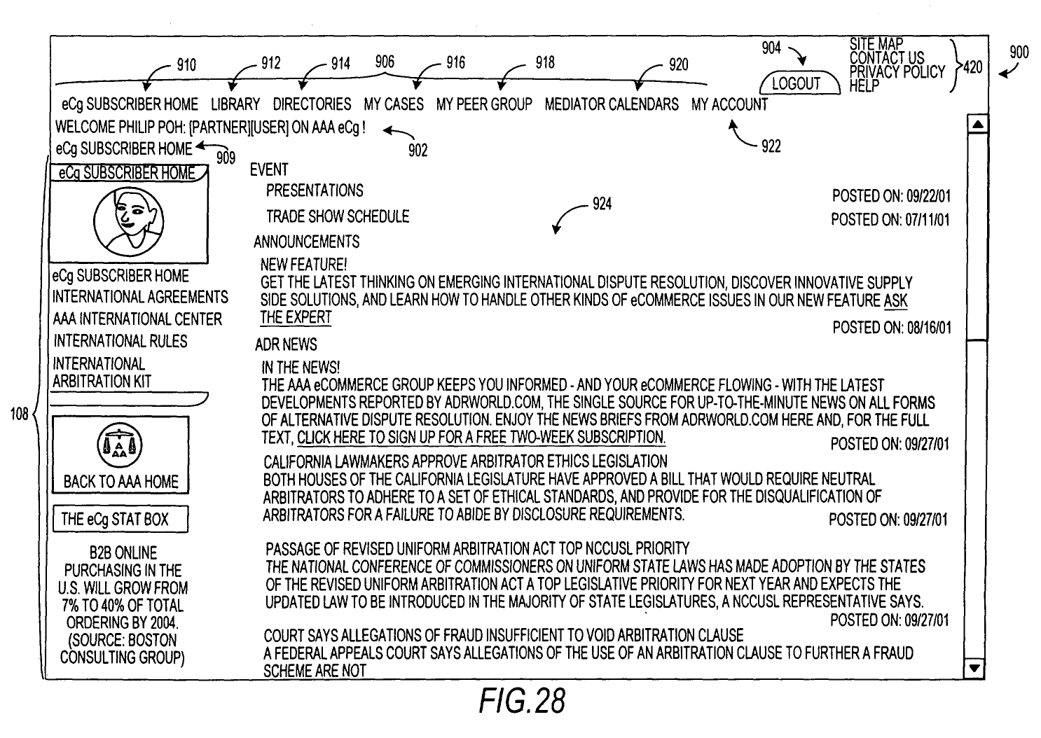

In response to verifying the password, the dispute management application may provide the user with an advanced menu displays, such as a “Subscriber” main menu shown in FIG. 28 (step 48). At step 49, the dispute management application may provide the user with advanced options relating to dispute management.

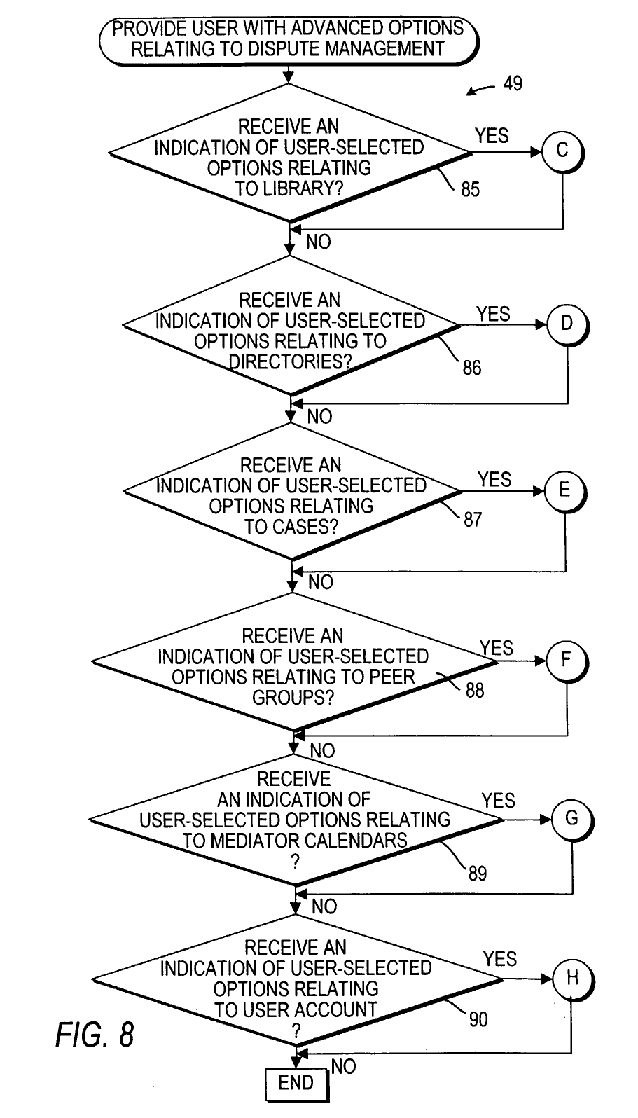

FIG. 8 is a flowchart of an illustrative method for providing users with advanced options relating to dispute management. Such advanced options may include, for example, accessing online resources (e.g., the library feature), viewing directory information, viewing case information, participating in an online arbitration, joining peer groups, viewing mediator calendars, or any other suitable option.

In some embodiments, the dispute management application may provide the user with online resources relating to dispute management (hereinafter referred to as the “library”). For example, a user may view information on a variety of alternative dispute resolution process and information on incorporating dispute management into an electronic commerce relationship. The library feature may provide the user with access to books, periodicals, pamphlets, manuscripts, and articles relating to dispute management. The library feature may allow the user to view these online resources in various formats (e.g., text, HTML, Microsoft Word, etc.).

In some embodiments, the library feature may provide the user with alternative dispute resolution (ADR) clauses. These clauses and resources related to ADR clauses may assist a user incorporate or tailor an ADR process into the user's business. For example, a user may view a publication which may assist the user in drafting ADR clauses. In some embodiments, the library feature may provide the user with information relating to ADR processes. Such information may assist a user in understanding the multiple ADR processes. For example, a user may view a primer on mediation and arbitration. In some embodiments, the library feature may provide the user with information relating to ethical codes. Such information may assist a user in understanding the roles that various participants play in a dispute resolution process.

In some embodiments, neutrals are used to assist in a dispute resolution process. In some embodiments, the library feature may provide the user with neutrals criteria. Understanding the standards for selecting neutrals may instill confidence in the parties that participate in a dispute resolution process. In some embodiments, the library feature may provide the user with rules and procedures, which may assist a user in understanding the framework for resolving disputes. For example, a user may view a document relating to procedures for on-call mediation. The library features may also provide a user with surveys and studies, which may assist a user in determining how the user should use ADR processes in the future.

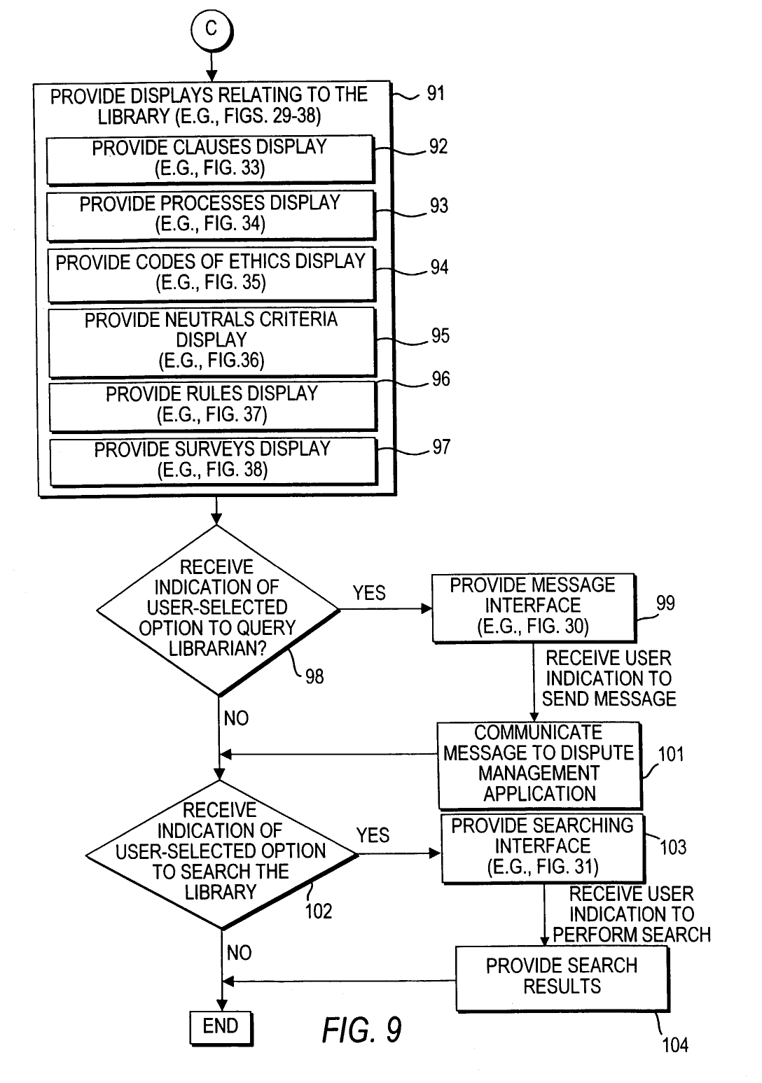

Upon receiving an indication from the user to provide options relating to a library at step 85, the dispute management application may provide the user with options relating to the library. An illustrative method for providing users with options relating to the library is shown in FIG. 9.

FIG. 9 is a flowchart of an illustrative method for providing users with options relating to the library. In response to receiving indication of user-selected options relating to the library, the dispute management application may provide displays relating to the library at step 91. In some embodiments, the dispute management application may provide users with access to information about clauses by providing a clauses display (substep 92), access to information about dispute management processes by providing a processes display (substep 93), access to information about codes of ethics by providing a codes of ethics display (substep 94), access to information about neutrals criteria by providing a neutrals criteria display (substep 95), access to information about rules by providing a rules display (substep 96), access to information about surveys and studies by providing a surveys display (substep 97), or perform any other suitable function. Within each of these steps, the dispute management application may provide a display or displays that provide information suitable to the respective steps. The displays may also provide users with other content (e.g., advertisements, messages, graphics, news, etc.), and access to additional features.

In response to receiving an indication from the user to query an administrator (sometimes referred to herein as a “librarian”) or any other suitable user (step 98), the dispute management application may provide the user with a message interface at step 99. The message interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to send the message, the dispute management application may communicate the message to the librarian at step 101.

In response to receiving an indication from the user to search the library (step 102), the dispute management application may provide the user with a searching interface at step 103. The searching interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to perform the search, the dispute management application may provide the search results to the user.

In some embodiments, the dispute management application may provide contact and resource information relating to dispute management through a directories feature. For example, a user may use the directories feature to view a list of available neutrals and their respective contact information. In some embodiments, the directories feature may provide the user with information relating to ADR providers. For example, a user may view a document relating to inter-association arbitration agreements. In some embodiments, the directories features may provide the user with links. Such links may include a link to a law dictionary, a link to the American Bar Association, and a link to a website that provides access to Asian law resources.

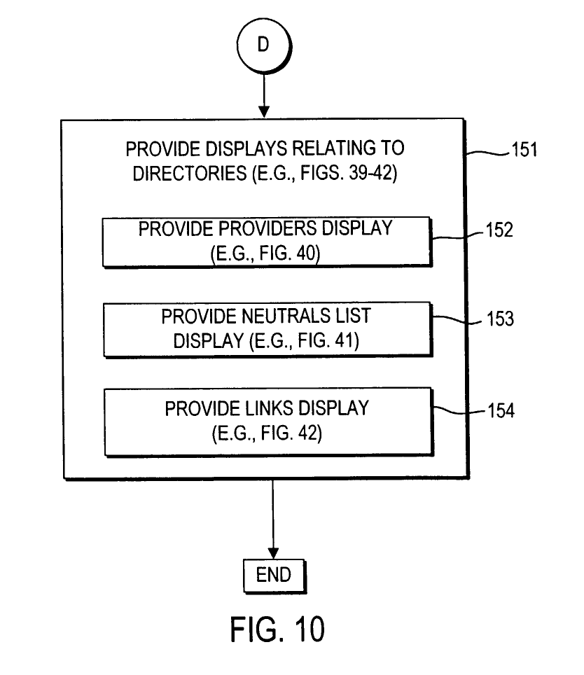

Referring back to FIG. 8, upon receiving an indication from the user to provide options relating to directories at step 86, the dispute management application may provide the user with options relating to directories. An illustrative method for providing the user with options relating to directories is shown in FIG. 10. In response to receiving an indication from a user to provide options relating to directories, the dispute management application may provide displays relating to directories at step 151. In some embodiments, the dispute management application may provide users with access to information about providers by providing a providers display (substep 152), access to neutrals lists by providing a neutrals list display (substep 153), access to links related to dispute management by providing a links display (substep 154), or perform any other suitable function. Within each of these steps, the dispute management application may provide a display or displays that provide information suitable to the respective steps. The displays may also provide users with other content (e.g., advertisements, messages, graphics, news, etc.), and access to additional features.

In some embodiments, the dispute management application may provide the user with a cases feature. The cases feature may provide the user with multiple options relating to cases (e.g., case-specific activities), such as, for example, filing a claim, viewing the status of active cases, and access an active case. In some embodiments, the cases feature may allow a user to participate in a documents-only arbitration, an in-person arbitration, an on-call mediation, an in-person mediation, or any other suitable ADR process. The cases feature may also provide the user with information related to cases and case-specific activities. For example, a user may view documents relating to resolution processes. Such information may assist the user in understanding the various types of resolution process and may assist the user in determining the optimal process for the user's claim.

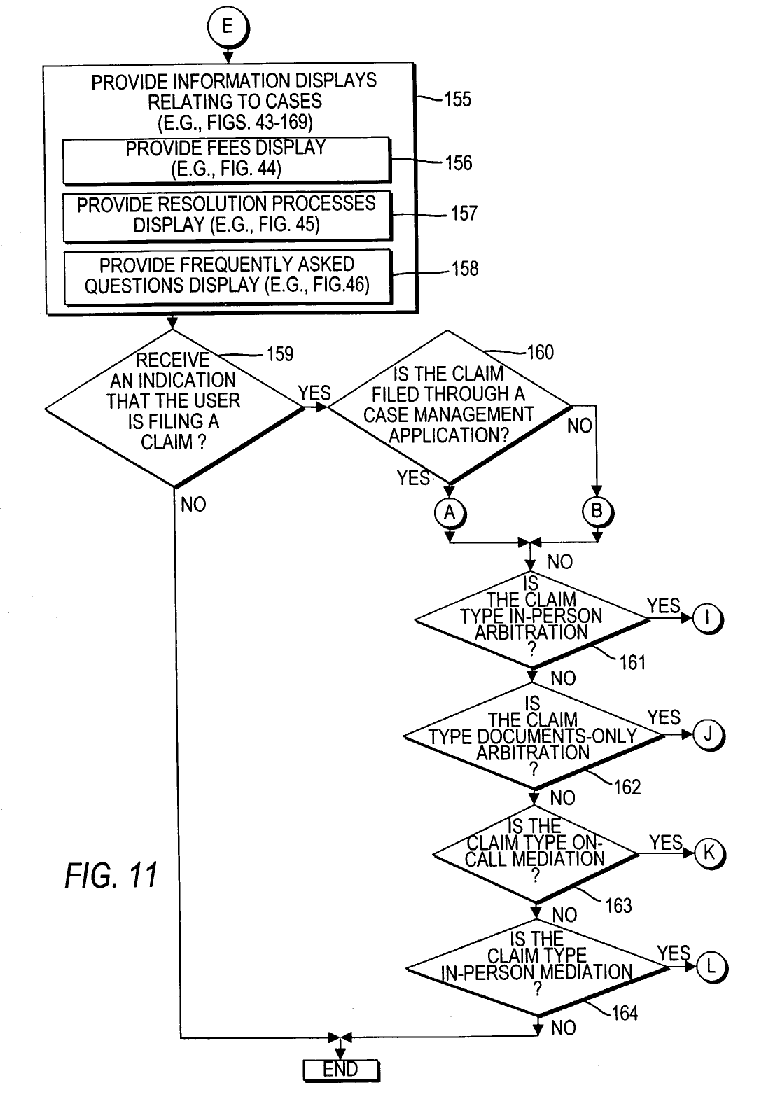

Referring back to FIG. 8, upon receiving an indication from a user to provide options relating to cases at step 87, the dispute management application may provide the user with options relating to cases. Illustrative methods for providing the user with options relating to cases are discussed in FIGS. 11-19.

FIG. 11 is a flowchart of an illustrative method for providing users with options relating to cases. In response to receiving an indication from a user to provide options relating to cases, the dispute management application may provide displays relating to cases at step 155. In some embodiments, the dispute management application may provide users with access to information about fees by providing a fees display (substep 156), access to information about dispute resolution processes by providing a resolution processes display (substep 157), access to frequently asked questions (FAQs) by providing a frequently asked questions display (substep 158), or perform any other suitable function. Within each of these steps, the dispute management application may provide a display or displays that provide information suitable to the respective steps. The displays may also provide users with other content (e.g., advertisements, messages, graphics, news, etc.), and access to additional features.

In response to receiving an indication that the user is filing a claim (step 159), the dispute management application may determine if the user has filed the claim using a case filing application (“pre-filed”) (step 160). If the user is filing the claim through a case filing application, the dispute management application may perform the steps described previously in FIG. 6. If the user is filing the claim through the dispute management application or if the user has filed the claim through a case filing application, the dispute management application may perform the steps described previously in FIG. 7.

In some embodiments, the dispute management application may provide arbitration services (sometime referred to herein as “in-person arbitraton”). Arbitration services may be used to allow one or more neutral arbitrators to consider evidence (e.g., submissions) from both disputing parties and render a decision. For example, when parties have a dispute, they may access an on-line list of potential arbitrators and either agree to use or participate in a selection process to determine the arbitrator. An arbitrator may be appointed by, for example, a case manager. The parties may be provided with a schedule for the submission of arguments, evidence, replies, and any other suitable information. The arbitrator may provide a decision on the dispute.

In some embodiments, the dispute management application may provide documents-only arbitration services. For example, when parties have a dispute, they may access an on-line list of potential arbitrators and either agree to use or participate in a selection process to determine the arbitrator. If desired, an arbitrator may be appointed. Some embodiments may provide the disputing parties with a schedule for the submission of arguments, evidence, replies, and any other suitable information in document format. The arbitrator may view the documents and provide a decision on the dispute.

In some embodiments, the dispute management application may provide mediation services. Mediation services may be used to allow parties to work together with the aid of a neutral facilitator (e.g., a mediator). One particular type of mediation service is referred to herein as on-call mediation. For example, when parties have a dispute, they may access an on-line calendar of mediators' availabilities. The disputing parties (i.e., the claimant and the respondent) may agree to a mediator through a scheduling interface. Upon selecting a mediator and a time slot, the parties may be provided with contact information and a schedule for submitting any documentation. Mediators may be notified of their selection and the time slot may be removed from the online calendar. If the mediator accepts the case, the disputing parties may be notified. In some embodiments, dates and other information may be automatically published for information that is due before the meeting with the mediator.

In response to the user filing a claim, the dispute management application may determine the type of claim that has been filed. In some embodiments, the dispute management application may provide the user with dispute management processes, such as “In-Person Arbitration,” “Documents-Only Arbitration,” “On-Call Mediation,” and “In-Person Mediation.” Although described in context of these processes, any other suitable dispute management process may also be used, such as a Conciliation process.

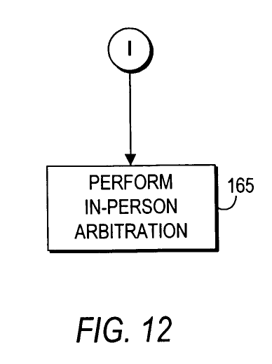

Upon receiving an indication from the user to participate in an “In-Person Arbitration” (step 161), the dispute management application may provide the user with options relating to In-Person Arbitration. An illustrative method for providing the user with features relating to In-Person Arbitration is shown in FIG. 12.

FIG. 12 is a generalized flowchart of an illustrative method for providing users with features relating to In-Person Arbitration. In response to receiving an indication from the user to participate in an In-Person Arbitration, the dispute management application may direct the user to perform the In-Person Arbitration at step 165. In some embodiments, the dispute management application may provide users with access to information about fees, rules, or any other information relating to In-Person Arbitration.

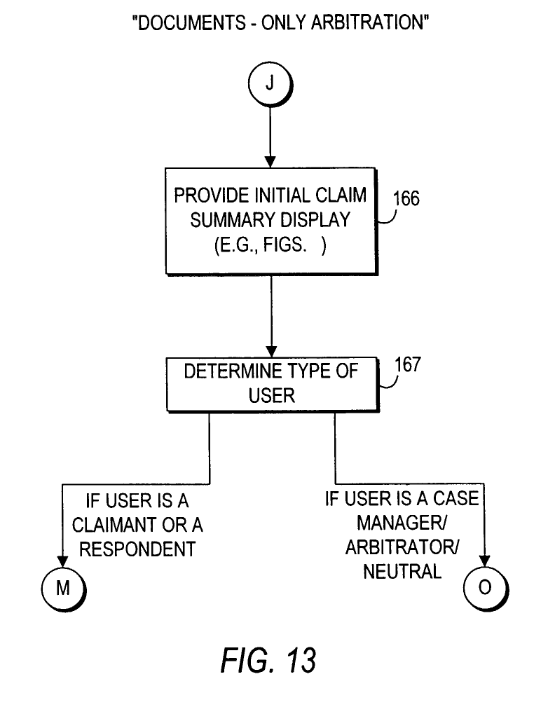

Referring back to FIG. 11, upon receiving indications from the user to participate in a “Documents-Only Arbitration” (step 162), the dispute management application may provide the user with options relating to Documents-Only Arbitration process. An illustrative method for providing the user with features relating to Documents-Only Arbitration are discussed in FIGS. 13-15.

FIGS. 13-15 are flowcharts of illustrative methods for providing users with features relating to Document-Only Arbitration. In FIG. 13, in response to receiving an indication from the user to participate in a Documents-Only Arbitration, the dispute management application may provide the user with an initial claim summary display at step 166.

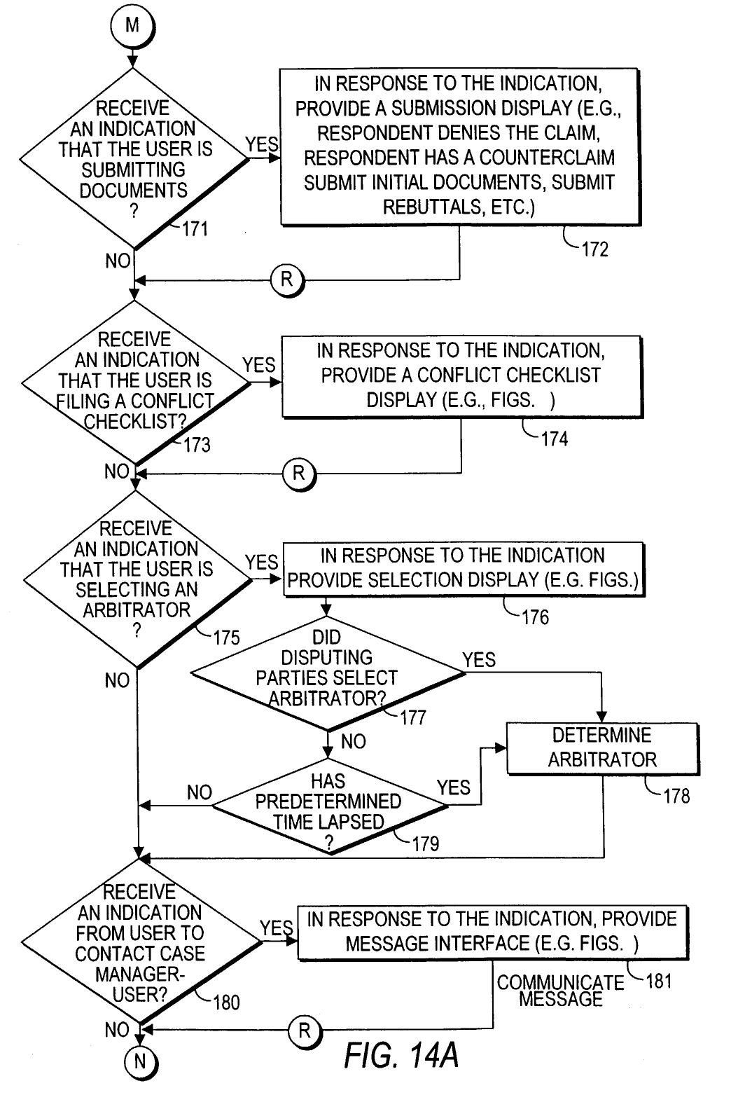

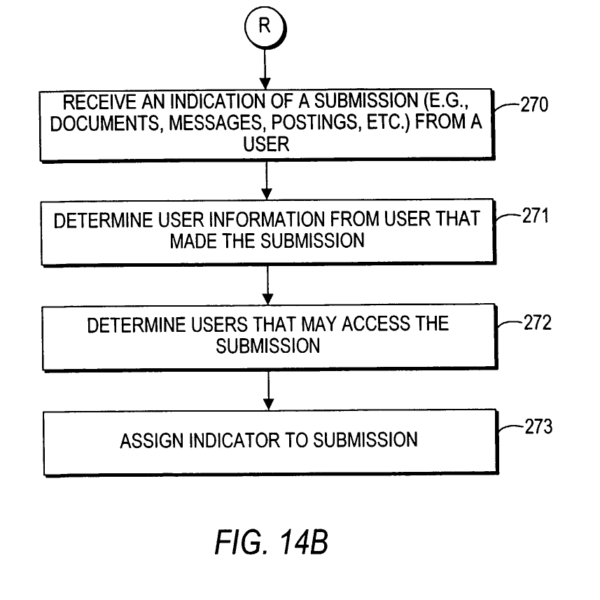

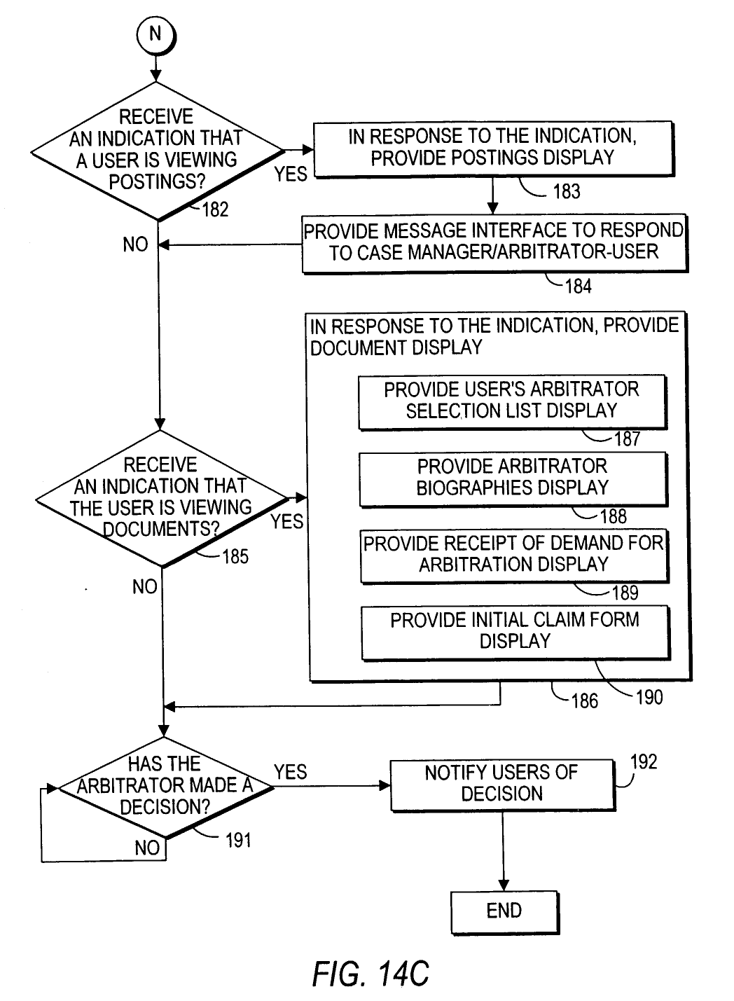

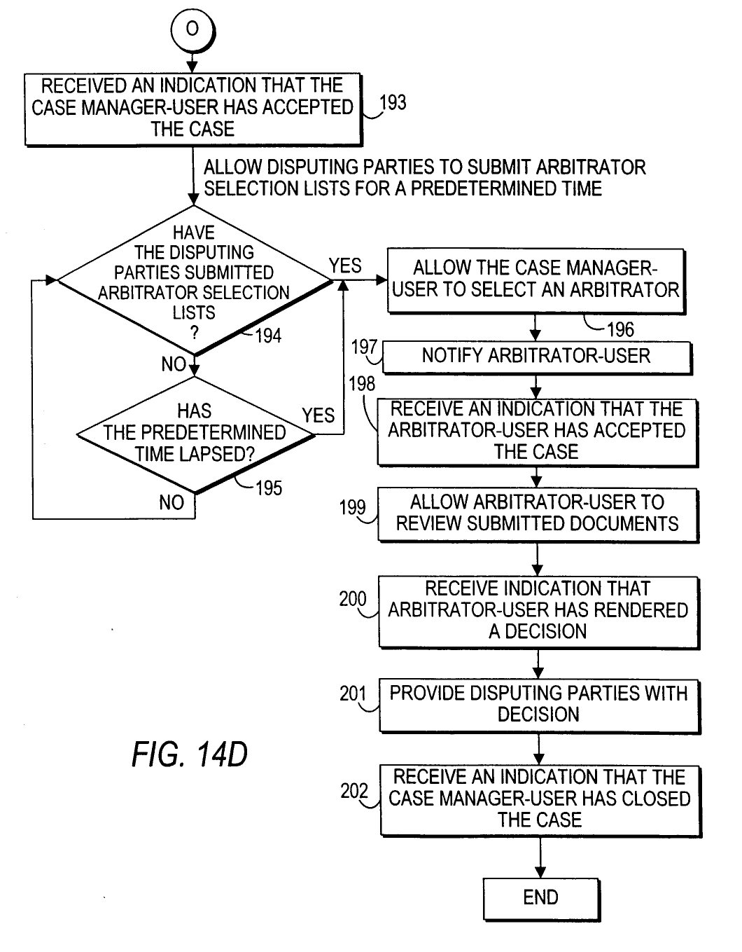

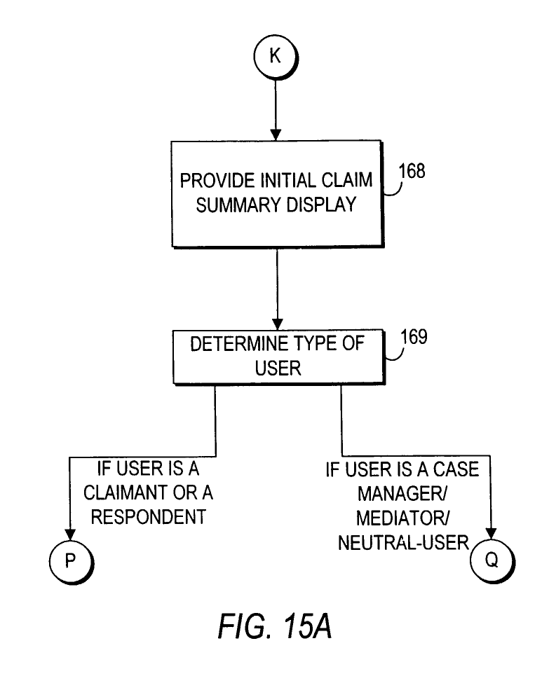

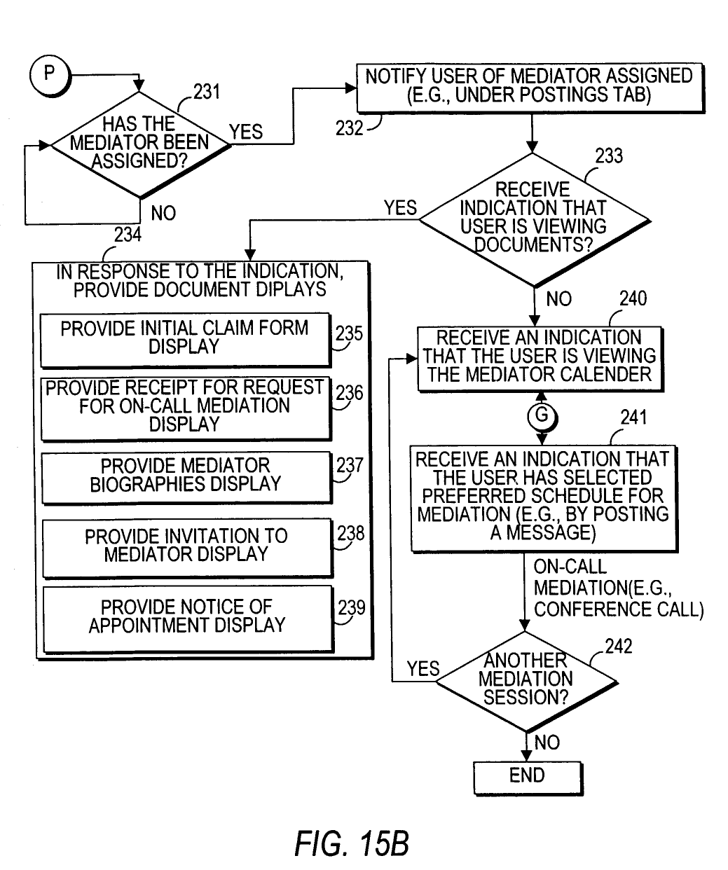

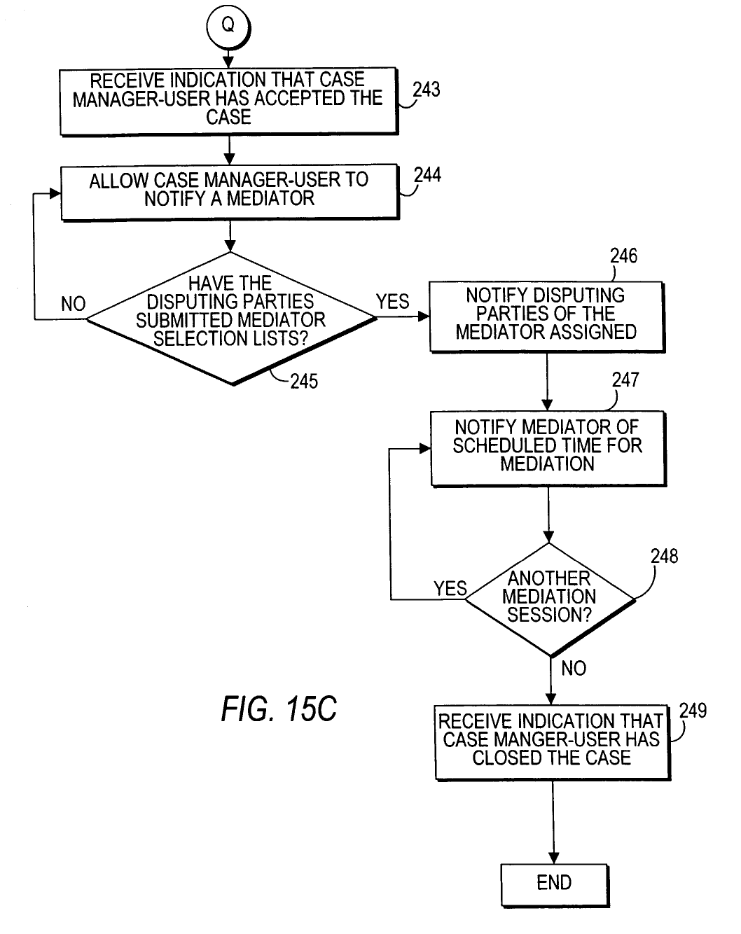

At step 167, the dispute management application may determine the type of user accessing the case. The features of the dispute management application that are available to the user may depend on whether the type of user and, in some embodiments, the user's specialty. Also, the information, interfaces, and displays may change based on the type of user (e.g., whether the user is a claimant, respondent, neutral, case manager, or any other suitable user). For example, the dispute management application may provide a case manager-user with the broadest range of features. In some embodiments, the dispute management application may provide a case manager-user with the broadest amount of user information (e.g., access to claimant information, respondent information, arbitrator information, etc.). Case manager-users may, for example, communicate messages to the disputing parties (e.g., by posting messages), select arbitrators or mediators, or perform any other suitable function. An illustrative method for providing a claimant-user or a respondent-user with features relating to Documents-Only Arbitration is shown in FIGS. 14. An illustrative method for providing a case manager-user, an arbitration-user, or any other suitable neutral-user, with features relating to Documents-Only Arbitration is shown in FIGS. 15.

FIGS. 14A-14C are flowcharts of an illustrative method for providing a claimant-user or a respondent-user with features relating to Documents-Only Arbitration. In response to receiving an indication that the user is submitting documents (step 171), the dispute management application may provide the user with a submission display. The submission display may allow the user to, for example, submit a counterclaim, deny the claim, submit initial documents, submit rebuttals, or any other suitable information at step 172. For example, the respondent-user may submit a counterclaim in response to the claimant-user's claim. In some embodiments, the dispute management application may provide the user (e.g., the claimant-user and the respondent-user) with a document submission schedule. The document submission schedule may include predetermined times that the user may submit documents. If desired, the dispute management application may send the user a printed or electronic (e.g., via e-mail) schedule. In some embodiments, a printed or electronic notification may be sent to the disputing parties when an action (e.g., response, submission, confirmation, etc.) is required.

In some embodiments, the dispute management application may determine which users may access a submission (e.g., document, message, posting, argument, evidence, etc.). For example, a case manager may view a document posted by a respondent, while a claimant may not view a document posted by a respondent. FIG. 14B is a flowchart of an illustrative method for assigning permission to access submissions. At step 270, the dispute management application may receive an indication that a submission has been made by a user. In response to the indication, the dispute management application may determine the user information of the user that made the submission (step 271). For example, the dispute management application may determine that the user that filed the submission is a respondent in a documents-only arbitration.

The dispute management application may also determine users that may access the submission (step 272). For example, if a respondent filed an arbitrator selection list, the dispute management application may determine that a claimant may not view the respondent's arbitrator selection list. In some embodiments, the dispute management application may determine users that may access the submission based at least in part on the type of user (e.g., claimant, respondent, neutral, case manager, arbitrator, mediator, etc.). In another suitable approach, the dispute management application may determine users based at least in part on the document type (e.g., conflict checklist, arbitrator selection list, posted message, etc.). In response to determining users, the dispute management application may assign an indicator associated with the submission at step 273. For example, the dispute management application may assign a value to a document such that only the case manager may view the document.

In some embodiments, the dispute management application may allow a case manager to determine viewing priorities of users (e.g., participants in the case). The case manager may determine which users can view a particular submission. In some embodiments, the case manager may determine viewing priorities for a particular submission or for an area within the dispute management application (e.g., submissions under the “Postings” tab). The case manager may determine the viewing priorities and may notify (e.g., electronically) the dispute management application of the case manager's determination. In some embodiments, the case manager may interact with users, such as the participants of a case, throughout the dispute management process. The case manager may guide and assist the users through the dispute management process. The case manager may also act as a troubleshooting representative (e.g., customer support) for the dispute management application.

In some embodiments, users may have conflicts of interest with another user in the selected case. For example, the dispute management application may provide a neutral with a list of participants for a case and may allow the neutral to determine if he or she has a conflict of interest with the case based at least in part on the participants.

Referring back to FIG. 14A, in response to receiving an indication that the user is filing a conflict checklist (step 173), the dispute management application may provide the user with a conflict checklist display at step 174. The display may allow the user to, for example, submit a list of users that may have a conflict of interest with the case. For example, a claimant may indicate the names of persons or entities that may have any conflict with the case.

In response to receiving an indication that the user is selecting an arbitrator (step 175), the dispute management application may provide the user with a selection display. The selection display may include an interface for selecting the arbitrator. In some embodiments, the user may select an arbitrator by striking the names of the arbitrators objected to and ranking the remaining arbitrators in order of preference. At step 177, the dispute management application may determine if the other user (e.g., respondent-user or claimant-user) selected an arbitrator. If the claimant-user and respondent-user has submitted an arbitrator listing (step 177) or if the predetermined time (e.g., one day, one week, etc.) for submitting an arbitrator listing has lapsed (step 179), the dispute management application may determine the arbitrator for the case. In some embodiments, the dispute management application may allow a case manager-user to select the arbitrator. For example, the case manager-user may compare the respective arbitrator listings and select the most matching arbitrator.

In response to receiving an indication from the user to contact the case manager-user (step 180), the dispute management application may provide the user with a message interface at step 181. The message interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to send the message, the dispute management application may communicate the message to the case manager-user.

In response to receiving an indication from the user to view postings (step 182), the dispute management application may provide the user with a postings display at step 183. The postings display may include messages from the case manager-user. For example, the case manager-user may provide the users with a message including a greeting and the case manager-user's contact information. At step 184, dispute management application may provide the users (e.g., claimant-user or respondent-user) with a message interface to response to the case manager-user. The message interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to send the message, the dispute management application may communicate (e.g., post) the message to the case manager-user.

In response to receiving an indication from the user to view documents (step 185), the dispute management application may provide the user with displays relating to documents at step 186. In some embodiments, the dispute management application may provide users with access to documents, such as, for example, the user's arbitrator selection list (substep 187), arbitrator biographies (substep 188), the receipt of demand for arbitration (substep 189), the initial claim form (substep 190), or any other suitable document. Within each of these steps, the dispute management application may provide a display or displays that provide information suitable to the respective steps. The displays may also provide users with other content (e.g., advertisements, messages, graphics, news, etc.), and access to additional features.

In response to the arbitrator rendering a decision (step 191), the dispute management application may notify the users (e.g., the claimant-user and the respondent-user) with the decision. In some embodiments, the dispute management application may inform the users to contact the service provider via telephone for the decision. In some embodiments, the dispute management application may send a printed or electronic notification to the user. In some embodiments, the dispute management application may allow the arbitrator to electronically submit the decision. For example, the arbitrator may electronically submit a document that includes the decision.

FIG. 14D is a flowchart of an illustrative method for providing a case manager-user, an arbitrator-user, or any other suitable user with features relating to Documents-Only Arbitration. At step 193, the dispute management application may receive an indication that the case manager-user has accepted the case. For example, the dispute management application may use a “first-in-first-out” (FIFO) approach to assign case manager-users with cases. The dispute management application may assign unassigned cases (e.g., new claims) to the extent that there are unassigned cases.

In response to allowing the disputing parties to select an arbitrator for a predetermined time, the dispute management application may determine whether the disputing parties submitted their respective arbitrator selection lists (step 194) or if the predetermined time (e.g., one day, one week, etc.) for submitting an arbitrator listing has lapsed (step 195). In response to the disputing parties submitting arbitrator selection lists, or the predetermined time lapsing, the dispute management application may determine the arbitrator for the case. At step 196, for example, the dispute management application may allow the case manager-user to select the arbitrator.

In response to the case manager-user selecting an arbitrator, the dispute management application may notify the arbitrator-user at step 197. In some embodiments, the dispute management application may send a printed or an electronic notification to the arbitrator-user. In some embodiments, the dispute management application may allow a case manager-user to contact the arbitrator-user. At step 198, the dispute management application may receive an indication that the arbitrator-user has accepted the case. If the arbitrator-user rejects the case, the dispute management application may return to step 196 and, for example, allow the case manager-user to select a replacement arbitrator.

At step 199, the dispute management application may provide the arbitrator-user with access to the documents submitted by the disputing parties. At step 200, the dispute management application may receive an indication that the arbitrator-user has rendered a decision. In response to the arbitrator-user rendering a decision, the dispute management application may provide the disputing parties with the decision at step 201. In response to providing the disputing parties with the decision, the case manager-user may close the case (step 202).

Referring-back to FIG. 11, upon receiving an indication from a user to participate in a “On-Call Mediation” (step 163), the dispute management application may provide the user with options relating to On-Call Mediation. An illustrative method for providing the user with features relating to On-Call Mediation is shown in FIGS. 15A-15C.

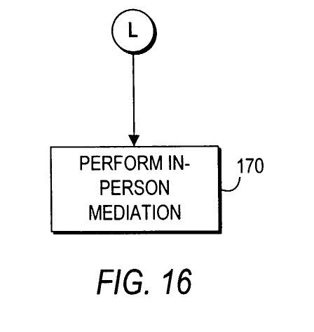

FIGS. 15A-15C are flowcharts of illustrative methods for providing users with features relating to On-Call Mediation. In FIG. 16, in response to receiving an indication from the user to participate in an On-Call Mediation, the dispute management application may provide the user with an initial claim summary display at step 168.

At step 169, the dispute management application may determine the type of user accessing the case. The features of the dispute management application that are available to the user may depend on whether the type of user and, in some embodiments, the user's specialty. The information, interfaces, and displays may change based on the type of user (e.g., whether the user is a claimant, respondent, neutral, case manager, or any other suitable user). An illustrative method for providing a claimant-user or a respondent-user with features relating to On-Call Mediation is shown in FIG. 15B. An illustrative method for providing a case manager-user, a mediator-user, or any other suitable neutral-user, with features relating to On-Call Mediation is shown in FIGS. 15C.

FIG. 15B is a flowchart of an illustrative method involved in providing a claimant-user or a respondent-user with features relating to On-Call Mediation. The steps for selecting a mediator are similar to steps 175-179 of FIG. 14A which illustrate selection of an arbitrator. In response to receiving an indication that a mediator has been assigned to the case (step 231), the dispute management application may notify the user of the mediator assigned to the case at step 232. For example, the dispute management application may post information relating to the mediator, such as contact information and biographical information.

In response to receiving an indication from the user to view documents (step 233), the dispute management application may provide the user with displays relating to documents at step 234. In some embodiments, the dispute management application may provide users with access to documents, such as, for example, the initial claim form (substep 235), the receipt for request for on-call mediation (substep 236), mediator biographies (substep 237), the invitation to the mediator (substep 238), the notice of appointment (substep 239), or any other suitable document. Within each of these steps, the dispute management application may provide a display or displays that provide information suitable to the respective steps. The displays may also provide users with other content (e.g., advertisements, messages, graphics, news, etc.), and access to additional features.

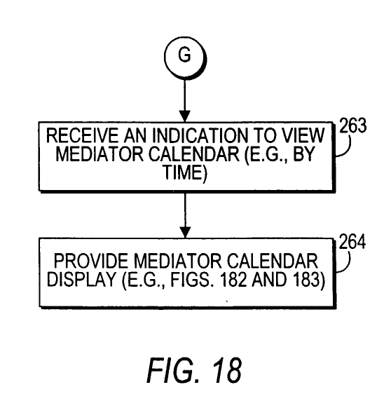

At step 240, the dispute management application may receive an indication from the user to view mediator calendars. The mediator calendar features is described further in connection with FIG. 18. Using the mediator calendar feature, the dispute management application may receive an indication that the user has selected a preferred schedule for mediation. For example, the user (e.g., a claimant-user or a respondent-user) may post a message indicating the user's preference (e.g., Tuesday at 10:00 AM) at step 241. The case manager-user and the mediator-user may determine the time of the mediation session. In response to the on-call mediation session, the dispute management application may query the users whether another mediation session is desired at step 242. If another mediation session is desired, the dispute management application may return to step 240.

FIG. 15C is a flowchart of an illustrative method for providing a case manager-user, a mediator-user, or any other suitable user with features relating to On-Call Mediation. At step 243, the dispute management application may receive an indication that the case manager-user has accepted the case. For example, the dispute management application may use a “first-in-first-out” (FIFO) approach to assign case manager-users with cases. The dispute management application may assign unassigned cases (e.g., new claims) to the extent that there are unassigned cases.

In response to allowing the disputing parties to select a mediator and a mediation session time (e.g., from the mediator calendars), the dispute management application may allow the case manager-user to notify the mediator of his or her appointment at step 244.

At step 245, the dispute management application may receive an indication that the mediator-user has accepted the case. If the mediator-user rejects the case, the dispute management application may return to step 244 and, for example, allow the case manager-user to select a replacement mediator.

At step 246, the dispute management application may notify the disputing parties of the mediator assigned to the case. The dispute management application may also notify the scheduled time for the mediation session at step 247. Upon notifying the mediator-user of the scheduled time, the dispute management application may remove the available time slot from the mediator-user's calendar.

At the mediation session, the mediator may be used to facilitate the disputing parties to work together. At step 248, the dispute management application may query the users whether another mediation session is desired. If another mediation session is desired, the dispute management application may return to step 247.

In response to an indication that the users have terminated the mediation or in response to an indication that an agreement has been reached, the case manager-user may close the case (step 249).

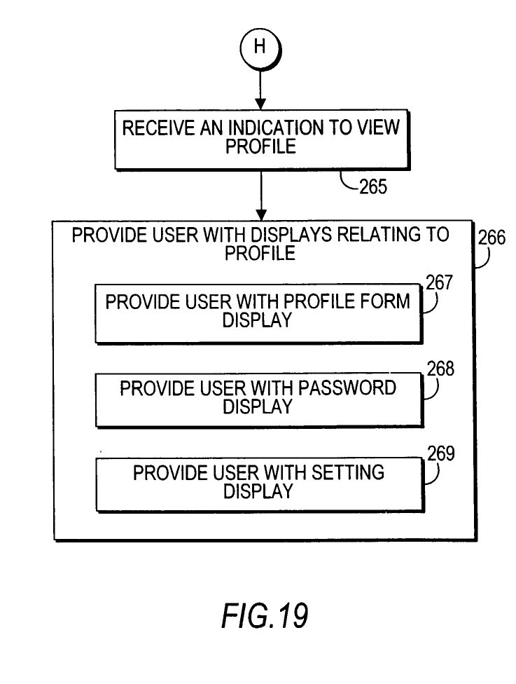

Referring back to FIG. 11, upon receiving indications from the user to participate in a “In-Person Mediation” (step 164), the dispute management application may provide the user with options relating to In-Person Mediation. An illustrative method for providing the user with features relating to In-Person Mediation is discussed in connection with FIG. 19.

FIG. 16 is a generalized flowchart of an illustrative method for providing the user with features relating to In-Person Mediation. In response to receiving an indication from the user to participate in an In-Person Mediation, the dispute management application may direct the user to perform the In-Person Mediation at step 170. In some embodiments, the dispute management application may provide users with access to information about fees, rules, dates, or any other information relating to In-Person Arbitration. For example, dates and other information may be automatically published to inform the user that the corresponding information is due before meeting with the mediator.

In some embodiments, the dispute management application may provide user with discussion areas, such as peer groups. These peer groups may provide users with an area to discuss issues, solutions, industry trends, or any other suitable topic. For example, a user may join a peer group to discuss and exchange insights about a difficult issue. In some embodiments, a user may create a user profile, such as a peer group profile. Such a profile may assist in bringing together like peers.

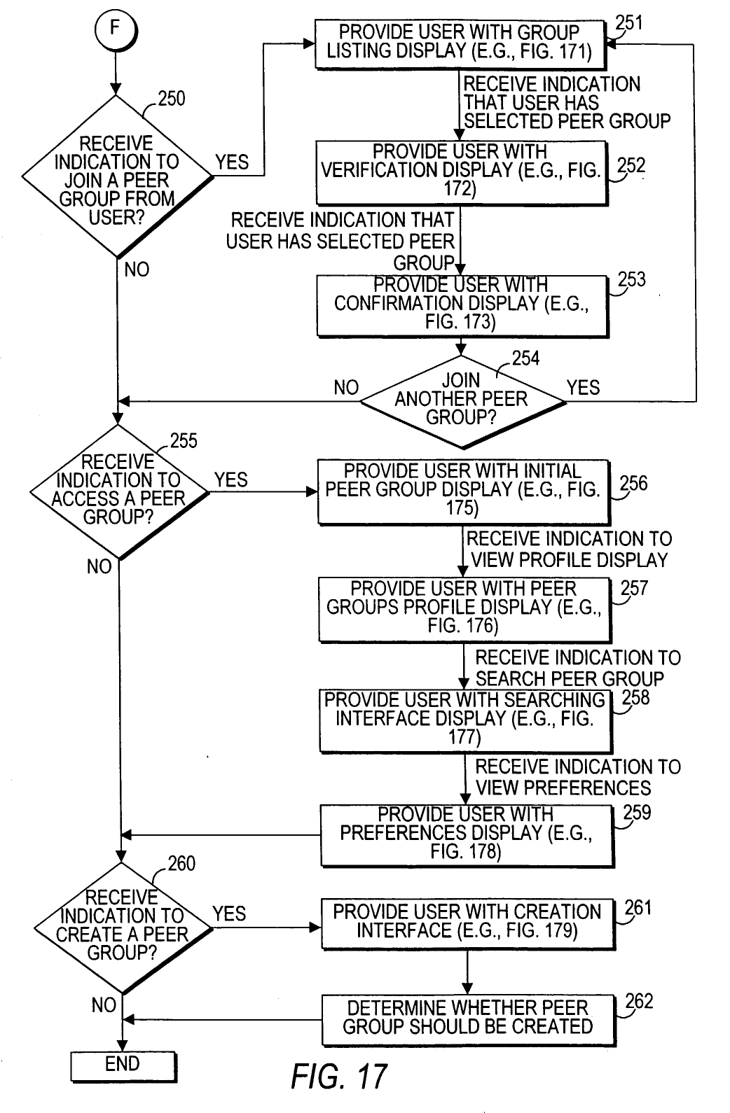

Referring back to FIG. 8, upon receiving indications of user-selected options relating to peer groups at step 88, the dispute management application may provide the user with options relating to peer groups. An illustrative method for providing users with options relating to peer groups is shown in FIG. 17.

In response to receiving an indication from a user to join a peer group (step 250), the dispute management application may provide the user with a group listing display at step 251. The group listing display may include a listing of the peer groups that the user may join. In response to receiving an indication that the user has selected a peer group to join, the dispute management application may provide the user with a verification display indicating the user's selection at step 252. In response to receiving an indication that the user has verified joining the peer group, the dispute management application may provide the user with a confirmation display, which may include, for example, a message that the user has completed joining the selected peer group. If the dispute management application receives an indication from a user to join another peer group, the dispute management application may return to step 251.

In response to receiving an indication that the user is accessing a peer group, the dispute management application may provide the user with an initial peer group display at step 256. For example, the initial peer group display may indicate the peer groups that the user has joined. In response to receiving an indication to view the profile of the peer group, the dispute management application may provide the user with a profile display at step 257. In response to receiving an indication to search within the selected peer group, the dispute management application may provide the user with a searching interface display at step 258. The dispute management application may provide the users with a searching interface. The searching interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to perform the search, the dispute management application may provide the user with search results.

In response to receiving an indication to view preferences of the selected peer group, the dispute management application may provide the user with preferences display at step 259. Preferences display may, for example, include graphical prompts that allow the user to indicate his or her preference.

In response to the receiving an indication from the user to create a peer group, the dispute management application may provide the user with a creation interface at step 261. The creation interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. At step 262, the dispute management application may determine whether the peer group should be created. In some embodiments, the dispute management application may allow an administrator to determine whether the peer group should be created.

In some embodiments, the dispute management application may provide the user with mediator calendars. Users may desire to review mediator availabilities for on-call mediation cases where immediate resolution is desirable. In some embodiments, the dispute management application may allow a user to search through mediator calendars by date or by mediator.

Referring back to FIG. 8, upon receiving an indication from a user to provide options relating to mediator calendars at step 89, the dispute management application may provide the user with options relating to mediator calendars. An illustrative method for providing user with options relating to mediator calendars is shown in FIG. 18.

In response to receiving an indication from the user to view mediator calendars (step 263), the dispute management application may provide the user with mediator calendar displays at step 264. In some embodiments, the dispute management application may allow the user to view mediator calendars by mediator, by time, or by any other suitable criteria. The mediator calendar displays may include an interface or respondent-user) to submit a preferred schedule for mediation. The interface may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct. In response to receiving an indication to send the schedule, the dispute management application may communicate (e.g., post) the schedule to the case manager-user.

In some embodiments, the dispute management application may allow the user to modify or access the user's profile. Users may desire to change the information in the profile, change a password, change settings and preference, or perform any other suitable function.

Referring back to FIG. 8, upon receiving an indication from a user to provide options relating to the user's account at step 90, the dispute management application may provide the user with options relating to the user's account. An illustrative method for providing user with options relating to the user's account is shown in FIG. 19.

In response to receiving an indication from the user to view the user's profile (step 265), the dispute management application may provide the user with displays relating to the user's profile at step 266. In some embodiments, the dispute management application may provide users with access to displays, such as, for example, a profile form display (substep 267), a change password display (substep 268), a settings display (substep 269), or any other suitable display. Within each of these steps, the dispute management application may provide a display or displays that provide information suitable to the respective steps. The displays may also provide users with other content (e.g., advertisements, messages, graphics, news, etc.), and access to additional features.

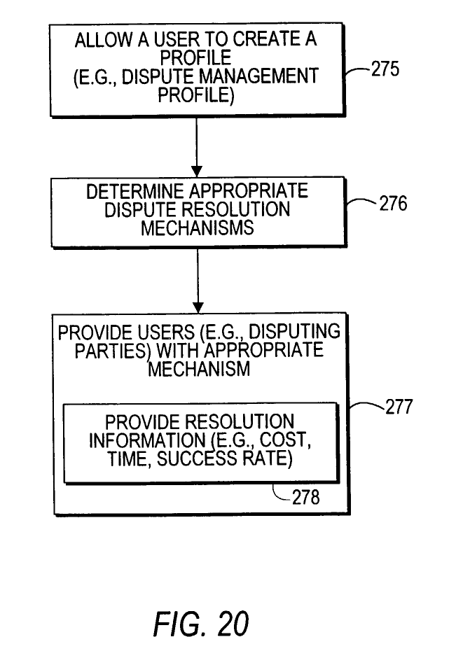

In some embodiments, the dispute management application may guide disputing parties in understanding resolution options and aid them in selecting the most appropriate mechanism for solving their dispute. FIG. 20 is a flowchart of an illustrative method for guiding users in understanding dispute resolution mechanisms and the selection of the mechanism.

In some embodiments, the dispute management application may allow users to create a profile, such as a dispute management profile, and retrieve profiles for other users (step 275). In response to an indication from a user to create a profile, the dispute management application may prompt the user to describe how the user prevents and resolves dispute. Such information may be made available to other users. For example, before a buyer purchases supplies from a manufacturer, the buyer may access information about the manufacturer from the manufacturer's profile. Profile information may include, for example, contact information (e.g., address, phone number, e-mail address, etc.), references, certification status, links to ratings and reports, or any other suitable information about the user.

In some embodiments, profiles may include, for example, information links to information resources, both general and specific to a trading partner or other user, which may assist users in their contract decision-making. Such information may include, for example, trading history, dispute prevention and resolution history, ratings, industry news, or any other suitable information. In some embodiments, the dispute management application may provide users with a certification or rating for meeting a particular standard of conducting business. The dispute management application may automatically award certifications to users whose criteria meet predefined values.

The dispute management application may guide disputing parties in understanding resolution options and aid them in selecting the most appropriate mechanism for solving their dispute. The dispute management application may determine the appropriate resolution mechanism by considering such variables as the information in the profile, the size of the dispute, the relationship between the disputing parties, and any other suitable variables (step 276). In some embodiments, the dispute management application may provide the disputing parties with an appropriate dispute resolution mechanism or a plurality of appropriate dispute resolution mechanisms at step 277. For example, the dispute management application may provide the disputing parties with a specific dispute resolution path based at least in part of their respective profiles. Such a path may be graphically displayed to assist the disputing parties in understanding the steps in the dispute resolution process. In some embodiments, major events and milestones may be shown with the dispute resolution path.

The dispute management application may also provide the disputing parties with information, such as, for example, the cost of the resolution (e.g., a cost estimate), an estimated time to resolve similar disputes, the success rate for similar disputes, or any other suitable information (step 278).

In an effort to preserve relationships and promote the continuity of business, users may be provided with suggestions for minimizing damages and preserving relationships during a dispute or before a dispute arises. For example, a buyer purchased a product from a manufacturer. However, the manufacturer failed to delivery the product to the buyer at the agreed-upon date of delivery. The dispute management application may notify the manufacturer is late in delivering the product and may provide the manufacturer with information related to dispute management. Such information may include a statistic which advises the manufacturer that “9 out of 10 times a dispute arises from late shipments.”

The dispute management application may perform a trend analysis by, for example, sifting through databases or monitoring received communications. The dispute management application may search for patterns of activity based on either criteria stored in memory, user inputs, or as determined by the dispute management application to be anomalous or suspicious. The trend analysis performed by the dispute management application may be a continuously running application using, for example, data mining techniques to identify and draw conclusions from such patterns. Data mining is a process of identifying useful patterns or relationships in databases using advanced statistical tools. When a trend requiring a response is identified, a flag or any other suitable indicator may be assigned. If the dispute management application determines that the trend is potentially serious (i.e., has a high priority), the dispute management application may create a high priority indicator, such as an alarm.

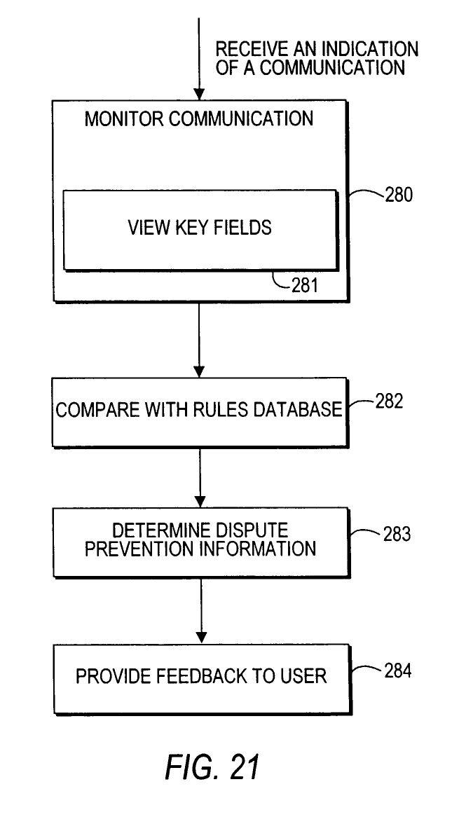

FIG. 21 is a flowchart of an illustrative method for providing users with feedback. In response to receiving a communication (e.g., an e-mail, a notice, etc.), the dispute management application may monitor the communication (step 280). In some embodiments, the dispute management application may determine key fields in an e-mail message (step 281). The dispute management application may compare the information with a database. The database may contain rules, procedures, statistics, or any other suitable information. Upon comparing the communication with the information stored in the database, the dispute management application may determine the dispute prevention information (step 283). Such information may include statistics on a dispute (e.g., “9 out of 10 times a dispute arises), mechanisms for preventing a dispute from occurring, the likelihood fo a dispute arising, or any other suitable information. The dispute management application may provide the feedback to the user at step 284. The dispute management application may provide the user with an electronic (e.g., e-mail, pop-up message) or printed notification.

In some embodiments, the dispute management application may be used to address International and cross-border dispute resolution policies and procedures. For example, in the area of electronic commerce, the dispute management application may respond to requests from companies who require education, information, and processes to assist them in addressing International dispute management procedures, such as International alternative dispute resolution procedures. Such information regarding dispute management polices, clauses, and procedures may be provided in real-time.

For example, company A and company B may desire to complete a transaction, where both companies are located in different countries and their representatives (e.g., legal counsel) may not know the particulars of dispute management processes in the different countries. In another suitable example, a user may desire to advise his or her client on dispute management processes for various countries as needed by the client. In yet another suitable example, a user may desire to draft a contract that binds a transaction to an International dispute management process. The dispute management application may, for example, determine the appropriate International dispute management process based on such parameters as the user's profile, parameters established by both parties, or any other suitable information relating to the parties.

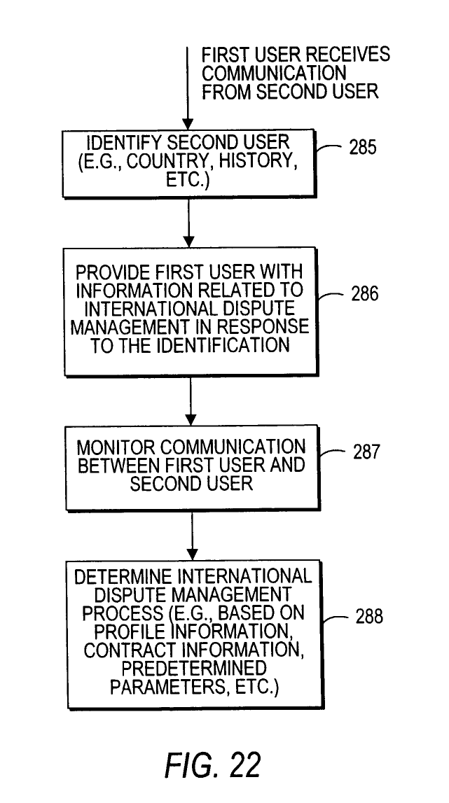

FIG. 22 is a flowchart of an illustrative method for providing users with International dispute management processes. In some embodiments, a first user may receive a communication (e.g., an e-mail, a notice, etc.) from a second user. The communication may be, for example, an order for a product from another user via e-mail or a subscription to an International dispute management service provided by the dispute management application. In response to receiving the communication, the dispute management application may determine the identity of the second user at step 285. For example, the dispute management application may determine whether the user has a profile with the dispute management application. In another suitable example, the dispute management application may determine the country that the user is located.

In response to identifying the second user, the dispute management application provide the user with information relating to International dispute management at step 286. International dispute management information may include, for example, dispute resolution policies (e.g., arbitration policies, mediation policies, etc.) for particular countries, arbitration clauses for particular countries, rules and procedures, expert assistance, or any other suitable information relating to International dispute management. For example, in response to the dispute management application determining that the second user is from Spain, the dispute management application may provide the first user with, for example, alternative dispute resolution clauses that may be used in a contract between the first user and the second user.

In some embodiments, the dispute management application may determine the appropriate International dispute management rules for the users at step 287. For example, the dispute management may determine appropriate International or domestic dispute management rules such as, for example, dispute resolution clauses, based on parameters such as, for example, user profiles, parameters predetermined by the users, or any other suitable parameter. In some embodiments, when the dispute management application determines that no user profile exists, the dispute management application may query a user for additional information. For example, the dispute management application may query the user to agree to accepting a standard alternative dispute resolution policy.

The dispute management application may provide a user with one or more interfaces having suitable displays that may be used by the user for dispute management. The dispute management application may provide various displays that allow users to, for example, log in, create profiles, select one or more dispute resolution pathways, select an arbitrator, obtain additional information, or use any other feature related to dispute management. In some embodiments, a user, such as a company or a representative, may be provided with multiple web pages to facilitate the dispute management process. Any suitable interface element or combination of elements may be used to provide dispute management features, such as, for example, web pages, web site maps, navigational bars, graphical prompts, menu structures, screen elements, forms, and other suitable interface or portion of an interface.

Illustrative user interface approaches are described below. While the approaches are described separately, their features may be combined in any suitable way, modified in accordance with other approaches, or performed instead of or in addition to the features of the approaches. Any suitable combination, substitution, or exchange of features between the interface approaches described herein, or with any other suitable interface approach, may be used. Also, although the illustrated embodiment of the user interface is directed to dispute management, it should be noted that this user interface may be modified for any other types of electronic commerce applications.

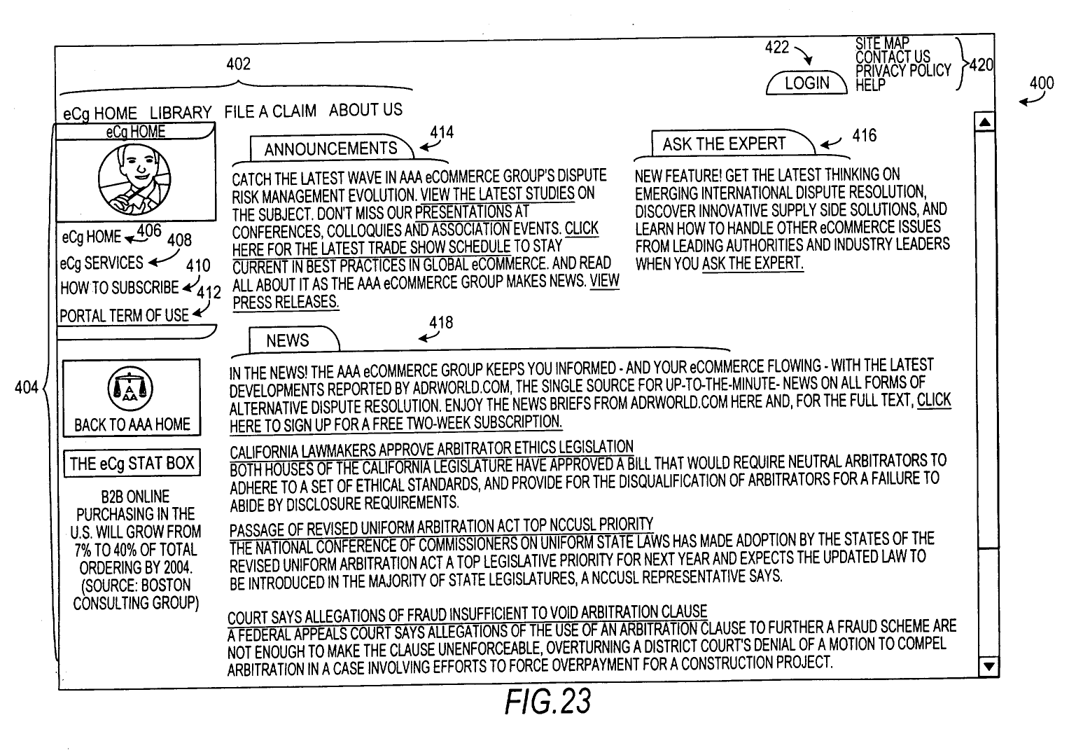

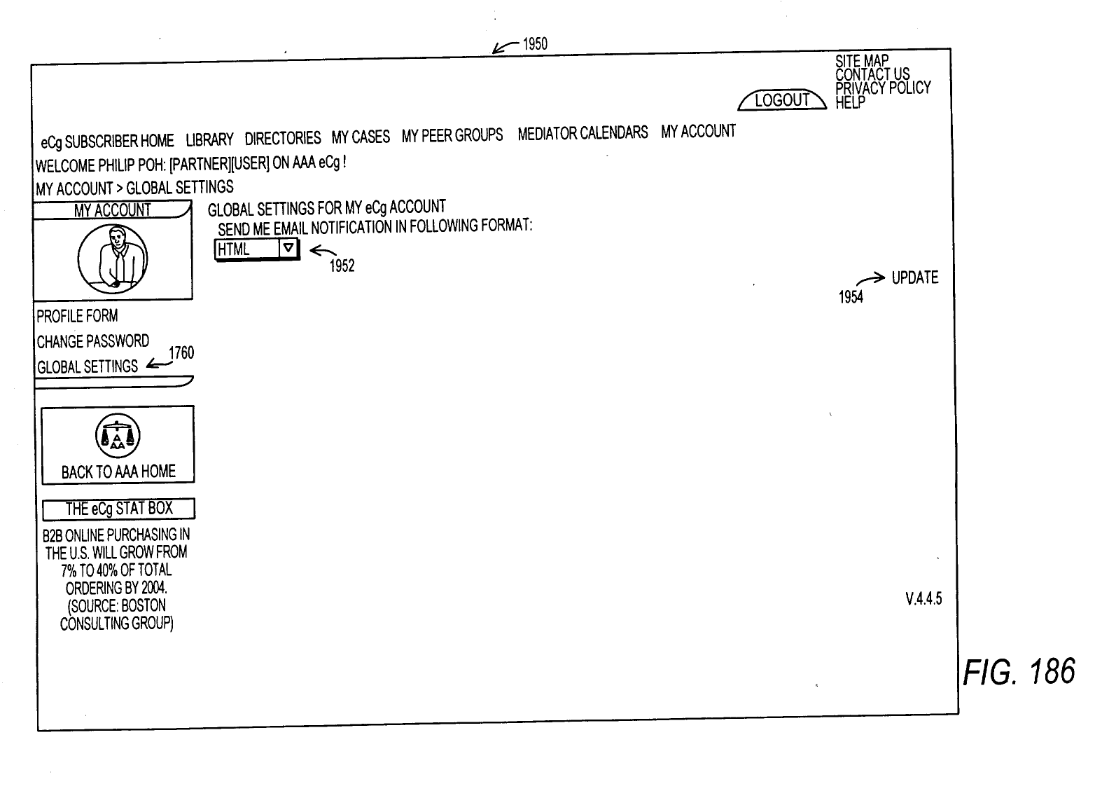

FIGS. 23-186 show illustrative displays for providing users with access to information and features for dispute management. For purposes of illustration, the examples of FIGS. 23-186 are described primarily in the context of an on-line interactive dispute management application in which users access a server (e.g., Internet and application server 110 of FIG. 1) using a personal computer.

An illustrative main menu display 400 is shown in FIG. 23. Display 400, as well as other displays described herein, may include header portion 402, side frame 404, and selectable links 406. Header portion may include, for example, the name given to the system by the system provider and links that allow users to navigate through the application to features such as, for example, “file a claim,” information about the system provider, or any other suitable feature or information. The name may include any suitable passive or interactive text, graphics, audio, video, animation, or other suitable content.

Display 400 may also include navigation links 420. Navigation links 420 may include any suitable links or information for assisting the user in navigating through the web site to features such as, for example, a site map, contact information, a privacy policy, and a help menu.

Side frame 404 may, for example, include one or more selectable links relating to dispute management, such as “eCg Home” link 406, “eCg Services” link 408, “How to Subscribe” link 410, and “Portal Terms of Use” link 412. In this example, side frame 404 includes selectable links. However, any other suitable user interface element may be used. For example, radio buttons, character fields, or on-screen buttons may be used. In some embodiments, a user may indicate his or her selection by selecting one of selectable links 406-412 with a mouse or any other suitable user input device.

When “eCg Home” link 406 is selected from one of the displays shown herein, the dispute management application may transfer the user back to main menu display 400.

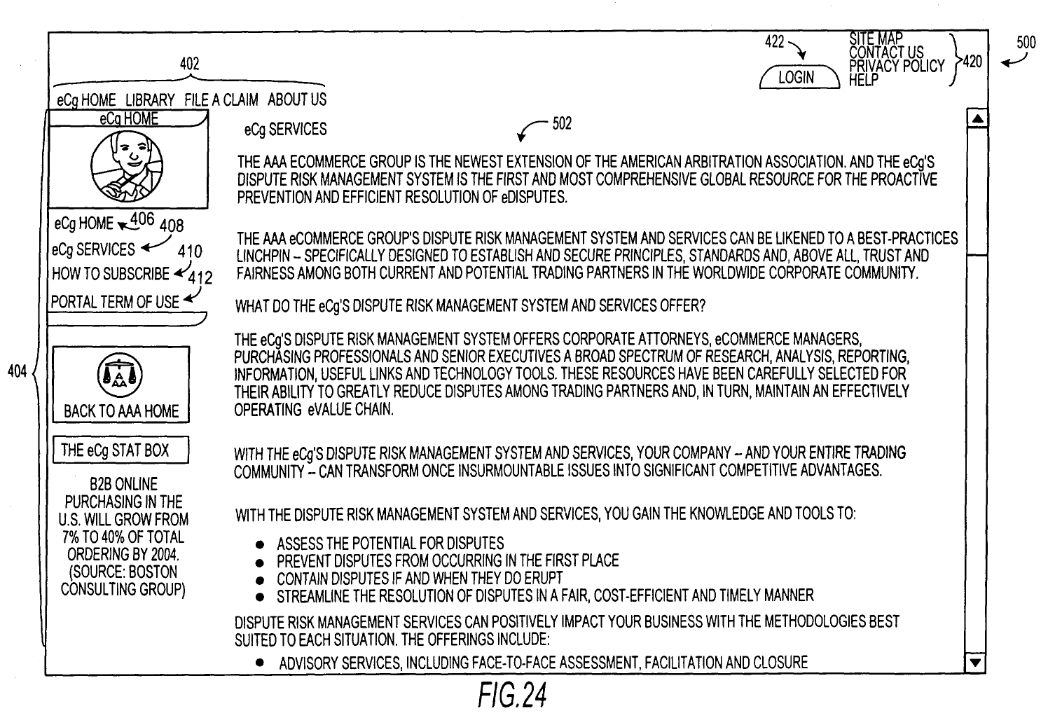

As shown in an illustrative display 500 of FIG. 24, the dispute management application may provide the user with display 500 when “eCg Services” link 408 is selected. Display 500 may include a list area 502 of available services offered by the system provider (e.g., “What do the ecg's Dispute Management system and services offer?”). The dispute management application may allow the user to view any suitable information for assisting the user in subscribing to an offered service.

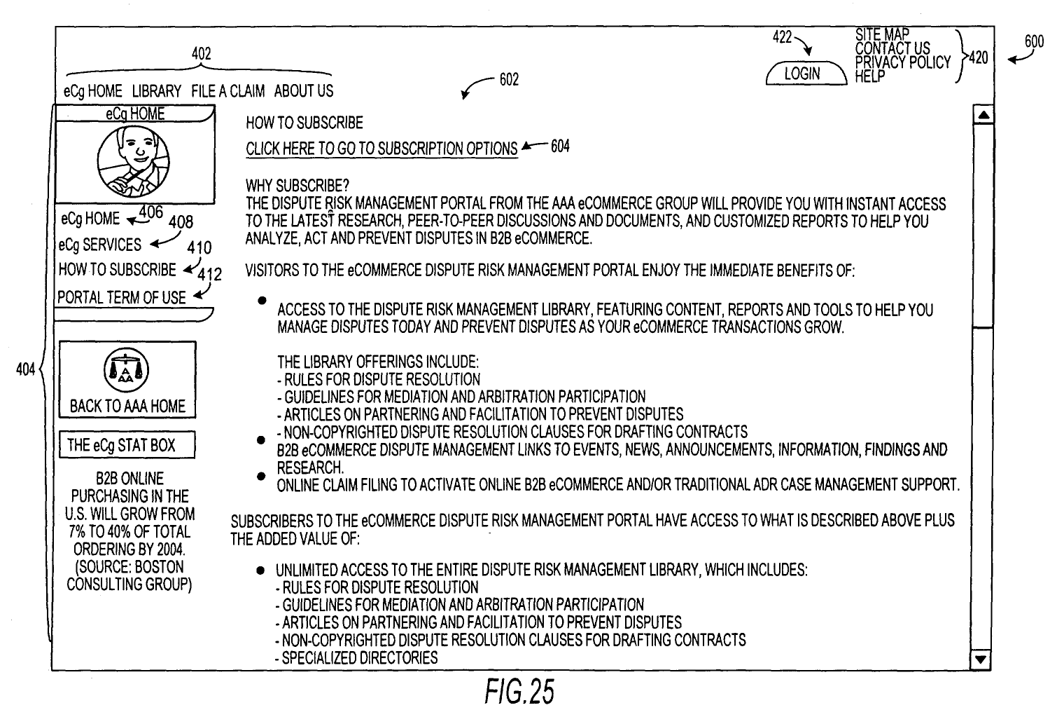

As shown in an illustrative display 600 of FIG. 25, the dispute management application may provide the user with display 600 when “How to Subscribe” link 410 is selected. Display 600 may include a detailed description area 602. Detailed description area 602 may include, for example, a list of benefits for visitors and a list of benefits for subscribers. Area 602 may also include “Subscription Options” link 604, which may transfer the user to a display providing information on one or more options relating to the dispute management application. The dispute management application may allow the user to view any suitable information for assisting the user in subscribing to an offered service.

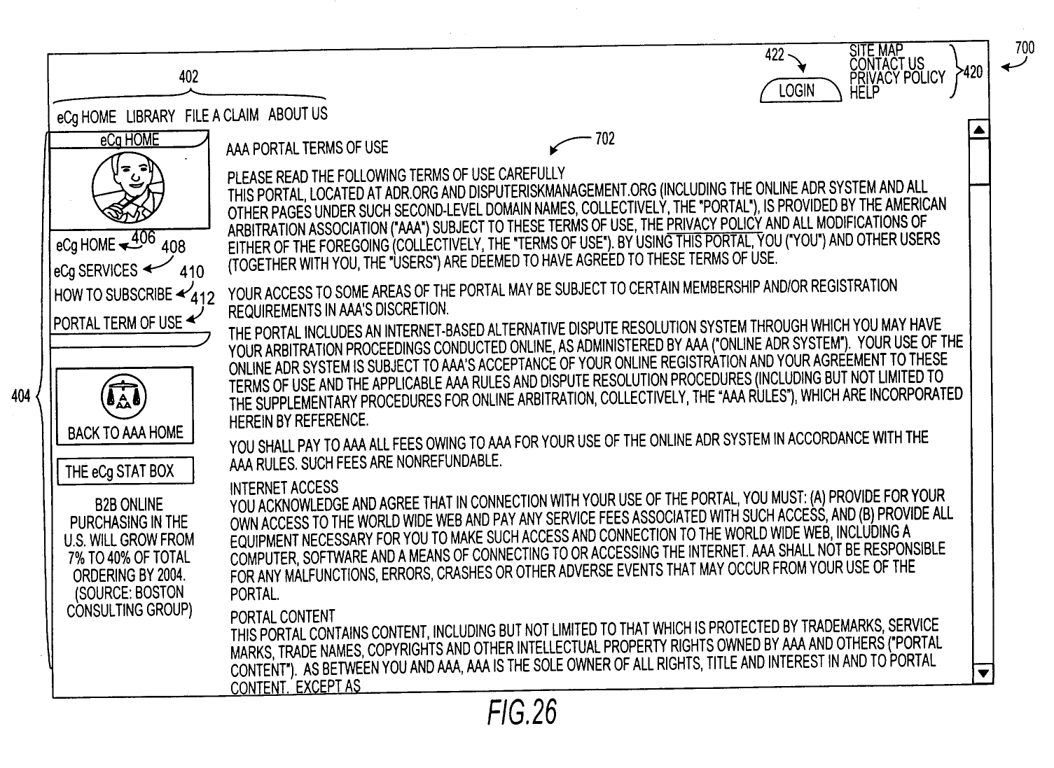

As shown in an illustrative display 700 of FIG. 26, the dispute management application may provide the user with display 700 when “Portal Terms of Use” link 412 is selected. Display 700 may include a detailed description area 702. Detailed description area 702 may include, for example, a list of terms the user must view before using the dispute management application.

In some embodiments, users may log in by, for example, entering a user name and a password. However, users may not be required to log in. In approaches where users log in, the users may be differentiated into categories, such as non-subscribers, subscribers, non-subscriber case participants, neutrals, or any other suitable category.

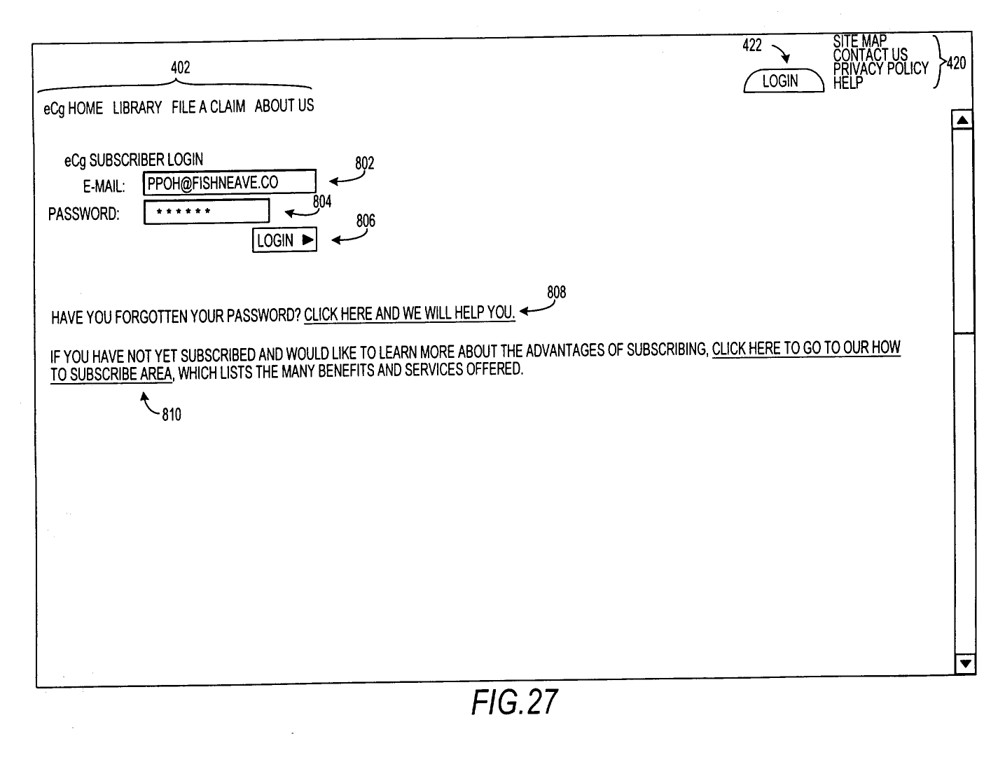

As shown in FIGS. 23-26, a user may log in, for example, by selecting a “login” button 422. The dispute management application may provide the user with an illustrative login display 800 when “login” button 422 is selected (as shown in FIG. 27). Display 800 may include text fields 802 and 804. As shown in display 800, the dispute management application may allow the user to input a user name (e.g., the user's e-mail address, the user's last name, or any other suitable identification information) into text field 802. The dispute management application may allow the user to input a password into text field 804. When the user inputs the password into text field 804, the dispute management application may automatically convert the characters of the password to an indistinguishable form (e.g., replacing the numbers the character with asterisks).

In response to the user inputting the password, the dispute management application may verify the user name and the password. In some embodiments, when the dispute management application verifies the user name and password, the user is transferred to an illustrative “Subscriber” main menu 900 as shown in FIG. 28. The dispute management application may provide the user with a login message 902. Login message 902 may include a welcome message and the status of the user, such as, for example, partner, AAA employee, user, neutral, and any other suitable type of user. In some embodiments, the dispute management application may provide “login” button 422 or a “logout” button 904 based on whether the user has logged in. In some embodiments, when a user (e.g., subscriber) selects “logout” button 904, the dispute management application may return the user to main menu display 400.

The illustrative “Subscriber” main menu display 900 is shown in FIG. 28. Display 900, as well as other displays described herein, may include a header portion 906, a side frame 908, a breadcrumb bar 909, and navigational links 420 (also shown in FIG. 4). Header portion 906 may include, for example, the name given to the system by the system provider. The name may include any suitable passive or interactive text, graphics, audio, video, animation, or other suitable content. Header portion 906 may also include links that allow users to navigate through the application to features such as, for example, a “eCg Subscriber Home” link 910, a “Library” link 912, a “Directories” link 914, a “My Cases” link 916, a “My Peer Groups” link 918, a “Mediator Calendars” link 920, and a “My Account” link 922. In practice, links 910-922 shown in FIGS. 23-186 may be displayed in any suitable order, some may be deleted, and others added.

Display 900 may also include an information area 924. Information area 924 may include subscriber information, such as, for example, upcoming presentations, upcoming trade shows, announcements, recent news relating to dispute management, and any other suitable information.

Side frame 908 may, for example, include one or more selectable links relating to dispute management, such as “eCg Subscriber Home” link, “International Agreements” link, “AAA International Center” link, “International Rules” link, “International Arbitration Kit” link, or any other suitable link for providing dispute management services. Display 900 may also include a summary of the steps taken to arrive at such results by providing breadcrumb bar 909.

When a user selects “eCg Subscriber Home” link 910 in FIGS. 28-186, the dispute management application may transfer the user to main menu display 900.

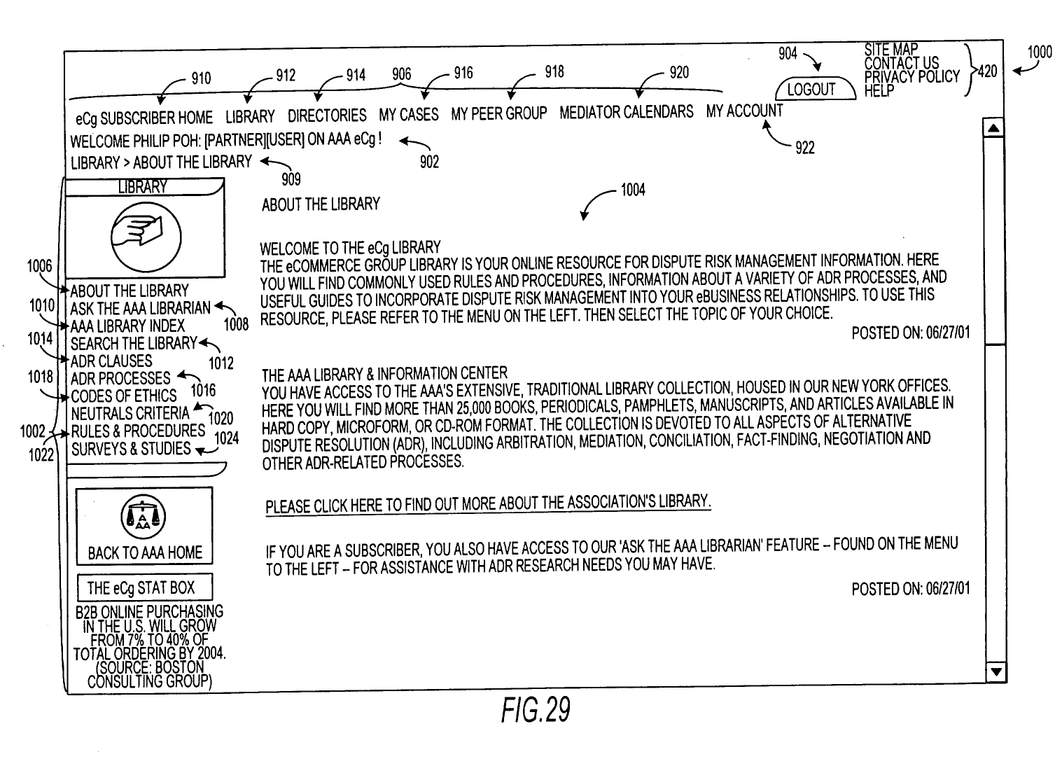

In some embodiments, the dispute management application may provide online resources relating to dispute management to a user. When a user selects “Library” link 912, the dispute management application may provide the user with an illustrative library menu display 1000 as shown in FIG. 29. Display 1000 may provide the user with a side bar 1002 and an information area 1004.

Side bar 1002 may include links, such as, for example, an “About the Library” link 1006, an “Ask the AAA Librarian” link 1008, an “AAA Library Index” link 1010, a “Search the Library” link 1012, an “ADR Clauses” link 1014, an “ADR Processes” link 1016, a “Codes of Ethics” link 1018, a “Neutrals Criteria” link 1020, a “Rules & Procedures” link 1022, a “Surveys & Studies” link 1024, or any other suitable link to services related to the library.

Information area 1004 may include introductory information to the library, such as, for example, notifying the user that the dispute management application may provide a user with access to books, periodicals, pamphlets, manuscripts, and articles relating to dispute management. The user may also access information area 1004 by, for example, selecting “About the Library” link 1006 in side bar 1002.

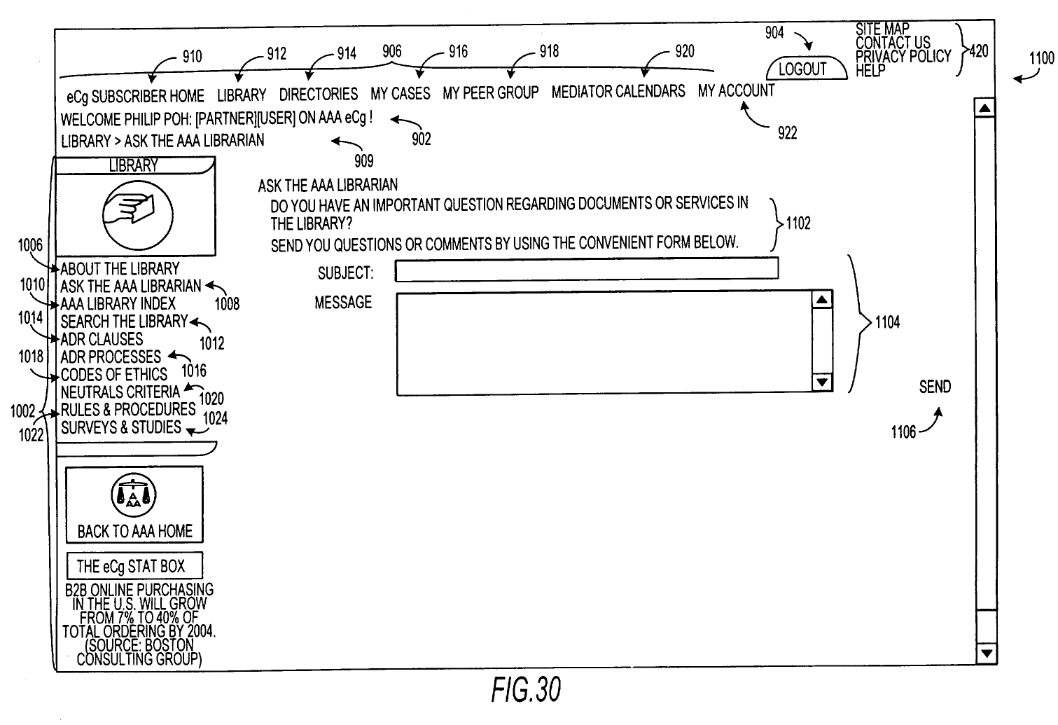

In some embodiments, the dispute management application may allow the user to notify a librarian when the user has a questions regarding documents or services in the library. As used herein, the “librarian” may be any suitable party or user relating to the library service. In this example, the user may create and submit a message to a library by selecting “Ask the AAA Librarian” link 1008. When the user selects link 1008, the dispute management application may provide the user with an illustrative message display 1100 as shown in FIG. 30.

Although the dispute management application is described herein as being implemented on access devices, this is only illustrative. The dispute management application may be implemented on any suitable platform (e.g., personal computer, palmtop computer, laptop computer, personal digital assistant, cellular phone, etc.) to provide such features.

Message display 1100 may include a message 1102, such as “Do you have an important question regarding documents or services in the Library? Send your questions or comments by using the convenient form below.” Display 1100 may also include a message interface 1104. As shown in display 1100, the dispute management application may allow the user to input a subject heading and message into message interface 1104. When the user completes inputting a message into message interface 1104, the dispute management application may transmit the message to the librarian by, for example, selecting a “send” button 1106. The librarian may respond to the user directly via e-mail, telephone, or any other suitable method.

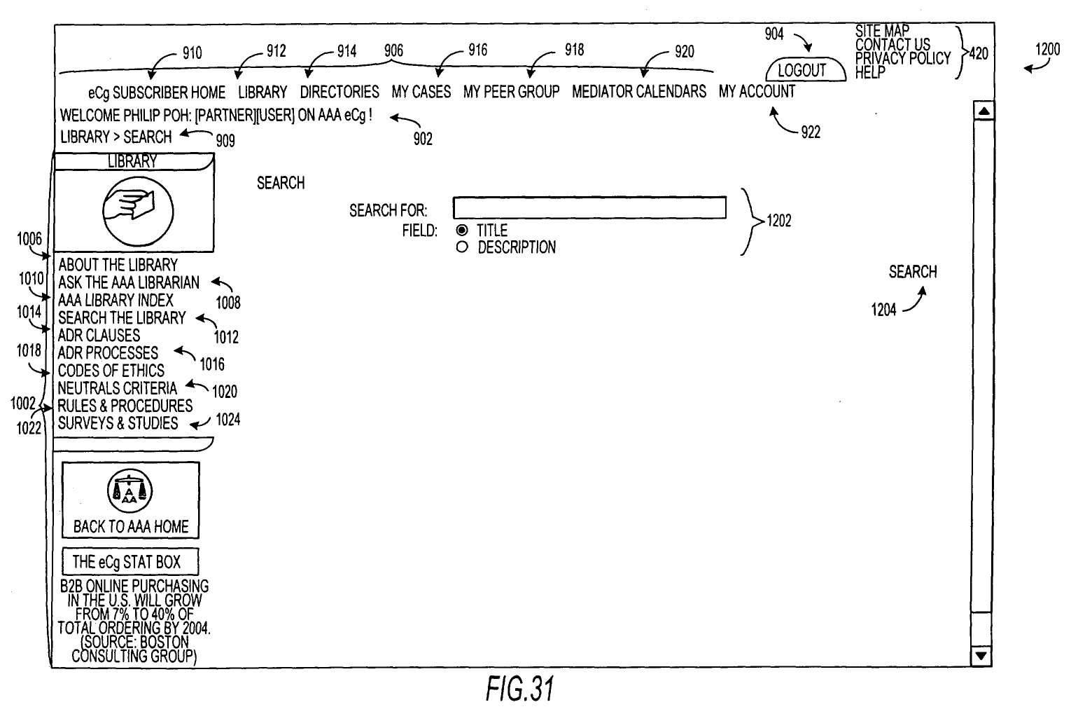

In some embodiments, the dispute management application may allow the user to search through the resources. When a user selects “Search the Library” link 1012, for example, the dispute management application may provide the user with an illustrative searching display 1200 as shown in FIG. 31. Display 1200 may include searching interface 1202. The dispute management application may allow the user to input keywords. The searching interface may also allow the user to select search criteria, such as, for example, search by title or search by description. In response to an inputted keyword and the user selecting a “search” button 1204, the dispute management application may search for matching resources or filter out resources that do not match the keywords.

As illustrative search display 1300 is shown in FIG. 32. In this example, a user inputted the keyword “neutral” into interface 1202. In response to the user selecting “search” button 1204, the dispute management application may provide search results 1302. In some embodiments, the dispute management application may provide search results 1302 in a window, such as a pop-up window or an overlay. In some embodiments, the dispute management application may provide a single display including search results 1302 and searching interface 1202.

Search results 1302 may include the title of the resource and may provide the user with options relating to the resource. For example, the dispute management application may allow the user to view the resource by selecting a “View Document” button 1304. The dispute management application may also allow the user to download the resource by selecting a “Download” button 1306. Search results 1302 may also include detailed information 1308, such as the type of resource (e.g., a public document), the name of the user that posted the resource, the date the resource was posted, and any other suitable information. In some embodiments, the dispute management application may provide the user with the size of the resource 1310.

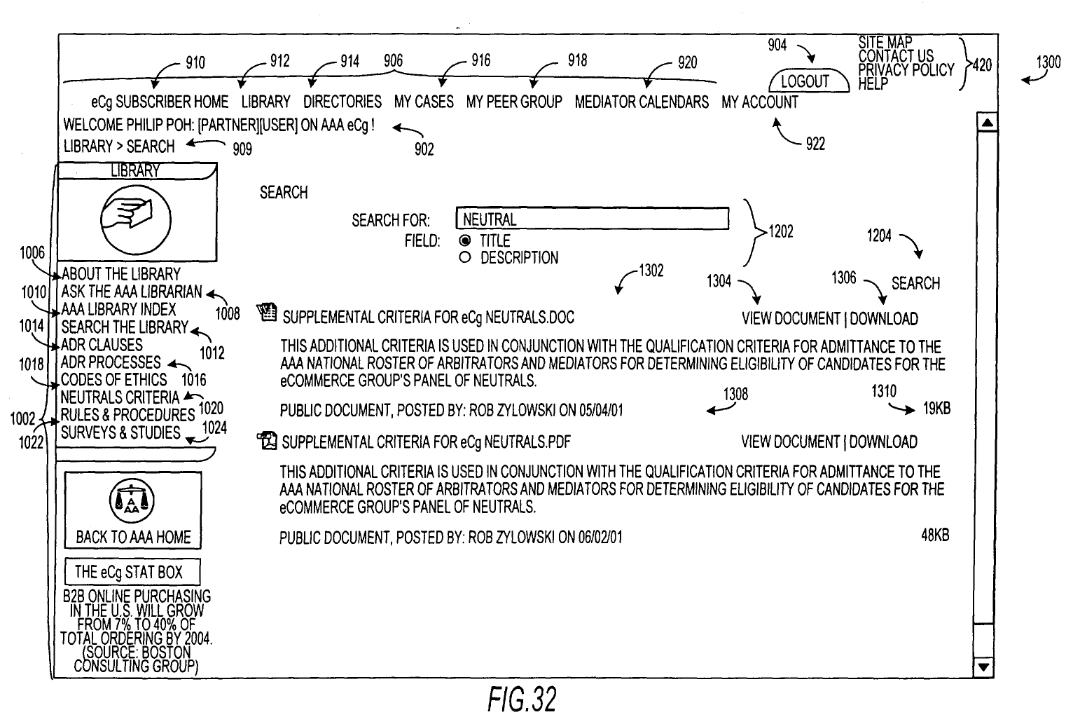

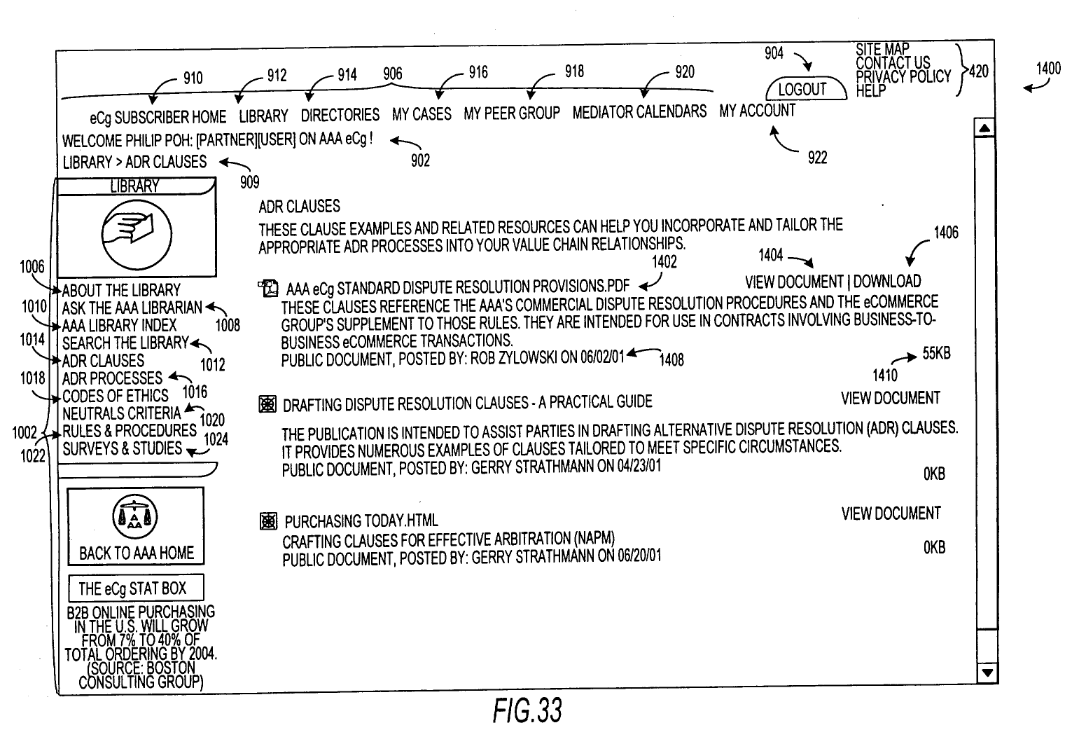

In some embodiments, the dispute management application may provide users with information relating to alternate dispute resolution (ADR) clauses. When a user selects “ADR Clauses” link 1014 from side bar 1002, the dispute management application may provide information relating to ADR clauses in an illustrative display 1400 of FIG. 33. As shown in FIG. 33, display 1400 may provide a listing 1402 of documents relating to ADR clauses. The provided information may include the title of the document and a description of the document. The information may also provide the user with options relating to the document. For example, the dispute management application may allow the user to view the document by selecting a “View Document” button 1404. The dispute management application may also allow the user to download the document by selecting a “Download” button 1406. Document information 1408 may include the type of document (e.g., a public document), the name of the user that posted the document, the date the document was posted, and any other suitable information. In some embodiments, the dispute management application may provide the user with the size of the document 1410.

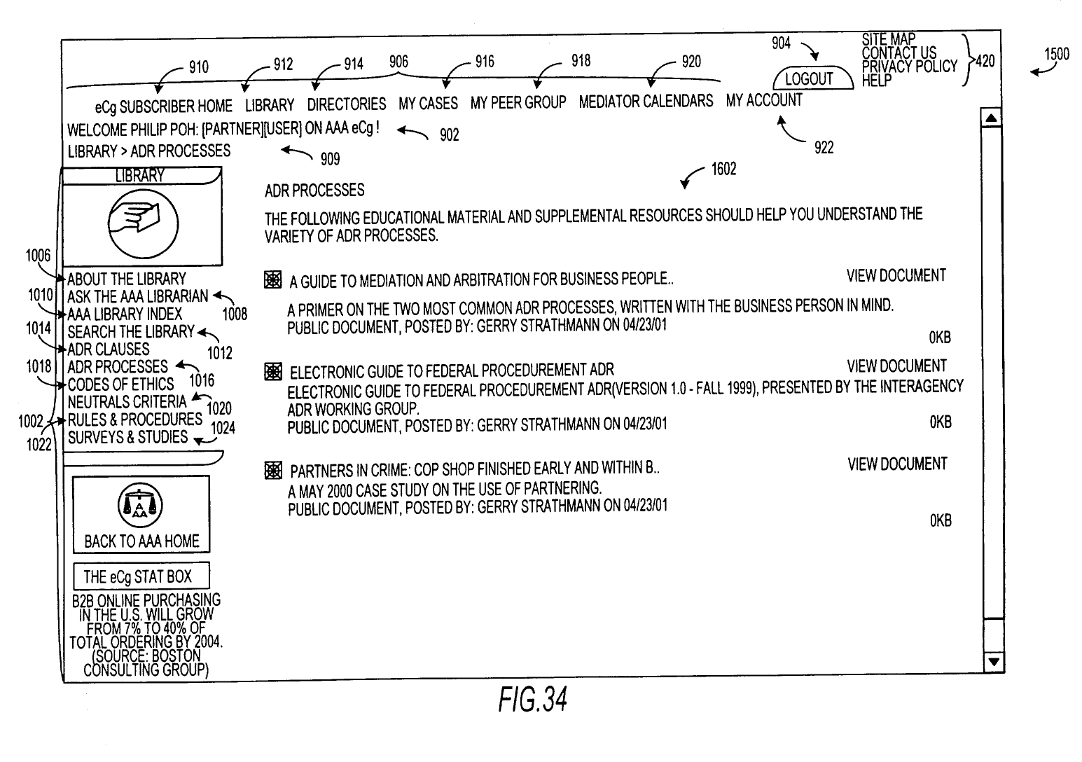

In some embodiments, the dispute management application may provide users with information relating to alternate dispute resolution (ADR) processes. When a user selects “ADR Processes” link 1016 from side bar 1002, the dispute management application may provide supplemental resources relating to ADR processes in an illustrative display 1500 of FIG. 34. As shown in FIG. 34, display 1500 may provide a listing 1502 of resources relating to ADR processes. Listing 1502 may also include the title of the resources and a description of the resources. The information may also provide the user with options relating to the document, such as, for example, a “View Document” button and a “Download” button.

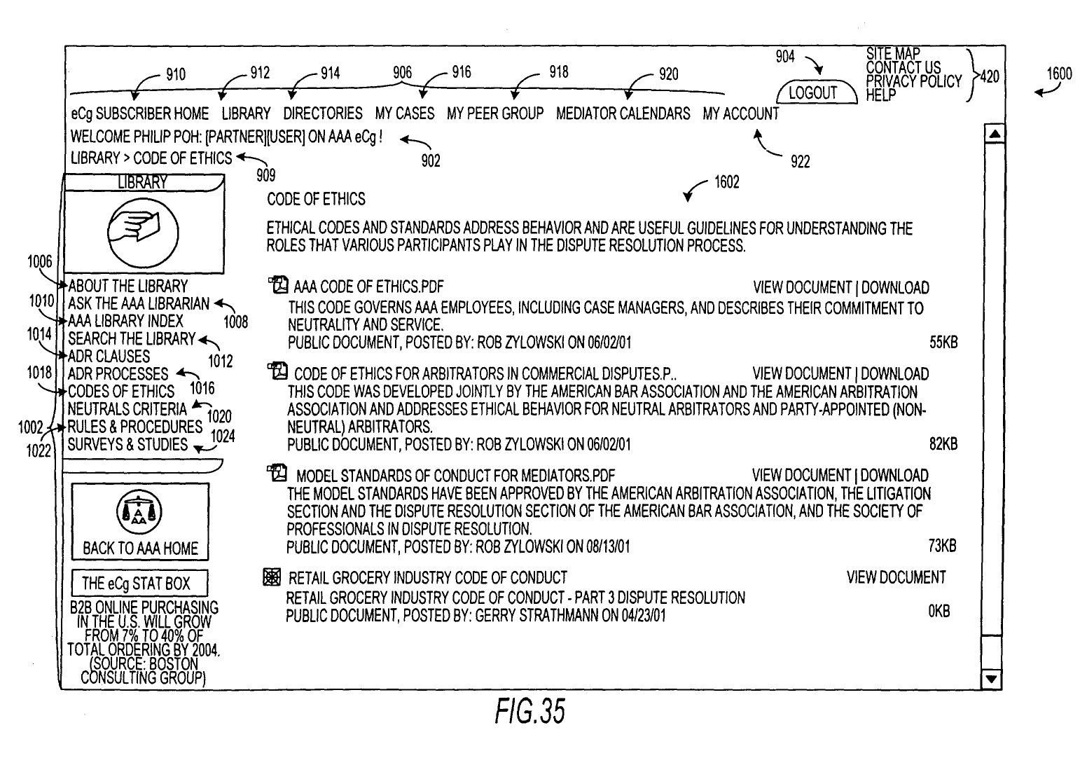

Typically, ethical codes and standards address behavior and may be useful guidelines for understanding the roles that various users play in the dispute resolution process. In some embodiments, the dispute management application may provide users with information relating to such ethical codes. When a user selects “Codes of Ethics” link 1018 from side bar 1002, the dispute management application may provide supplemental resources relating to ethical codes in an illustrative display 1600 of FIG. 35. As shown in FIG. 35, display 1600 may provide a listing 1602 of resources relating to ethical codes. Listing 1602 may also include the title of the resources and a description of the resources. The dispute management application may also provide the user with options relating to the resources, such as, for example, a “View Document” button and a “Download” button.

In some embodiments, the dispute management application may use neutrals, or any other suitable user, to assist in the ADR process. Typically, rigorous standards are established for selecting neutrals that may instill confidence in the users using the dispute management application. In some embodiments, the dispute management application may provide users with information relating to the criteria for selecting neutrals. When a user selects “Neutrals Criteria” link 1020, the dispute management application may provide such information relating to the criteria for selecting neutrals in an illustrative display 1700 of FIG. 36. As shown in FIG. 36, display 1700 may provide a listing 1702 of resources relating to neutrals criteria. Listing 1702 may also include the title of the resources and a description of the resources. The dispute management application may also provide the user with options relating to the resources, such as, for example, a “View Document” button and a “Download” button.

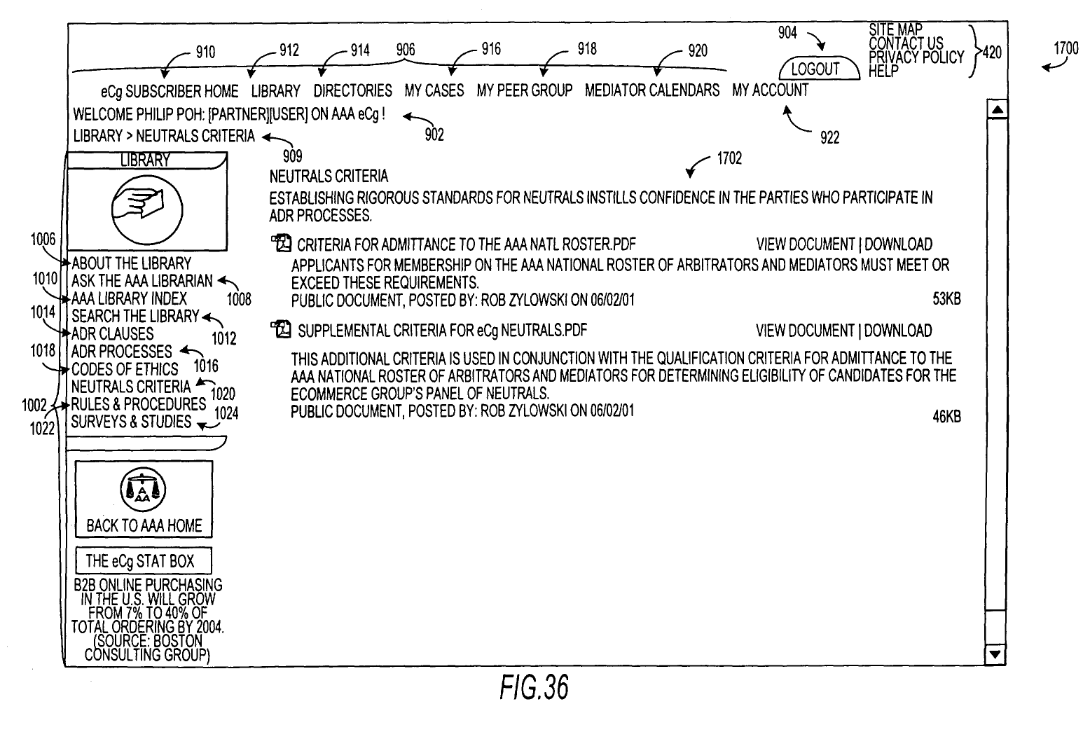

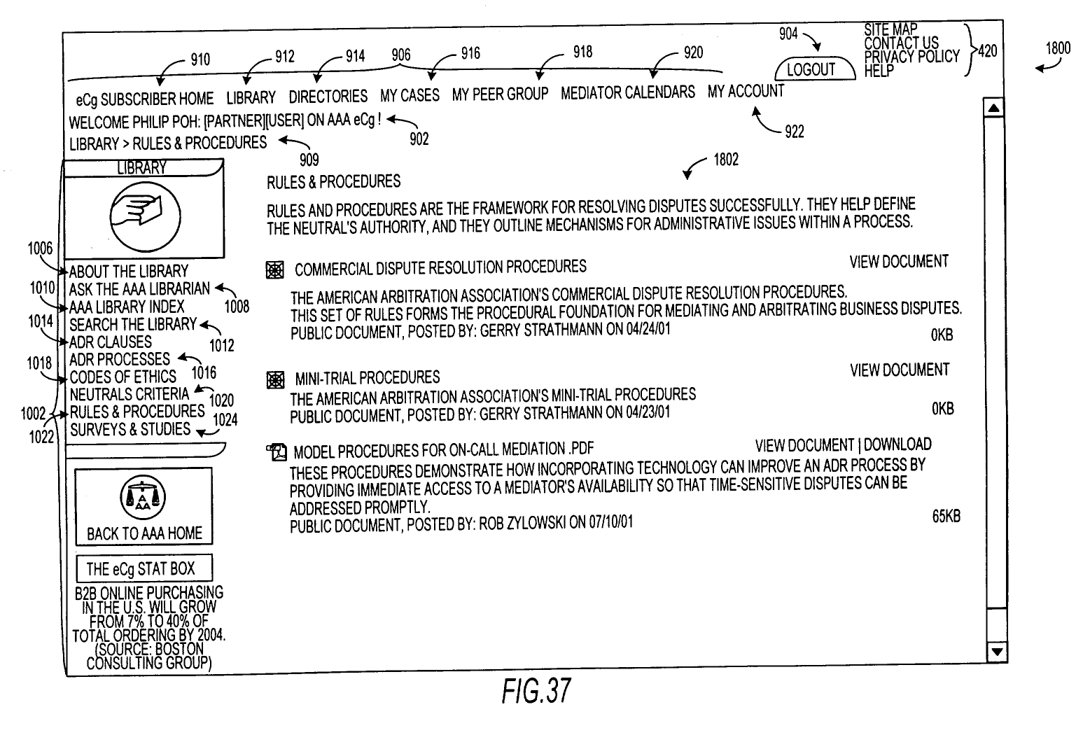

In some embodiments, the dispute management application may provide users with information relating to rules and procedures for the ADR process. Such rules and procedures may, for example, define a neutral's authority and outline mechanisms for administrative issues within an ADR process. When a user selects “Rules & Procedures” link 1022, the dispute management application may provide resources relating to such rules and procedures in an illustrative display 1800 of FIG. 37. As shown in FIG. 37, display 1800 may provide a listing 1802 of resources relating to rules and procedures. Listing 1802 may also include the title of the resources and a description of the resources. The dispute management application may also provide the user with options relating to the resources, such as, for example, a “View Document” button and a “Download” button.

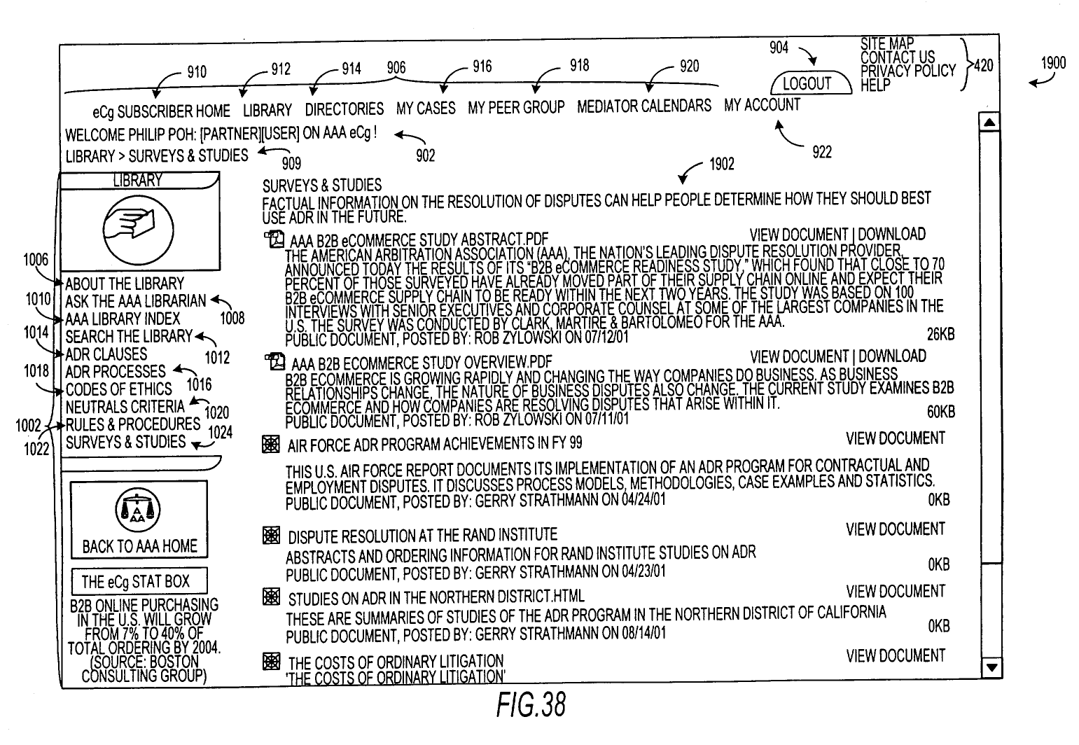

In some embodiments, the dispute management application may provide users with information relating to surveys and studies on ADR processes. Such surveys and studies may assist users in determining the best ADR process for their particular case. When a user selects “Surveys & Studies” link 1024, for example, the dispute management application may provide resources relating to such surveys and studies in an illustrative display 1900 of FIG. 38. As shown in FIG. 38, display 1900 may provide a listing 1902 of resources relating to surveys and studies on ADR processes. Listing 1902 may also include the title of the resources and a description of the resources. The dispute management application may also provide the user with options relating to the resources, such as, for example, a “View Document” button and a “Download” button.

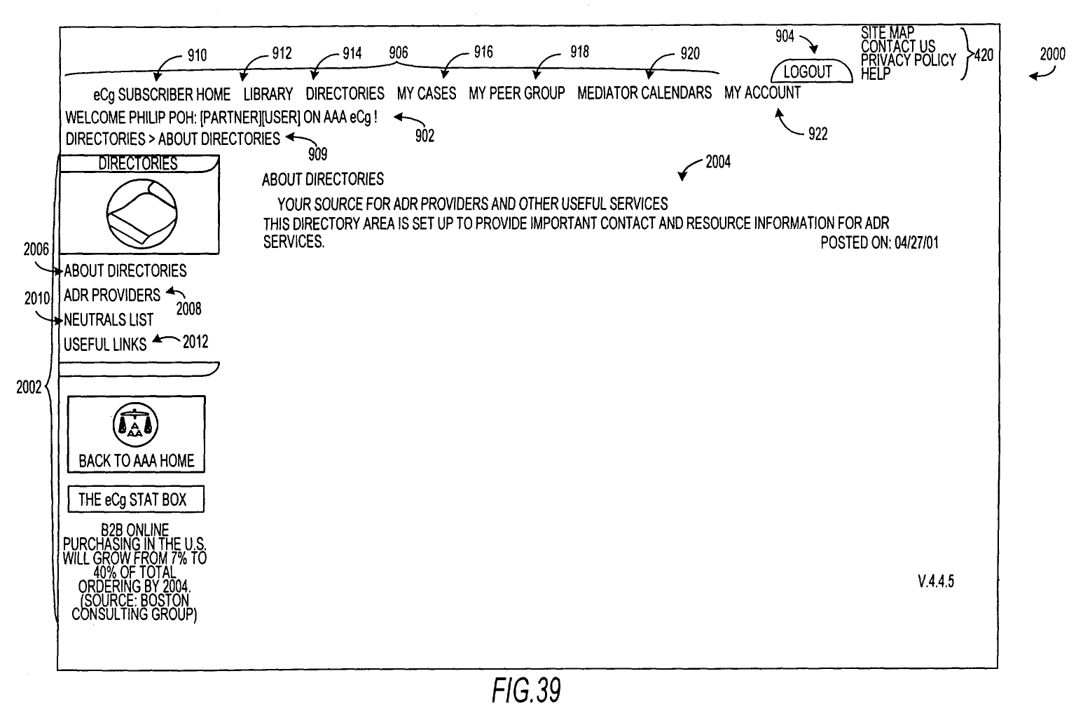

In some embodiments, the dispute management application may provide the user with a directory area. For example, when a user selects “Directories” link 914 from header portion 906, the dispute management application may provide the user with an illustrative directory menu display 2000 as shown in FIG. 39. Display 2000 may include a side bar 2002 and an information area 2004.

Side bar 2002 may include links, such as, for example, an “About Directories” link 2006, an “ADR Providers” link 2008, a “Neutrals List” link 2010, a “Useful Links” link 2012, and any other suitable link to services related to the directories service.

Information area 2004 may include introductory information to the directory service, such as, for example, notifying the user that the dispute management application may provide the user with access to contact and resource information relating to ADR services. The user may also access information area 2004 by, for example, selecting “About Directories” link 2006 in side bar 2002.

In some embodiments, the dispute management application may provide users with agreements between ADR service providers. When a user selects “ADR Providers” link 2008 from side bar 2002, the dispute management application may provide the user with information relating to agreements between ADR service providers in an illustrative display 2100 as shown in FIG. 40. Display 2100 may provide listings 2102. Listing 2102 may provide the user with, for example, an arrangement between two ADR service providers and any other inter-association arbitration agreements.

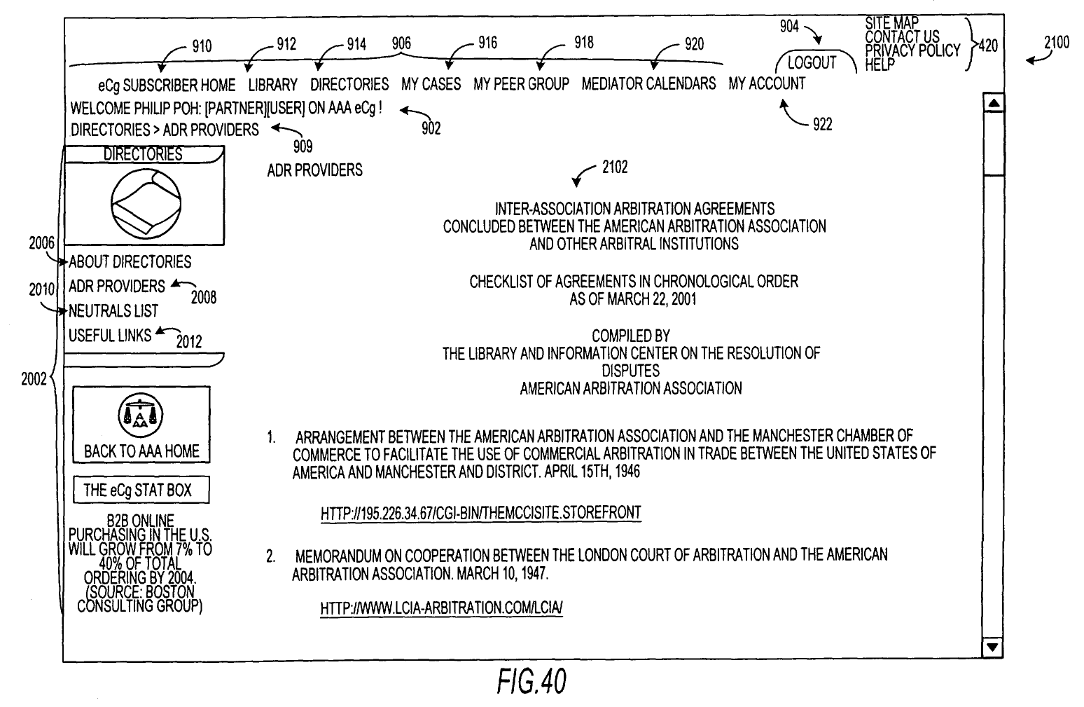

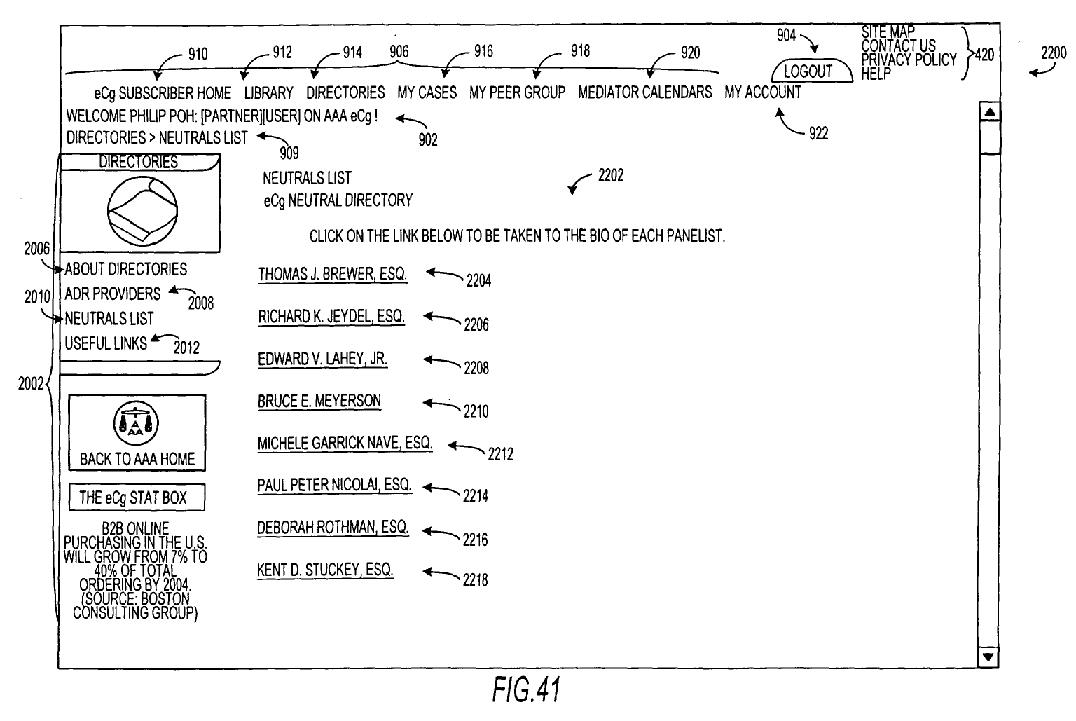

Referring back to FIG. 36, the dispute management application may use neutrals, or any other suitable user, to assist in the ADR process. Criteria for selecting these neutrals is shown in display 1700 of FIG. 36. In some embodiments, the dispute management application may provide users with a list of selected neutrals. When a user selects “Neutrals List” link 2010, the dispute management application may provide the user with an illustrative neutrals listing display 2200 as shown in FIG. 41. Display 2200 may include a list of neutrals 2202. The list 2202 may include selectable links 2204-2218 for each neutral. When the user selects one of selectable links 2204-2218, the dispute management application may provide the user with biographical information and any other suitable information relating to the selected neutral.

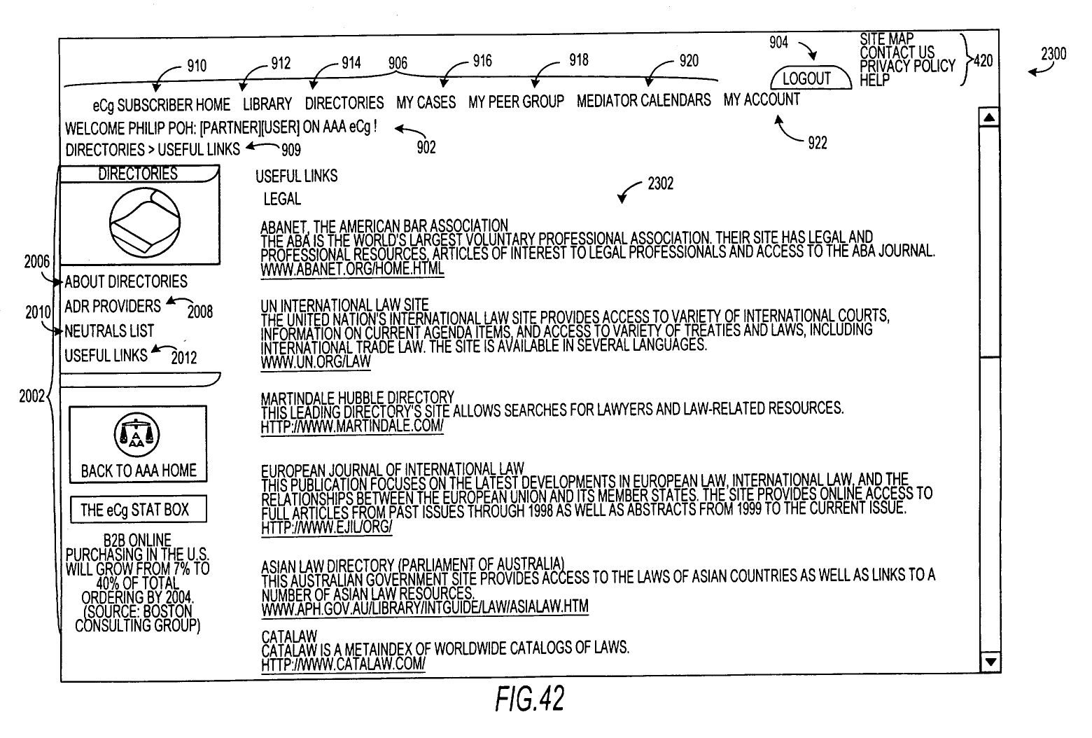

In some embodiments, the dispute management application may provide the user with related links. When a user selects “Useful Links” link 2012, the dispute management application may provide the user with an illustrative links display 2300 as shown in FIG. 42. Display 2300 may include a list of links 2302. The list 2302 may include links to other resources, such as “the United Nations International Law” web site or any other suitable web site related to dispute management.

In some embodiments, the dispute management application may provide the user with an area for dispute management case-specific activities. Such activities may include, for example, filing a new claim, accessing active cases, reviewing the status of an active case, and performing any other suitable activity.

Some embodiments of the present invention may provide arbitration services. Arbitration services may be used to allow one or more neutral arbitrators to consider evidence from both disputing parties and render a decision. For example, when parties have a dispute, they may access an on-line list of potential arbitrators and either agree to use or participate in a selection process to determine the arbitrator. An arbitrator may be appointed by, for example, a case manager. The parties may be provided with a schedule for the submission of arguments, evidence, replies, and any other suitable information. The arbitrator may provide a decision on the dispute.

Some embodiments of the present invention may provide documents-only arbitration services. For example, when parties have a dispute, they may access an on-line list of potential arbitrators and either agree to use or participate in a selection process to determine the arbitrator. An arbitrator may be appointed if desired. Some embodiments may provide the disputing parties with a schedule for the submission of arguments, evidence, replies, and any other suitable information in document format. The arbitrator may view the documents and provide a decision on the dispute.

Some embodiments of the present invention may provide mediation services. Mediation services may be used to allow parties to work together with the aid of a neutral facilitator (e.g., a mediator). One particular type of mediation service is on-call mediation. For example, when parties have a dispute, they may access an on-line calendar of mediators' availabilities. The disputing parties (i.e., a claimant and a respondent) may agree to a mediator through a scheduling interface. Upon selecting a mediator and a time slot, the parties may be provided with contact information and a schedule for submitting any documentation. Mediators may be notified of their selection and the time slot may be removed from the online calendar. If the mediator accepts the case, the disputing parties may be notified. In some embodiments, dates and other information may be automatically published for information that is due before the meeting with the mediator.

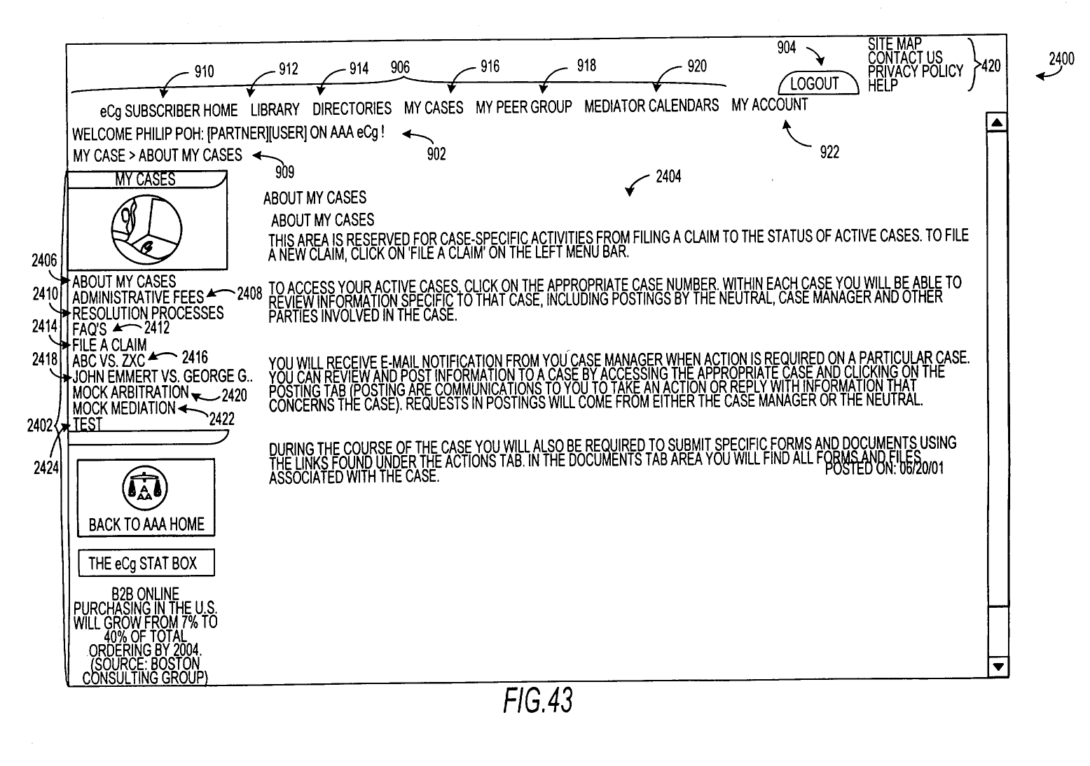

When a user selects “My Cases” link 916 from header portion 906, the dispute management application may provide the user with a case display, such as illustrative case display 2400 as shown in FIG. 43. Display 2400 may provide the user with a side bar 2402 and an information area 2404.

Side bar 2402 may include links, such as, for example, an “About My Cases” link 2406, an “Administrative Fees” link 2408, a “Resolution Processes” link 2410, a “FAQs” link 2412, a “File a Claim” link 2414, links to active cases 2416-2424, or any other suitable link to services related to the cases.

Although links to active cases 2416-2424 are shown, in some embodiments, the dispute management application may provide a user with access to cases that the user is permitted to view. For example, the dispute management application may allow a user to view a case in which he or she is designated a claimant-user, a respondent-user, a case manager-user, or a neutral user.

Information area 2404 may include introductory information to the “My Cases” area, such as, for example, instructions for using the “My Cases” area and notifications posted from case managers regarding the “My Cases” area. The user may also access information area 2404 by, for example, selecting “About My Cases” link 2406 in side bar 2402.

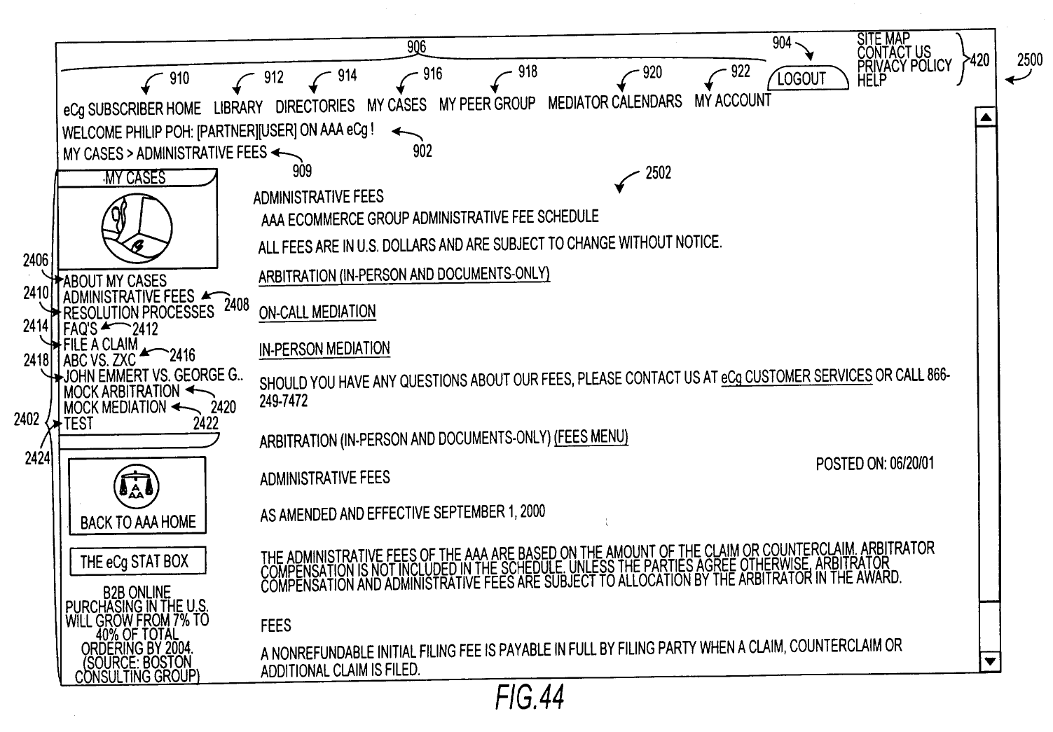

In some embodiments, the dispute management application may provide the user with the fees for a dispute resolution process. The fees may be based at least in part on the amount specified in a claim or a counterclaim. In another suitable approach, the fees may be based at least in part on the selected resolution process. When a user selects “Administrative Fees” link 2408 of side bar 2402, the dispute management application may provide the user with an illustrative fee display 2500 as shown in FIG. 44. Display 2500 includes an information area 2502 that includes a list of fees and an detailed explanation of how those fees are determined.

Some embodiments of the present invention may guide disputing parties in understanding resolution options and aid them in selecting the most appropriate mechanism for solving their dispute. Users may also be provided with information such as the cost of the resolution (e.g., estimate, average, or other cost), the typical time to resolve similar disputes, the success rate for similar disputes, or any other suitable information.

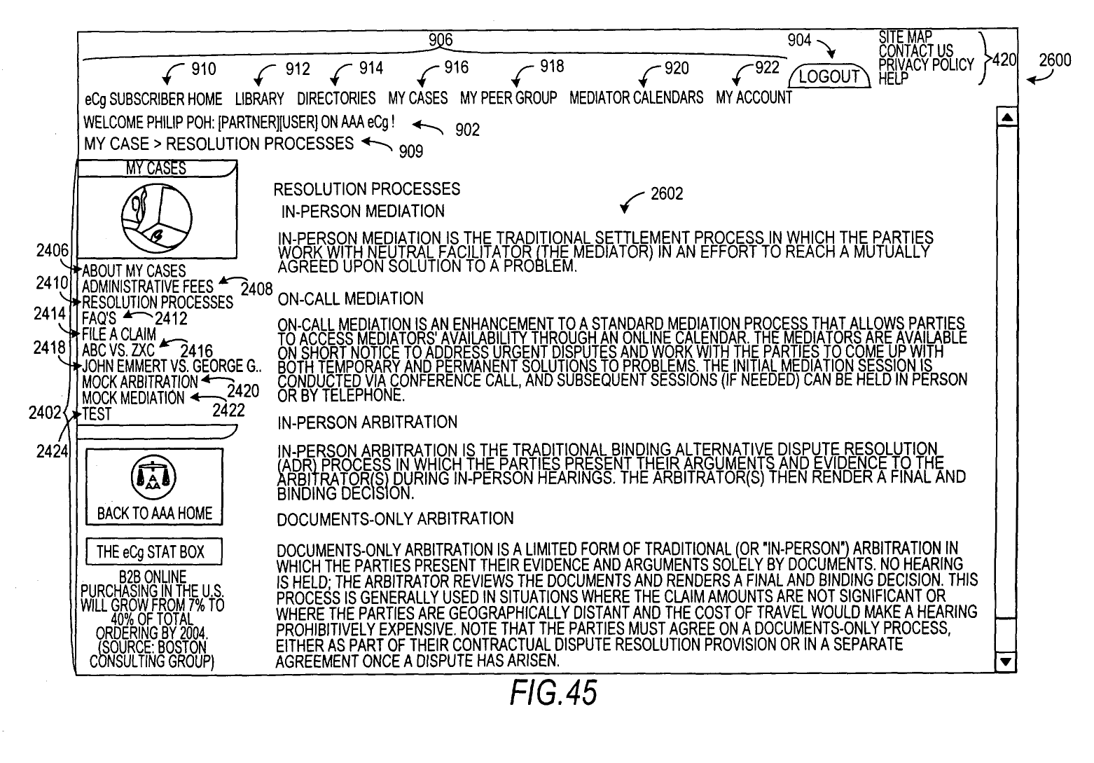

The dispute management application may provide the user with a display that describes the resolution mechanisms as shown in FIG. 45. When a user selects “Resolution Processes” link 2410 of side bar 2402, the dispute management application may provide the user with an illustrative information display 2600 as shown in FIG. 45. Display 2600 includes a detailed description area 2602. The dispute management application may include a description of the dispute resolution processes in detailed description area 2602.

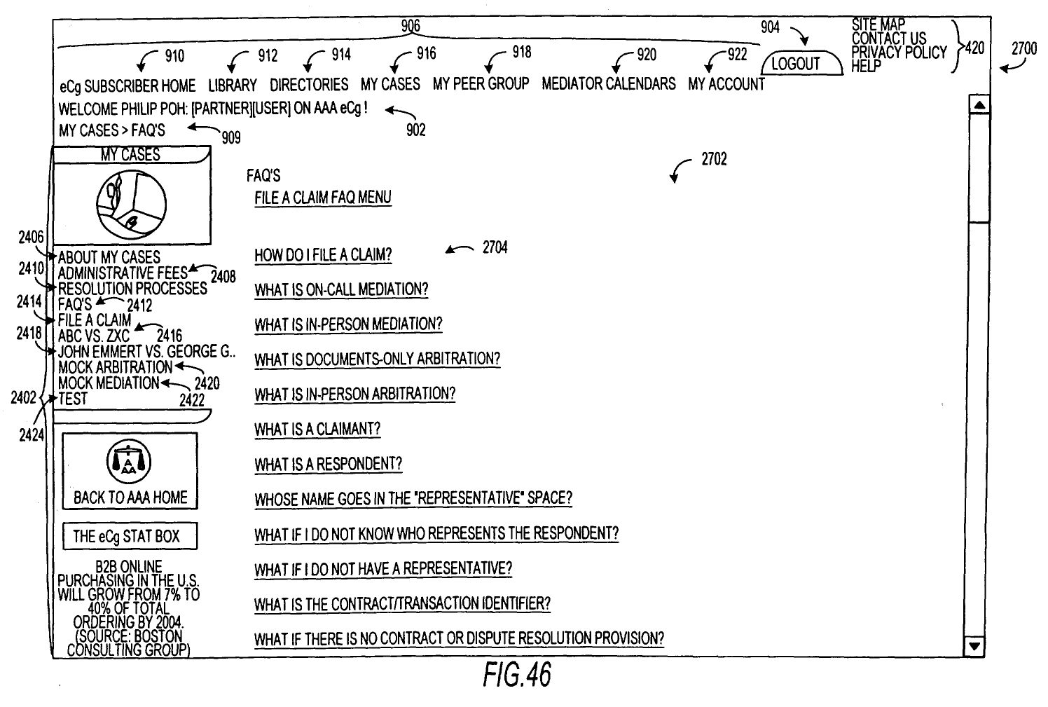

In some embodiments, the dispute management application may provide the user with a display that includes frequently asked questions (FAQs). When a user selects “FAQs” link 2412 of side bar 2402, the dispute management application may provide the user with an information display, such as illustrative information display 2700 as shown in FIG. 46. Display 2700 includes a questions area 2702. The dispute management application may include multiple questions links (e.g., a link 2704) that are frequently asked by users in questions area 2702. Such questions may include, for example, “How do I file a claim?” or “What if there is no contract or dispute resolution provision?” When the user selects question link 2704, the dispute management application may provide the user with the answer.

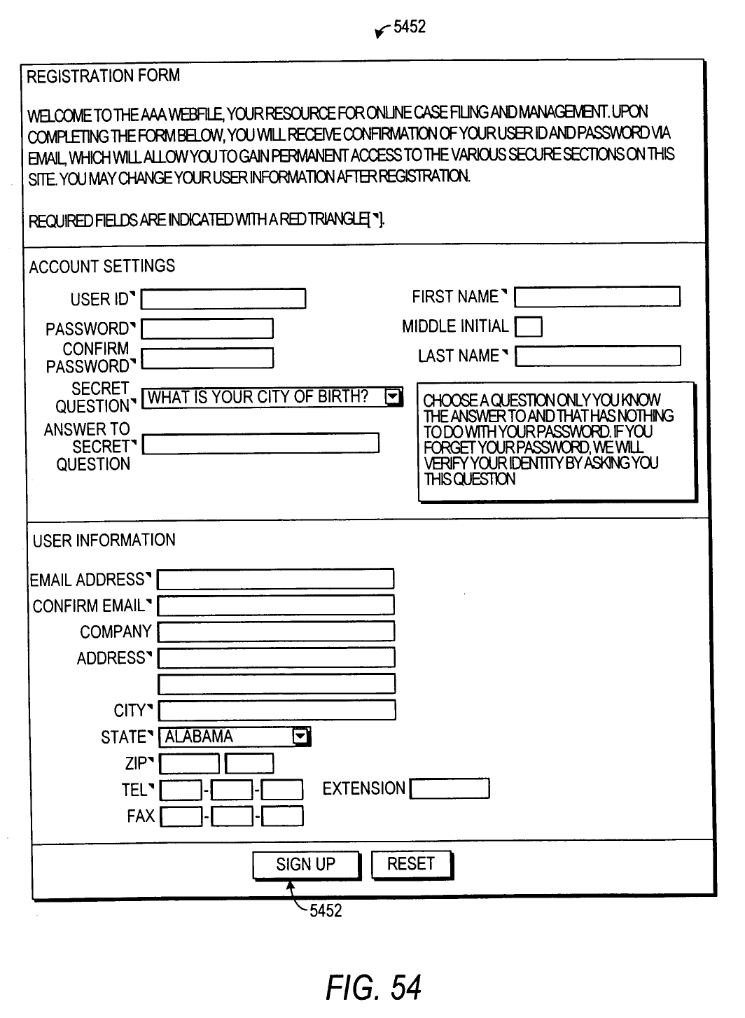

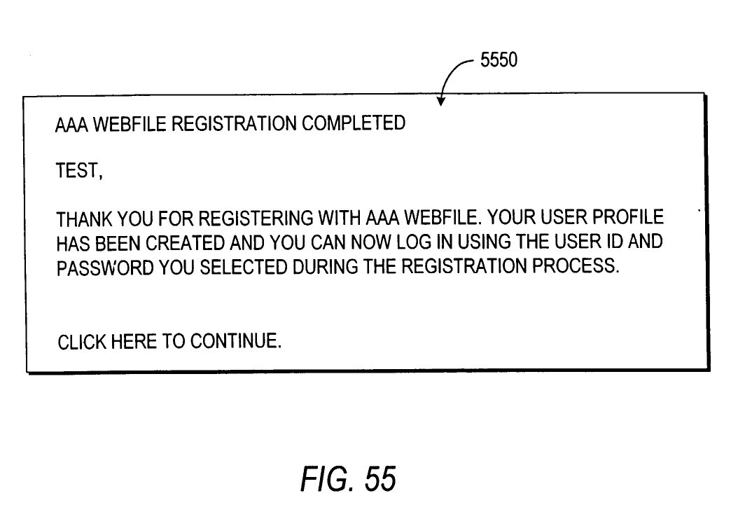

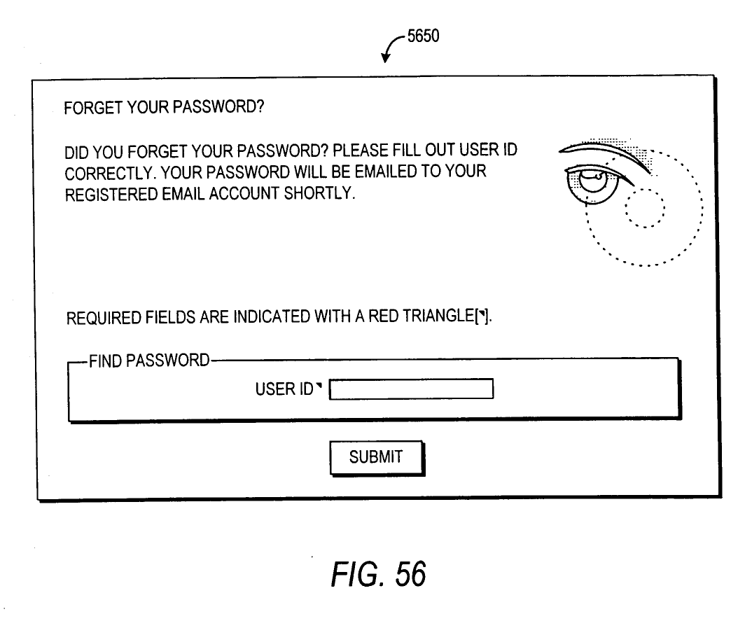

Some embodiments of the present invention may allow users to file claims. For example, a user may be prompted to input information such as name, address, telephone number(s), or any other information relating to the claim. The user may also be prompted to select a resolution process. Upon inputting the information, a user, such as a case manager or a neutral, may post messages viewable by users relating to the case. Illustrative displays that may be provided to a user when the user is filing a claim are shown in FIGS. 47-52 and FIGS. 53-104.

In FIG. 47, the dispute management application may provide a user with an illustrative display 2800 in response to, for example, a user indicating that he or she desires to file a claim. In some embodiments, the dispute management application may allow the user to file a claim by, for example, selecting “file a claim” link 2414 of side bar 2402. In some embodiments, the dispute management application may also allow the user to file a claim by, for example, selecting “file a claim” link in header portion 402 (FIG. 4). Display 2800 may allow the user to select from multiple links 2802 and 2804. When the user selects “AAA Claim Filing Area” link 2802, the dispute management application may transfer the user to an alternate web site or application for dispute resolution. When the user selects “AAA eCommerce group Claim Filing Area” link 2804, the dispute management application may provide the user with an illustrative display 2900 as shown in FIG. 48.

As shown in FIG. 48, the dispute management application may prompt the user to answer multiple questions. In some embodiments, the user may respond to the questions by, for example, placing a checkmark into a checkbox. Each checkbox may correspond to a provided answer. For example, the user may be prompted with the question “Does your agreement have a clause providing for administration by the American Arbitration Association?” The user may answer “Yes” by, for example, placing a checkmark in the box adjacent to the provided answer. However, any other suitable approach may also be used. For example, the user may answer the question by selecting an answer. Upon selecting the answer (e.g., clicking on “Yes” with the mouse), a checkmark may be placed indicating the user's response.

When the user has responded to the questions, the user may proceed with the claim filing process by, for example, selecting a “Submit” button 2904. When the user selects “Submit” button 2904, the dispute management application may provide the user with a claimant information display, such as an illustrative claimant information display 3000 as shown in FIG. 30. In some embodiments, the user may cancel the claim filing process by, for example, selecting a “Cancel” button 2906. When the user selects “Cancel” button 2906, the dispute management application may return the user to menu display 2400 (FIG. 43) or any other suitable display.

As shown in display 3000 of FIG. 49, the dispute management application may prompt the user to input information relating to the claimant of the dispute. In some embodiments, the dispute management application may provide the user with a claimant form 3002. Form 3002 includes drop-down fields 3004 and 3022 and multiple text fields 3006-3020. The user may be prompted to input information, such as, for example, name, company name, representative, firm name, address, phone number, fax number, e-mail address, and any other suitable information. The user may also be prompted to indicate the resolution process that the user desires to use for resolution of the dispute (as shown in drop-down field 3004). When the user selects drop-down field 3004, the dispute management application may provide the user with resolution process, such as “On-Call Mediation,” “In-Person Mediation,” “Documents-Only Arbitration,” and “In-Person Arbitration.” The dispute management application may also prompt the user to indicate the number of respondents with drop-down field 3022.

In some embodiments, the user may cancel the claim filing process by, for example, selecting a “Cancel” button 3026. When the user selects “Cancel” button 3026, the dispute management application may return the user to menu display 2400 (FIG. 43) or any other suitable display.

When the user has inputted the claimant information, the dispute management application may allow the user to proceed with the claim filing process by, for example, selecting a “Submit” button 3024. When the user selects “Submit” button 3024, the dispute management application may provide the user with a combined claimant-respondent information display, such as illustrative combined claimant-respondent information display 3100 as shown in FIG. 50.

As shown in illustrative combined display 3100 (FIG. 50), the dispute management application may prompt the user to input information relating to the one or more respondents of the dispute. The dispute management application may also prompt the user to input information relating to the nature of the dispute (e.g., breach of contract) and the relief sought (e.g., damages). In some embodiments, the dispute management application may provide the user with a form 3104. Form 3104 includes multiple text fields 3106-3126. The user may be prompted to input information, such as, for example, name, company name, representative, firm name, address, phone number, fax number, e-mail address, and any other suitable information relating to the respondent.

When the user has inputted the information, the dispute management application may allow the user to proceed with the claim filing process by, for example, selecting a “Submit” button 3128. When the user selects “Submit” button 3128, the dispute management application may provide the user with a payment information display, such as illustrative payment information display 3200 as shown in FIG. 51.

As shown in payment display 3200, the dispute management application may prompt the user to input payment information. The user may be prompted to input information, such as, for example, credit card information and any other suitable payment information. In some embodiments, the dispute management application may provide the user with a form 3202. Form 3202 includes interfaces 3204-3218. For example, the dispute management application may provide interface 3206 for allowing the user to indicate the type of credit card. In another suitable approach, the dispute management application may allow the user to indicate a payment by check.

When the user has inputted the information, the dispute management application may allow the user to proceed with the claim filing process by, for example, selecting a “Submit” button 3220. When the user selects “Submit” button 3220, the dispute management application may provide the user with a submission display, such as illustrative submission display 3300 as shown in FIG. 52.

In some embodiments, the user may cancel the claim filing process by, for example, selecting a “Cancel” button 3222. When the user selects “Cancel” button 3222, the dispute management application may return the user to menu display 2400 (FIG. 43) or any other suitable display.

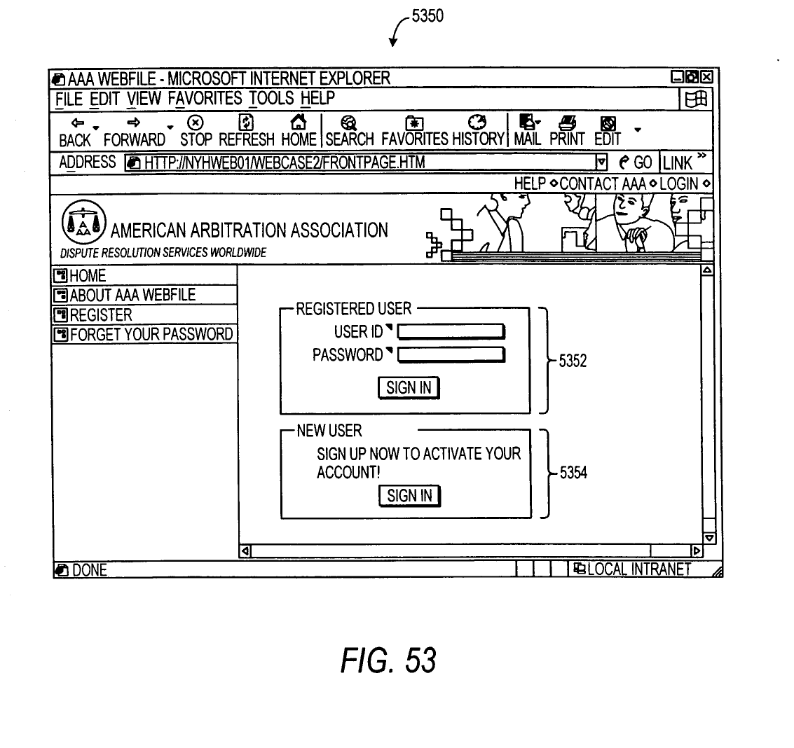

Illustrative user interfaces shown in FIGS. 53-59 are an alternative embodiment in which a user may register to become a user, log in, and modify their profile.

The on-line nature of the dispute management application may allow display 5350 to be accessed by persons who are not registered users. Non-registered users may indicate a desire to become a registered user by, for example, selecting “Sign Up” button 5354 or any other suitable approach, such as selecting a link. In response to the user indication to become a registered user, the dispute management application may provide a registration display, such as illustrative registration display. The illustrative registration display 5450 may, for example, prompt the new user for information, such as, for example, the user's name, a desired username and password, a user identification, e-mail address, company, telephone and fax numbers, and any other suitable information.

In response to the user selecting “Signup” button 5452, the dispute management application may provide the user with a confirmation display, such as illustrative confirmation display 5530. Display 5530 may include a message indicating that the user has completed the registration process.

In response to the user inputting an incorrect password, the dispute management application may provide the user with a password display, such as illustrative password display 5650. In this example, the dispute management application is prompting the user for the user's user identification. In response to the user entering the information, the dispute management application may communicate the user's username and password electronically (e.g., via e-mail).

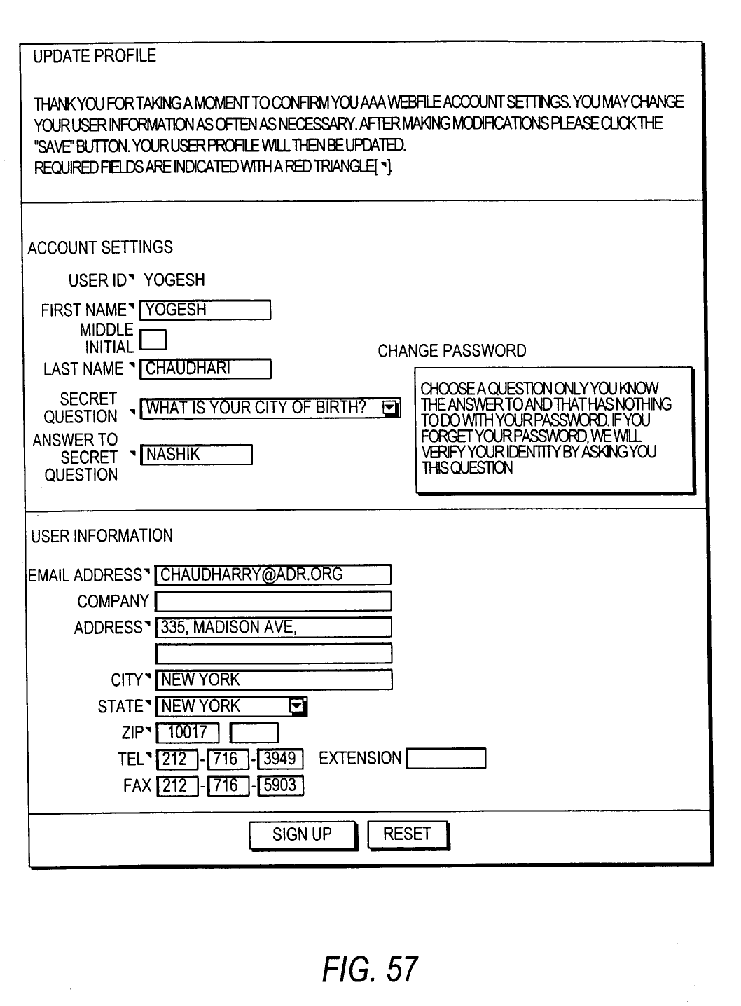

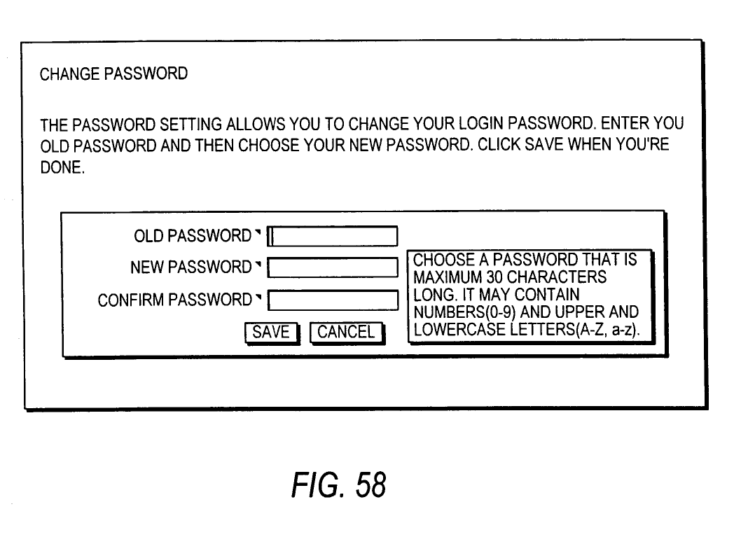

In FIGS. 57 and 58, the dispute management application may also allow the user to access the user's profile. The dispute management application may prompt the user to update the user's profile. In some embodiments, the dispute management application may also allow the user to change the user's password as shown, for example, in FIG. 58.

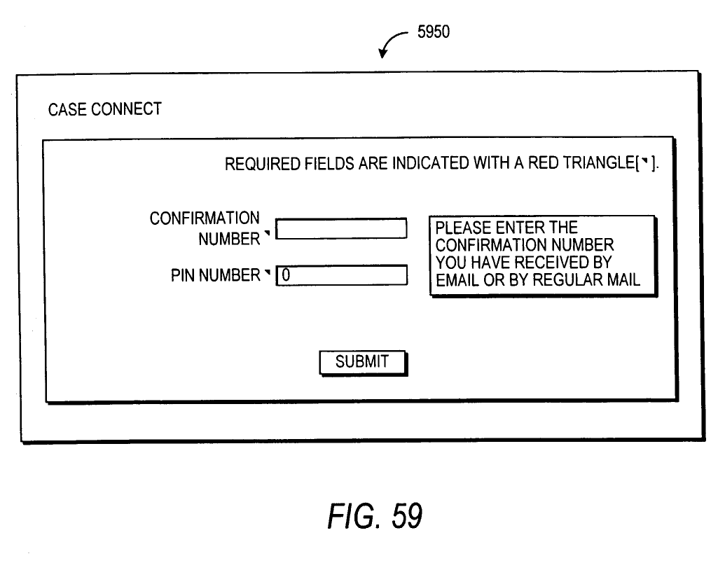

In some embodiments, the dispute management application may allow the user to connect with claims or cases filed by other parties. As shown in FIG. 59, the dispute management application may provide the user with a case connect display, such as illustrative case connect display 5950. In some embodiments, the dispute management application may provide the user with a printed or electronic (e.g., e-mail) notification. The notification may include a confirmation number that connects the user to claims or cases filed by other parties.

A second illustrative user interface approach for filing a claim is shown in FIGS. 60-104. This approach is described, for example, in above-mentioned U.S. provisional application No.______ (Attorney Docket No. AAA-004 Prov.), filed Nov. 21, 2001, which is incorporated by reference herein in its entirety. The approach shown in FIGS. 60-104 includes some of the same display elements of the other approaches described herein, some of which may have different display characteristics.

In the second illustrative user interface, the dispute management application may provide users with a claim display, such as illustrative claim display 6050 in response to, for example, a user indicating that he or she desires to file a claim. As shown in FIG. 60, the dispute management application may prompt the user to answer multiple questions. In some embodiments, the user may respond to questions by, for example, placing a checkmark into a checkbox or selecting a radio button. Each checkbox may correspond to a provided answer. However, any other suitable interface element may also be used, such as, for example, push buttons and radio buttons. For example, the dispute management application may prompt the user the answer questions, such as “Who is your dispute in accordance with?” or “Are you filing this claim as a claimant or claimant's representative?” Display 6050 may also include questions relating to arbitration clauses, such as “Does your agreement have an arbitration clause?”

Display 6050 may also include radio buttons 6052, radio buttons 6054, and checkbox 6056. In this example, radio buttons 6052 allow the user to indicate the type of user that is filing the claim. For example, the user may indicate that he or she is a claimant or a representative of the claimant. The dispute management application may also provide the user with radio buttons 6054 to allow the user to indicate the type of dispute the user is filing. The dispute management application may also provide the user with checkbox 6056 to indicate whether there is an arbitration clause in the user's agreement. In this example, checkbox 6056 is associated with the question “Does your agreement have an American Arbitration Association clause providing for administration by this Association?” Although radio buttons 6052, radio button 6054, and checkbox 6056 are shown, any other suitable user graphical or audio prompts may be used, such as, for example, push buttons, scroll bars, drop-down menus or lists, input fields or text boxes, or any other suitable user interface construct.

In some embodiments, the dispute management application may provide the user with a “Reset” button 6060. In response to the user selecting “Reset” button 6060, the dispute management application may clear the indications previously inputted by the user.

In some embodiments, the dispute management application may provide the user with a “Next Step” button 6058. In response to the user selecting “Next Step” button 6058, the dispute management application may provide the user with a claimant information display, such as illustrative claimant information display 6150 shown in FIG. 61.

As shown in FIG. 61, display 6150 includes a claimant information area 6152. The dispute management application may allow the user to input claimant information into claimant information area 6152. Although text fields are shown, any other suitable user graphical or audio prompts may be used, such as, for example, push buttons, radio buttons, scroll bars, drop-down menus or lists, input fields or text boxes, or any other suitable user interface construct.

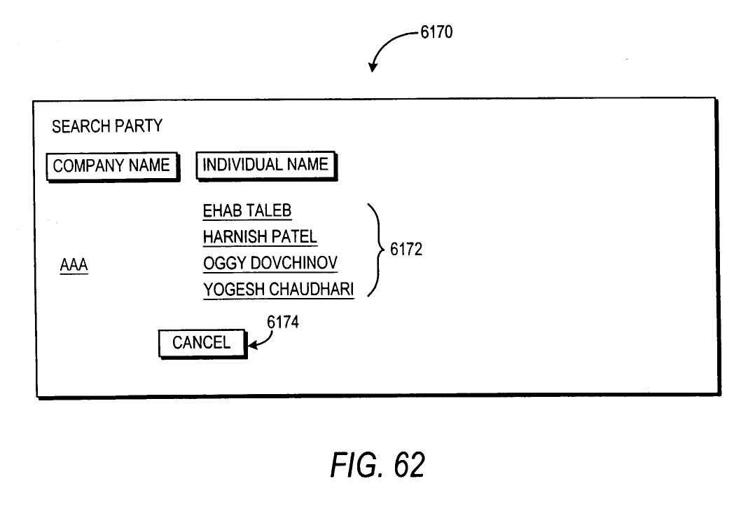

In some embodiments, the dispute management application may allow the user to search for information from previously filed cases. For example, when a user has inputted claimant information in a previous case, the user may desire to use the search feature such that he or she does not have to re-enter the information. Display 6150 may include search button 6162. In response to the user selecting search button 6162, the dispute management application may provide the user with a search party display, such as illustrative search party display 6170 as shown in FIG. 62.

As shown in FIG. 62, the dispute management application may allow a user to search for information on users, such as parties or representatives, from previously field claims or cases. Display 6170 may display a list 6172 of company names and individual names of the users that the user inputted in his or her previously field cases. In response to the user selecting a name from list 6172, the dispute management application may provide the user with a search address display, such as illustrative search address display 6180 as shown in FIG. 63. Display 6180 includes a list 6182 of addresses for the selected user. In response to the user selecting an address from list 6182, the dispute management application may populate the information into claimant information area 6152. However, any other suitable approach may also be used, such as, for example, the dispute management application may provide the user with a table of users and their respective user information.

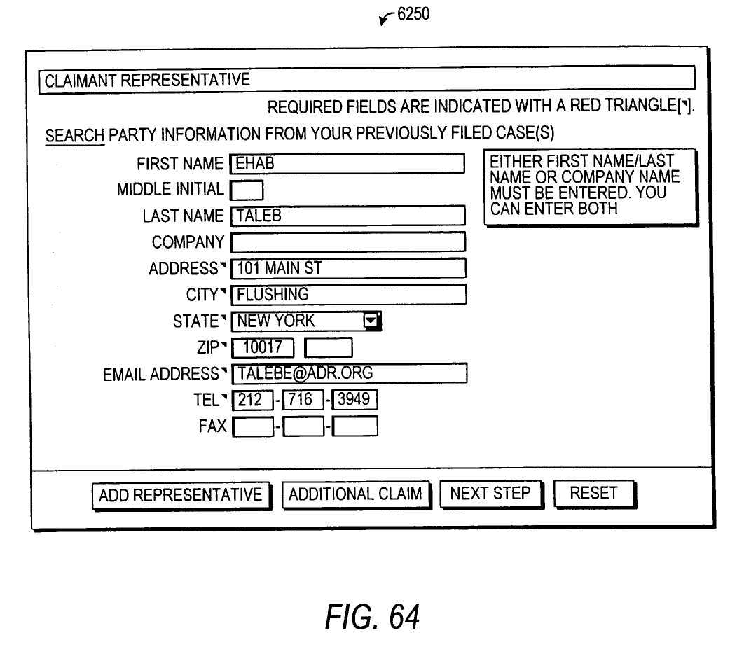

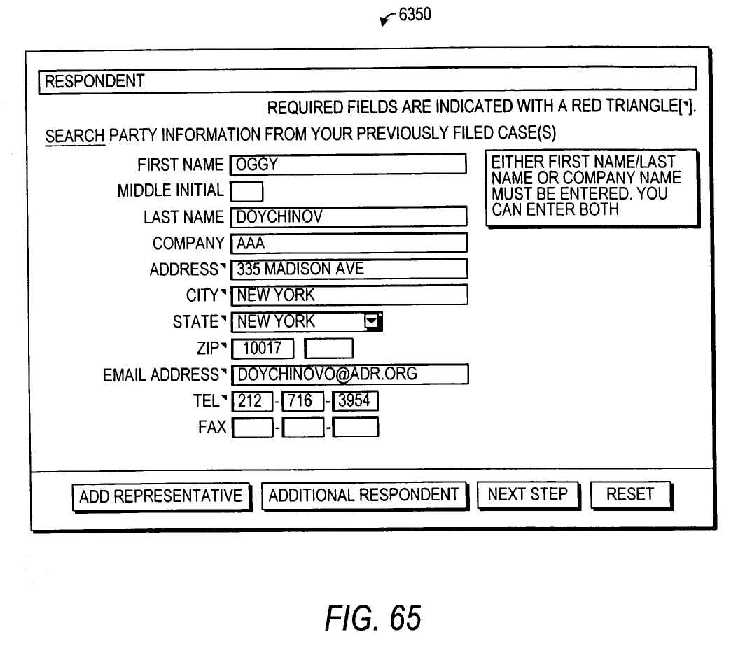

Returning back to FIG. 61, the dispute management application may also provide the user with an “Add Representative” button 6154, an “Additional Claimant” button 6156, a “Next Step” button 6158, and a “Reset” button 6160. In some embodiments, the dispute management application may allow a user to input information relating to a representative of the user. In response to the user selecting button 6154, the dispute management application may provide the user with a claimant representative display, such as illustrative claimant representative display 6250 as shown in FIG. 64. In some embodiments, the dispute management application may allow the user to input information relating to a respondent. In response to the user selecting button 6156, the dispute management application may provide the user with a respondent information display, such as illustrative respondent information display 6350 as shown in FIG. 65.

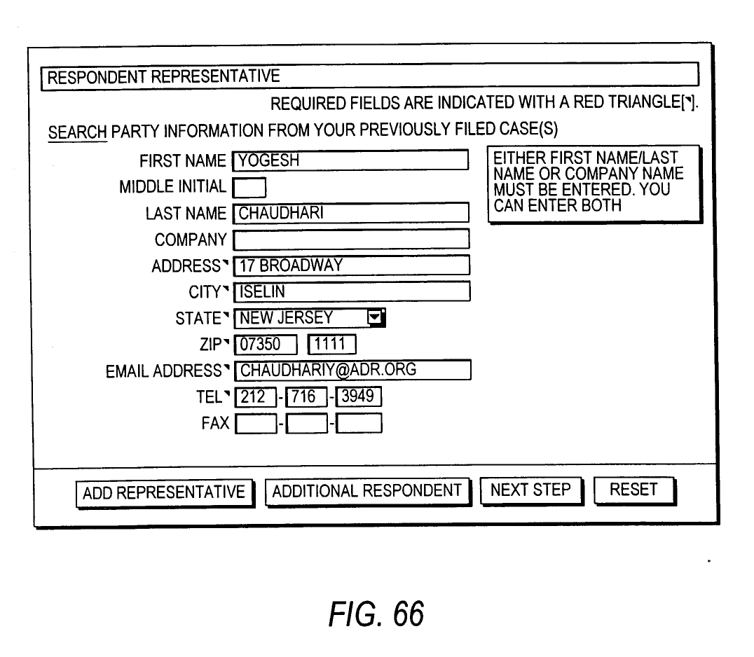

Similar to FIG. 61, the dispute management application may allow the user to input information on the respondent's representative. In response to the user indicating a desire to input information on the respondent's representative, the dispute management application may provide the user with a respondent representative information display, such as illustrative respondent representative information display 6450 as shown in FIG. 66. In some embodiments, the dispute management application may allow the user to input information on an additional respondent.

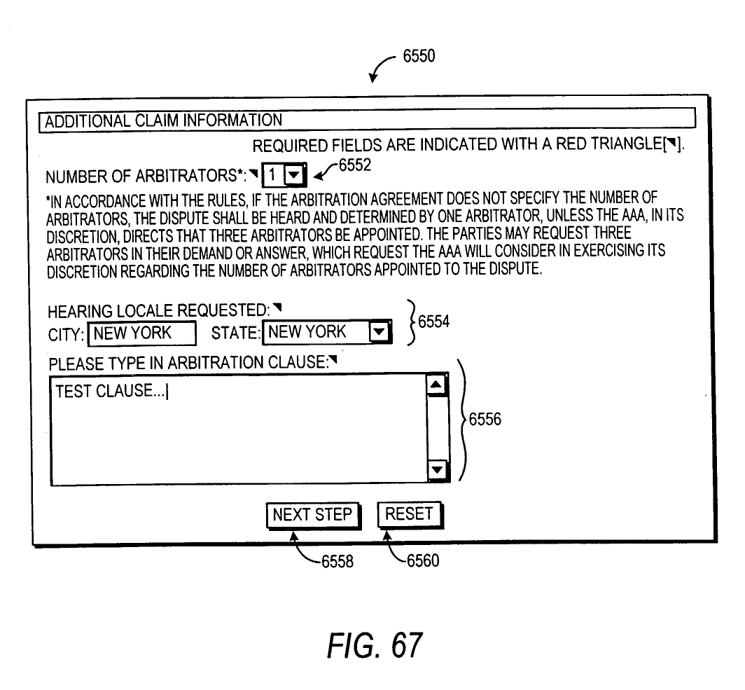

In some embodiments, the dispute management application may allow the user to input claim-related information, such as the number of arbitrators, the hearing location, and the arbitration clause. As shown in FIG. 67, the dispute management application may provide an illustrative claim information display 6550. Display 6550 may include a drop-down menu 6552 and text fields 6554 and 6556. In this example, drop-down menu 6552 may allow the user to indicate the number of arbitrators for the case. The dispute management application may allow the user to indicate a preferred hearing location in text fields 6554. For example, the user may indicate that he or she desires to have the hearing in New York, New York. In some embodiments, the dispute management application may allow a user to indicate the arbitration clause that relates to the case in text field 6556.

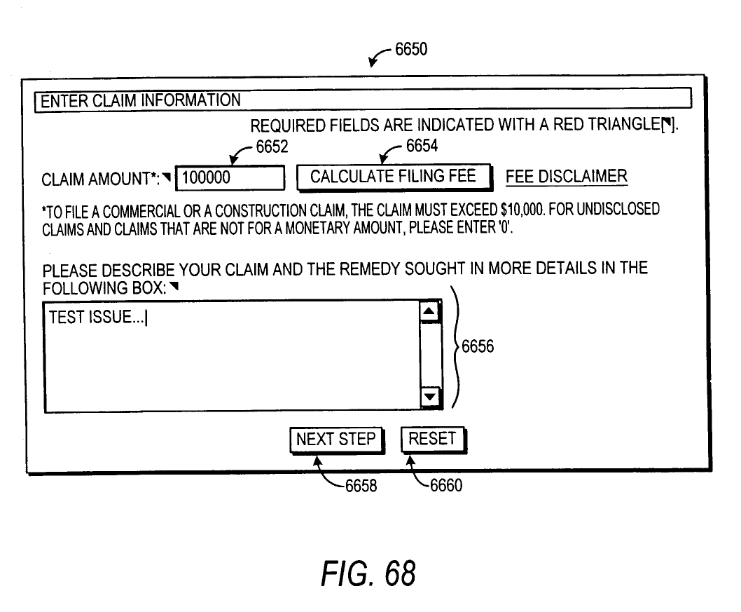

In response to the user selecting a “Next Step” button 6558 or any other suitable user interface construct, the dispute management application may provide the user with a claim information display, such as illustrative claim information display 6650 shown in FIG. 68. In some embodiments, the dispute management application may allow the user to input claim information, such as the claim amount and a description of the claim. As shown in FIG. 68, the dispute management application may allow the user to input the claim amount into a text field 6652 and a description of the claim into a text field 6656.

In some embodiments, the dispute management application may provide the user with the initial filing fee for the inputted claim. In response to the user indication by, for example, selecting “Calculate Filing Fee” button 6654 (FIG. 68), the dispute management application may provide the user with a fee calculator display, such as illustrative fee calculator display 6950 shown in FIG. 69. As shown in FIG. 69, the dispute management application may prompt the user to input claim information, such as dispute procedure in a drop-down menu 6952, the claim amount into a text field 6954, the number of arbitrators required in a drop-down menu 6956, or any other suitable claim information. In response to the user indicating to calculate the filing fee by, for example, selecting a “Calculate” button 6960, the dispute management application may provide the filing fee in text field 6958.

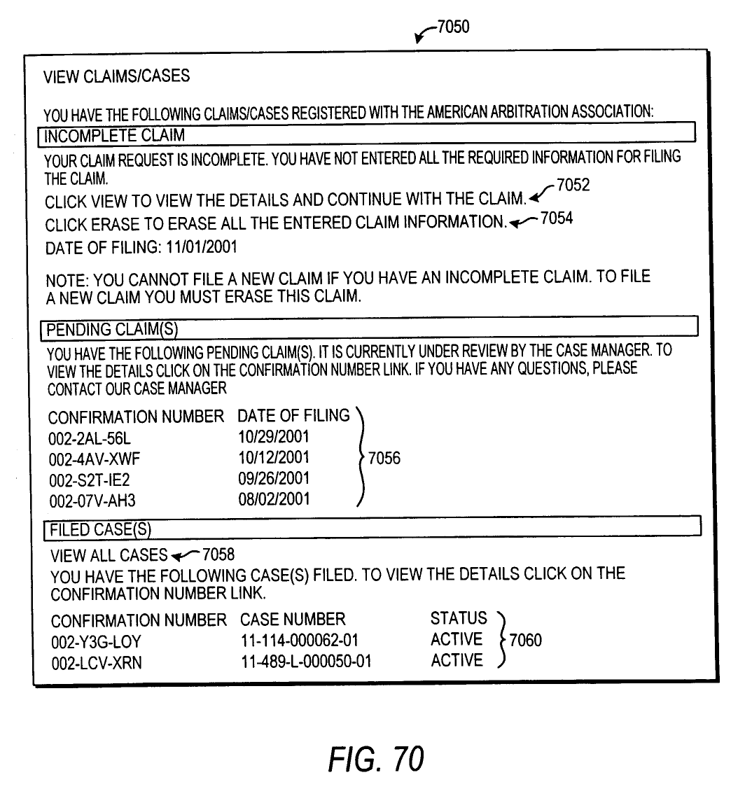

In response to the user indicating to proceed with the claim filing process by, for example, selecting a “Next Step” button 6658 in FIG. 68, the dispute management application may provide the user with a summary display, such as illustrative summary display 7050 as shown in FIG. 70. Display 7050 may include, for example, a summary of the claim (as inputted in FIGS. 60-69), a list of pending claims 7056, and a list of filed cases 7060. In this example, the claim the user has inputted is incomplete. In some embodiments, the dispute management application may allow the user to view the details of the claim and edit the claim by, for example, selecting a “view” link 7052. In some embodiments, the dispute management application may allow the user to erase the inputted claim information by, for example, selecting an “erase” link 7054. The dispute management application may inform the user that an incomplete claim may not be filed.

List 7056 may, for example, include one or more claims that are under review by a case manager. The dispute management application may allow the user to view a pending claim by, for example, selecting a confirmation number in list 7056. List 7058 may, for example, list one or more cases that the user has filed. In some embodiments, the dispute management application may allow the user to view the details of the case by, for example, selecting a case in list 7058. In some embodiments, the dispute management application may allow the user to view cases, such as filed cases and closed cases, by, for example, selecting “view all cases” link 7058.

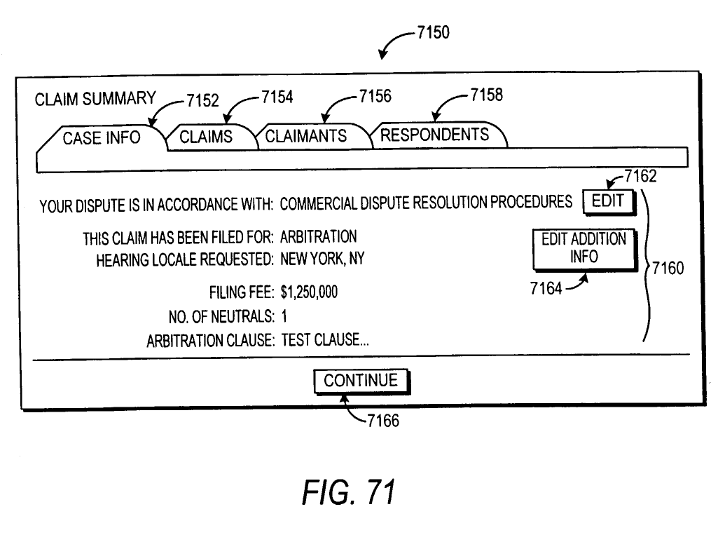

In response to receiving a user indication to edit the inputted claim information, the dispute management application may provide the user with claim summary displays as shown in FIG. 71-75. FIGS. 71-75 may include navigational tabs, such as a “Case Info” tab 7152, a “Claims” tab 7154, a “Claimants” tab 7156, and a “Respondents” tab 7158.

As shown in FIG. 71, the dispute management application may provide the user with a case information display, such as illustrative case information display 7150. Display 7150 may include the claim information that the user has inputted in claim summary area 7160. Display 7150 may also include an “Edit” button 7162 and “Edit Additional Info” button 7164. In response to receiving an indication from the user to edit information by, for example, selecting button 7162, button 7164, or any other suitable user interface, the dispute management application may allow the user to change or verify the inputted information.

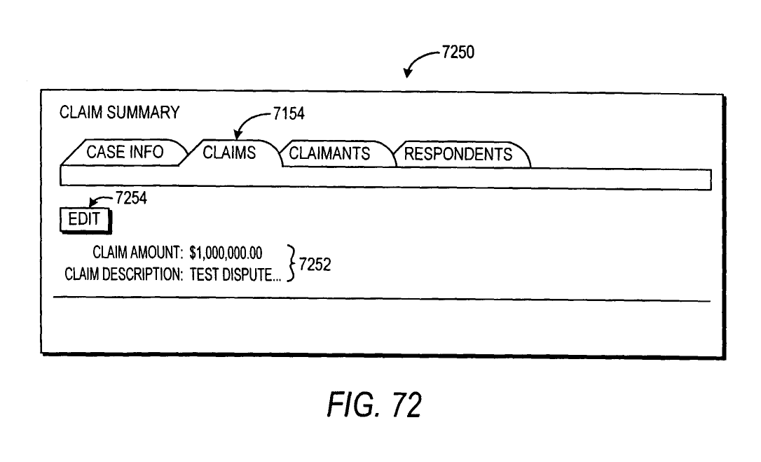

As shown in FIGS. 72-75, the dispute management application may allow the user to edit the inputted information, add additional representatives, add respondents, or perform any other suitable function.

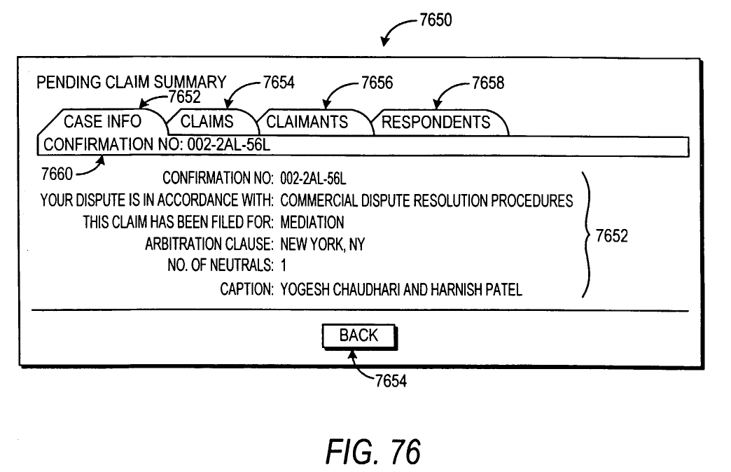

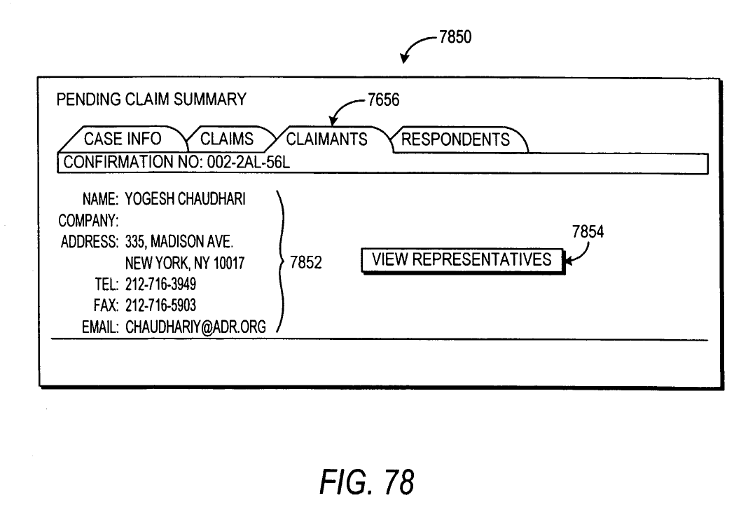

Referring back to FIG. 70, in response to receiving an indication from the user to view a pending claim by, for example, selecting a confirmation number from list 7056, the dispute management application may provide the user with pending claim summary displays as shown in FIGS. 76-81. In some embodiments, the dispute management application may allow the user to view the pending claim information. In some embodiments, the dispute management application may not allow the user to change the pending claim information. In some embodiments, displays 7650-8150 shown in FIGS. 76-81 may include navigational tabs, such as a “Case Info” tab 7652, a “Claims” tab 7654, a “Claimants” tab 7656, and a “Respondents” tab 7658. In response to selecting one of tabs 7652-7658, the dispute management application may provide the user with the corresponding pending claim information associated with the tab. For example, when the user selects “Claimants” tab 7656, the dispute management application may provide the user with claimant information (as shown in FIG. 78). Displays 7650-8150 shown in FIGS. 76-81 may also include the confirmation number for the pending claim.

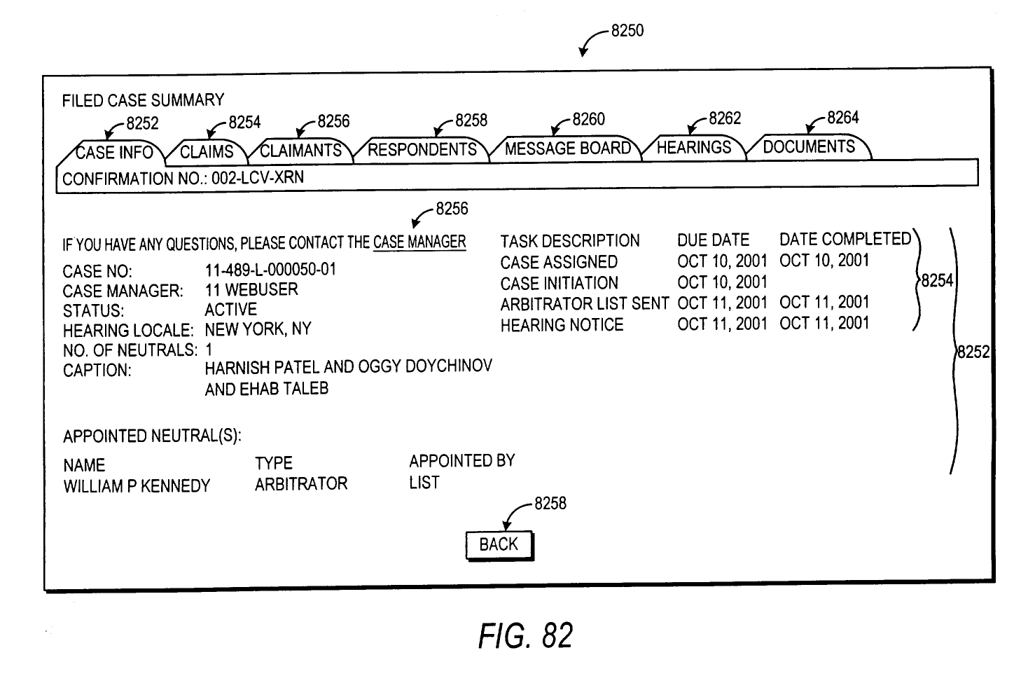

Referring back to FIG. 70, in response to receiving an indication from the user to view a filed case by, for example, selecting a confirmation number from list 7060, the dispute management application may provide the user with filed case summary displays as shown in FIGS. 82-94. FIGS. 82-94 may include navigational tabs, such as a “Case Info” tab 8252, a “Claims” tab 8254, a “Claimants” tab 8256, a “Respondents” tab 8258, a “Message Board” tab 8260, a “Hearings” tab 8262, and a “Documents” tab 8264.

As shown in FIG. 82, the dispute management application may provide the user with a summary of the filed case in an information area 8252. Area 8252 may also include a documents summary area 8254 and a link to the case manager 8256. The dispute management application may allow the user to contact the case manager by selecting link 8256. In this example, documents summary area 8254 provides the user with a list of tasks, such as send in an arbitrator list or assign the case, and their associated due dates and completion dates.

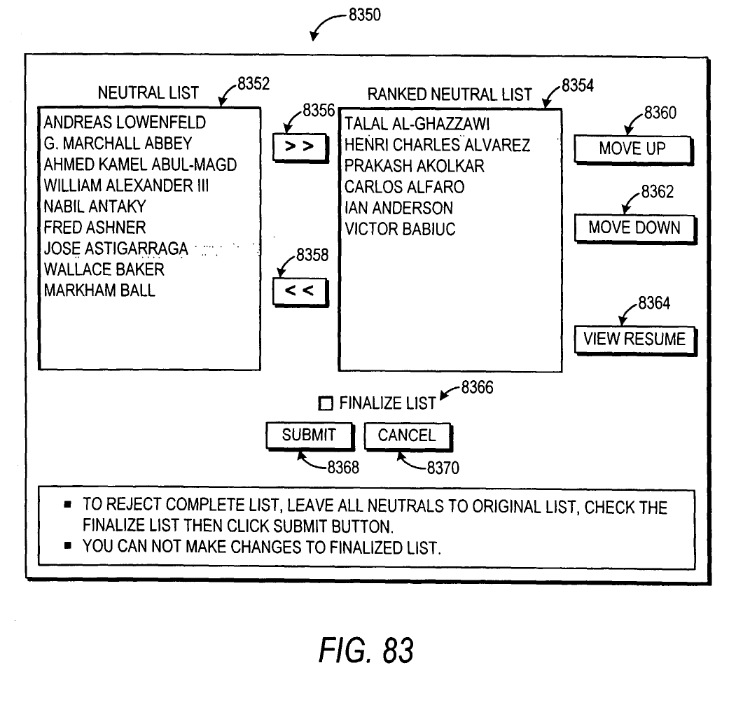

In response to receiving an indication from a user to perform a task by, for example, selecting a task from the documents summary area 8254, the dispute management application may provide the user with a display corresponding to the selected task. For example, in response to the user selecting “Arbitrator List Sent” in area 8254, the dispute management application may provide the user with a ranking display, such as illustrative rank neutrals display 8350 shown in FIG. 83.

Display 8350 may include initial neutral list area 8352, ranked list area 8354, navigational buttons 8356-8362, resume viewing button 8364, and checkbox 8366. List 8352 may include the names of available neutrals. The dispute management application may allow the user to highlight a particular neutral by, for example, using up button 8360 and down button 8362. The dispute management application may allow the user to move a neutral from list 8352 to ranked list 8354 by, for example, using right button 8356. However, any other suitable approach may also be used. For example, the dispute management application may allow the user click and drag the desired neutral.

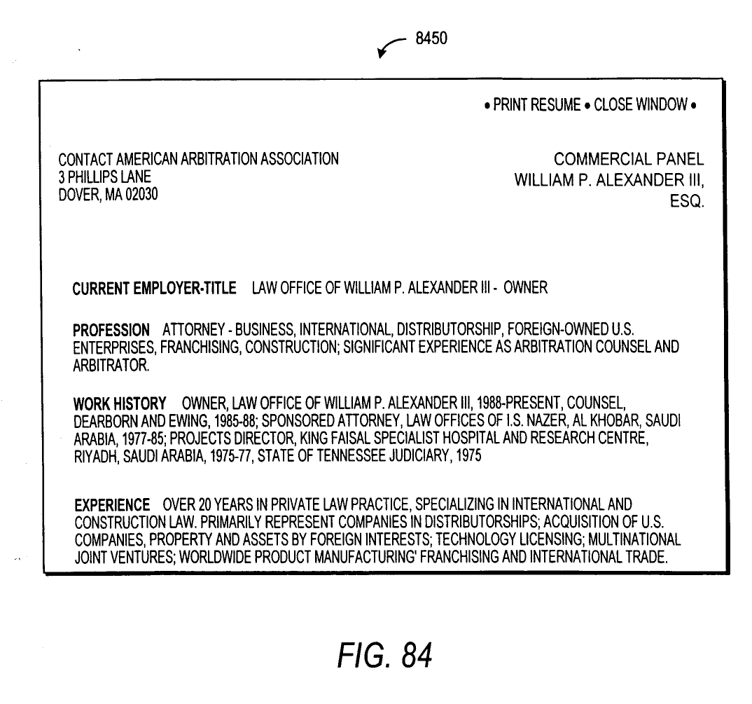

The dispute management application may also allow the user to view the resume of the selected neutral by, for example, highlighting a neutral and selecting the resume viewing button 8364. In response to receiving an indication from the user to view a resume, the dispute management application may provide the user with the resume associated with the selected user in an illustrative resume display as shown in FIG. 84. In some embodiments, display 8450 may be overlaid onto display 8350.

Returning to FIG. 83, navigational buttons 8356-8362 may allow the user to move neutrals, sort lists, highlight neutrals, or perform any other suitable function. The dispute management application may provide the user with checkbox 8366 to indicate when the user has completed ranking the neutrals list. In response to the user submitting the list by, for example, selecting checkbox 8366 and selecting a “Submit” button 8368, the dispute management application may communicate the neutrals list to the case manager.

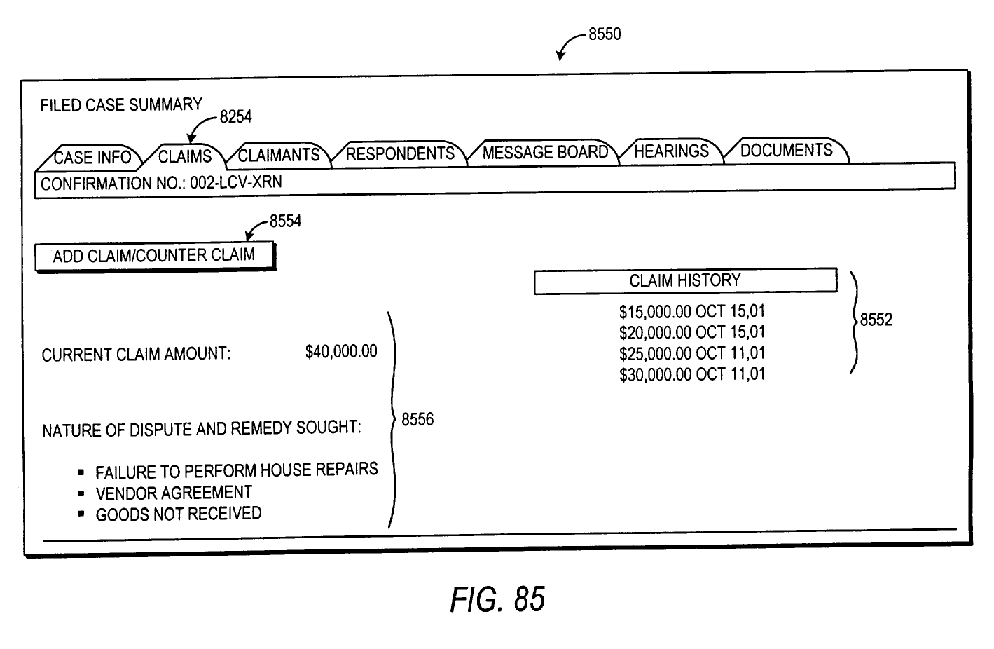

Referring back to FIG. 82, in response to receiving an indication from the user to view information relating to the claim (e.g., selecting “Claims” tab 8254), the dispute management application may provide the user with a claims display, such as illustrative claims display 8550 as shown in FIG. 85. Display 8550 may include a history of the claim in a history area 8552 and summary of the current claim in claim area 8556. In some embodiments, the dispute management application may allow the user to add a claim or add a counterclaim (e.g., if the user is a respondent).

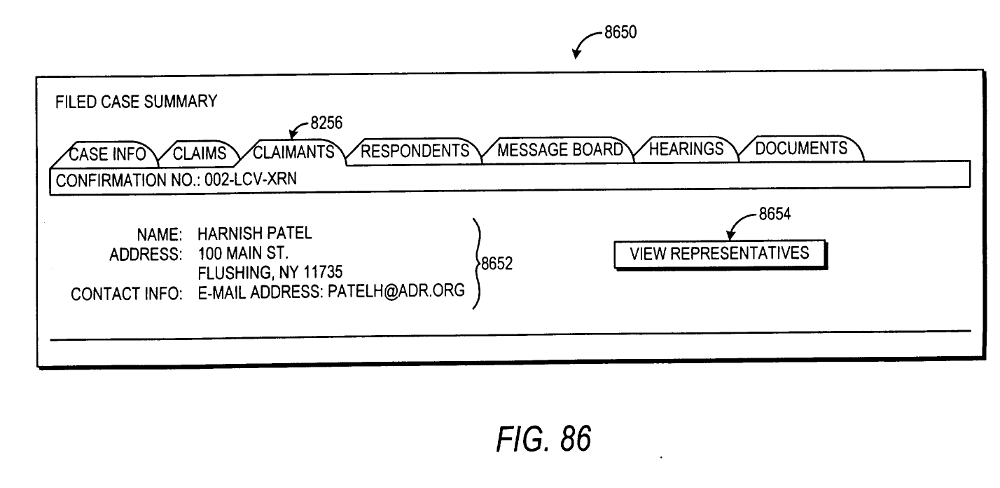

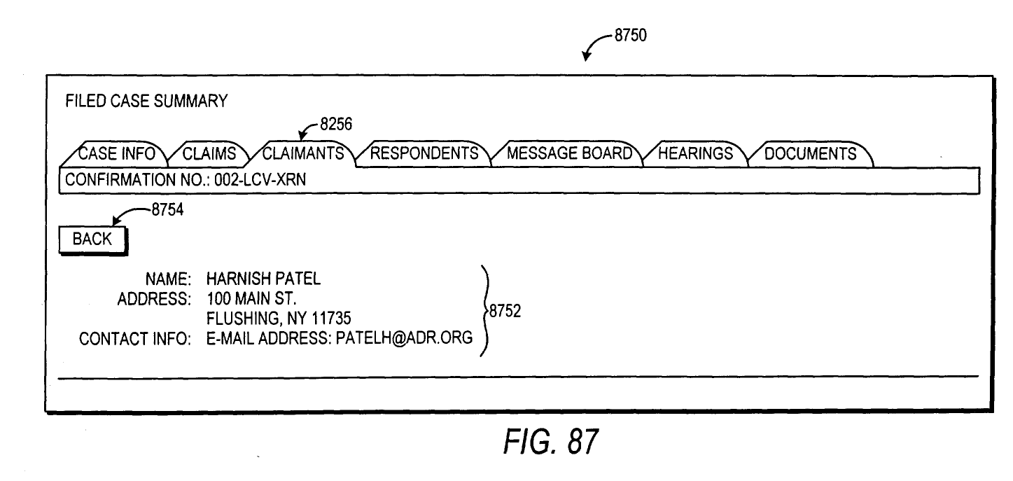

Referring back to FIG. 82, in response to receiving an indication from the user to view information relating to the claimant (e.g., selecting “Claimants” tab 8256), the dispute management application may provide the user with claimant displays as shown in FIGS. 86 and 87. In this example, FIG. 86 includes claimant information (e.g., name, address, contact info) and FIG. 87 includes claimant representative information.

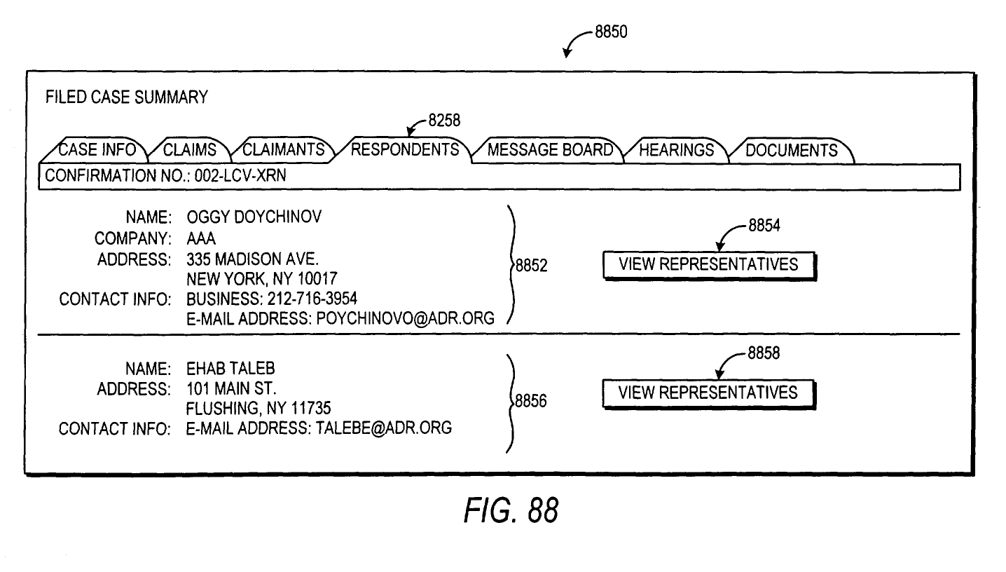

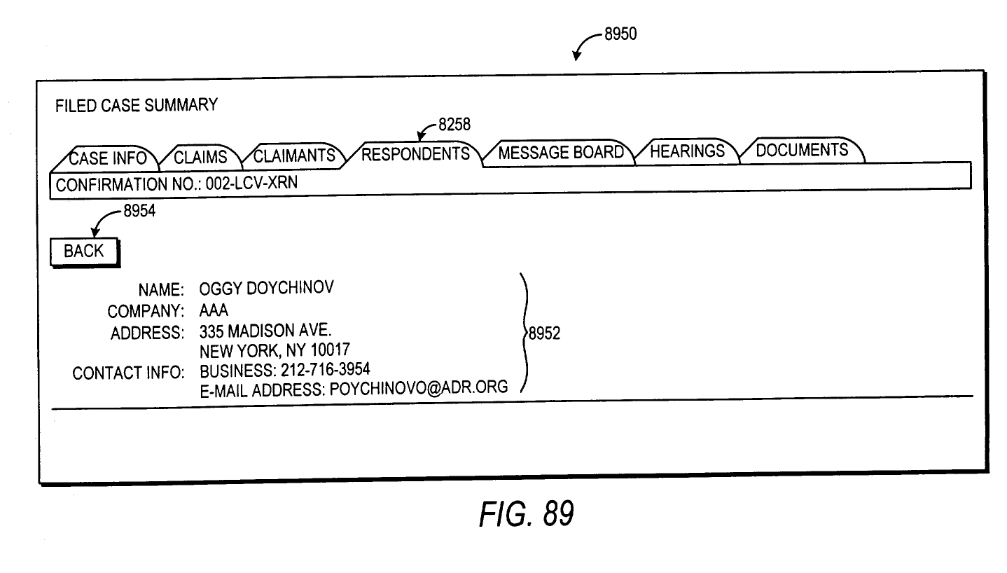

Referring back to FIG. 82, in response to receiving an indication from the user to view information relating to the respondent (e.g., selecting “Respondents” tab 8258), the dispute management application may provide the user with respondents displays as shown in FIGS. 88 and 89. In this example, FIG. 88 includes respondent information (e.g., name, company, address, contact info) and FIG. 89 includes respondent representative information.

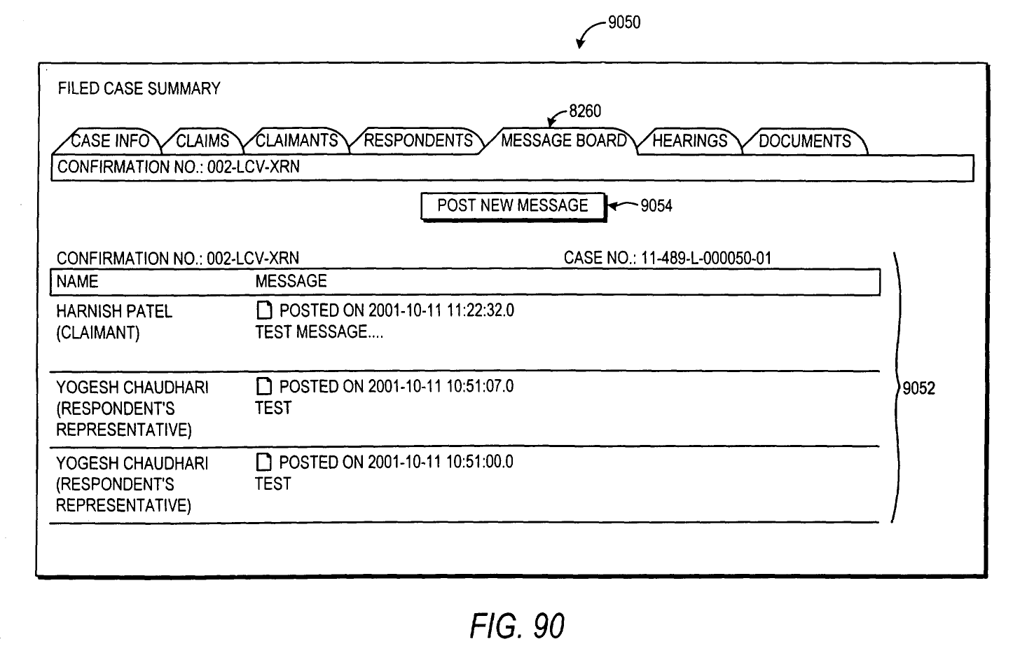

In some embodiments, the dispute management application may allow the user to view or post a message to the users in the case (e.g., claimants, respondents, representatives, neutrals, case managers). Referring back to FIG. 82, in response to receiving an indication from the user to view or post a message (e.g., selecting “Message Board” tab 8260), the dispute management application may provide the user with a message board display, such as illustrative message board display 9050 as shown in FIG. 90.

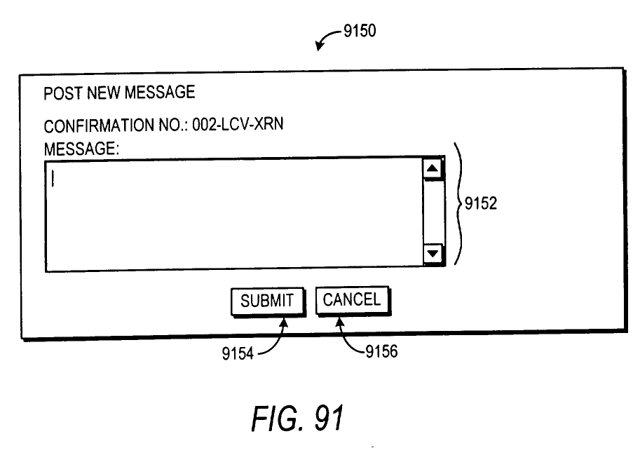

In response to receiving an indication from the user to post a message (e.g., by selecting a button 9054), the dispute management application may provide the user with a message interface, such as illustrative message interface 9150 shown in FIG. 91. Message interface 9150 may include, for example, graphical or audio prompts to the user. Suitable graphical prompts may include, for example, push buttons, check boxes, radio buttons, scroll bars, or any other suitable graphical user interface construct. In response to the user, for example, selecting a “Submit” button 9154, the dispute management application may present the message in a messaging area 9052 (FIG. 90).

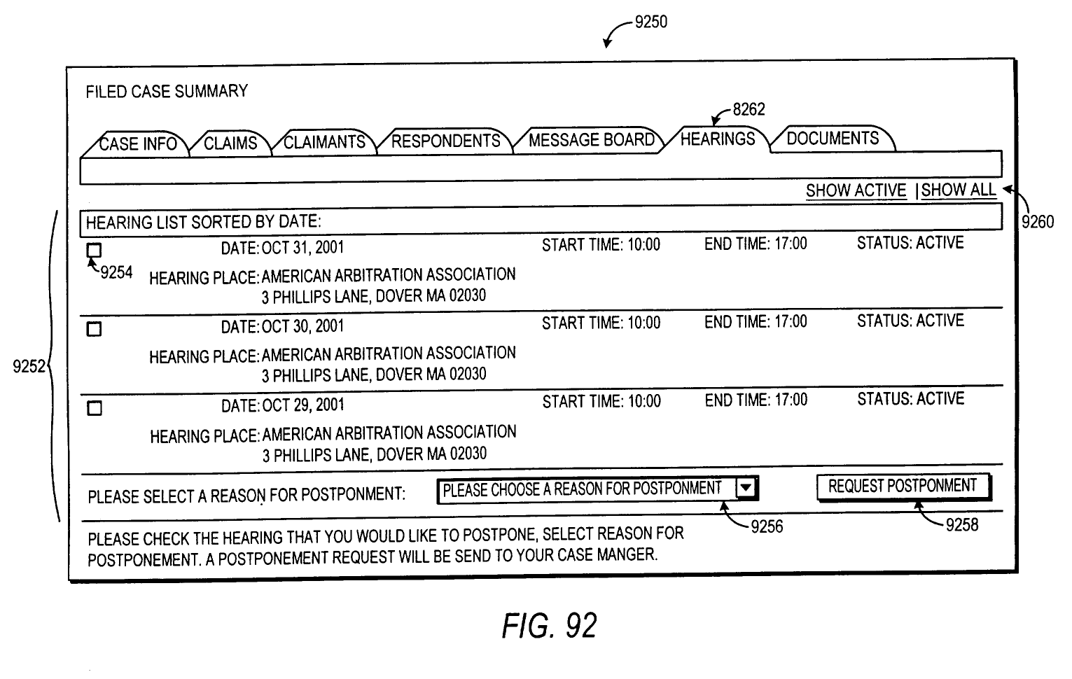

In some embodiments, the dispute management application may allow the user to perform functions relating to hearings. Referring back to FIG. 82, in response to receiving an indication from the user to access a hearing-related function (e.g., selecting “Hearings” tab 8262), the dispute management application may provide the user with a hearings display, such as illustrative hearings display 9250 as shown in FIG. 92. The dispute management application may allow the user to view hearings, such as active hearings and postponed hearings, by, for example, selecting a “Show All” link 9260.

In some embodiments, the dispute management application may allow the user to postpone a hearing by, for example, selecting a checkbox 9254, indicating a reason for postponement in a drop-down menu 9256, and selecting a “Request Postponement” button 9258. In response to receiving an indication from the user to postpone a hearing, the dispute management application may communicate a message to the case manager of the request to postpone the selected hearing.

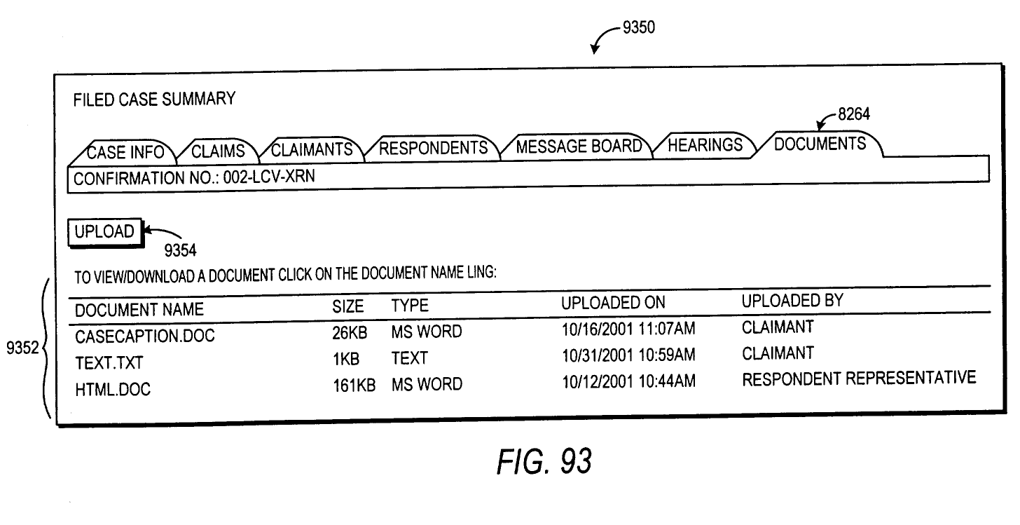

In some embodiments, the dispute management application may allow the user to view and upload documents. Referring back to FIG. 82, in response to receiving an indication from the user to access documents (e.g., selecting “Documents” tab 8264), the dispute management application may provide the user with a documents display, such as illustrative documents display 9350 as shown in FIG. 93. The dispute management application may allow the user to view documents by, for example, selecting a document link from a document list 9352.

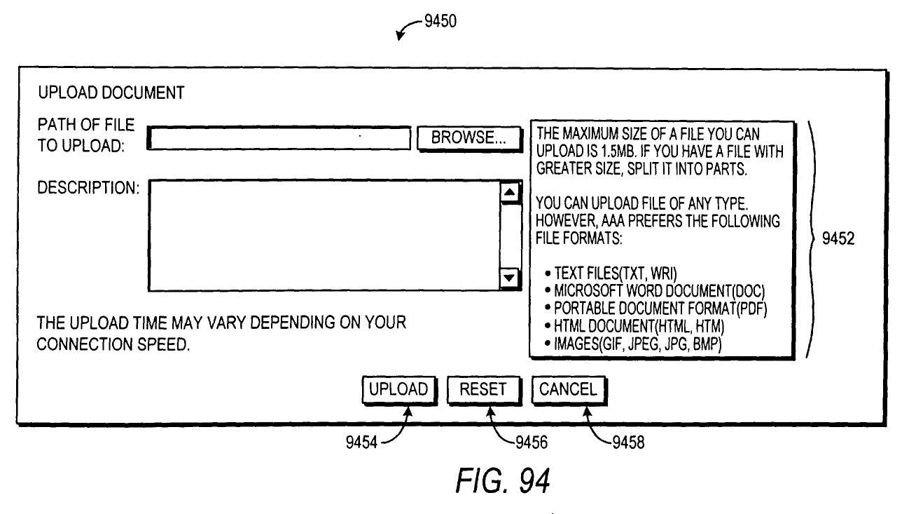

In some embodiments, the dispute management application may allow the user to upload documents. In response to receiving an indication from the user to upload a document (e.g., selecting an “Upload” button 9354), the dispute management application may provide the user with an upload interface, such as illustrative upload interface 9450 as shown in FIG. 94.

As shown in FIG. 94, upload interface 9450 may include, for example, graphical or audio prompts to the user. In this example, upload interface 9450 prompts the user to input the location of the file and a description of the file. Upload interface 9450 may include, for example, graphical or audio prompts to the user. Suitable graphical prompts may include, for example, push buttons, check boxes, radio buttons, scroll bars, or any other suitable graphical user interface construct. In response to the user, for example, selecting a “Upload” button 9454, the dispute management application may communicate (e.g., upload) the document and display the name of the uploaded document in document list 9352 (FIG. 93).

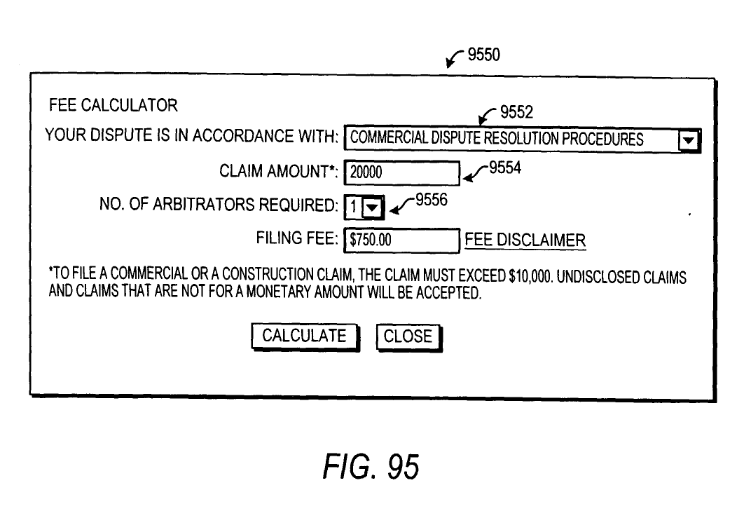

Referring back to FIG. 70, in response to the user editing the incomplete claim, the dispute management application may provide the user with displays relating to making a payment for the claim as shown in FIGS. 95-104.

As shown in FIG. 95, the dispute management application may provide the user with a fee calculator. An illustrative fee calculator display 8550 is shown in FIG. 95. The dispute management application may calculate an estimate of the initial filing fee. As shown in FIG. 95, the filing fee may be determined when the user enters the type of dispute, the claim amount, the number of arbitrators, and any other suitable information relating to the claim.

In response to receiving an indication from the user to make a payment, the dispute management application may provide the user with a payment display, such as illustrative payment display 9650 shown in FIG. 96. In this example, display 9650 allows the user to indicate whether he or she is paying by check or by credit card.

In response to receiving an indication from the user to pay by check, the dispute management application may provide the user with a demand summary display, such as illustrative demand summary display 9750 as shown in FIG. 97. For example, when the user indicates a payment by check, the dispute management application may provide the user with a summary of the claim and instructions for sending the check. Display 9750 may also include links 9754-9758. The dispute management application may allow the user to view the user's pending claims and filed cases (as shown in FIG. 70) in response to the user selecting link 9754. The dispute management application may allow the user to file a new claim (as shown in FIG. 60) in response to the user selecting link 9756. The dispute management application may allow the user to log out by, for example, selecting link 9758.

Referring back to FIG. 96, in response to receiving an indication from the user to make a payment by credit card, the dispute management application may provide the user with a credit card information display, such as illustrative credit card information display 9850. In some embodiments, the dispute management application may display previously entered credit card information. In this example, the user has previously entered information for three credit cards in credit card area 9854.

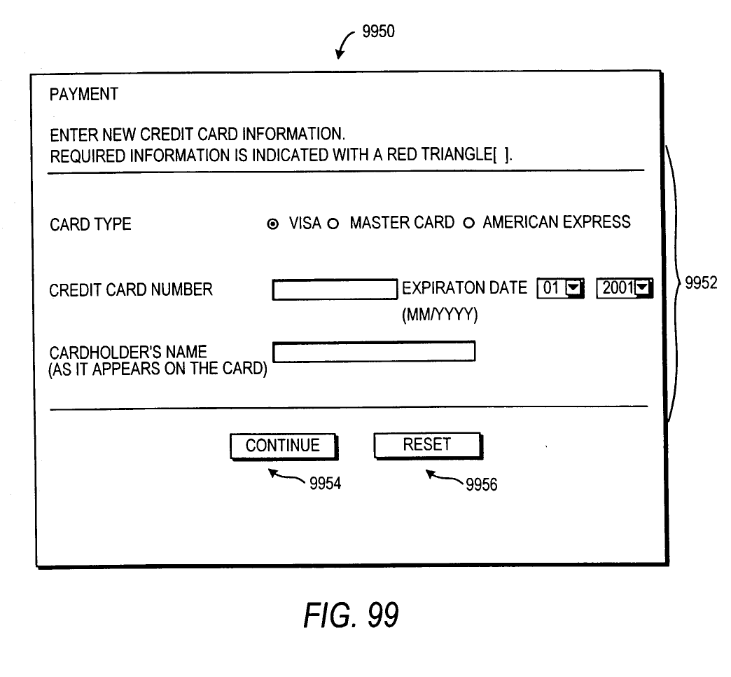

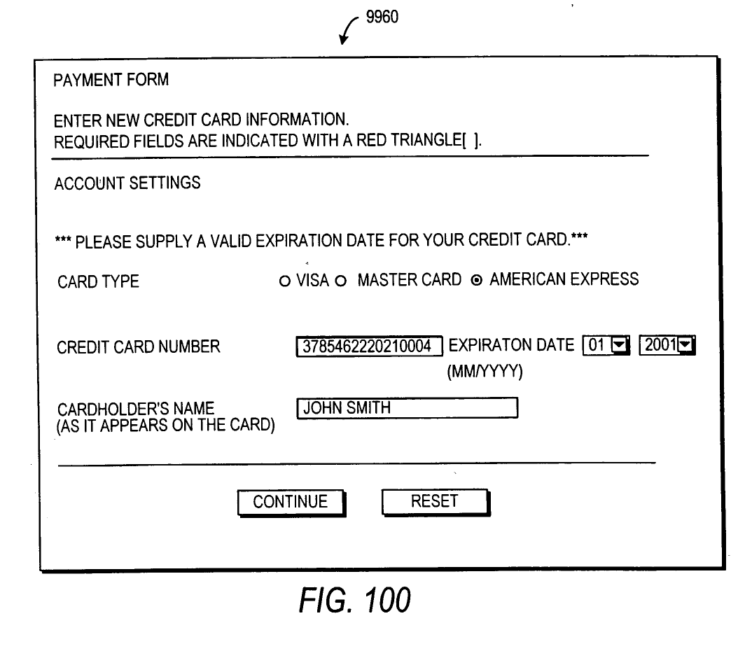

In some embodiments, the dispute management application may allow the user to enter new credit card information by, for example, selecting “Enter New” link 9852. In response to receiving an indication from the user to enter a new credit card, the dispute management application may provide the user with a payment display, such as illustrative payment display 9950 as shown in FIG. 99. Display 9950 may prompt the user to enter payment information, such as credit card type, card number, name, expiration date, and any other suitable information relating to the credit card. In response to an invalid expiration date, the dispute management application may provide the user with an illustrative error display 9960 as shown in FIG. 100.

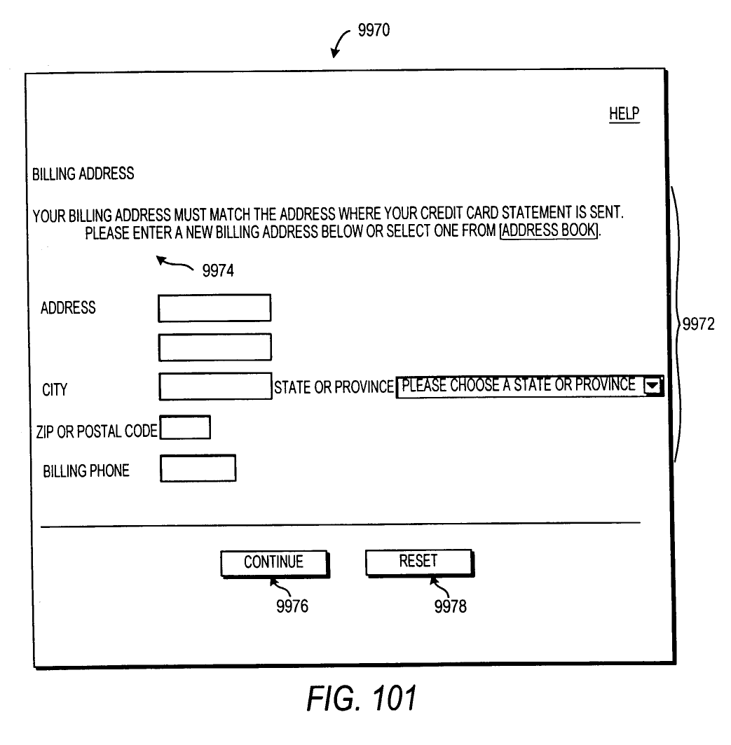

In response to the user inputting payment information, the dispute management application may provide the user with a billing address display, such as illustrative billing address display 9970 as shown in FIG. 101. Display 9970 may include billing address area 9972, which may prompt the user to enter information relating to the billing address (e.g., address, city, state, zip code, phone number, etc.).

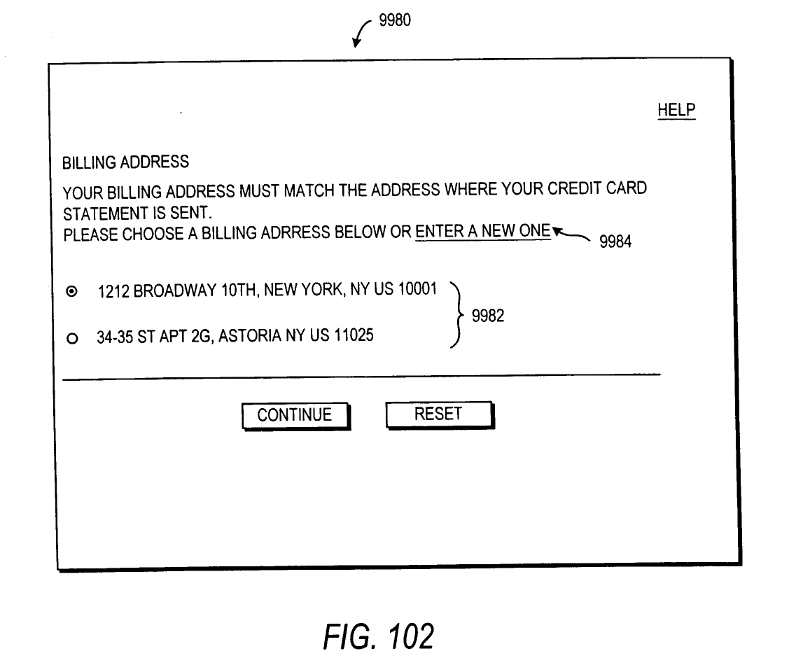

In some embodiments, the dispute management application may allow the user to select from previously inputted billing addresses by, for example, selecting “Address Book” link 9974. In response to the user selecting link 9974, the dispute management application may provide the user with an address selection display, such as illustrative address selection display 9980 as shown in FIG. 102. Display 9980 may include radio buttons 9982 associated with particular billing addresses. In some embodiments, the dispute management application may allow the user to enter a new address from display 9980 by, for example, selecting link 9984. In response to selecting link 9984, the dispute management application may return the user to FIG. 101.

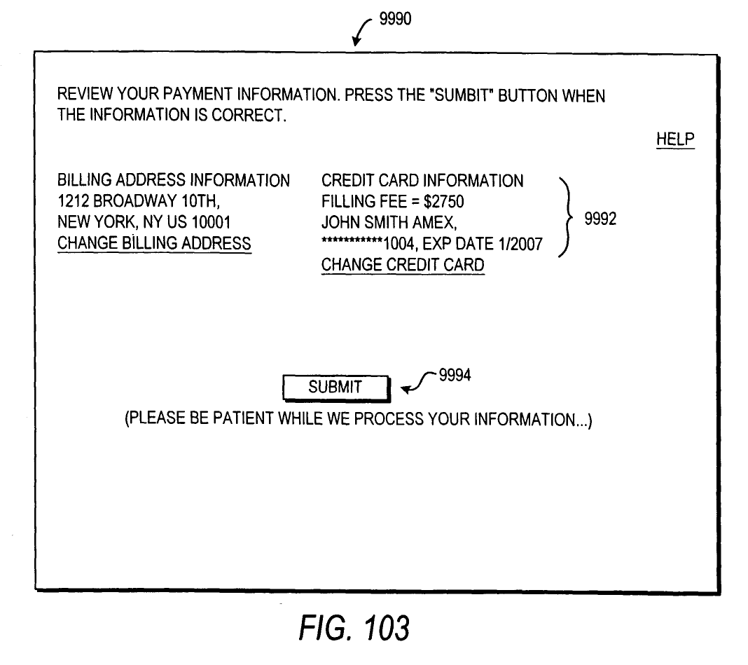

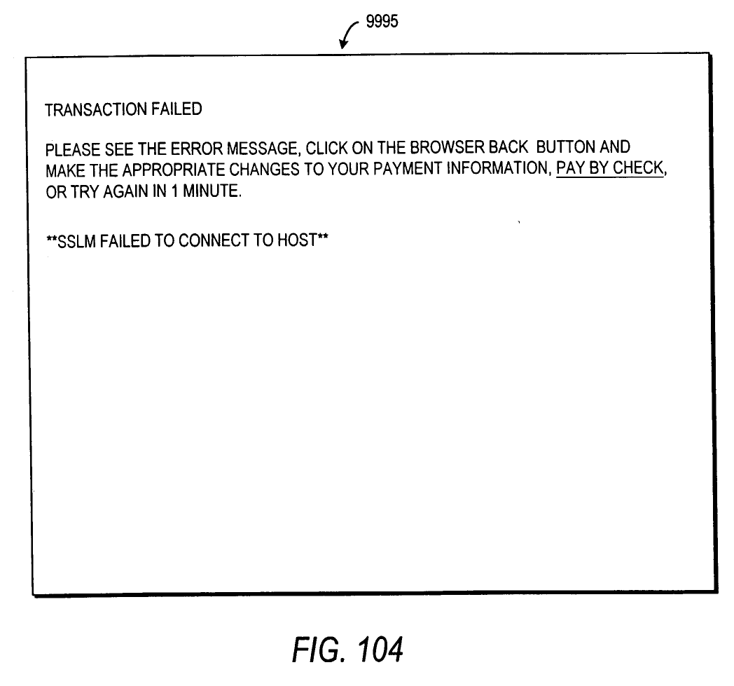

In response to the user inputting billing information, the dispute management application may provide the user with a verification display, such as illustrative verification display 9990 as shown in FIG. 103. In response to the user verifying the inputted billing information and selecting a “Submit” button 9994” (or any other suitable user interface construct), the dispute management application may process the payment information. If an error occurs when processing the payment information, the dispute management application may provide the user with an illustrative failure message display 9995 as shown in FIG. 104. Display 9995 may include graphical or audio prompts. In this example, the dispute management application allows the user to re-transmit the billing information or pay by check.

A third illustrative user interface approach for filing a claim is shown in FIGS. 105-111. This approach and case filing applications are described, for example, in above-mentioned U.S. provisional application No.______ (Attorney Docket No. AAA-004 Prov.), filed Nov. 21, 2001, which is incorporated by reference herein in its entirety. The approach shown in FIGS. 105-111 includes some of the same elements of the other approaches described herein. Some of these display elements may have different display characteristics.

In some embodiments, the approach shown may be used to complete a case filed using the second illustrative user interface. In some embodiments, the approach shown may be used to file non-Internet cases.

In the third illustrative user interface, the case filing application may provide users with a pre-claim display, such as illustrative claim display 6050 in response to, for example, a user indicating that he or she desires to file a claim. As shown in FIG. 105, the case filing application may provide the user with an illustrative display 1570 for inputting “pre-filing” information. Pre-filing information may include, for example, a case identification number, the status of the case, a rule identification number, a confirmation number, or any other suitable information. The dispute management application may allow the user to enter pre-filing information into text fields 1572.

In some embodiments, the dispute management application may allow the user to view a previously entered case. For example, when the user inputs a confirmation number into field 1574, the dispute management application may provide the user with the previously inputted case information. For example, the dispute management application may populate text fields 1572 with the corresponding pre-filing information.

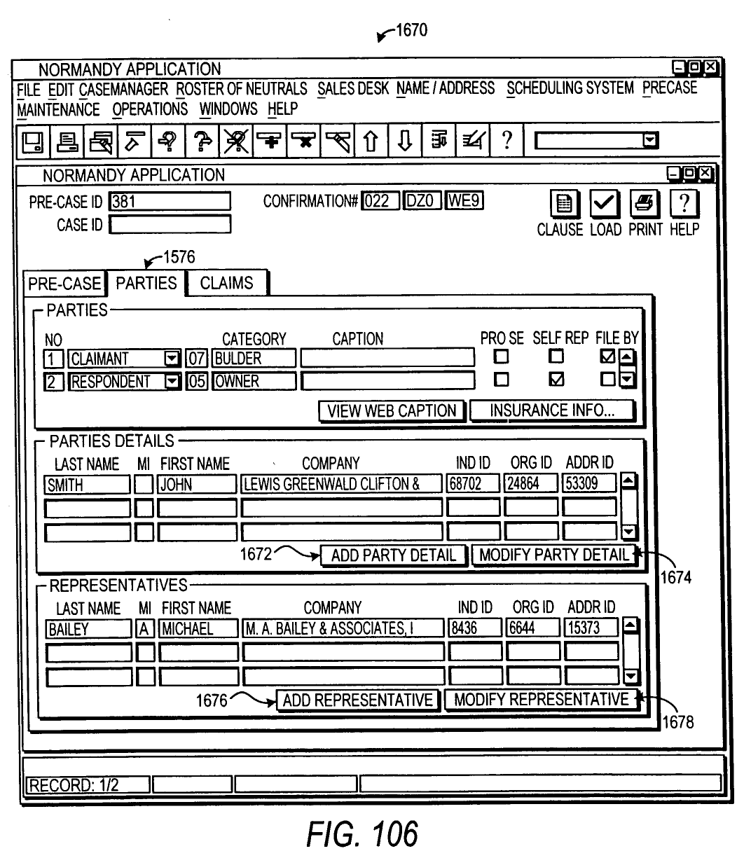

In response to the case filing application receiving an indication that the user has inputted the pre-filing information (e.g., by selecting a “Parties” tab 1576), the case filing application may provide the user with an illustrative party information display 1670 as shown in FIG. 106. Party information may include, for example, claimant information (e.g., name, company, address, telephone numbers of the claimant, etc.), respondent information (e.g., name, company, address, telephone numbers of the respondent, etc.), information on the representative of the claimant, information on the representative of the respondent, or any other suitable party information. The case filing application may allow the user to add party information or representative information by, for example, selecting buttons 1672 or 1674, respectively. The case filing application may also allow the user to modify party information or representative information by, for example, selecting buttons 1676 or 1678, respectively.

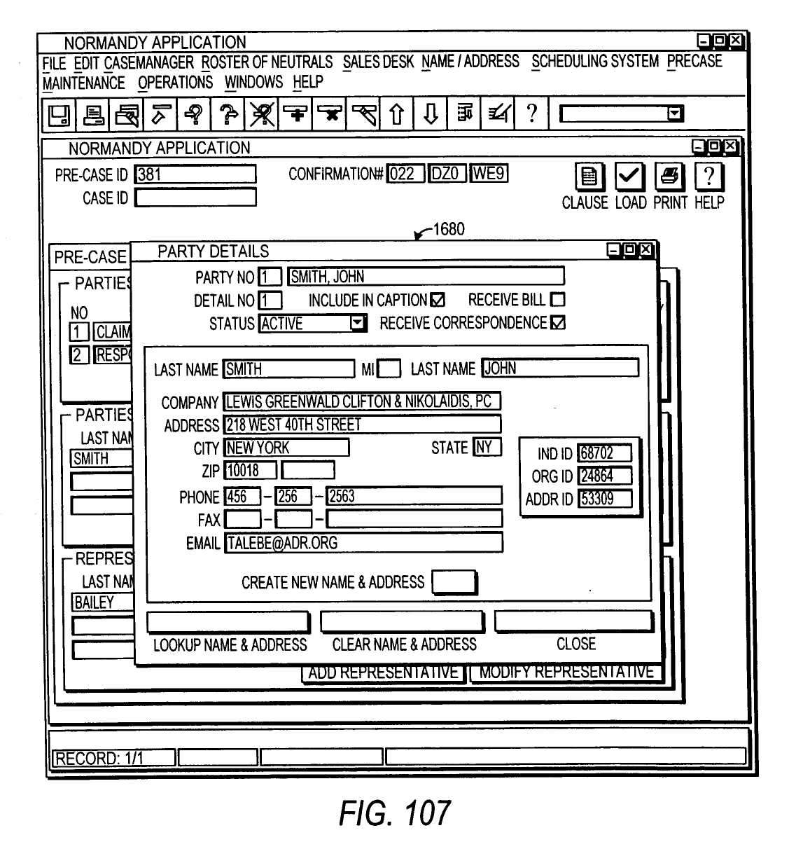

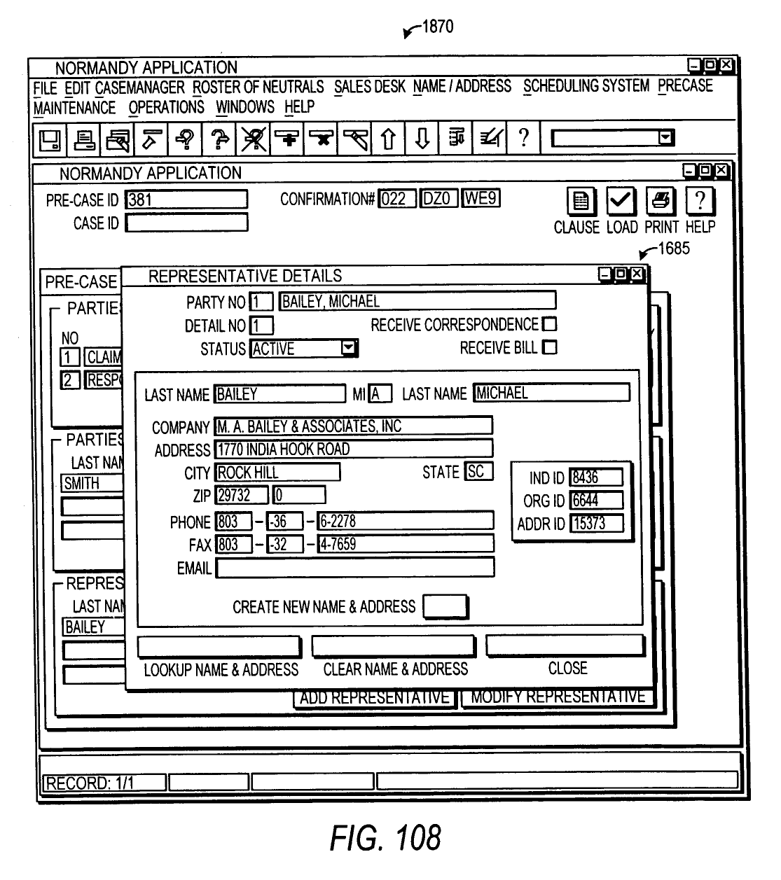

For example, in response to the user selecting button 1672 or button 1674, the case filing application may provide the user with a window 1680 (as shown in FIG. 107). In this example, the window may allow the user to input party details. In another example, in response to the user selecting button 1676 or button 1678, the case filing application may provide the user with a window 1685 (as shown in FIG. 108). In some embodiments, window 1680 or window 1685 may include a “Lookup Name and Address” button, which allows the user to view previously inputted party information.

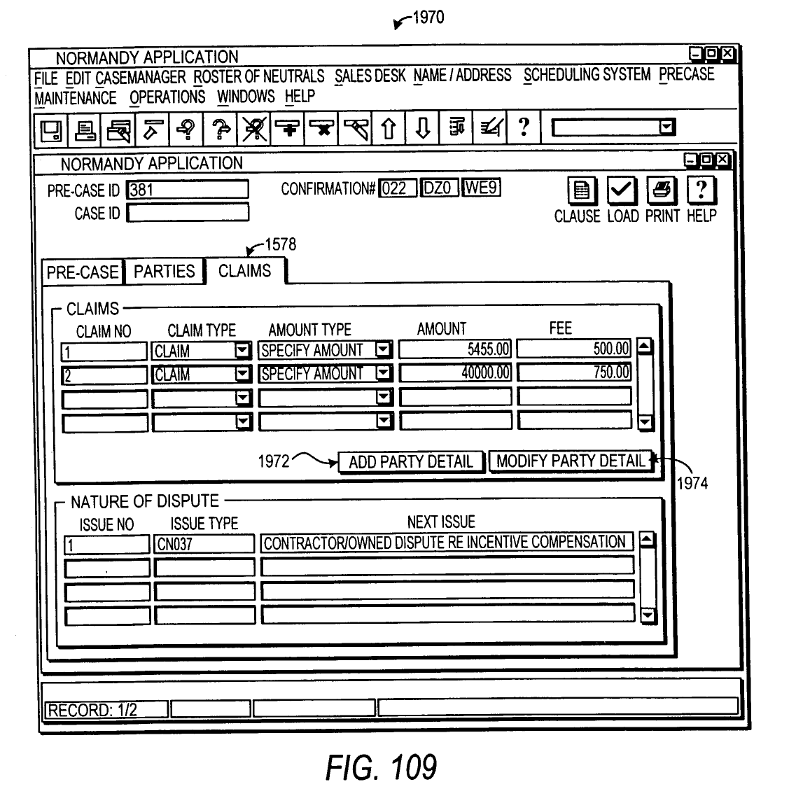

In response to the case filing application receiving an indication that the user has inputted party information (e.g., by selecting “Claims” tab 1578), the case filing application may provide the user with an illustrative claim information display 1970 as shown in FIG. 109. Claim information may include the amount of the claim, the type of claim (e.g., on-call mediation, in-person mediation, in-person arbitration, documents-only arbitration), the fees associated with the claim, the nature of the dispute (e.g., breach of contract), or any other suitable claim information. The case filing application may allow the user to add claim information by, for example, selecting an “Add Claim” button 1972. The case filing application may also allow the user to modify claim information by, for example, selecting “Modify Claim” button 1974. For example, in response to the user selecting button 1972 or button 1974, the case filing application may provide the user with a window 1976. In this example, the window may allow the user to input (e.g., add or modify) claim details.

The case filing application may allow the user to communicate the inputted information (e.g., pre-filing information, party information (e.g., claimant information, respondent information, representative information), claim information) to the dispute management application by, for example, selecting a “Load” button 1978. In response to receiving a user indication for loading the inputted information, the case filing application may provide the user with confirmation message 1980.

In some embodiments, the third user interface approach shown in FIGS. 105-111 may be used to store claim-related information inputted using the second user interface approach shown in FIGS. 60-104. For example, the dispute management application may allow the user to input claim-related information using the second user interface approach (shown in FIGS. 60-104). In response to inputting the claim-related information using the second user interface approach, the dispute management application may transfer the inputted claim-related information into the case filing application described in FIGS. 105-111 (e.g., the third user interface approach). In response to receiving an indication from the user to proceed with filing the claim, the case filing application may transfer the inputted information into the dispute management application.

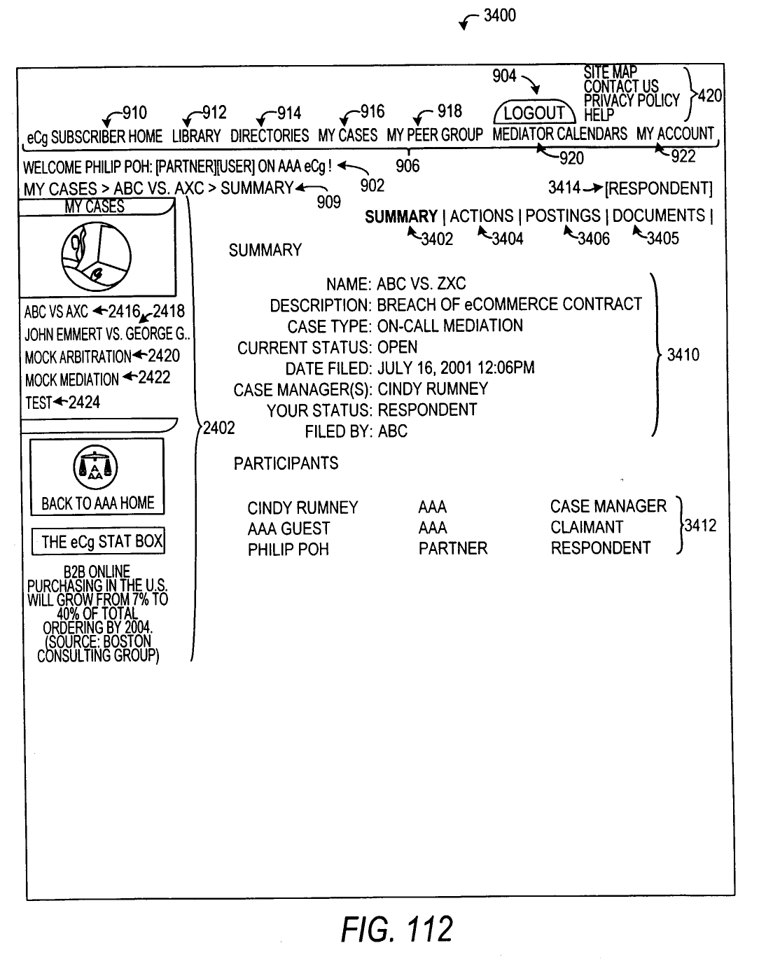

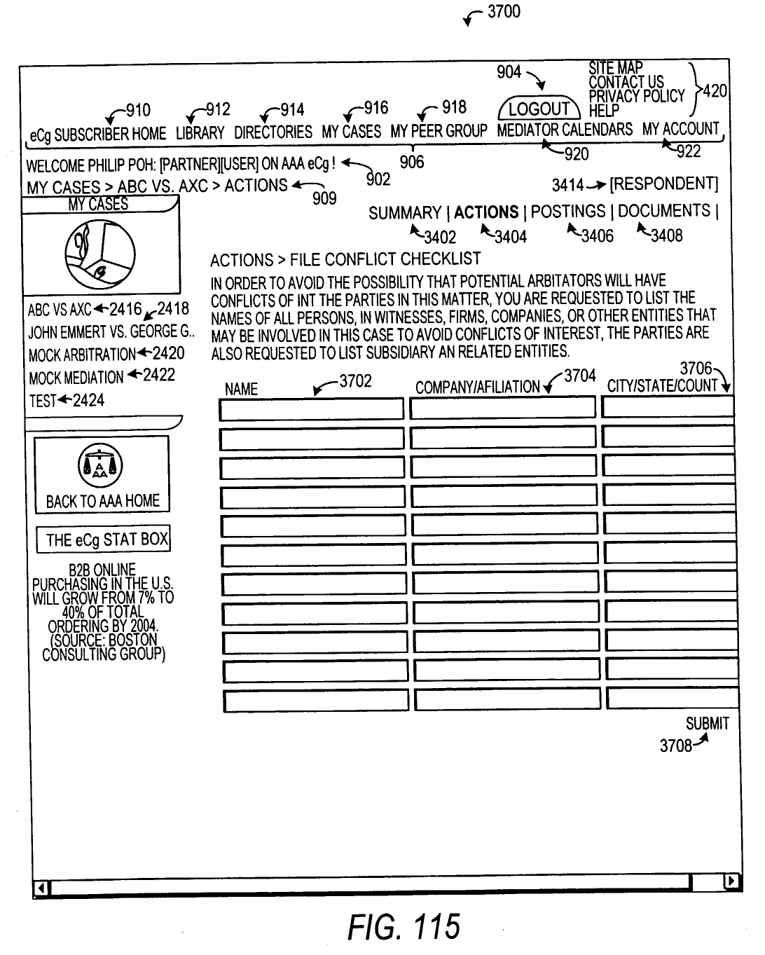

In response to a user submitting a claim (e.g., through the dispute management application or a case filing application), the dispute management application may assign a case manager. In some embodiments, the dispute management application may notify the user that the claim has been submitted. Some embodiments may provide the user with multiple displays relating to the claim. For example, the dispute management application may allow the user to access these displays to, for example, submit documents, file a counterclaim, correspond with the case manager, select an arbitrator or mediator, or any other suitable action relating to dispute management. Illustrative displays that may be provided to the user for dispute management are shown in FIGS. 112-128.

For example, when a user selects link to active case 2416, the dispute management application may provide the user with a case summary display, such as illustrative case summary display 3400 as shown in FIG. 112. In this example, the user has selected the “ABC vs. ZXC” case. The dispute management application may indicate the user's selection by, for example, highlighting the case name, changing the color of the case name, or by using any other suitable approach.

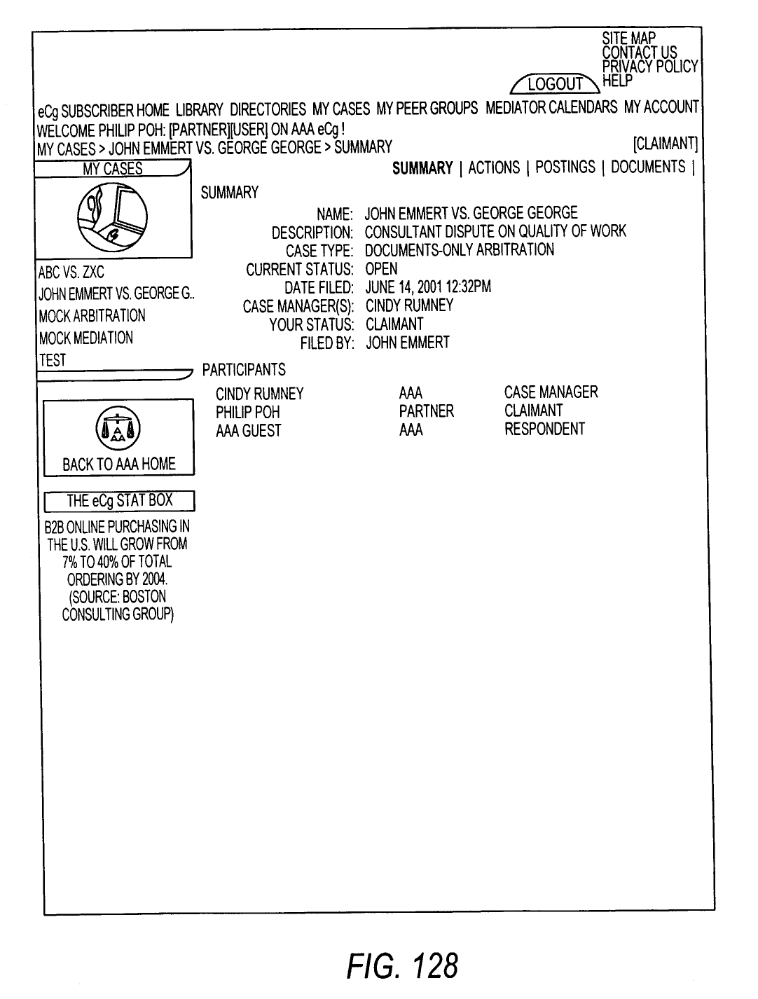

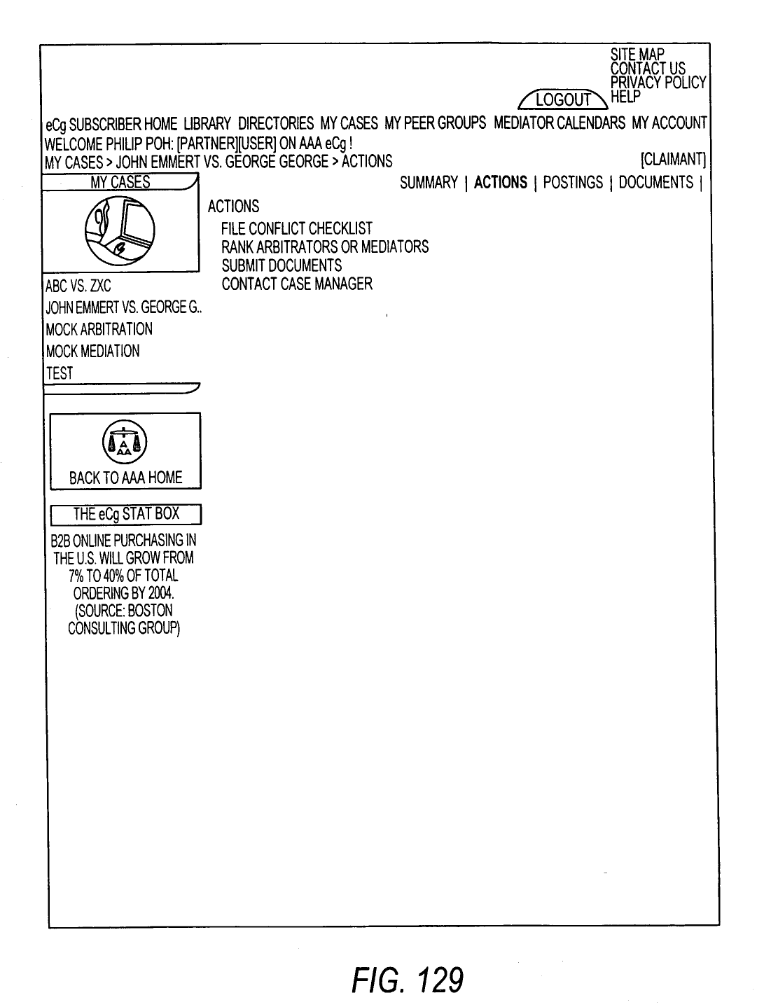

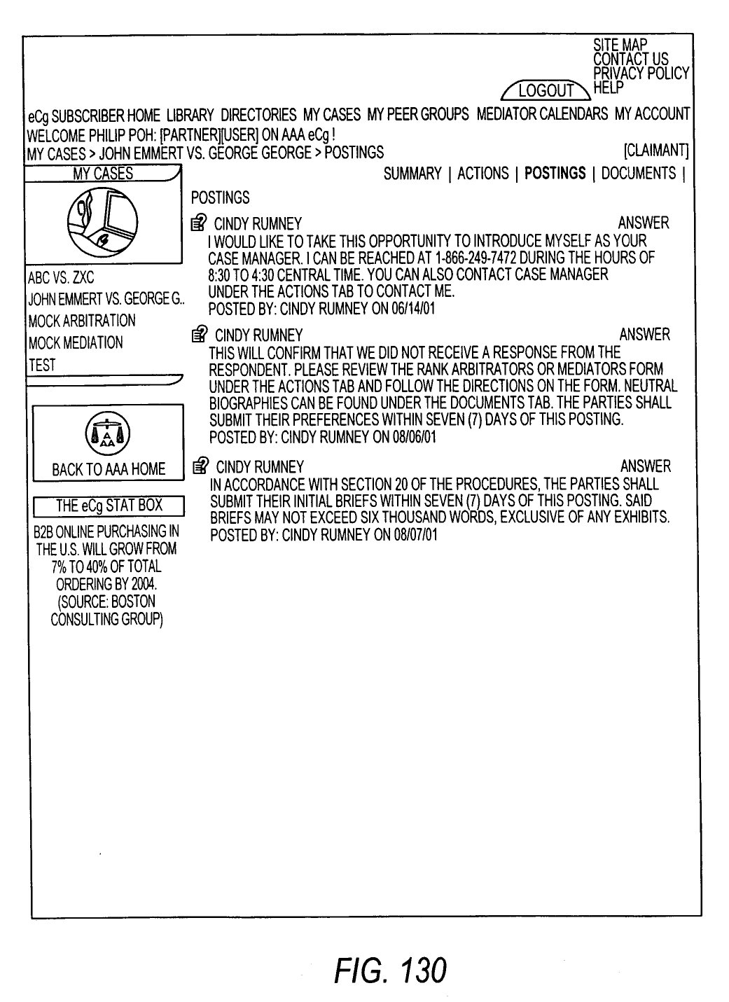

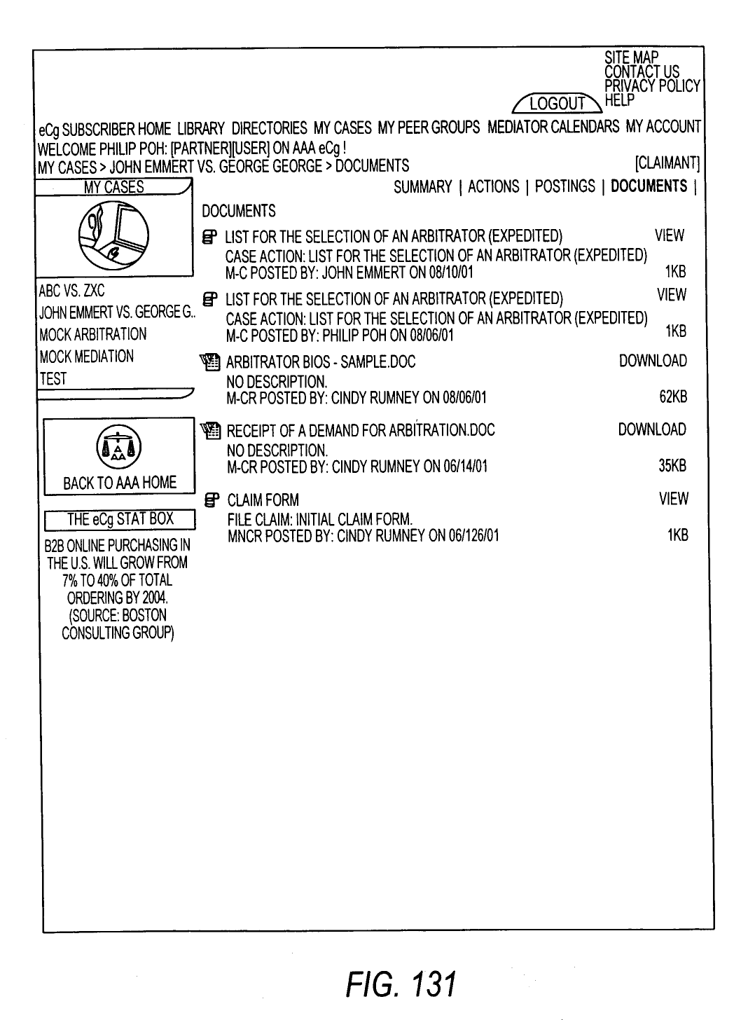

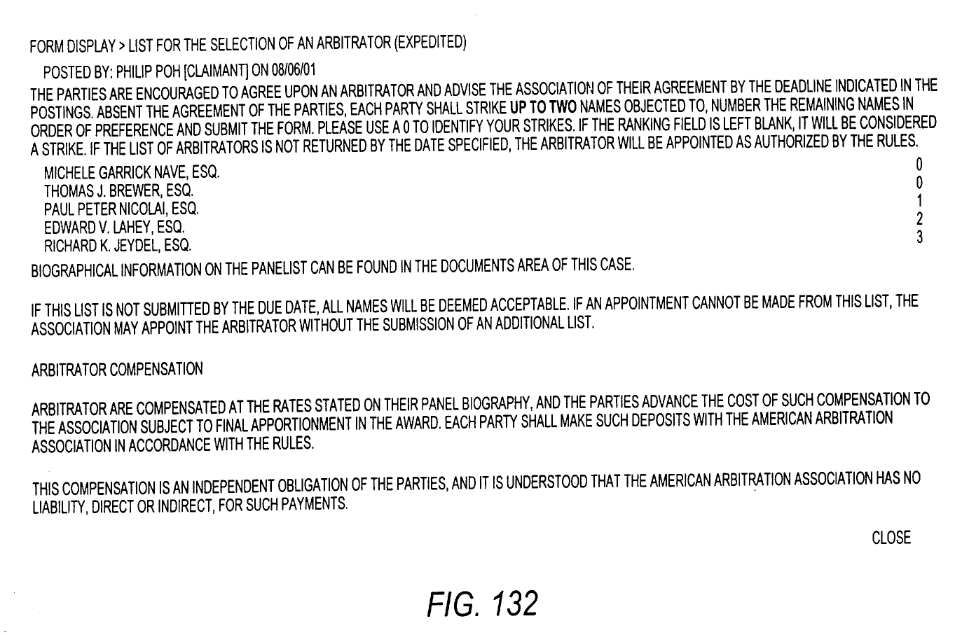

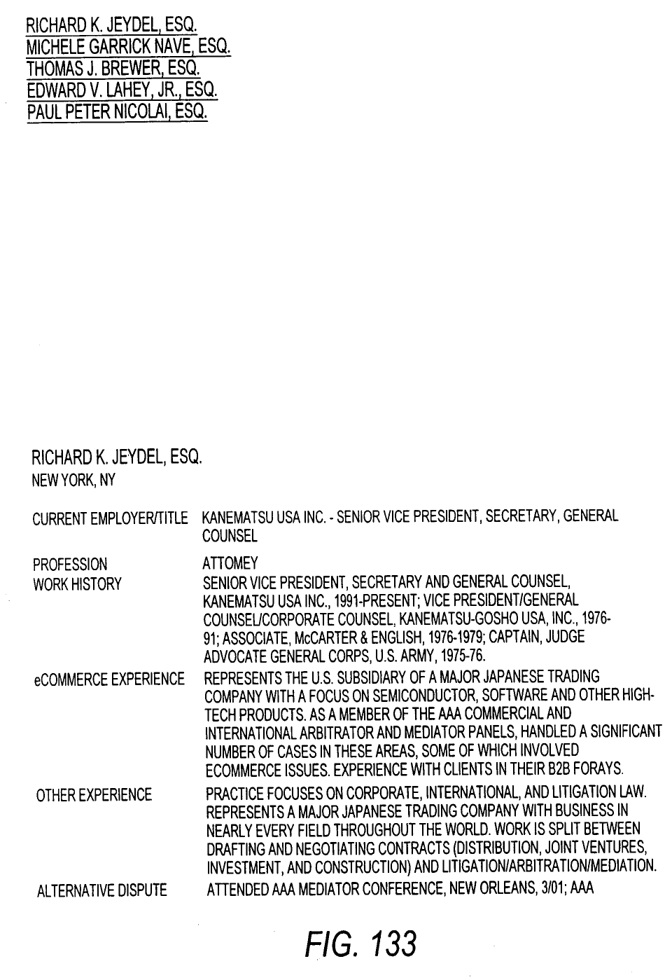

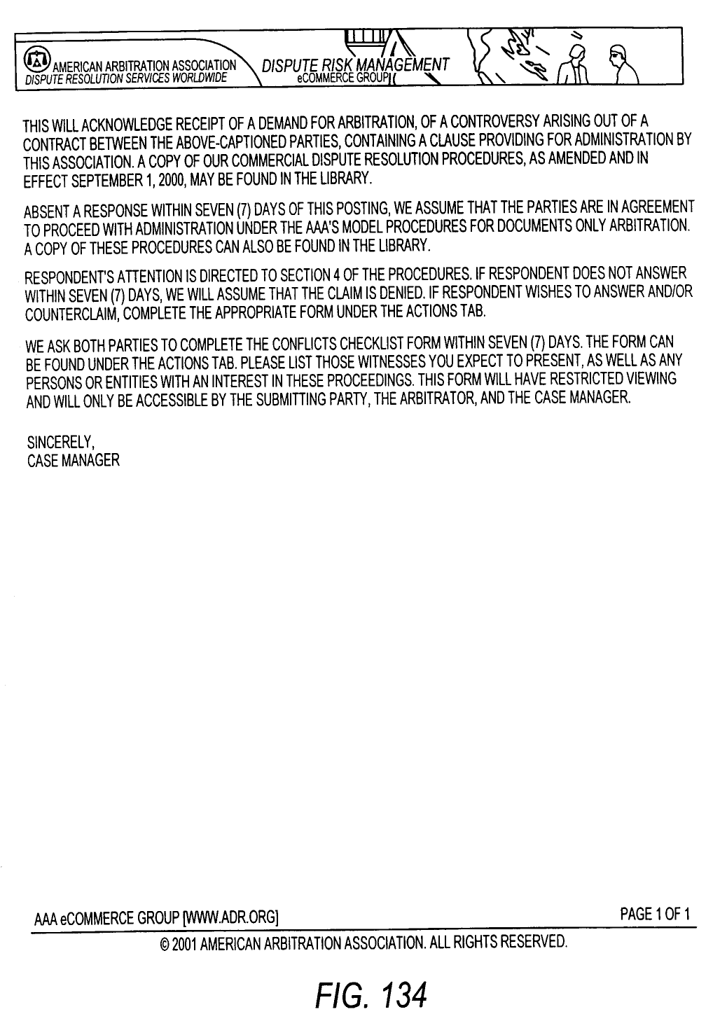

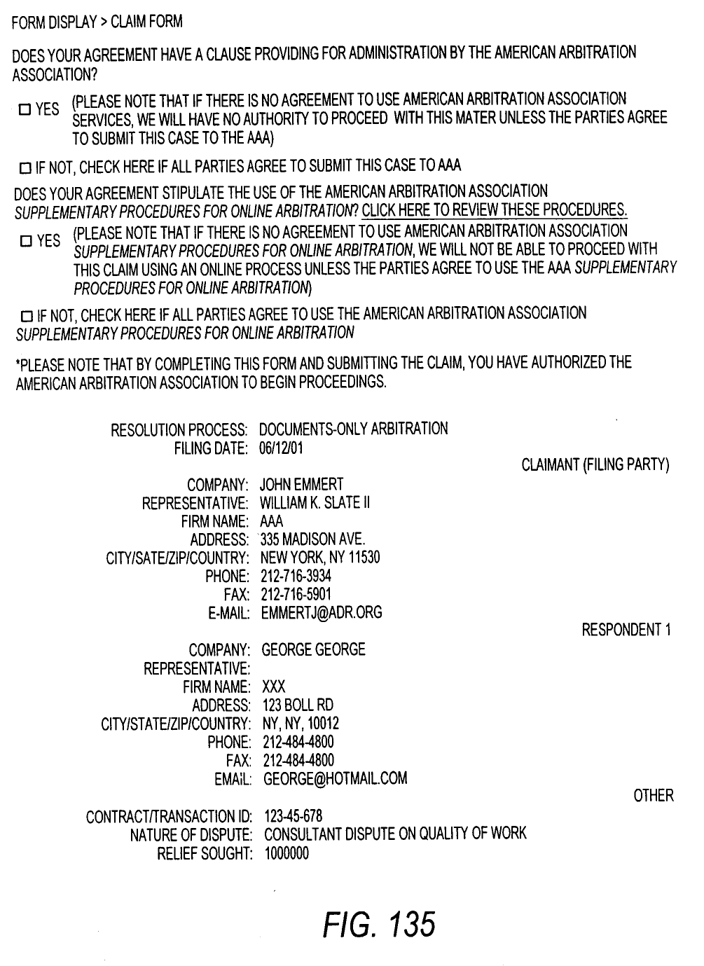

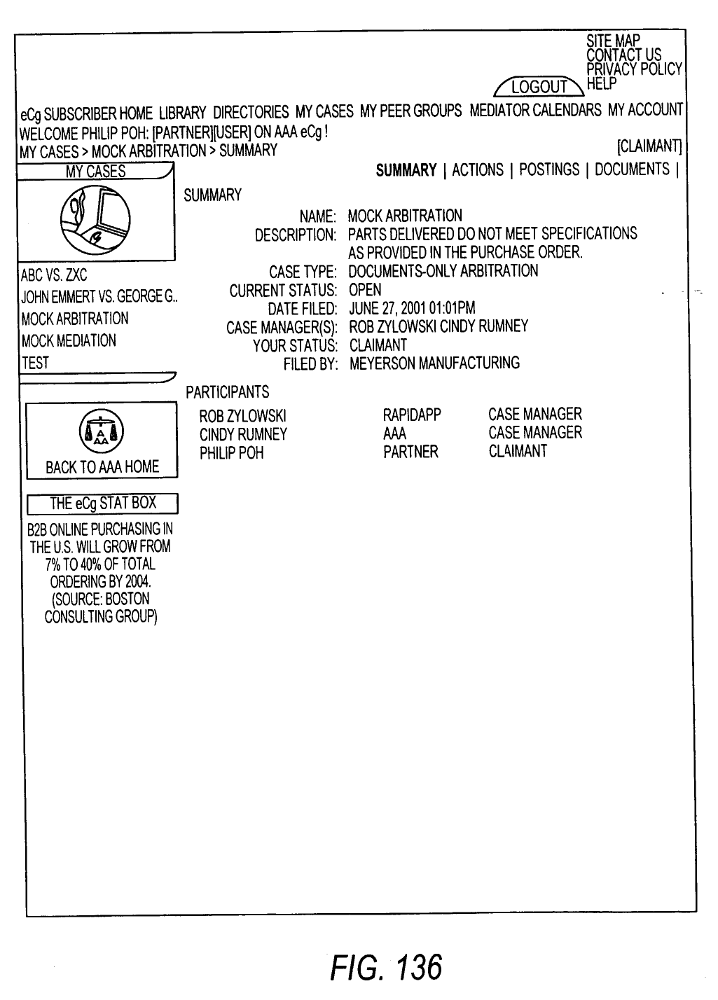

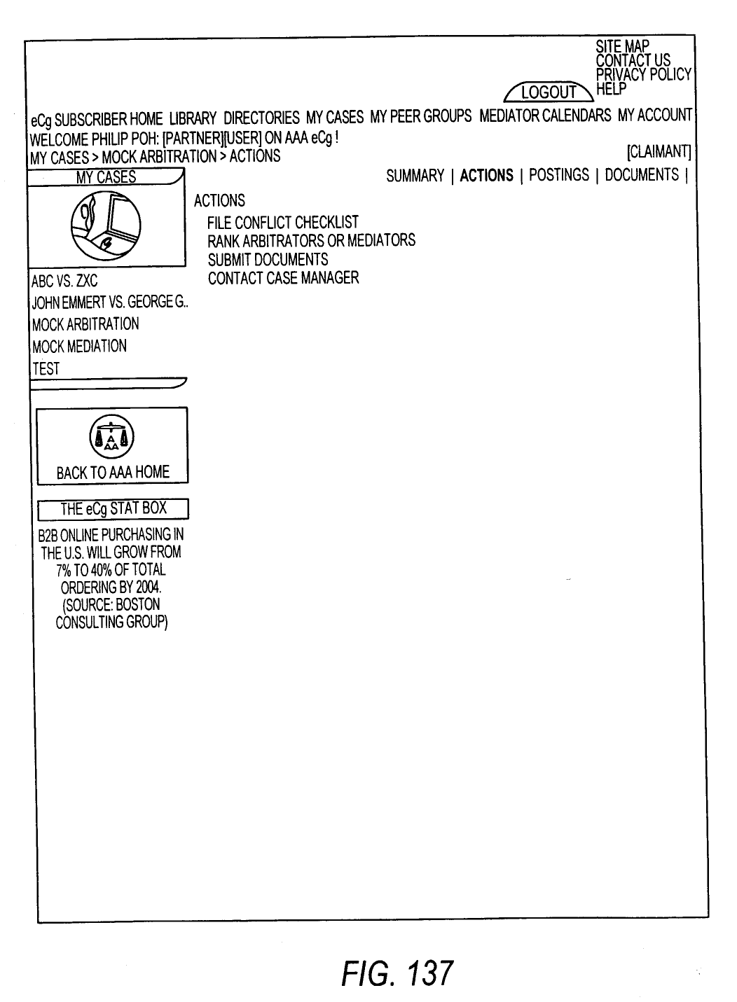

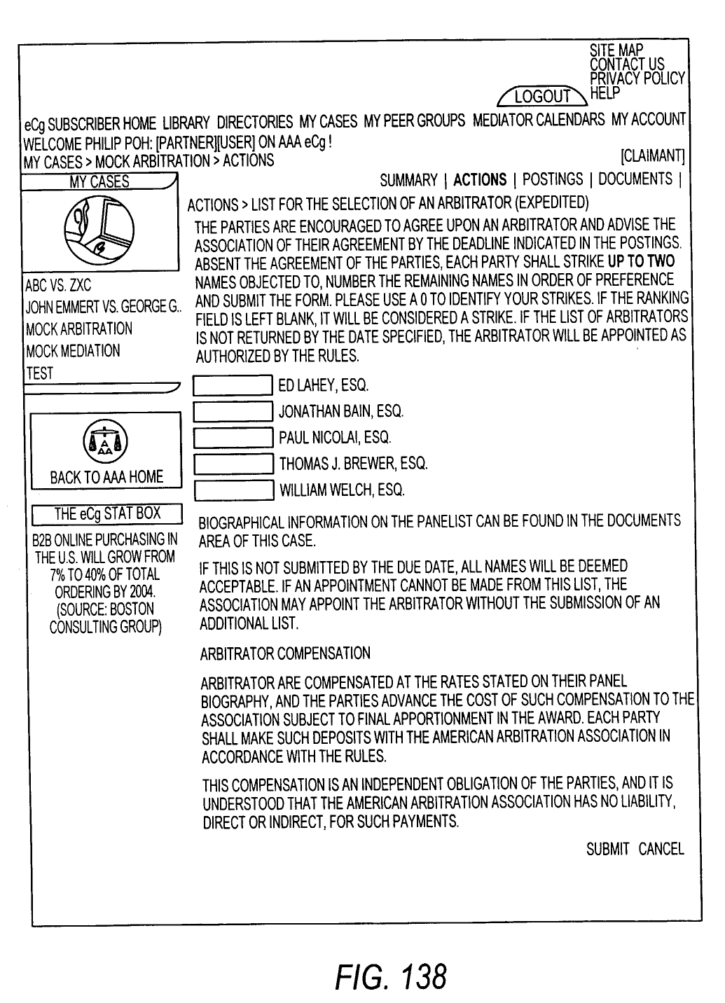

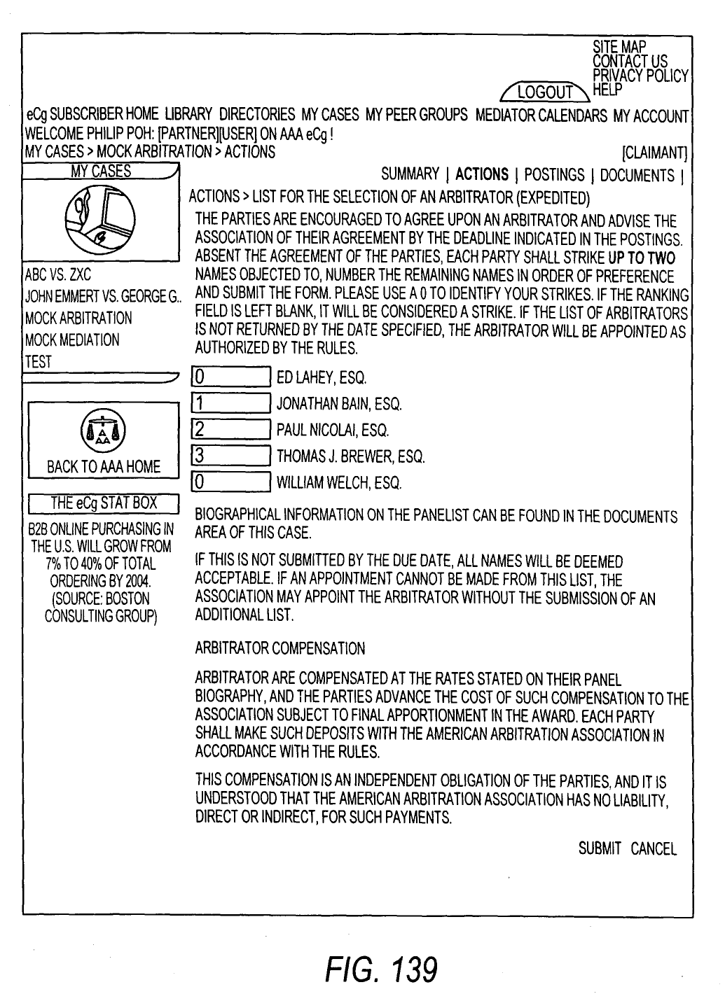

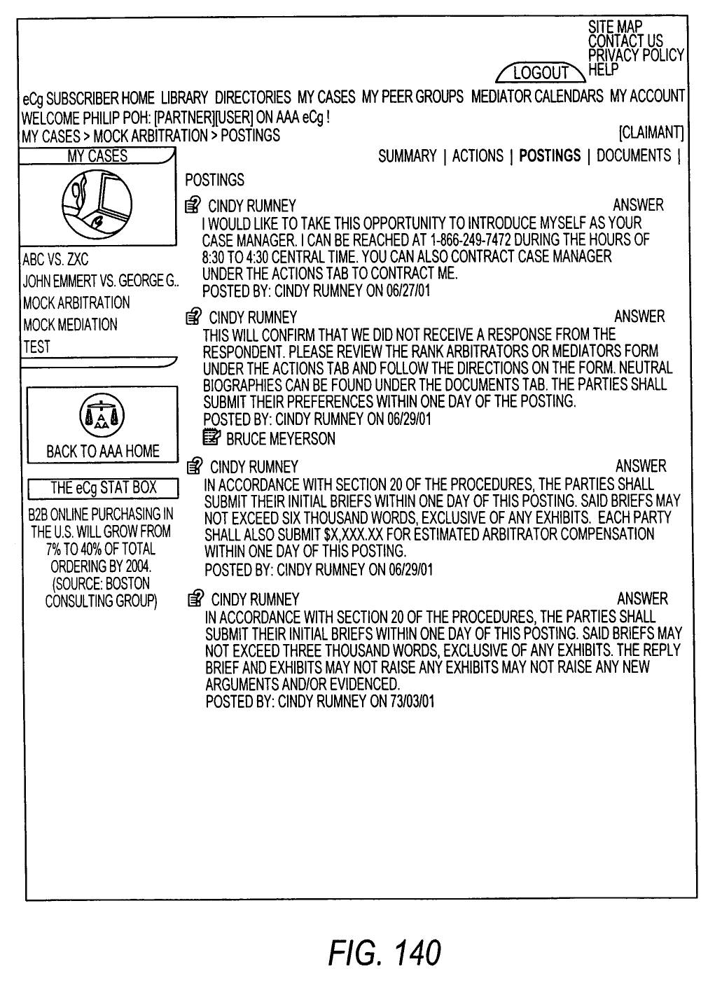

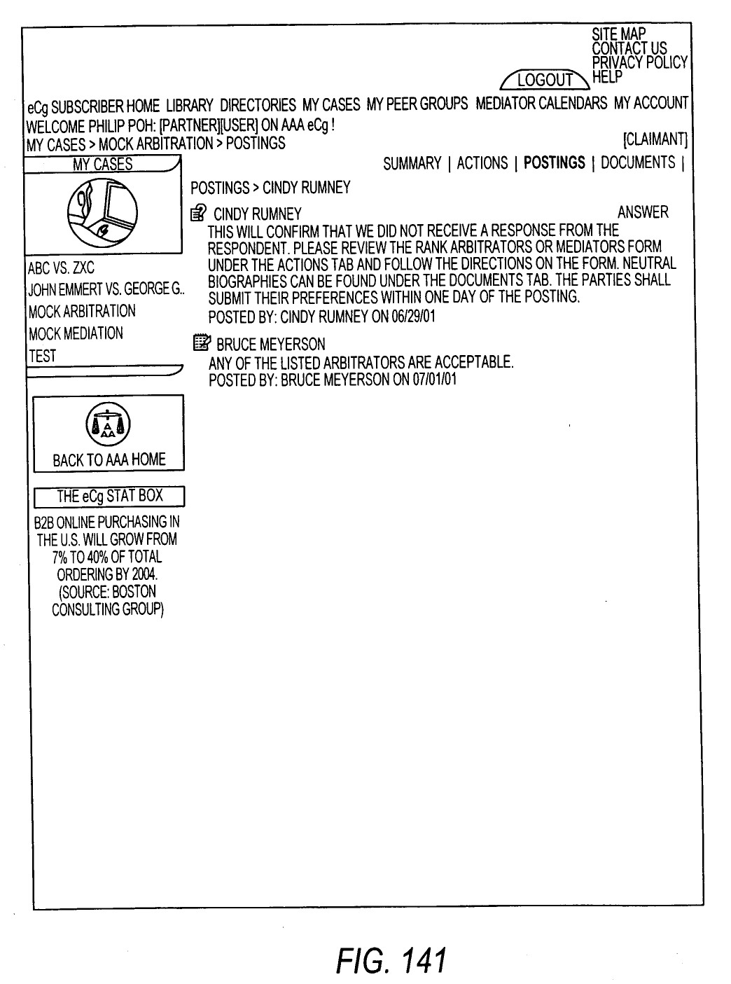

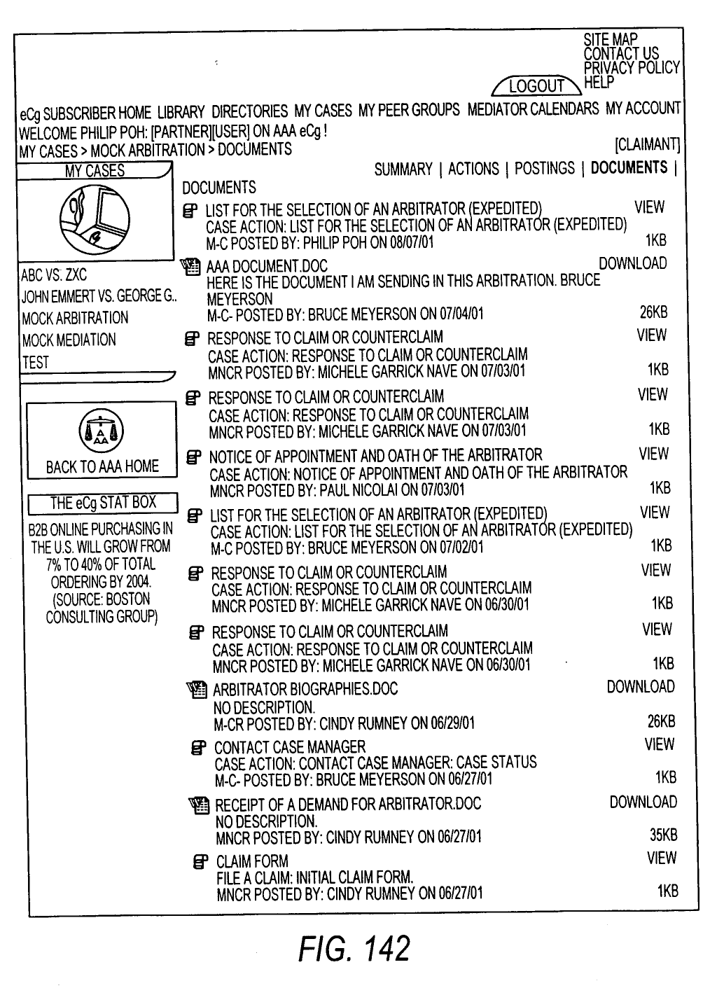

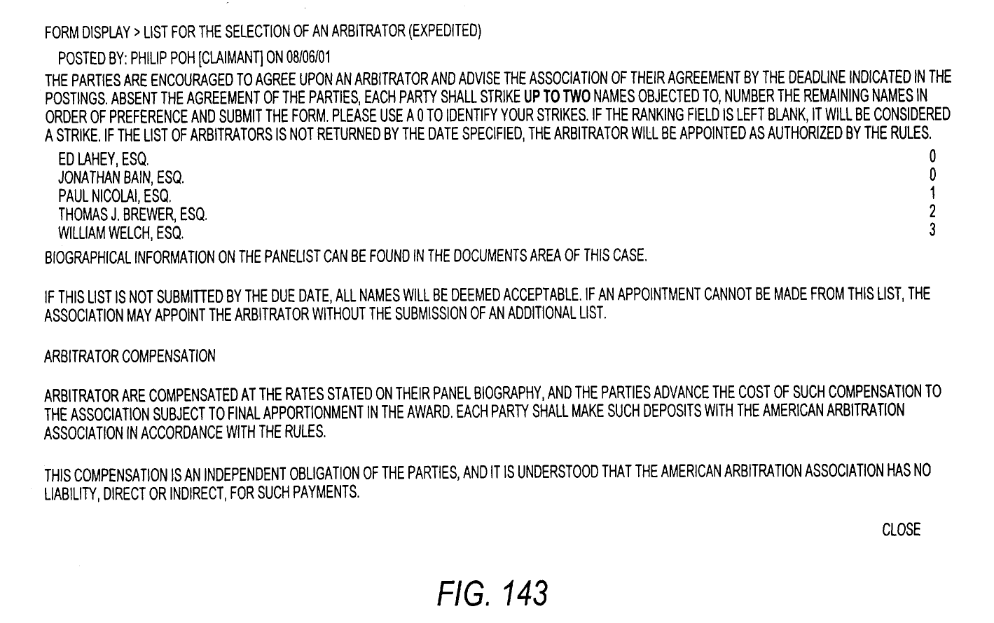

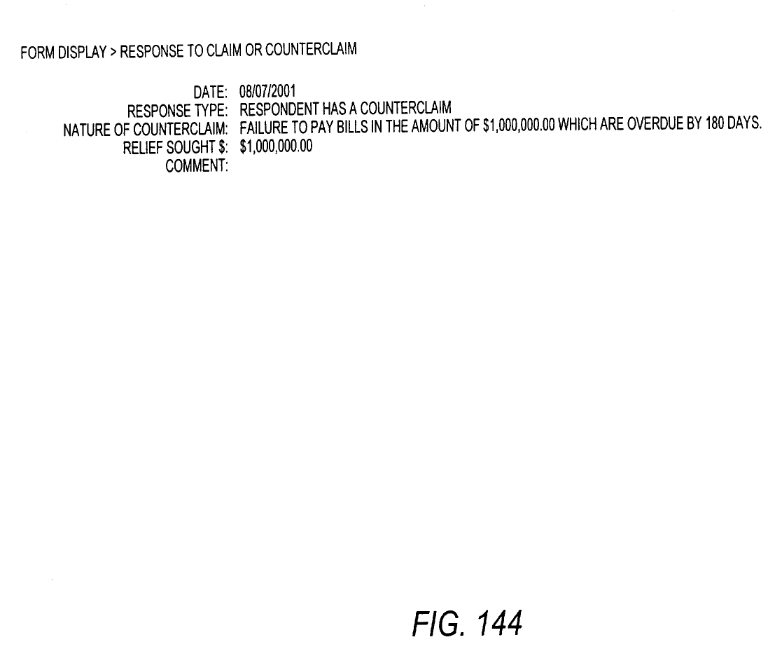

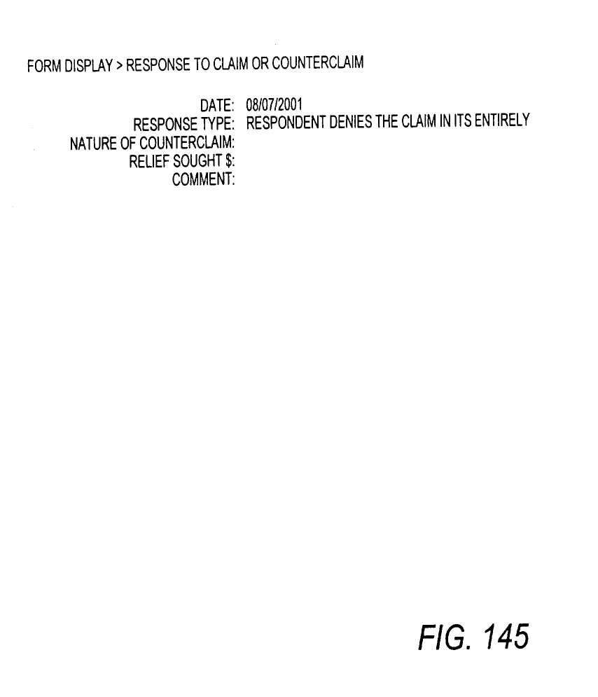

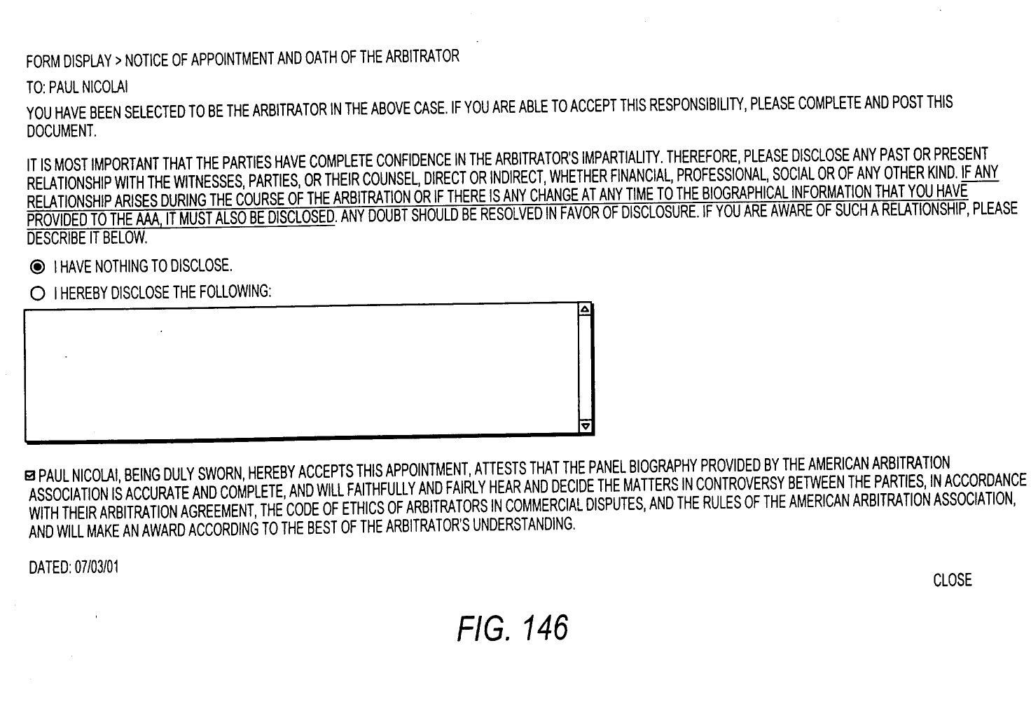

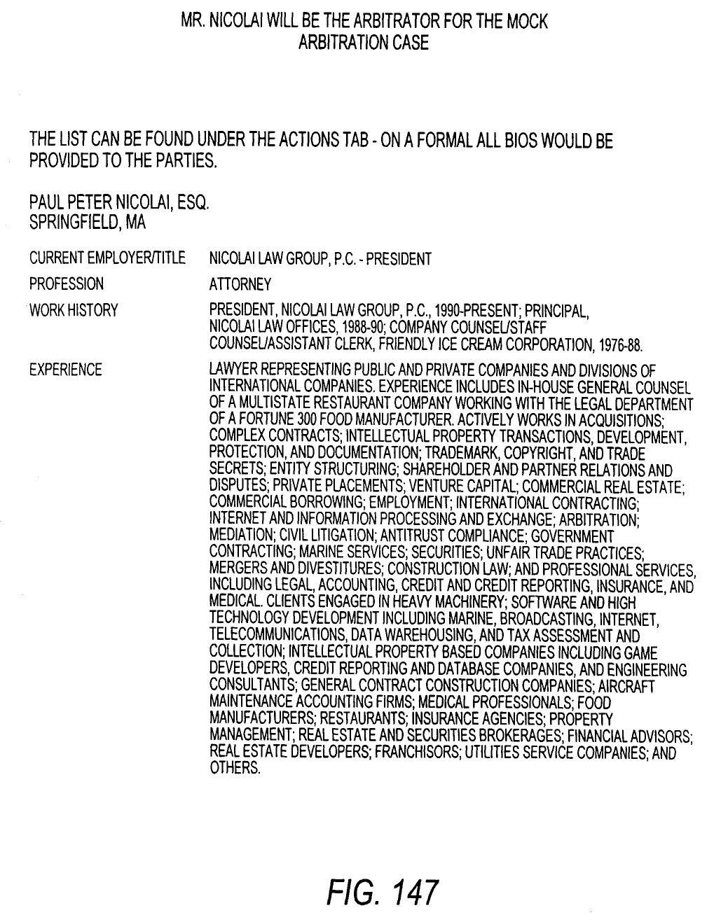

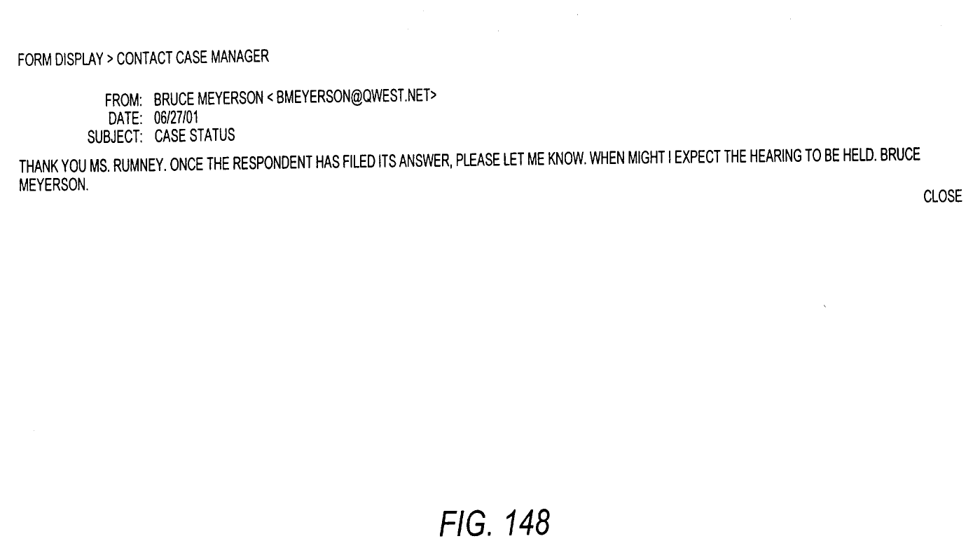

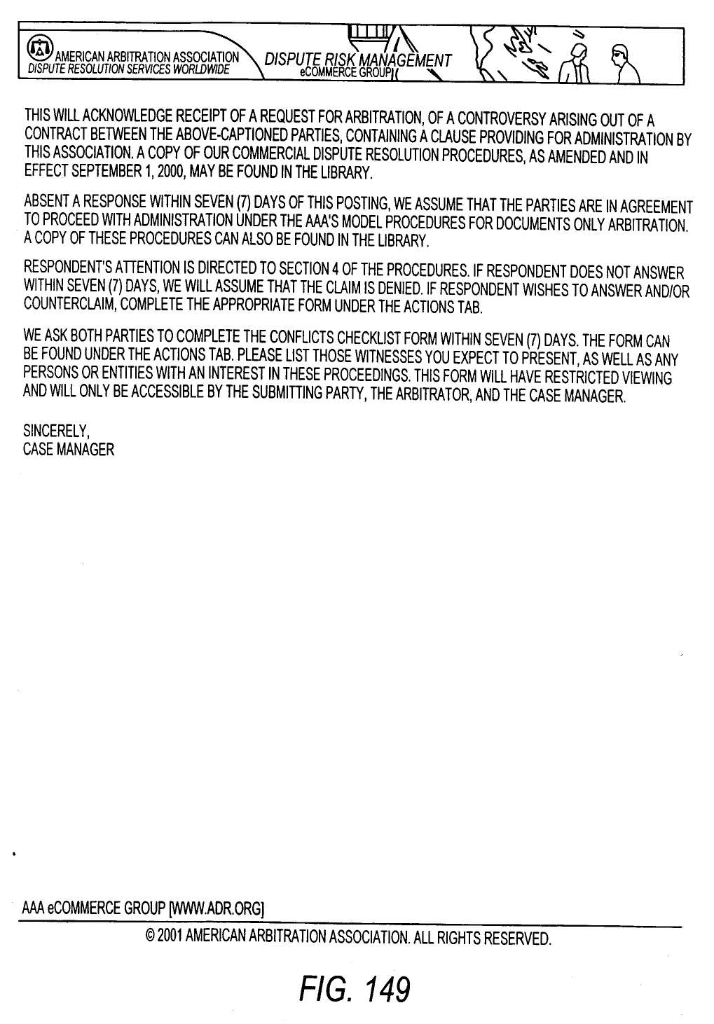

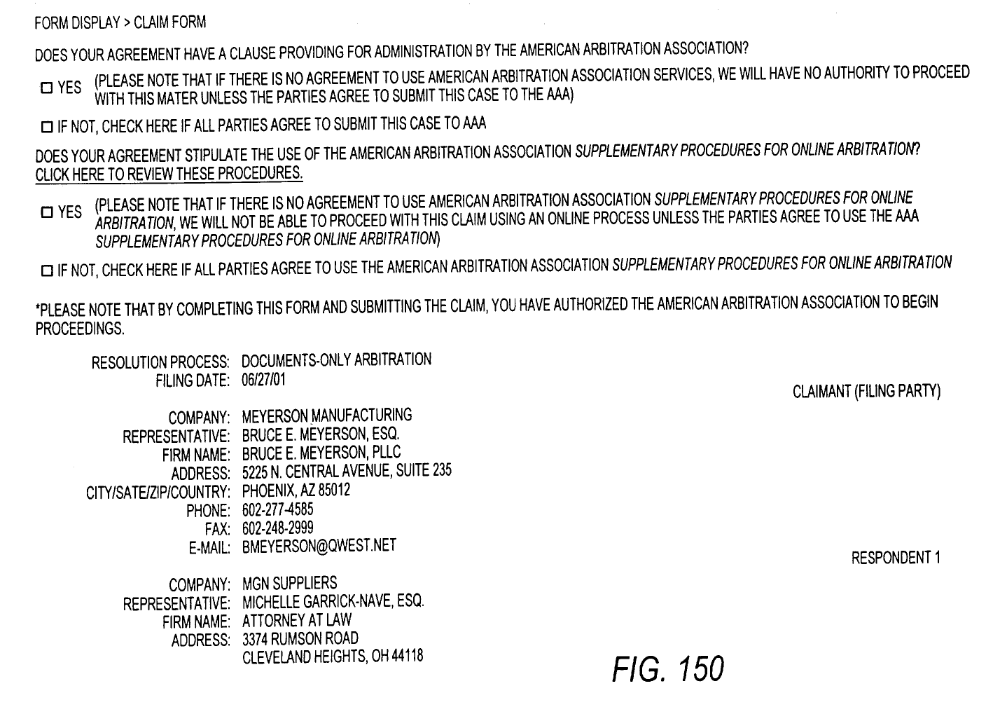

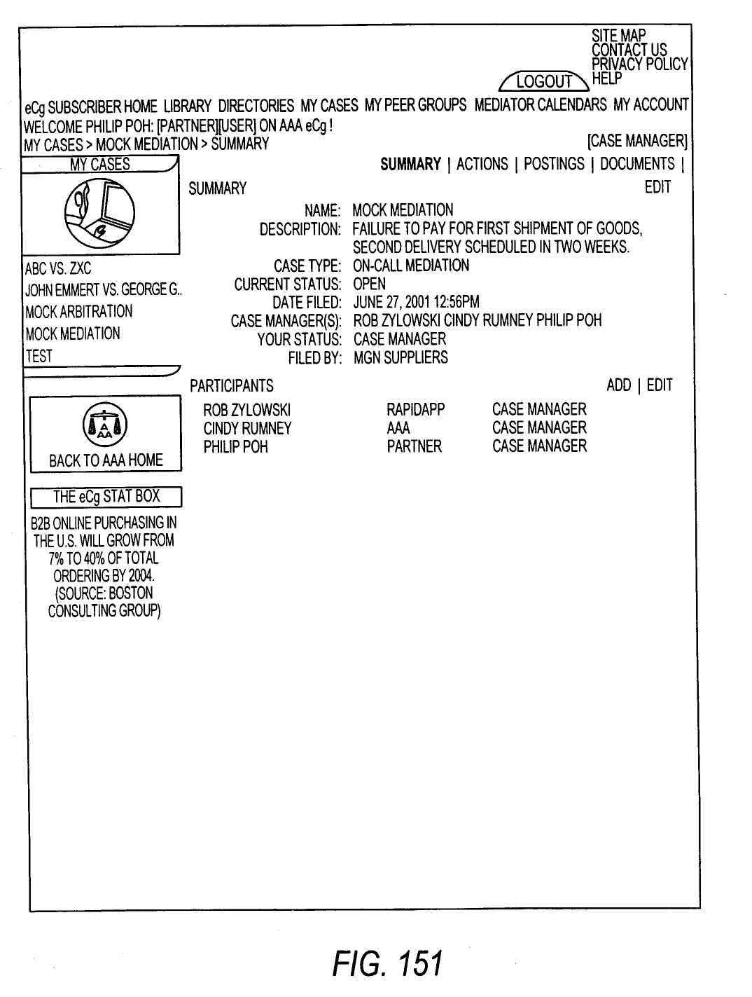

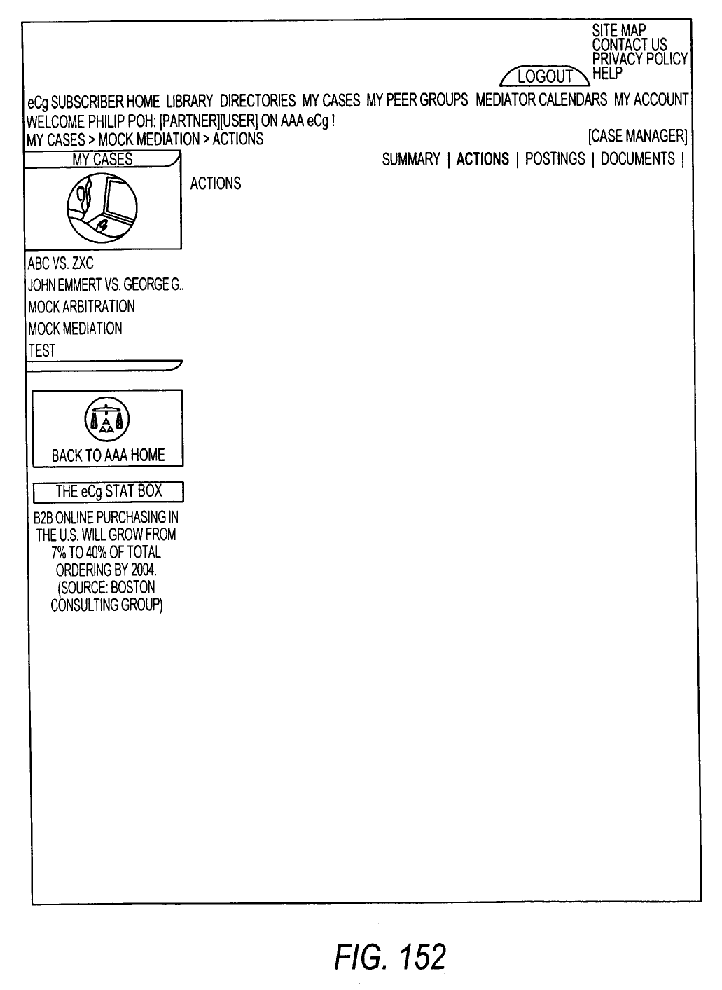

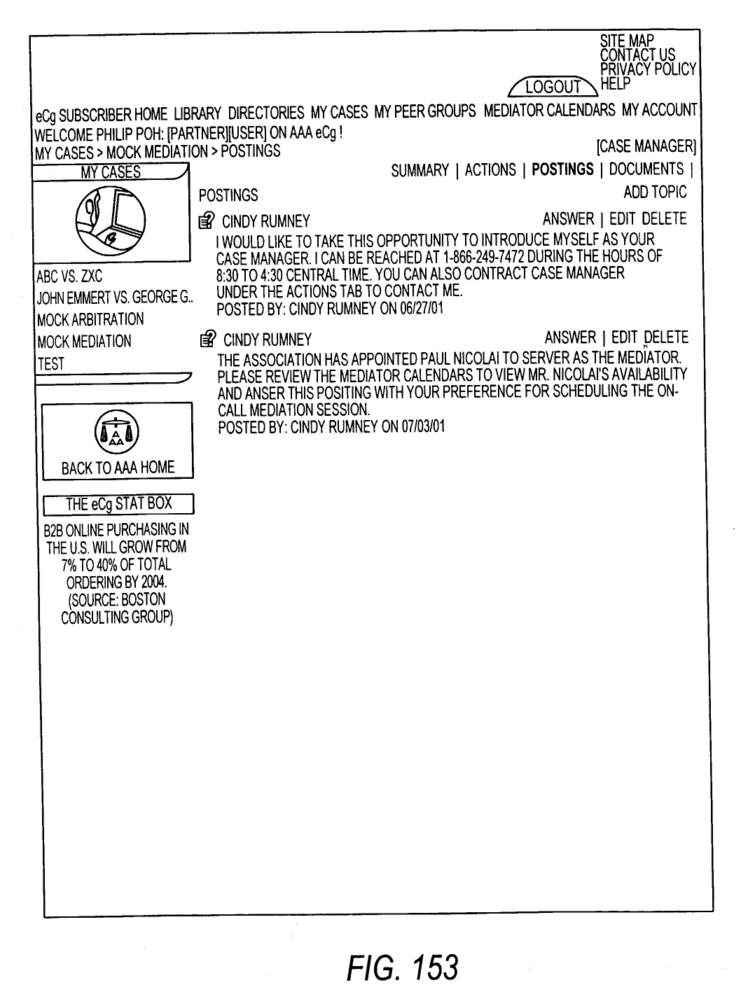

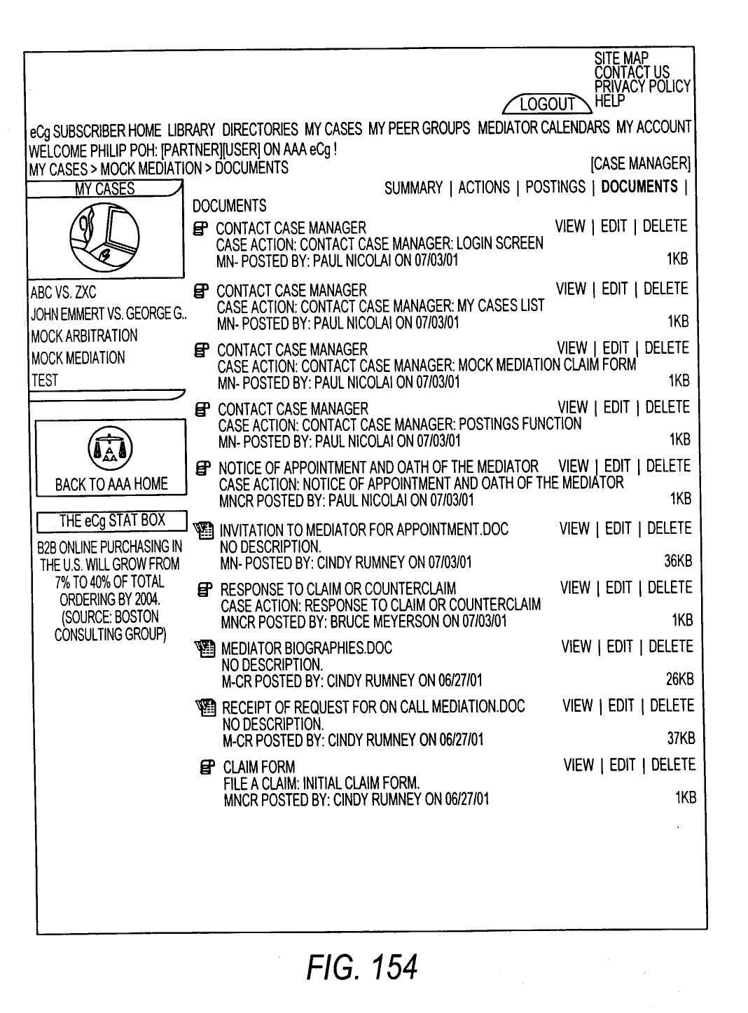

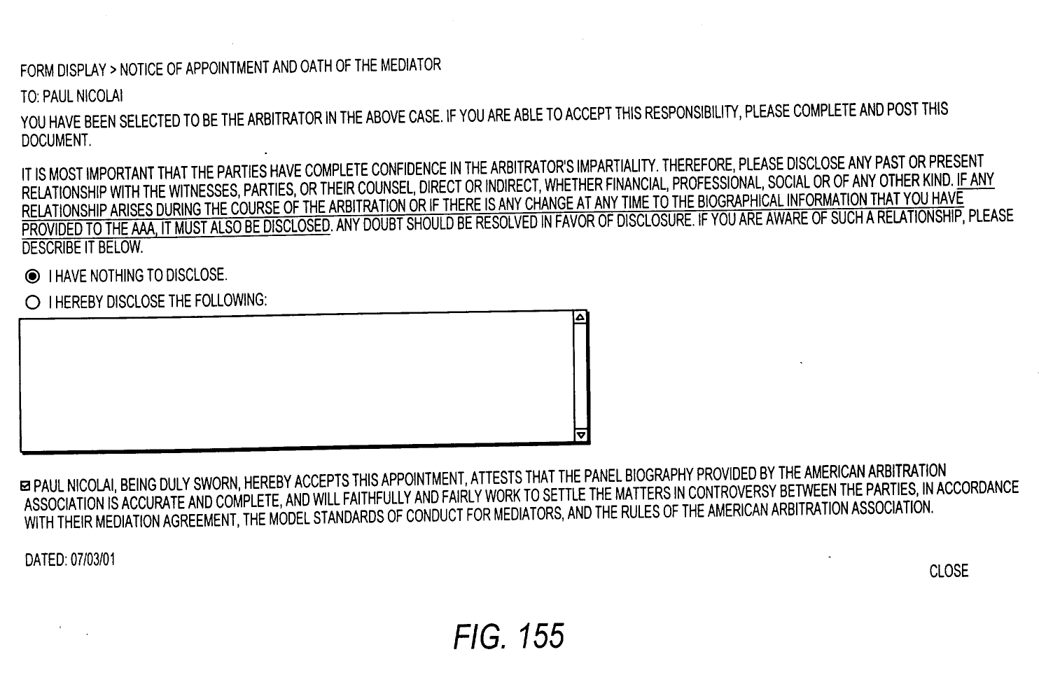

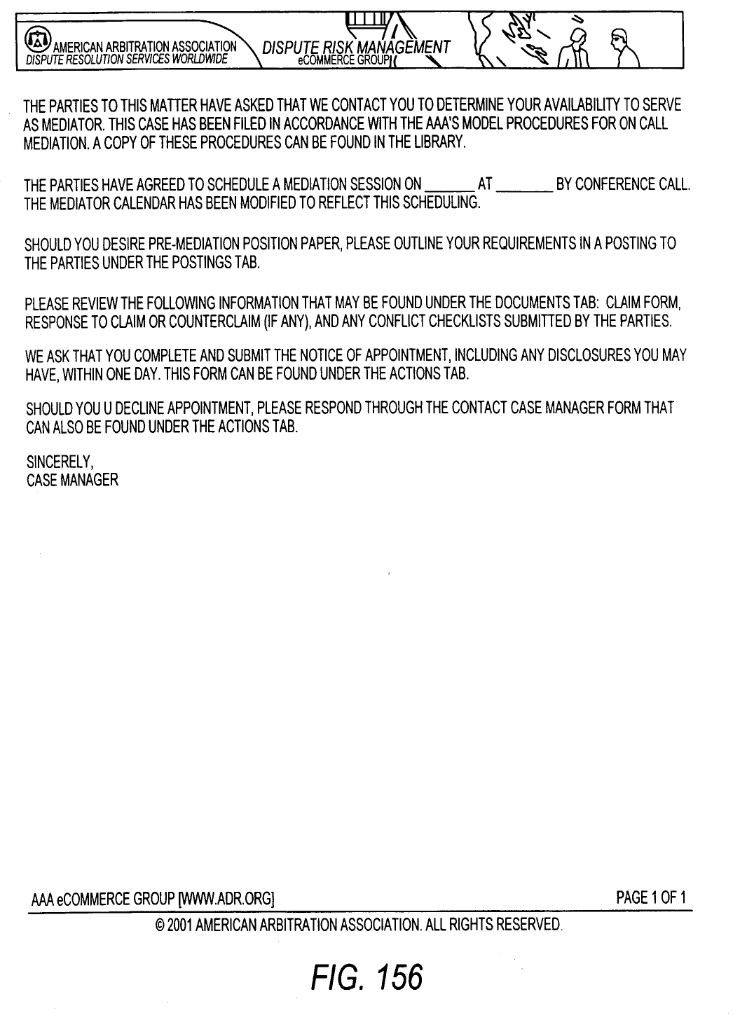

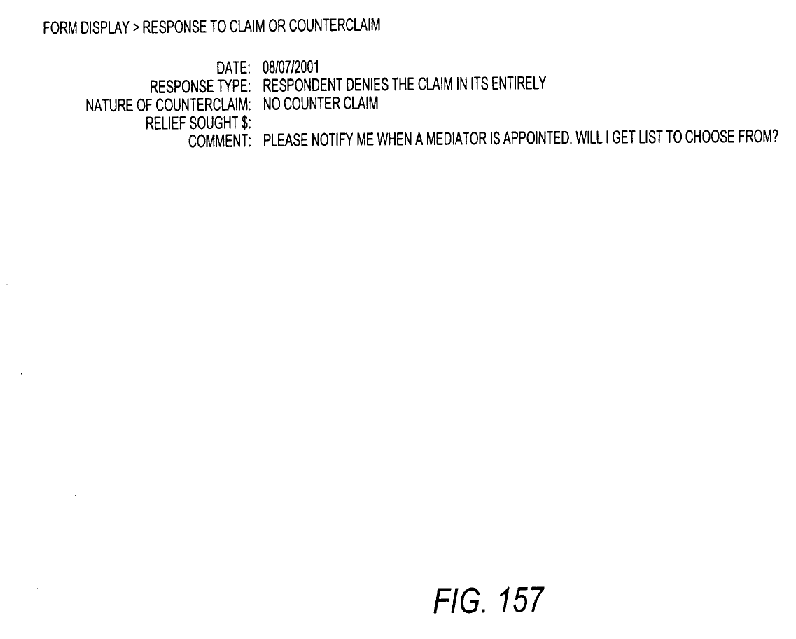

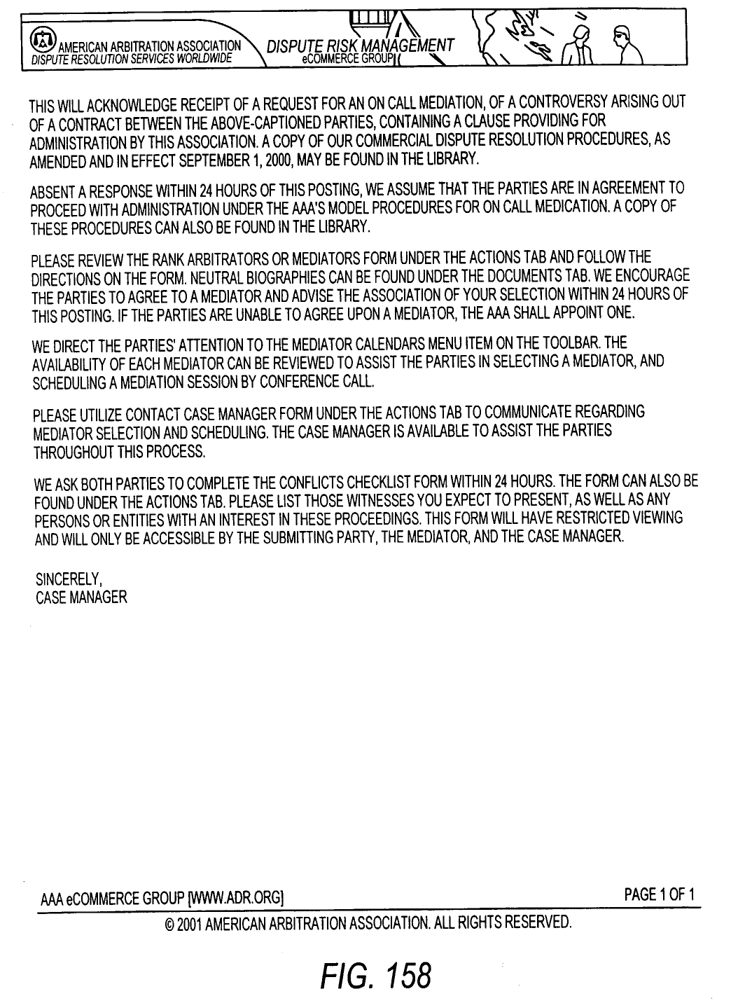

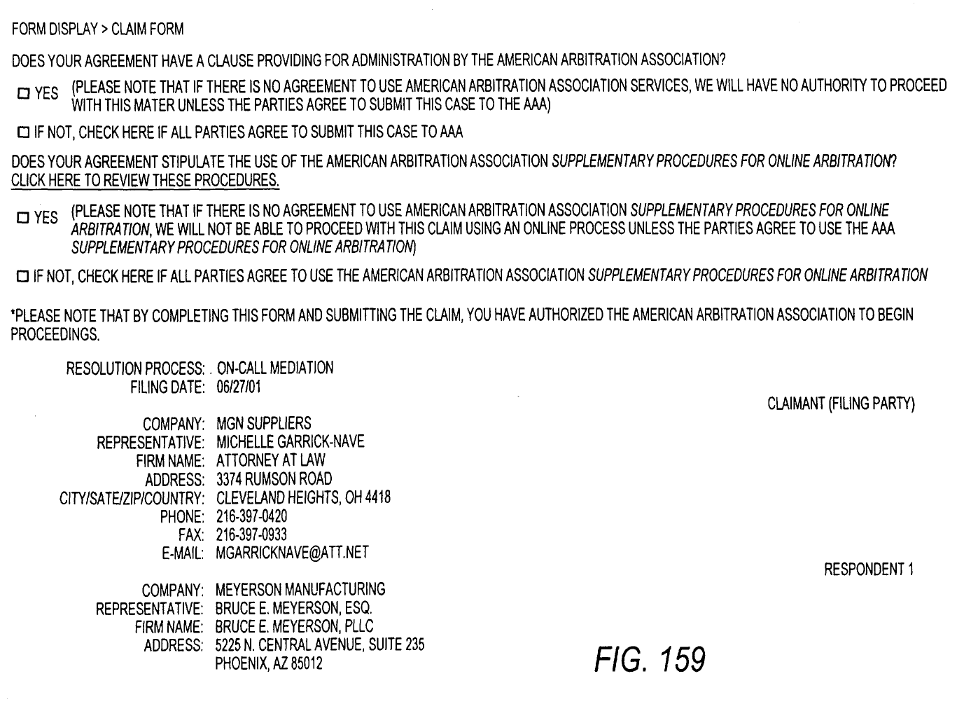

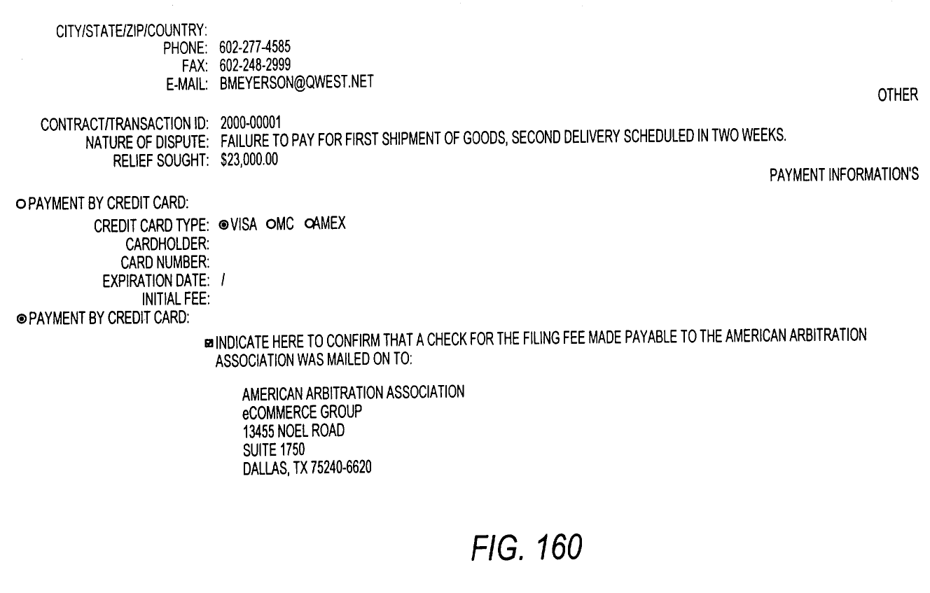

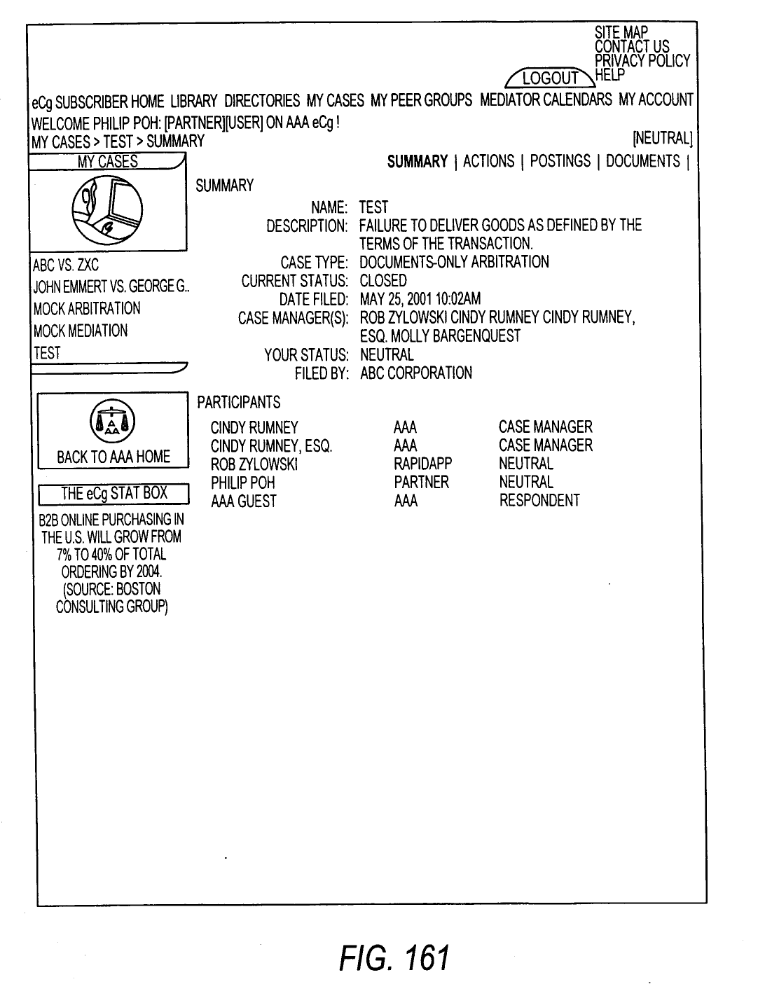

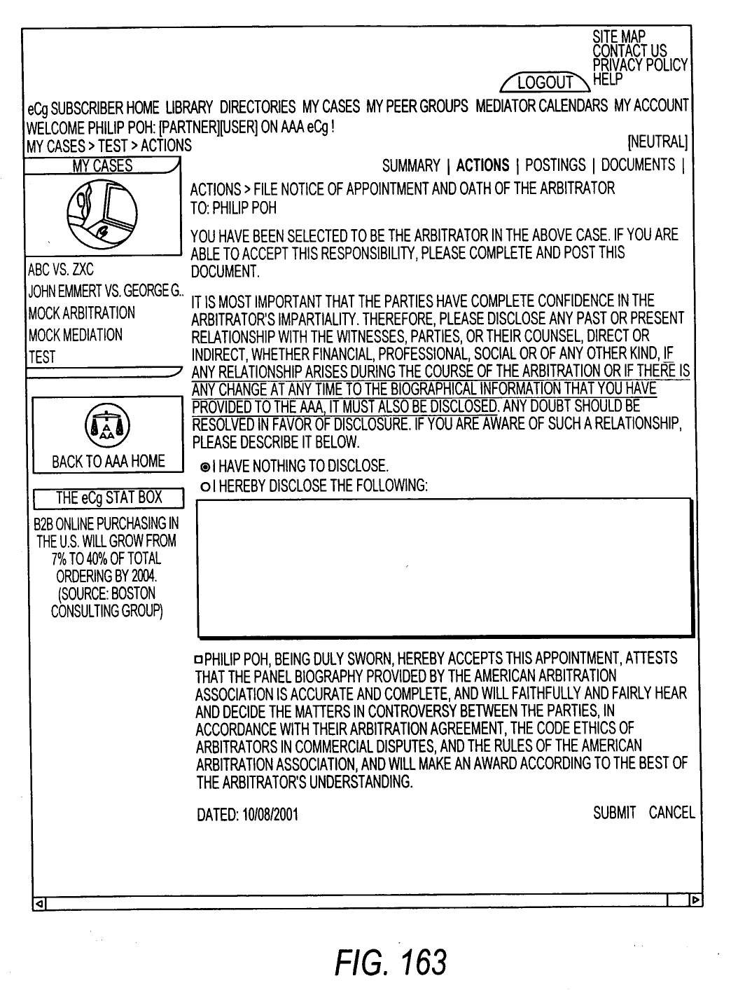

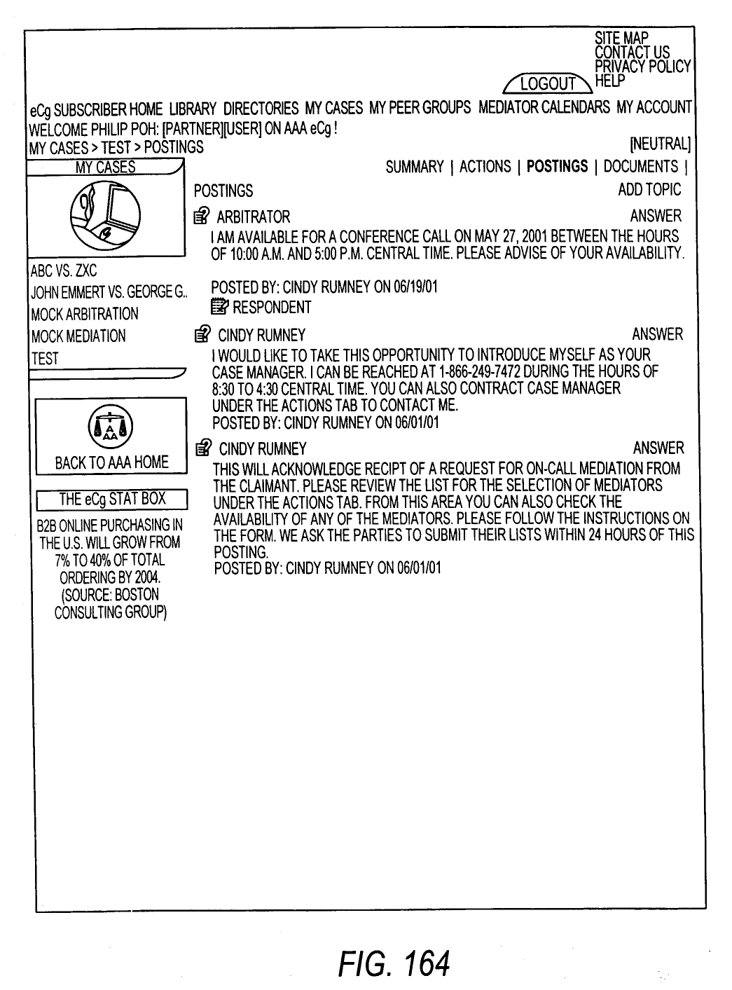

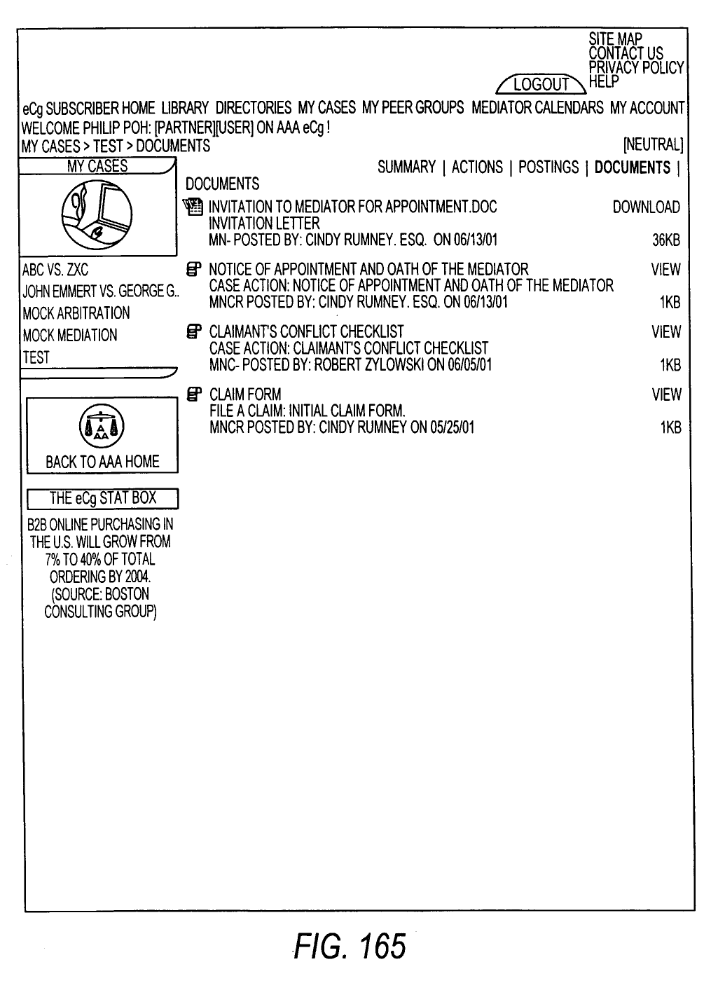

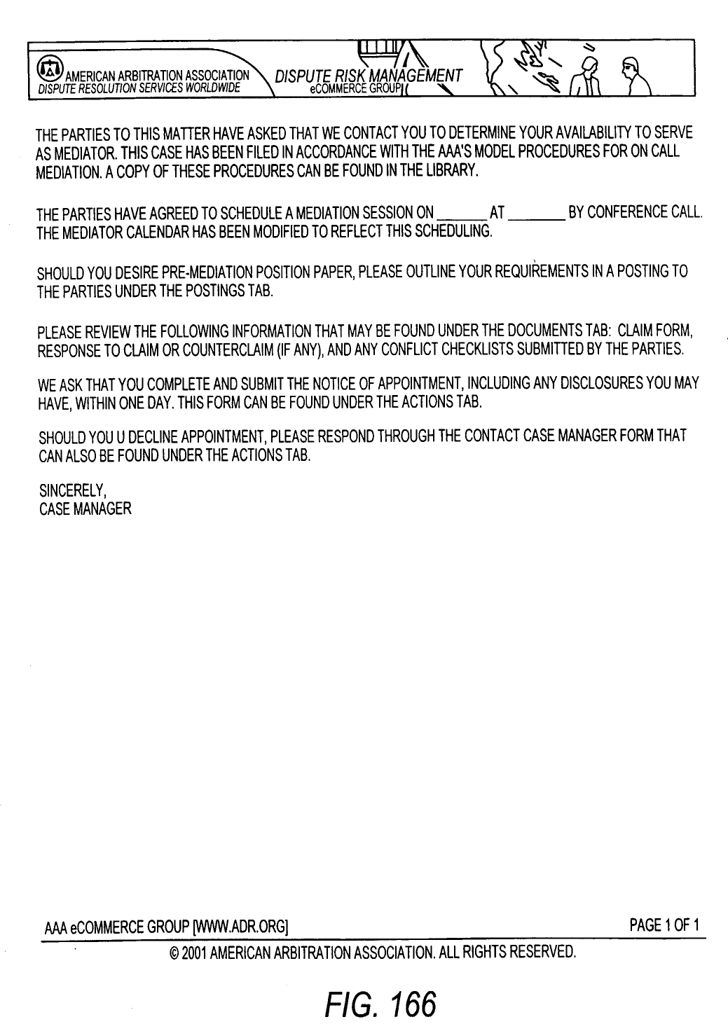

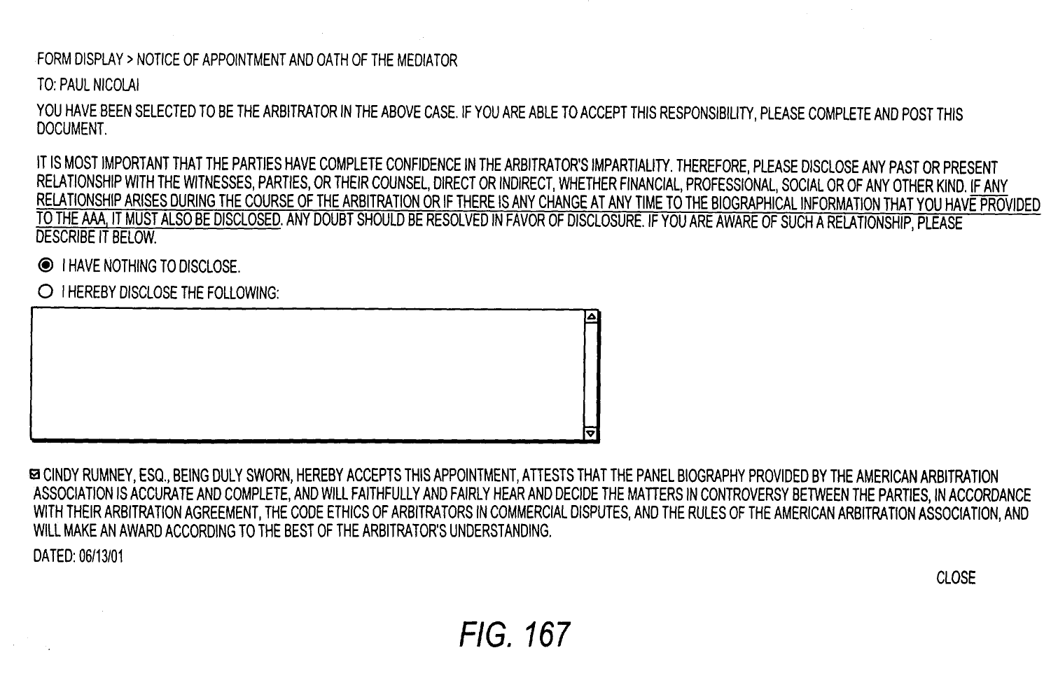

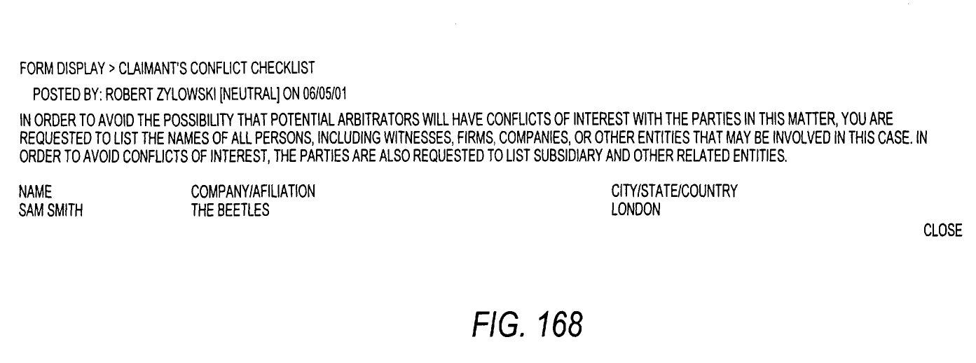

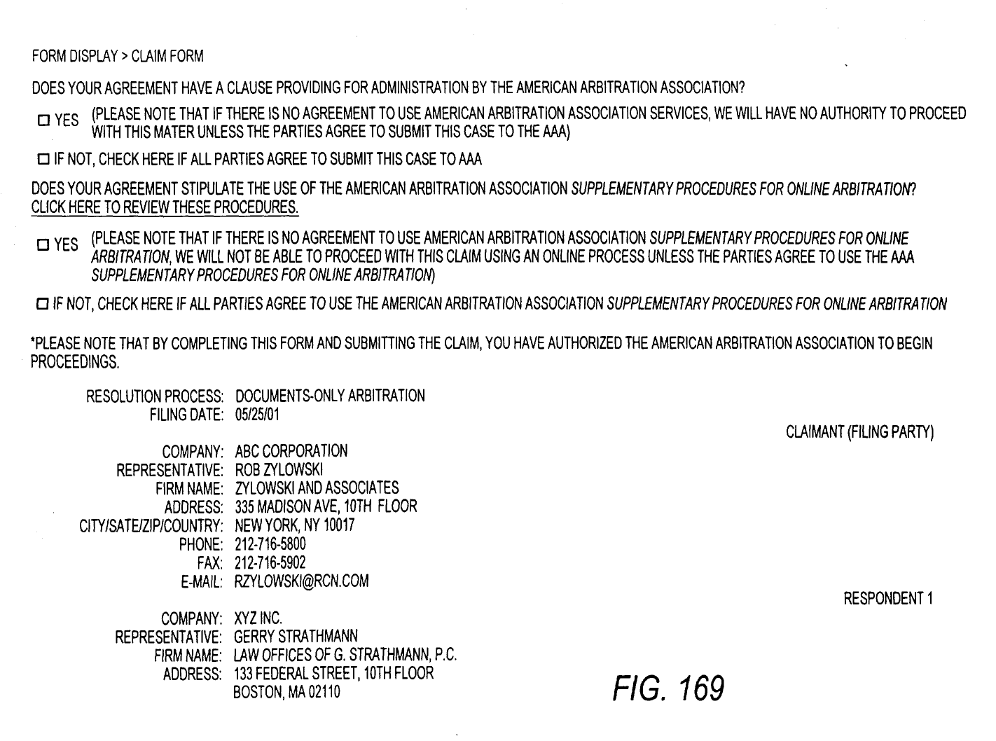

In this example, the user is the respondent (hereinafter referred to as a “respondent-user”). As shown in display 3400, the respondent-user (e.g., Philip Poh), the claimant (e.g., AAA Guest), and the case manager (e.g., Cindy Rumney) are the participants in the selected case. However, in other cases, the user may be a claimant, a case manager, a neutral, or any other suitable user. For example, in the “John Emmert v. George George” case shown in FIGS. 128-135 and the “Mock Arbitration” case shown in FIGS. 136-150, the user is the claimant (claimant-user). In the “Mock Mediation” case shown in FIGS. 151-160, the user is one of the case managers (case manager-user). In the “test” case shown in FIGS. 161-169, the user is a neutral (neutral-user). In this example, the dispute management application may provide the user with access to the “John Emmert v. George George” case, the “Mock Arbitration” case, the “Mock Mediation” case, and the “test” case, when the user selects link to active case 2418, link to active case 2420, link to active case 2422, and link to active case 2424, respectively.

As shown in FIGS. 112-169, the information and interfaces displayed in display 3400, and other displays described herein, may change based on the type of user (e.g., whether the user is a claimant, respondent, neutral, case manager, or any other suitable user). In the examples of FIGS. 112-169, the information, options, and interfaces displayed therein may change based on the selected resolution process (e.g., On-Call Mediation, In-Person Mediation, Documents-Only Arbitration, In-Person Arbitration, or any other suitable resolution mechanism).

In the “ABC vs. ZXC” case shown in display 3400, display 3400 may include tabs 3402-3408, a summary information area 3410, a participants information area 3412, and a user indicator 3414.

In some embodiments, the dispute management application may provide users (e.g., claimant-user, respondent-user, case manager-user, neutral-user, or any other suitable user) with tabs 3402-3408, such as a “Summary” tab 3402, an “Actions” tab 3404, a “Postings” tab 3406, and a “Documents” tab 3408. In practice, tabs 3402-3408 shown in FIGS. 112-169 may be displayed in any suitable order, some may be deleted, and others added.

In some embodiments, the dispute management application may highlight the tab to indicate the user's current selection. As shown in display 3400, “Summary” tab is highlighted. However, any other suitable approach may also be used. For example, the dispute management application may change the color of the tab selected by the user.

The dispute management application may also provide a summary and description of the selected cage in summary information area 3410. The dispute management application may provide the user with the participants in the case in participants information area 3412.

In some embodiments, the dispute management application may provide the user with user indicator 3414 to indicate the type of user. In this example, indicator 3414 indicates that the user is a “Respondent.” Indicator 3414 may change based on the type of user. For example, indicator 3414 may indicate that the user is a “Claimant,” “Respondent,” “Case Manager,” or a “Neutral.”

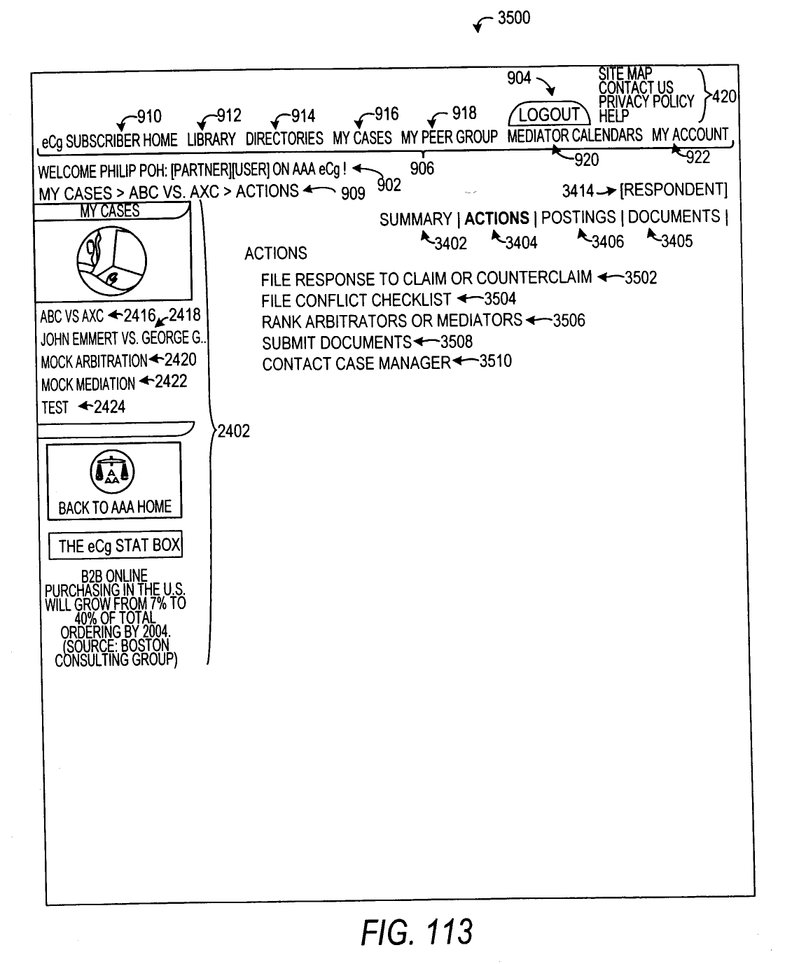

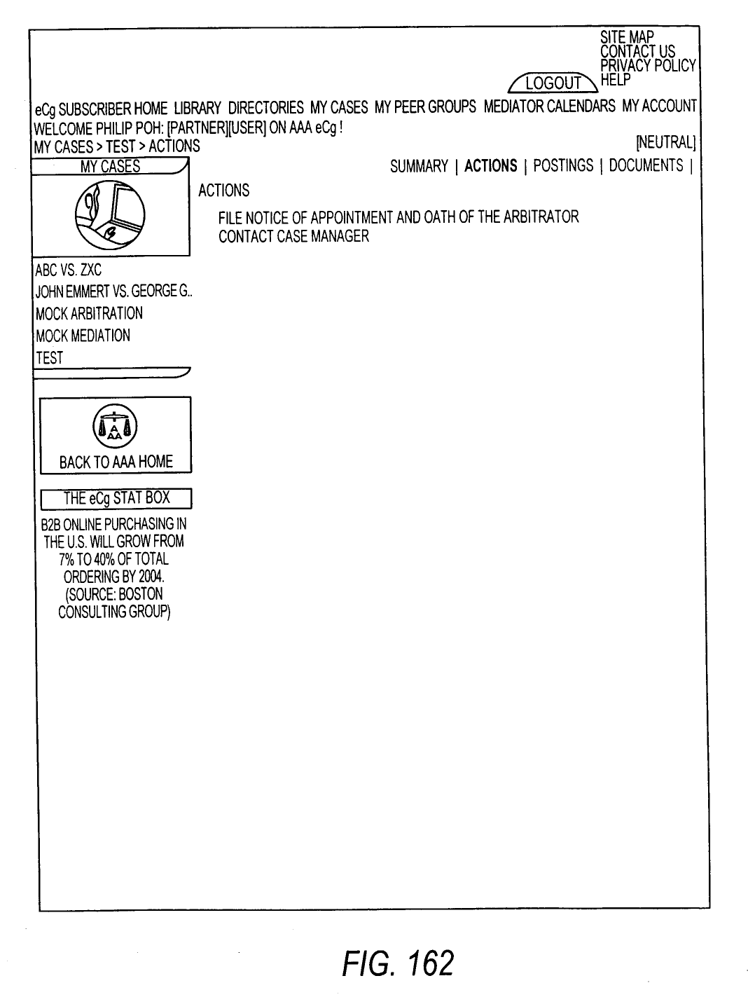

When a claimant-user submits a claim, the dispute management application may notify the respondent-user. For example, the respondent-user may receive a printed notification or an electronic notification (e.g., e-mail). The respondent-user may be prompted to file a response to the claimant-user's claim. The respondent-user may also file a counterclaim. As shown in an illustrative actions display 3500 (FIG. 113), the dispute management application may, in response to the respondent-user selecting “Actions” tab 3404, provide the respondent-user with multiple actions, such as a “File Response to Claim or Counterclaim” option 3502, a “File Conflict Checklist” option 3504, a “Rank Arbitrators or Mediators” option 3506, “Submit Documents” option 3508, and “Contact Case Manager” option 3510. In practice, options 3502-3510 shown in FIGS. 113 may be displayed in any suitable order, some may be deleted, and others added. In some embodiments, the dispute management application may provide a case manager-user with no actions under “Actions” tab 3404. In some embodiments, the dispute management application may provide a neutral-user with actions, such as a “File Notice of Appointment and Oath of the Arbitrator” or any other suitable action (FIG. 162).

As shown in display 3500, “Actions” tab 3404 is highlighted in response to the user selecting “Actions” tab 3404. However, any other suitable approach may also be used. For example, the dispute management application may change the color of the tab selected by the user.

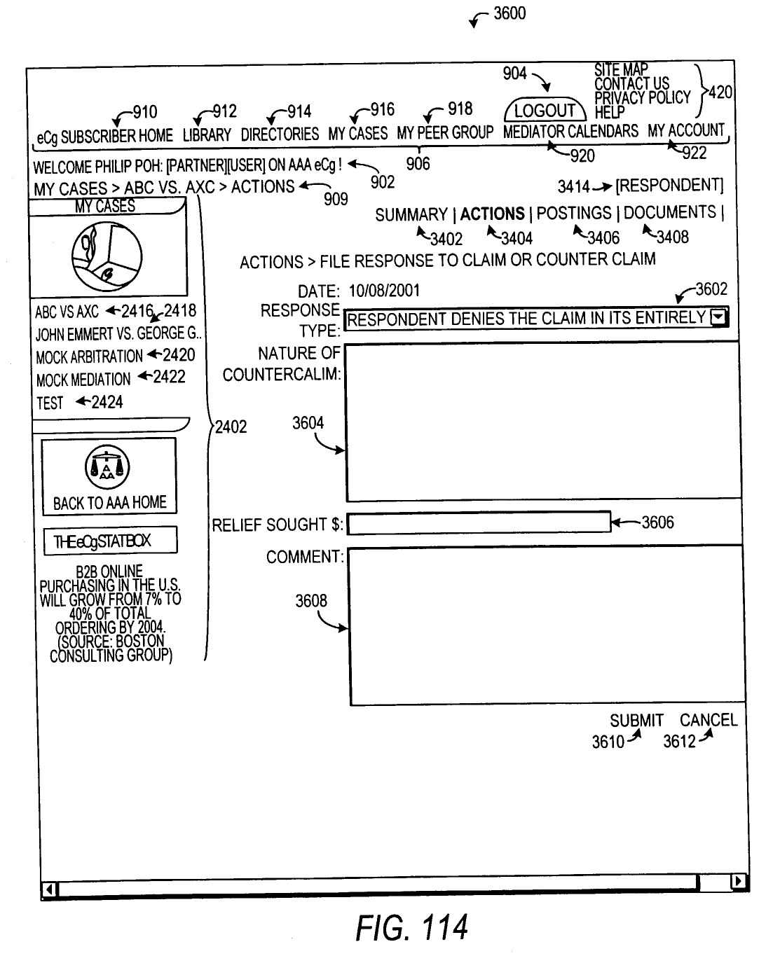

In some embodiments, the dispute management application may receive an indication that the respondent-user wishes to file a response to a claim or counterclaim by, for example, selecting option 3502. In response, the dispute management application may provide the respondent-user with an illustrative claim response display 3600 as shown in FIG. 114. Display 3600 includes a drop-down field 3602 and text fields 3604-3608. However, any other suitable interface may also be used. For example, display 3600 may include list boxes, push buttons, radio buttons, or any other suitable interface. As shown in display 3600, the dispute management application may allow the respondent-user to indicate the user's type of response in drop-down field 3602. When the user selects drop-down field 3602, the dispute management application may provide the respondent-user with types of responses, such as “Respondent Denies the Claim in its entirety,” “Respondent Denies the Claim in part,” “Respondent has a counterclaim,” or any other suitable response. Display 3600 may also allow the respondent-user to input information, such as the nature of the counterclaim, the relief sought by the respondent, comments from the respondent-user, and any other suitable information, in text fields 3604-3608.

When the respondent-user has inputted the response to the claim, the dispute management application may allow the respondent-user to submit the response by, for example, selecting a “Submit” button 3610. When the respondent-user selects “Submit” button 3610, the dispute management application may notify the respondent-user that the response has been submitted.

In some embodiments, the respondent-user may cancel the response by, for example, selecting a “Cancel” button 3612. When the respondent-user selects “Cancel” button 3612, the dispute management application may return the respondent-user to actions display 3500 (FIG. 113) or any other suitable display.

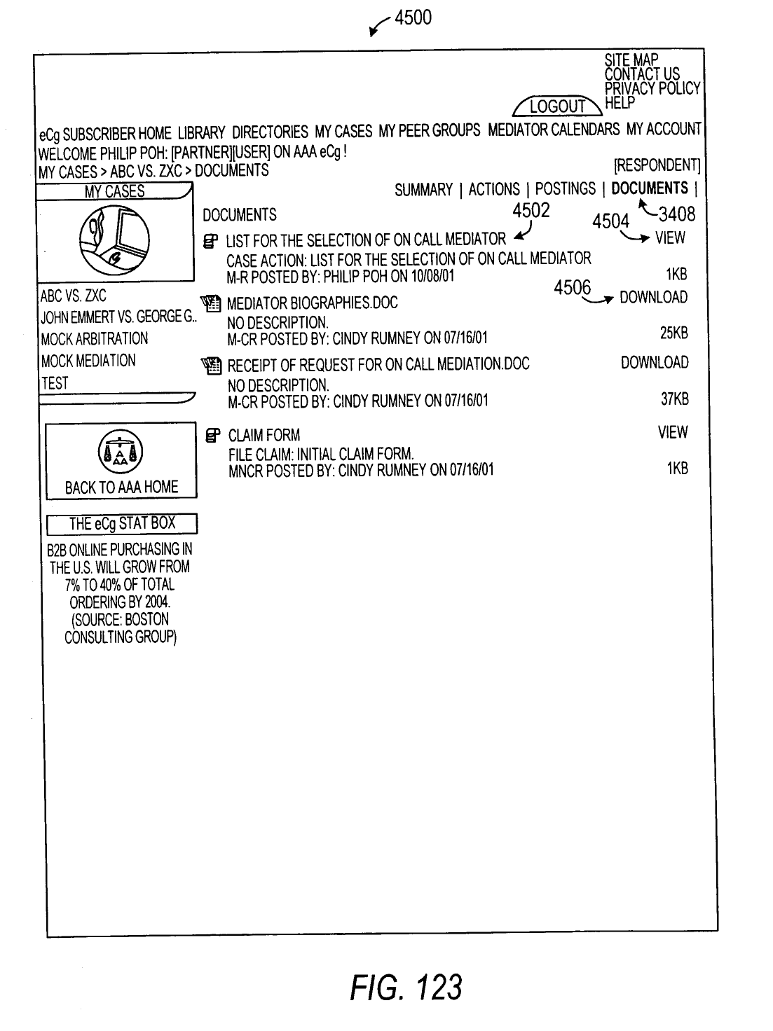

In some embodiments, users may have conflicts of interest with another user in the selected case. In some embodiments, the dispute management application may allow a user (e.g., a claimant-user, a respondent-user, a case manager-user, or a neutral-user) to input information of another user, such as an arbitrator, mediator, neutral, or entity that may have a conflict of interest with the case. The dispute management application may allow a user to input such information by, for example, selecting “File Conflict Checklist” option 3504. In response to the user selecting option 3504, the dispute management application may provide the user with an illustrative conflicts display 3700. Display 3700 may include multiple text fields (e.g., text fields 3702-3706). The user may input information on users that may have a conflict of interest with the case. The user may submit the list of conflicts by, for example selecting a “Submit” button 3708. When the user selects “Submit” button 3708, the dispute management application may notify the user that the response has been submitted. In some embodiments, the dispute management application may post the submission under “Documents” tab 3408 (as shown in FIG. 123). In response to submitting a list of conflicts, the case manager or any other neutral may, for example, view the list of conflicts and determine whether there are conflicts of interest that may exclude them from serving as a neutral for the case.

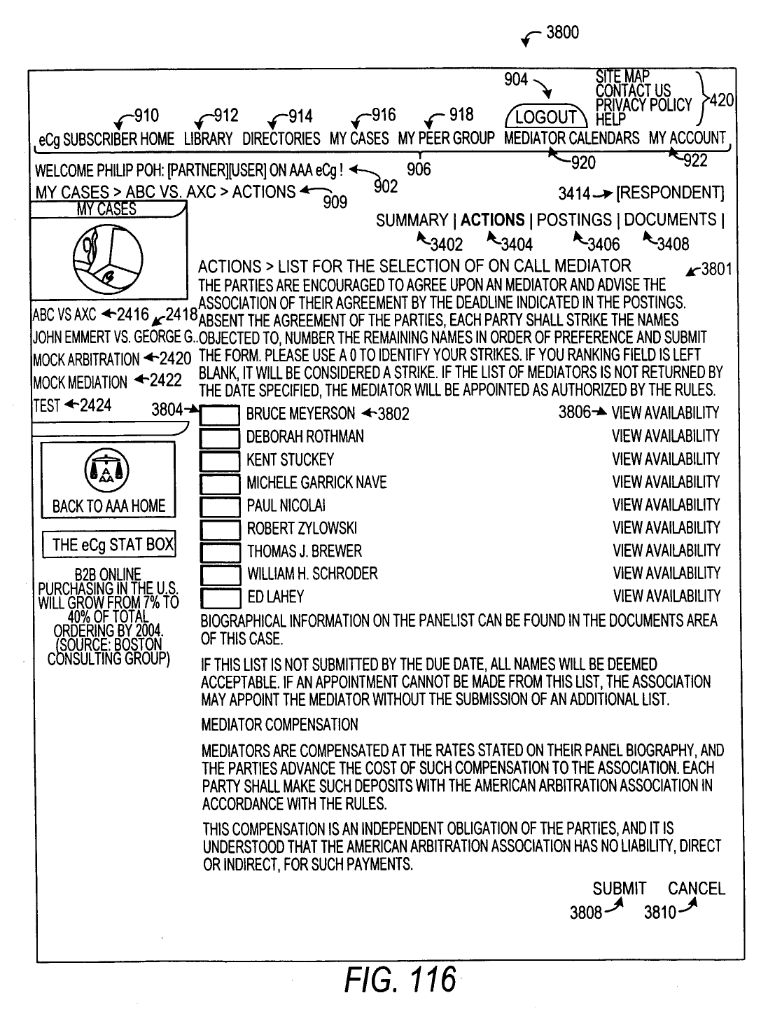

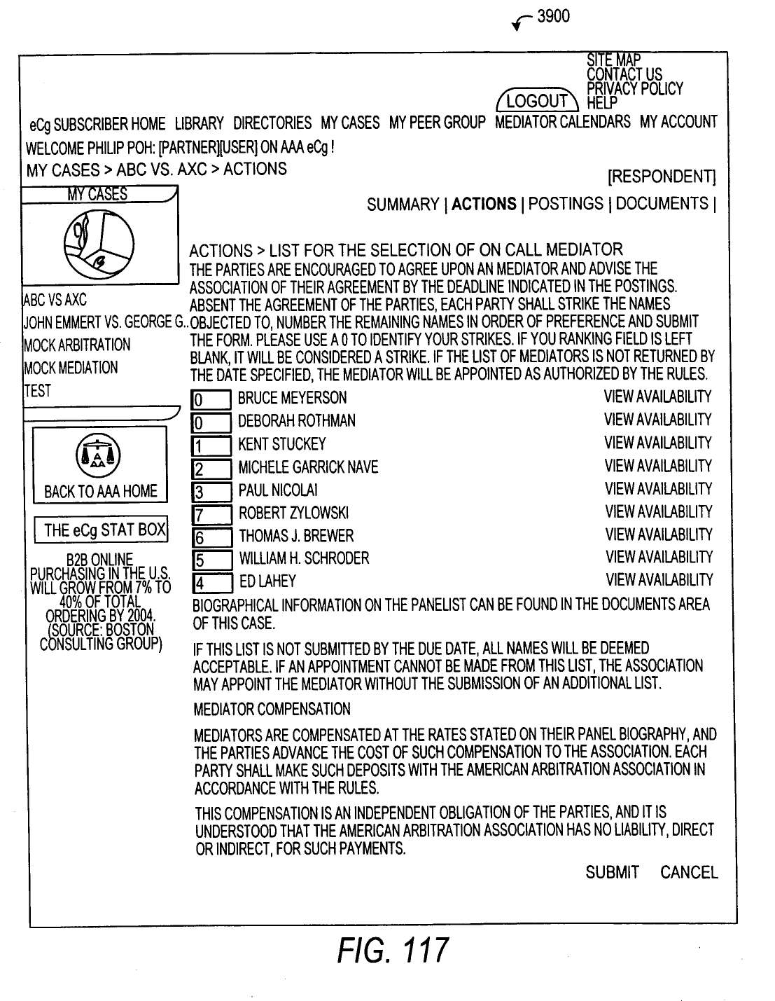

Some embodiments may prompt the user (e.g., a claimant-user or a respondent-user) to a selection process for choosing an arbitrator or mediator. Py striking the names of arbitrators or mediators objected to (e.g., by entering a “0”), ranking the remaining names in order of preference, and submitting the selection form, a user, such as a case manager, may determine the arbitrator for the case based at least in part on the rankings. Illustrative displays that may be provided to a user when the user is selecting an arbitrator or mediator are shown in FIGS. 116-117.

In some embodiments, the dispute management application may provide the user with an illustrative selection display 3800 as shown in FIG. 116 when the user selects “Rank Arbitrators or Mediators” option 3506 (as shown in FIG. 113). Although display 3800 shows a listing of mediators, in other displays, a listing of arbitrators may be shown. Display 3800 may include a list of mediators 3801. List 3801 may include the names of the mediators (e.g., a name field 3802), ranking fields associated with the names of the mediators (e.g., a ranking field 3804), and the availability of the mediators (e.g., a link 3806). When the user selects “View Availability” link 3806, the dispute management application may provide the user with, for example, a calendar indicating the selected mediator's available time slots. In some embodiments, the dispute management application may allow the user to rank the list of mediators 3801 in order of preference by, for example, placing a number into ranking fields 3804. In some embodiments, the user may input a “0” to strike a mediator from consideration. A completed mediation selection is shown in an illustrative display 3900 of FIG. 117.

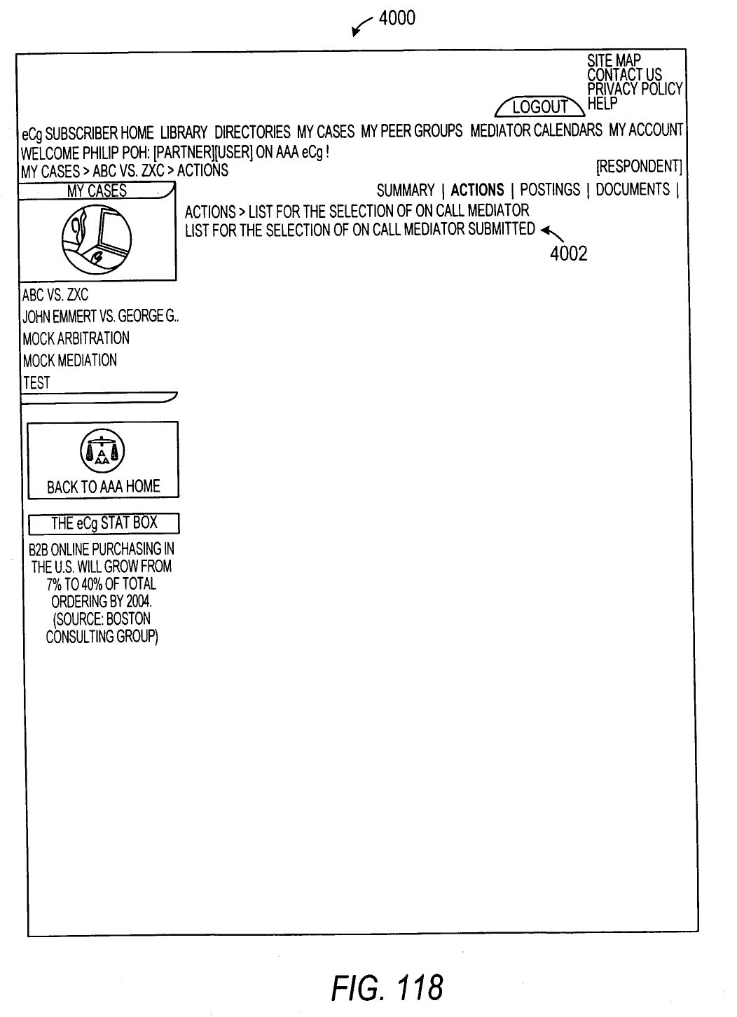

When the user has completed the mediator selection, the dispute management application may allow the user to submit the selection by, for example, selecting a “Submit” button 3808. When the user selects “Submit” button 3808, the dispute management application may notify the user that the response has been submitted as shown in FIG. 118.

In some embodiments, the user may cancel the response by, for example, selecting a “Cancel” button 3810. When the user selects “Cancel” button 3810, the dispute management application may return the user to actions display 3500 (FIG. 113) or any other suitable display.

In some embodiments, if the user does not submit a selection within a predetermined period of time, the dispute management application may automatically indicate that all of the mediators are acceptable. In some embodiments, the dispute management application may transmit reminder notifications to the user when the user has not completed the mediator selection.

In response to the user submitting an arbitrator or mediator selection, a user, such as a case manager-user or any other suitable user, may compare the mediator selections of the claimant-user and the respondent-user of the case. In some embodiments, the selection may have restricted viewing and may only be accessible to users, such as the submitting party, the arbitrator or mediator, and the case manager. In some embodiments, the dispute management application may allow the claimant-user to view the claimant-user's arbitrator or mediator selection. In some embodiments, the dispute management application may not allow the claimant-user to access or view the respondent-user's arbitrator or mediator selection. The case manager may select one or more arbitrators or mediators based at least in part on the rankings (e-g., an arbitrator/mediator agreed upon most by the disputing parties).

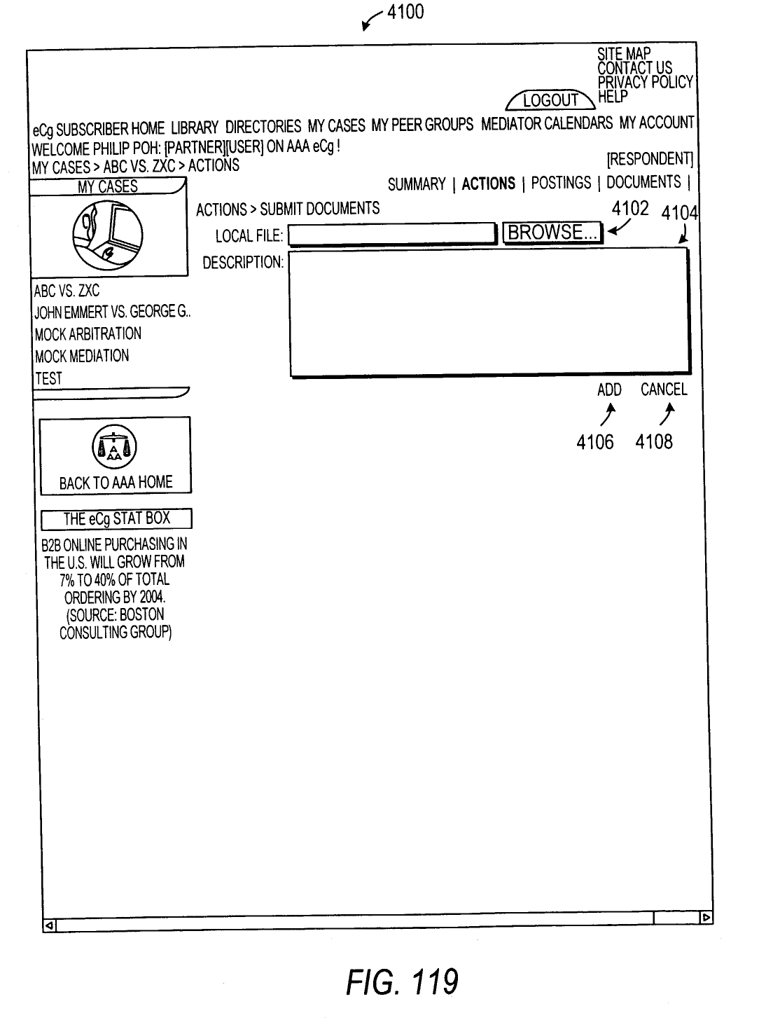

Some embodiments may provide users with a schedule for the submission of arguments, evidence, replies, and any other suitable information in document format. As shown in an illustrative document submission display 4100 of FIG. 119, the dispute management application may allow a user (e.g., a claimant-user or a respondent-user) to submit documents. Display 4100 may include file interface 4102 and description field 4014. File interface 4102 may include a “browse” button that allows the user to search through his or her current files. The user may input a description of the file into description field 4014. The arbitrator or mediator may view the documents and use the documents to assist him or her in the dispute. For example, documents submitted by the claimant-user and the respondent-user may assist the mediator in providing an understanding of the dispute.

The dispute management application may allow the user to submit the file by, for example, selecting an “Add” button 4106. When the user selects “Add” button 4106, the dispute management application may notify the user that the document has been submitted. In some embodiments, the user may cancel the submission by, for example, selecting a “Cancel” button 4108. When the user selects “Cancel” button 4108, the dispute management application may return the user to actions display 3500 (FIG. 113) or any other suitable display.

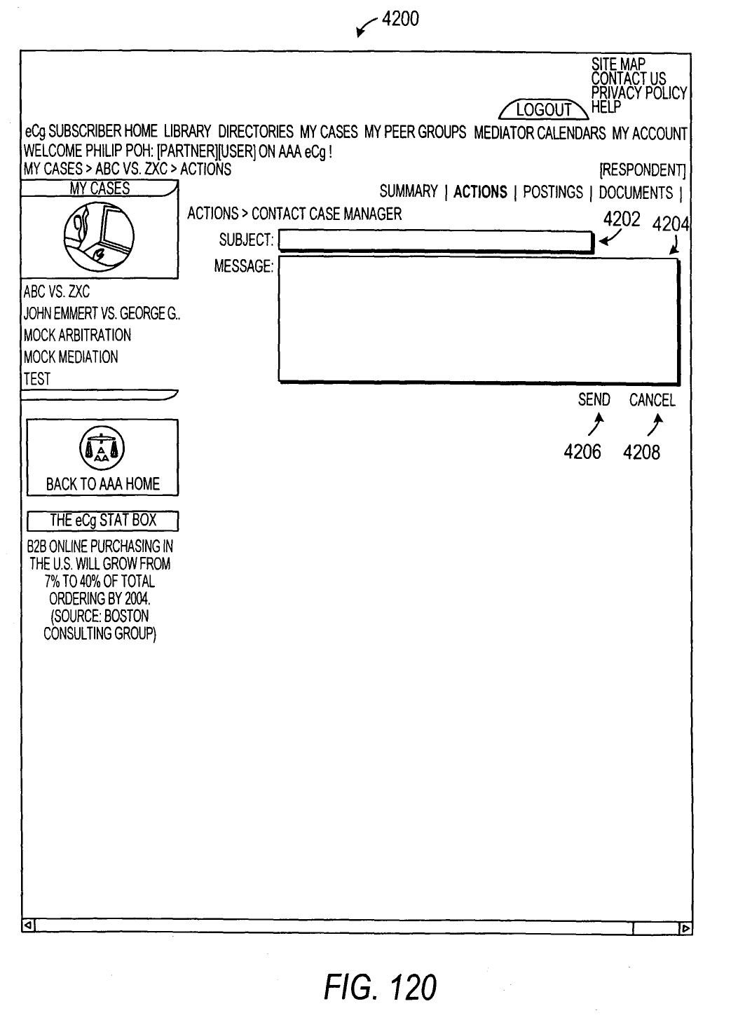

In some embodiments, the dispute management application may allow a user (e.g., a claimant-user, a respondent-user, or a neutral-user) to contact the case manager. An illustrative messaging display is shown in FIG. 120. Display 4200 includes text fields 4202 and 4204. The dispute management application may allow the user to enter a subject and message into text fields 4202 and 4204.

The dispute management application may allow the user to submit the message by, for example, selecting a “Send” button 4206. When the user selects “Send” button 4206, the dispute management application may notify the user that the message has been sent to the case manager. In some embodiments, the user may cancel the submission by, for example, selecting a “Cancel” button 4208. When the user selects “Cancel” button 4208, the dispute management application may return the user to actions display 3500 (FIG. 113) or any other suitable display.

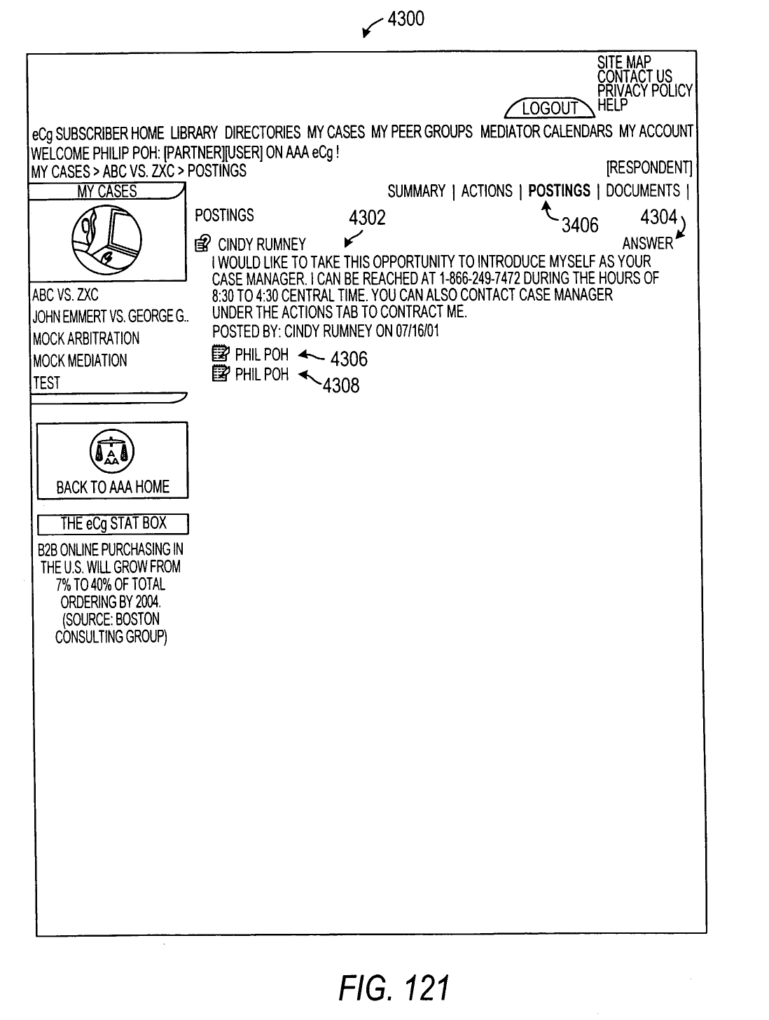

In some embodiments, the dispute management application may allow the case manager to communicate to the respondent, the claimant, neutrals, mediators, arbitrators, or any other suitable user. An illustrative postings display 4300 is shown in FIG. 121. The user may access postings display 4300 by, for example, selecting “Postings” tab 3406.

As shown in display 4300, a case manager-user (e.g., Cindy Rumney) may transmit a message 4302 to the participants of the case. In this example, the case manager-user posted an introduction, such as, for example, “I would like to take this opportunity to introduce myself as your Case Manager. I can be reached at 1-866-249-7472 during the hours of 8:30 to 4:30 Central Time. You can also use Contact Case Manager under the Actions tab to contact me.” In response to the posted message, a user (e.g., a claimant-user, a respondent-user, or a neutral-user) may respond to the message by, for example, selecting an “Answer” button 4304.

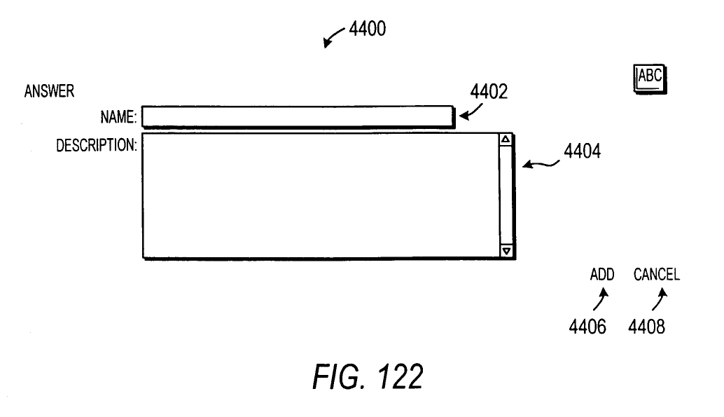

In response to a user selecting “Answer” button 4304, the user may be provided with an illustrative message interface as shown in FIG. 122. Display 4400 includes text fields 4402 and 4404. The dispute management application may allow the user to enter the user's name and a message into text fields 4402 and 4404.

The dispute management application may allow the user to submit the message by, for example, selecting an “Add” button 4406. When the user selects “Add” button 4406, the dispute management application may post the message (e.g., message 4306 and 4308). In some embodiments, the user may cancel the submission by, for example, selecting a “Cancel” button 4408. When the user selects “Cancel” button 4408, the dispute management application may return the user to actions display 3500 (FIG. 113), postings display 4300 (FIG. 121), or any other suitable display.

It should be noted that a user, such as the claimant and respondent, may respond to the messages posted by the case manager. In some embodiments, the claimant and respondent may not communicate to each other under the “Postings” tab.

In some embodiments, the dispute management application may allow a user (e.g., a claimant-user, a respondent-user, a case manager-user, or a neutral-user) to view documents submitted or posted relating to the case. For example, some embodiments may provide the user with mediator/arbitrator biographies to assist each party in making their selection. An illustrative documents display 4500 is shown in FIG. 123. The user may access documents display 4500 by, for example, selecting “Documents” tab 3408.

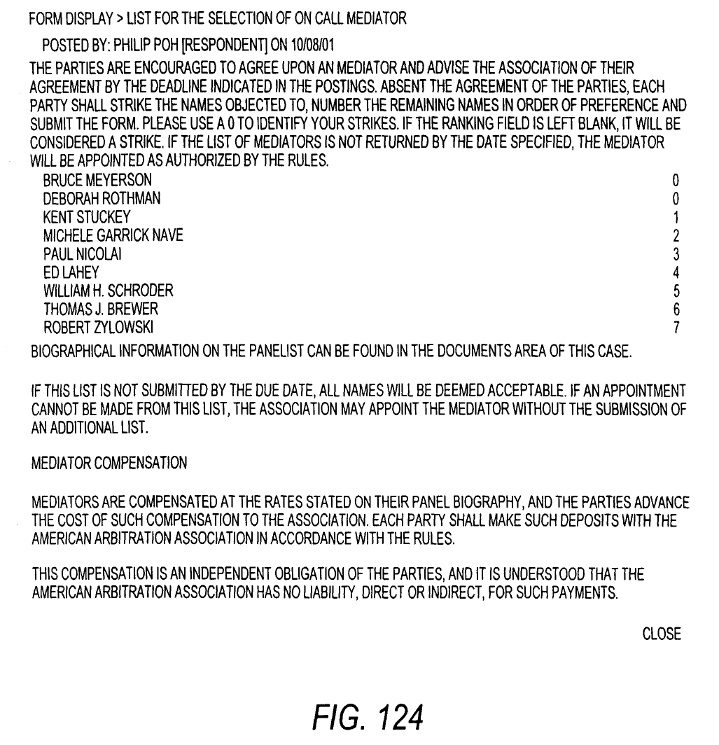

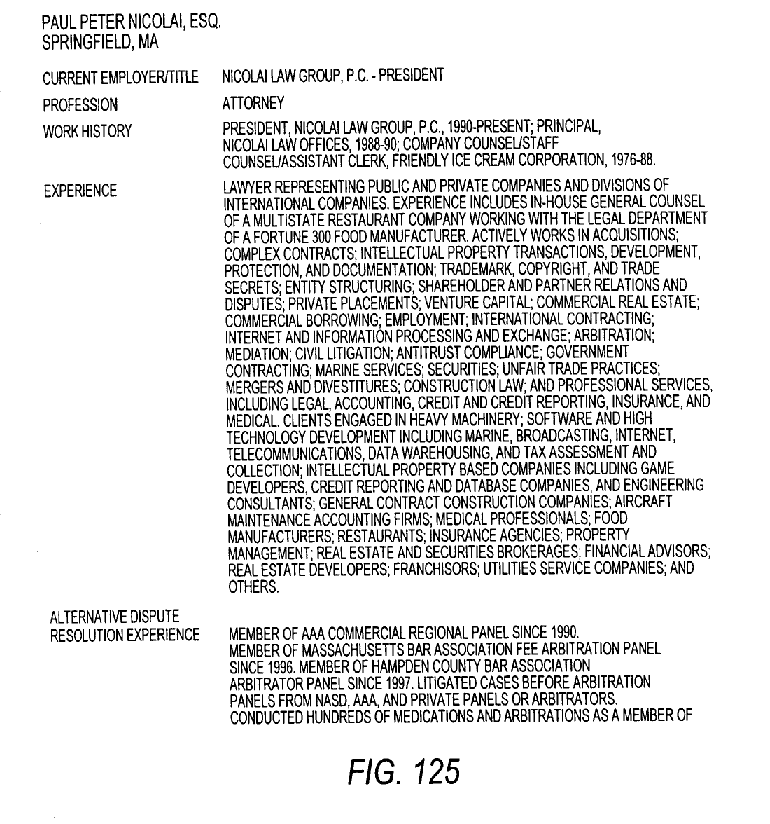

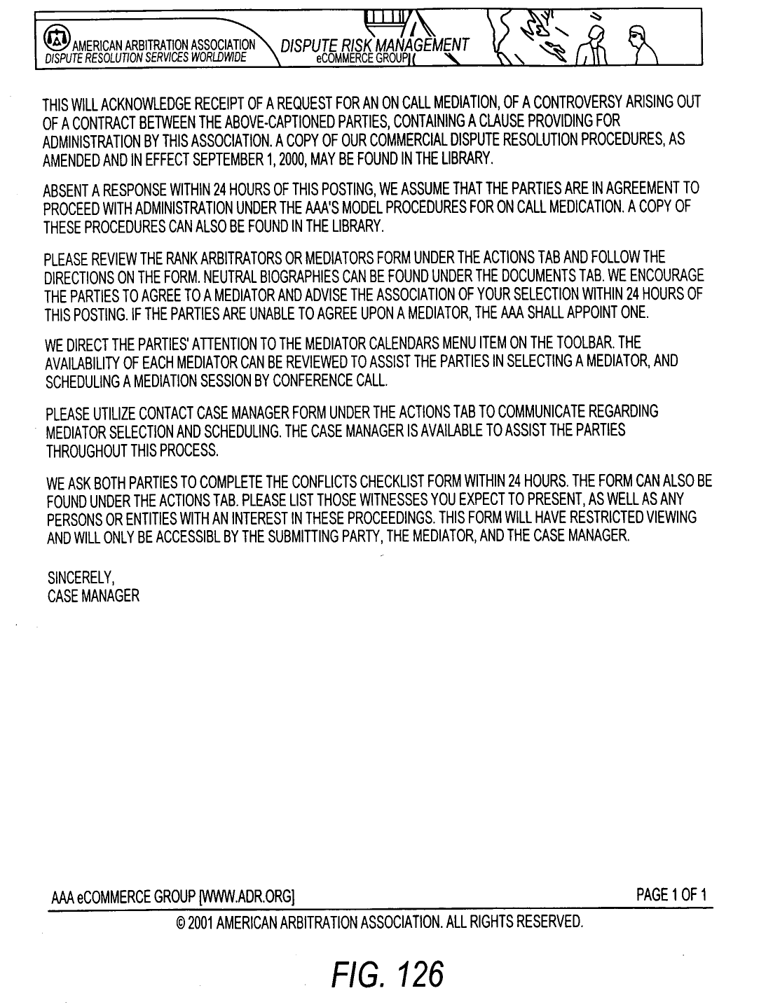

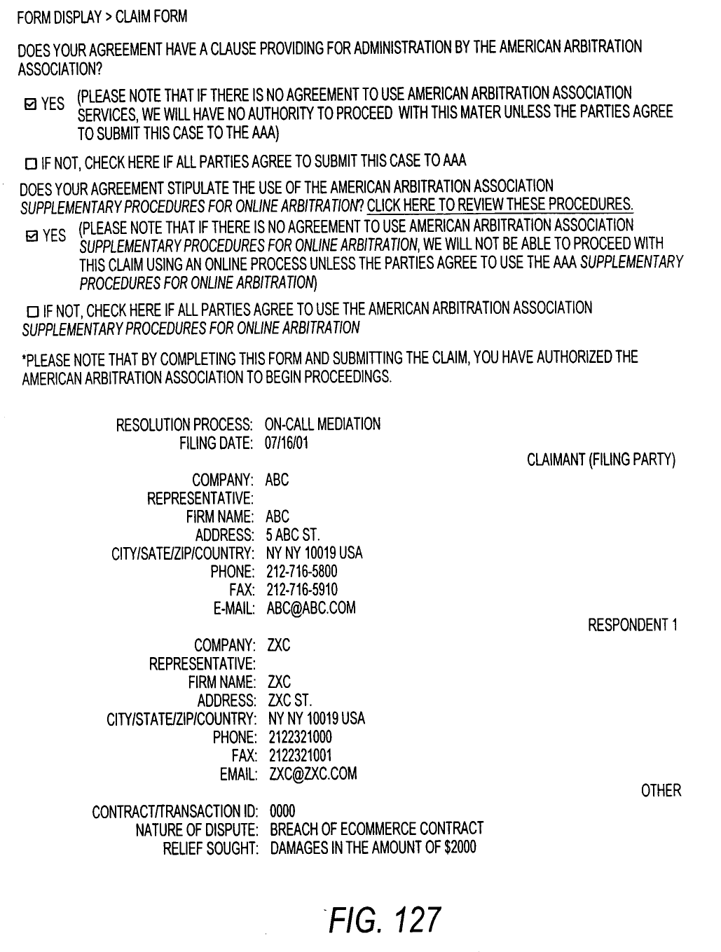

As shown in FIG. 123, the user is a respondent-user. In FIG. 123, display 4500 may provide the respondent-user with a list of one or more documents accessible to the user. For example, each document listing may include a description 4502, a “View” option 4504, and a “Download” option 4506. Description 4502 may include the title of the document, the name of the user that posted the document, the size of the document, and any other suitable information relating to the document. To view the document, the respondent-user may select “View” option 4504. To download the document, the respondent-user may select “Download” option 4506 option. In this example, the respondent-user may view or download the mediator selection (as shown in FIG. 124), mediator biographies (as shown in FIG. 125), a receipt of request for on-call mediation (as shown in FIG. 126), and the initial claim form (as shown in FIG. 127).

In some embodiments, when the user is a claimant-user, the dispute management application may provide the claimant-user with a list of documents relating to the claimant-user's submissions. For example, the dispute management application may allow the claimant-user to view the claimant-user's mediator selection.

In some embodiments, when the user is a case manager-user, the dispute management application may provide the case manager-user with a list of documents relating to the claimant-user's submissions and the respondent-user's submissions. For example, the dispute management application may allow the case manager-user to view the claimant-user's mediator selection and the respondent-user's mediator selection.

In response to the gubmimgions and responses from the claimant and respondent, the case manager along with the mediator or arbitrator may determine the resolution of the case. In some embodiments, the case manager may notify the disputing parties (i.e., the claimant and the respondent) that a decision has been rendered. In some embodiments, the dispute management application may inform the disputing parties to contact the case manager to obtain the decision. In some embodiments, the dispute management application may send a printed notification to the disputing parties that a decision has been rendered. For example, a printed notification may inform the disputing parties to contact the case manager and include the case manager's contact information.

For example, a mediation may be terminated by the execution of a settlement agreement by the disputing parties, by a written declaration of the mediator that further efforts at mediation are no longer worthwhile, or by a written declaration of a party or parties to the effect that the mediation proceedings are terminated. In some embodiments, such a document terminating the mediation may be stored electronically by the dispute management application.

In another example, if arbitration is selected as the resolution process, the disputing parties may be notified by the case manager of the document submission schedule. Each party may submit, for example, their opening and reply briefs in accordance with this schedule. The dispute management application may allow these briefs to be submitted electronically and posted under the “Documents” area (as shown in FIG. 123). The arbitration may proceed in the absence of a party who, after due notice, fails to file a submission by a predetermined time (e.g., a given due date). When the arbitrator determines that the record is complete, he or she may then declare the record closed.

Once the record is closed, the arbitrator may render a decision (e.g., make an award) based at least in part on the arguments and evidence presented by the disputing parties. In some embodiments, the dispute management application may allow the case manager to notify the disputing parties of the decision. In some embodiments, the dispute management application may send a printed notification to the disputing parties that a decision has been rendered. For example, a printed notification may inform the disputing parties to contact the case manager and include the case manager's contact information.

The “ABC vs. ZXC” case is an illustrative example for the user as a respondent in an On-Call Mediation. Other illustrative examples are shown in FIGS. 128-169. For example, in the “John Emmert vs. George George” case (FIGS. 128-135) and the “Mock Arbitration” case (FIGS. 136-150), the user is the claimant in a Documents-Only Arbitration. In the “Mock Mediation” case, the user is the case manager in an On-Call Mediation (shown in FIGS. 151-160). In the “test” case, the user is a neutral in a Documents-Only Arbitration (shown in FIGS. 161-169).

Some embodiments may provide a tool for managing e-mail, calendars, queues, data, and any other suitable information. With the increasing numbers of cases containing large amounts of information, users may require efficient and flexible data management tools. In some approaches, a user may have the capability of managing their personal calendar, as well as viewing and modifying the availability schedules for mediators and arbitrators. The user may also view upcoming tasks and overdue tasks. Additionally, neutrals and other users may have the capability to view specific disputes and track status of unique cases.

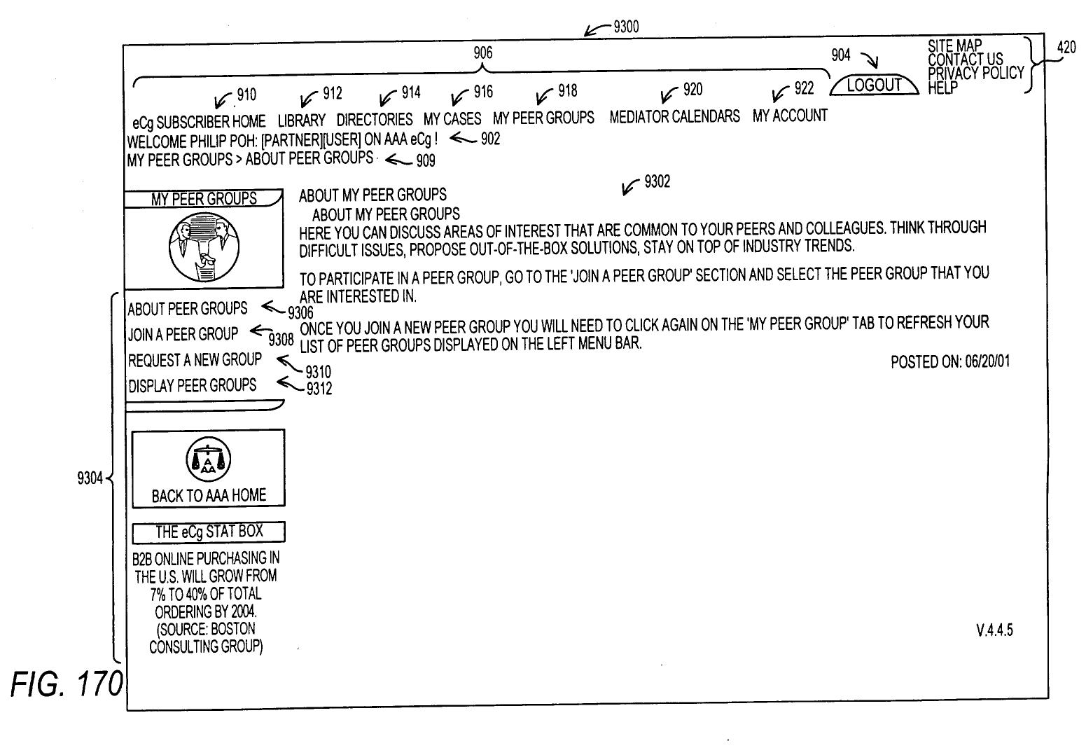

In some embodiments, the dispute management application may provide users with discussion areas, such as peer groups. Peer groups may provide users with an area to discuss issues, solutions, industry trends, or any other suitable topic. The dispute management application may provide the user with peer groups by, for example, selecting “My Peer Groups” link 918 in header portion 906. A peer groups display, such as illustrative peer groups display 9300, is shown in FIG. 170. Display 9300 includes an information area 9302 and a side bar 9304. Information area 9302 may include introductory information to the peer groups, such as, for example, notifying the user that the dispute management application may provide the user with access to discussion areas on a plurality of topics. The user may also access information area 9302 by, for example, selecting “About Peer Groups” link 9206 in side bar 9304.

Side bar 9304 may include links, such as, for example, “About Peer Groups” link 9306, a “Join a Peer Group” link 9308, a “Request a New Group” link 9310, a “Display Peer Groups” link 9312, and any other suitable link to services related to peer groups.

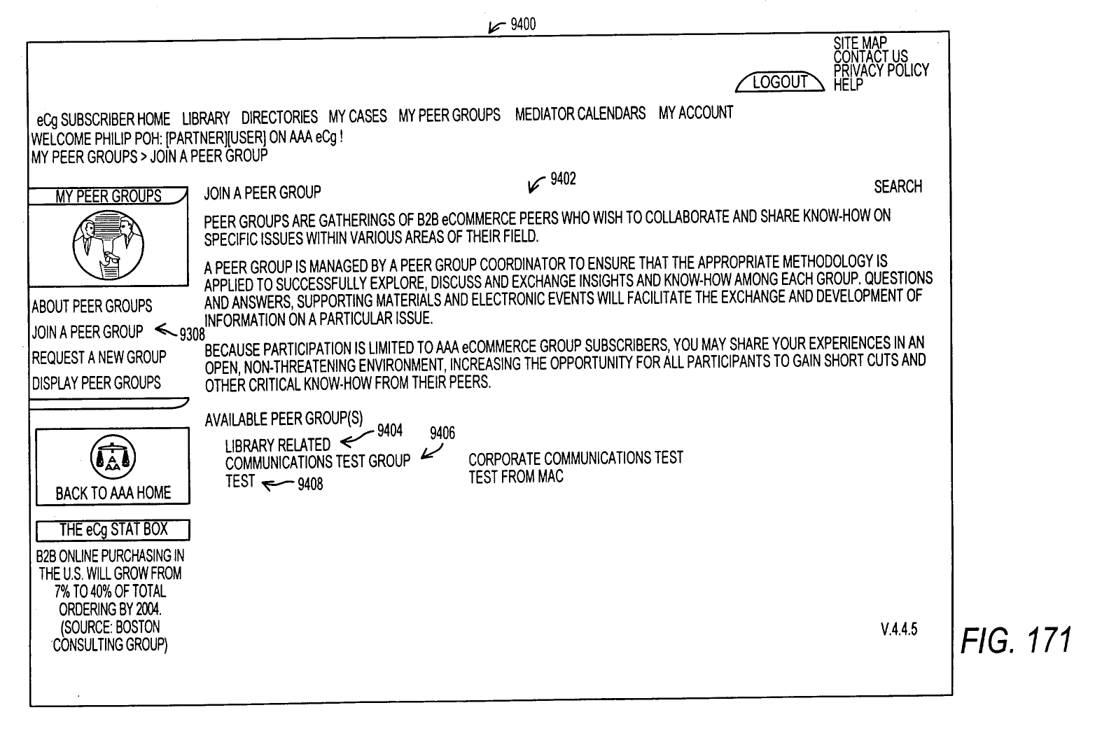

The dispute management application may allow the user to join a peer group by, for example, selecting “Join a Peer Group” link 9308. When the user selects link 9308, the dispute management application may provide the user with a display 9400, such as an illustrative display 9400 as shown in FIG. 171. Display 9400 includes information area 9402 which may include a list of available peer groups that the user may join. The list of available peer groups may, for example, include peer group links 9404-9408. The dispute management application may allow a user to join a peer group by selecting one of links 9404-9408.

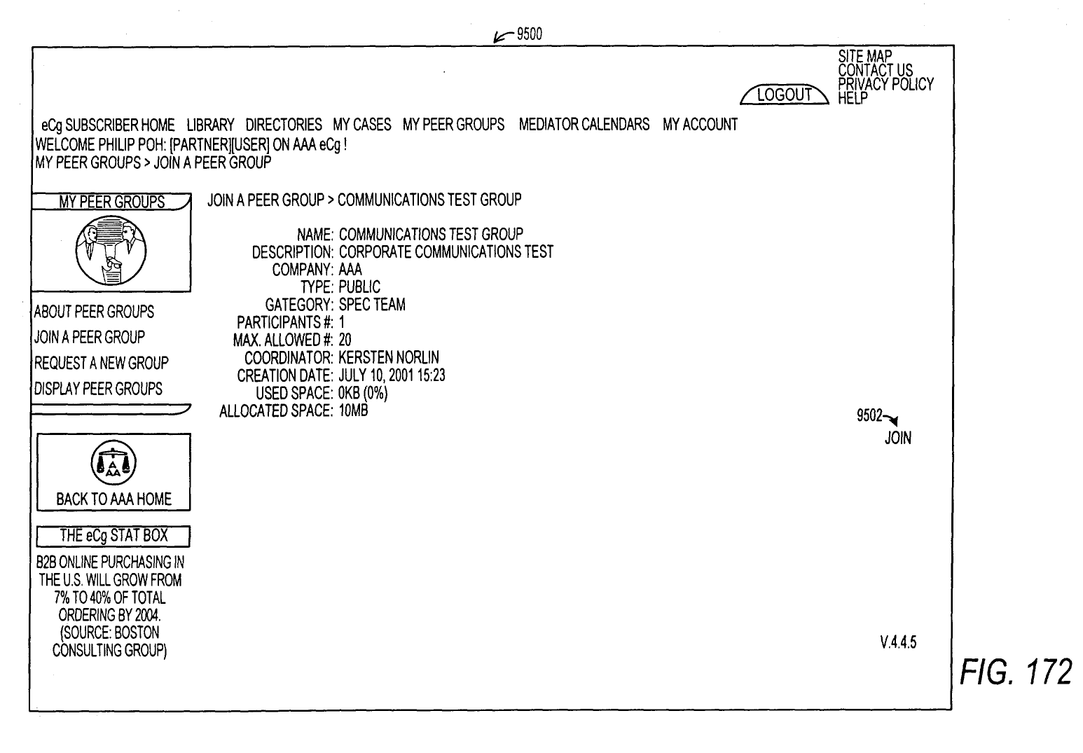

When a user selects, for example, “Communication Test Group” link 9406, the dispute management application may provide the user with a peer group summary display, such as illustrative peer group summary display 9500 as shown in FIG. 172. Display 9500 may include information relating to the “Communication Test Group.” Such information may include a description of the peer group, the number of participants, the name of the coordinator, and any other suitable information. The dispute management application may also provide the user with a “Join” button 9502.

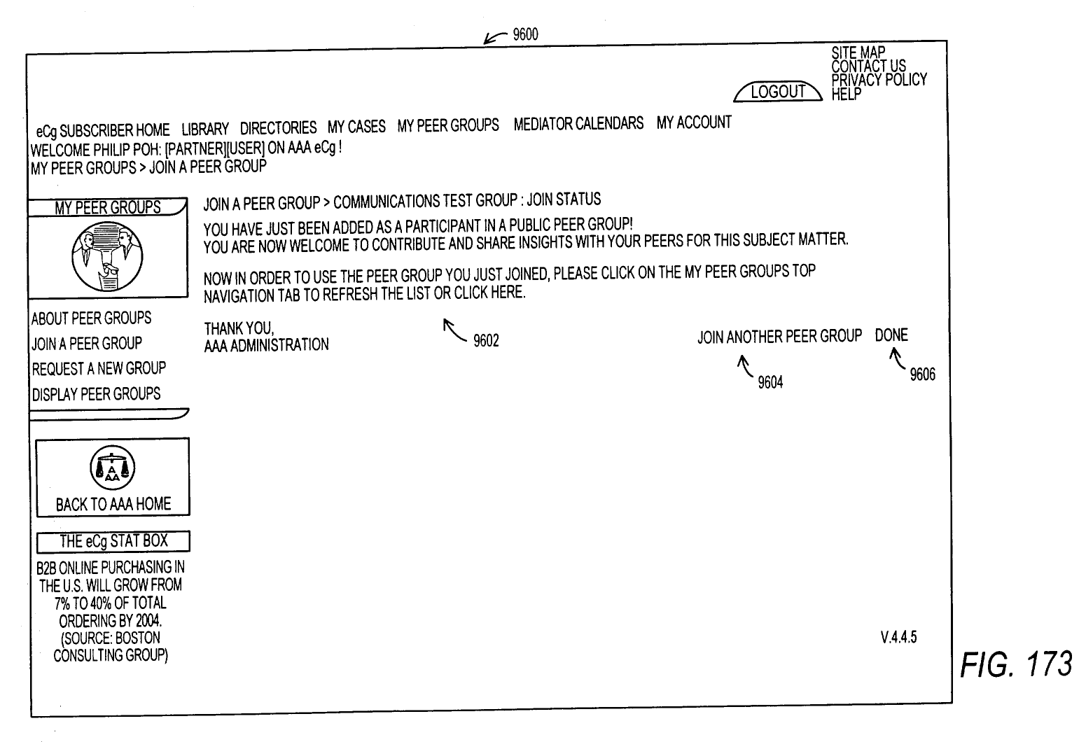

When the user selects “Join” button 9502, the dispute management application may provide the user with a status information display, such as illustrative status information display 9600 as shown in FIG. 173. Display 9600 includes a message 9602, a “Join Another Peer Group” button 9604, and a “Done” button 9606. Message 9602 may inform the user that the user has successfully joined the peer group. The dispute management application may allow the user to join another peer group by, for example, selecting “Join Another Peer Group” button 9604. When the user selects button 9604, the dispute management application may transfer the user back to display 9400 (FIG. 171). In some embodiments, the dispute management application may allow the user to indicate that the user has completed joining the desired peer groups by, for example, selecting “Done” button 9606. When the user selects button 9606, the dispute management application may transfer the user back to display 9400 (FIG. 171) or any other suitable display.

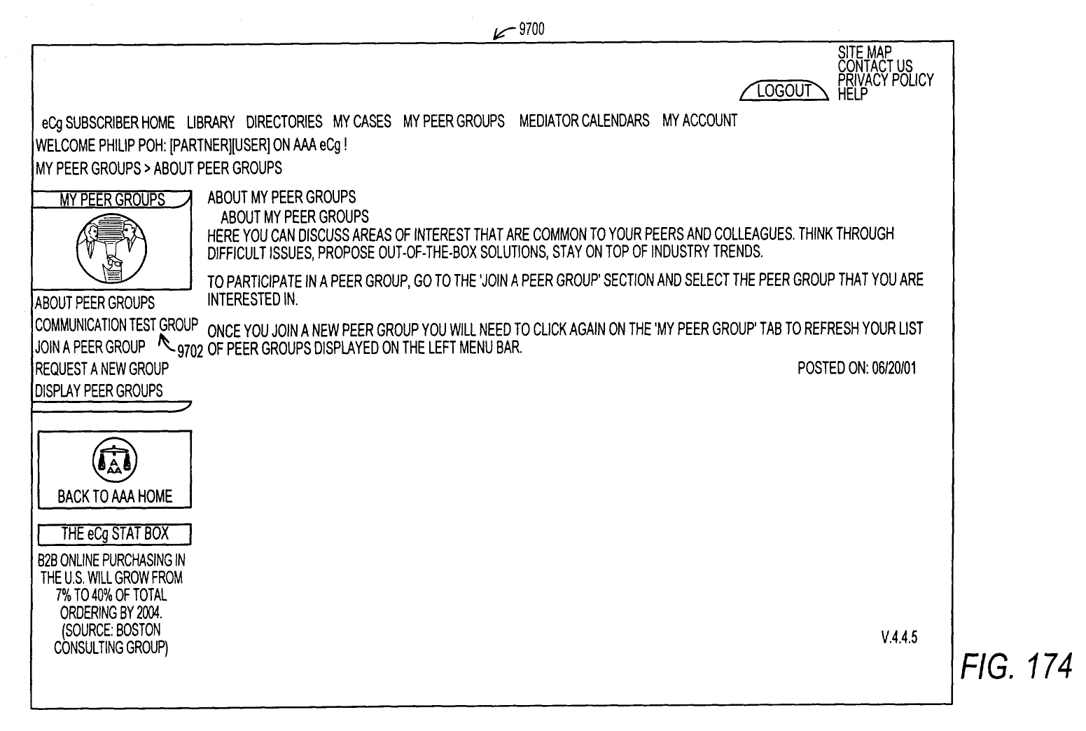

When the user returns to the peer groups menu display (as shown in FIG. 171), the dispute management application may indicate the peer groups that the user has joined. For example, the dispute management application provides the user with “Communications Test Group” link 9702 in side bar 9304 as shown in FIG. 174. The dispute management application may allow the user to access the “Communications Test Group” peer group by, for example, selecting link 9702 from side bar 9304.

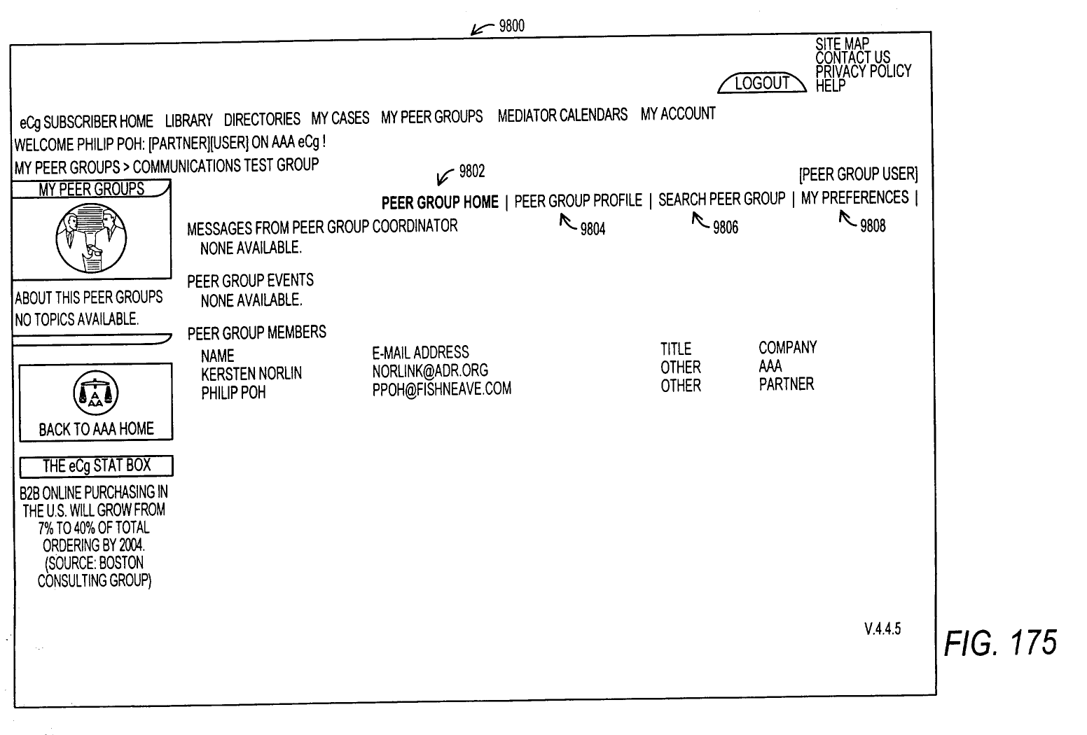

When the user selects link 9702, the dispute management application may provide the user with a peer group home display, such as illustrative peer group home display 9800 as shown in FIG. 175. Display 9800 may include messages from the peer group coordinator, a listing of events, a listing of members, or any other suitable information.

In some embodiments, the dispute management application may provide users with tabs 9802-9808, such as a “Peer Group Home” tab 9802, a “Peer Group Profile” tab 9804, a “Search Peer Group” tab 9806, and a “My Preferences” tab 9808. In practice, tabs 9802-9808 shown in FIGS. 175-178 may be displayed in any suitable order, some may be deleted, and others added.

In some embodiments, the dispute management application may highlight the tab to indicate the user's current selection. As shown in display 9800, “Peer Group Home” tab 9802 is highlighted. However, any other suitable approach may also be used. For example, the dispute management application may change the color of the tab selected by the user.

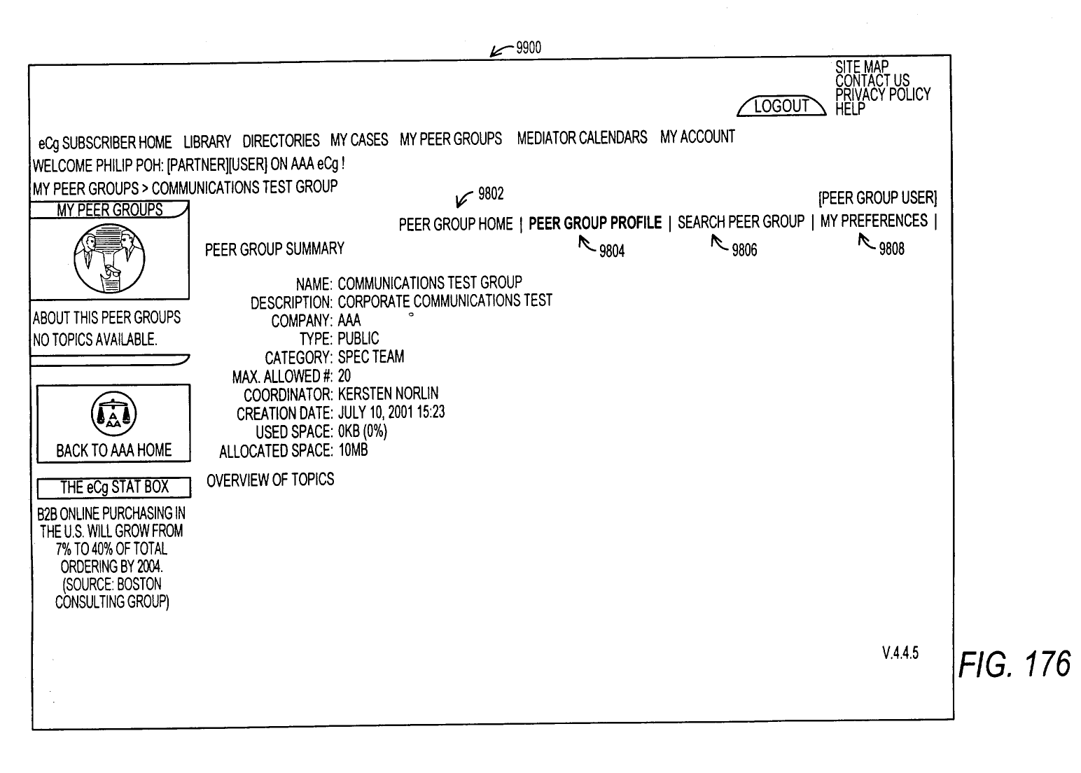

When the user selects tab 9804, the dispute management application may provide the user with a profile display, such as illustrative peer group profile display 9900 as shown in FIG. 176. Display 9900 may include a summary of the selected peer group and a listing of discussion topics within the selected peer group.

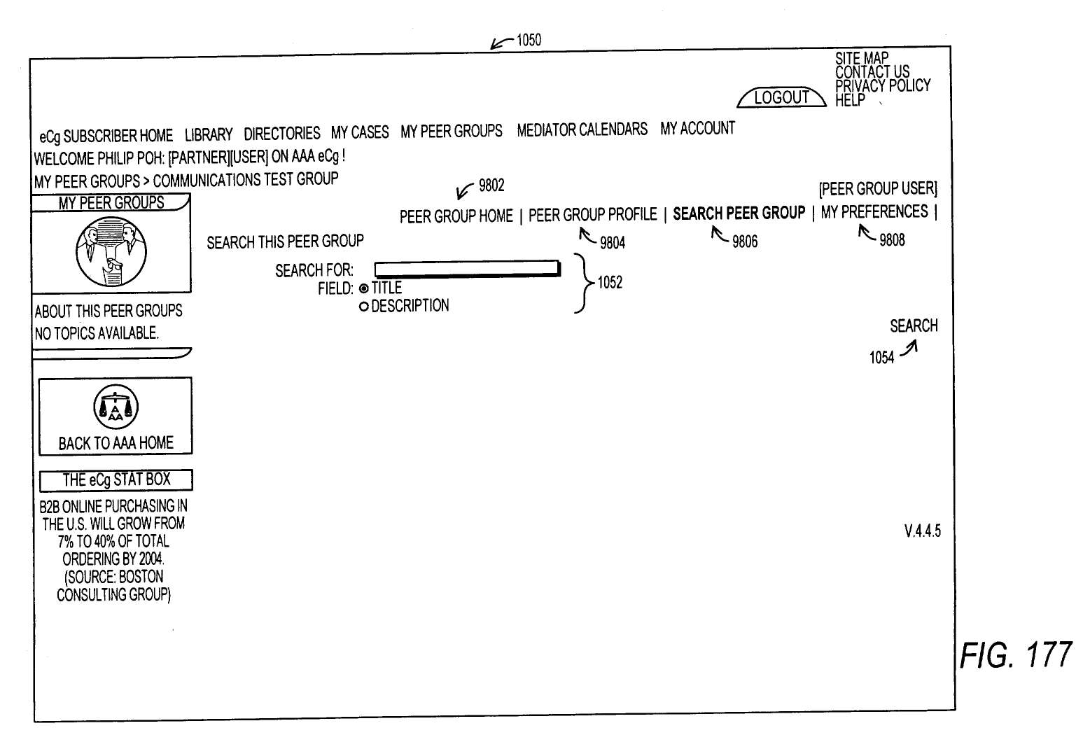

When the user selects tab 9806, the dispute management application may provide the user with a searching display, such as illustrative searching display 1050 as shown in FIG. 177.

Display 1050 may include searching interface 1052. The dispute management application may allow the user to input keywords. The searching interface may also allow the user to select search criteria, such as, for example, search by title or search by description. In response to an inputted keyword and the user selecting a “search” button 1054, the dispute management application may search for matching resources or filter out resources within the peer group that do not match the keywords. As discussed in FIG. 31, the dispute management application may provide the search results in a combined display or in a separate display.

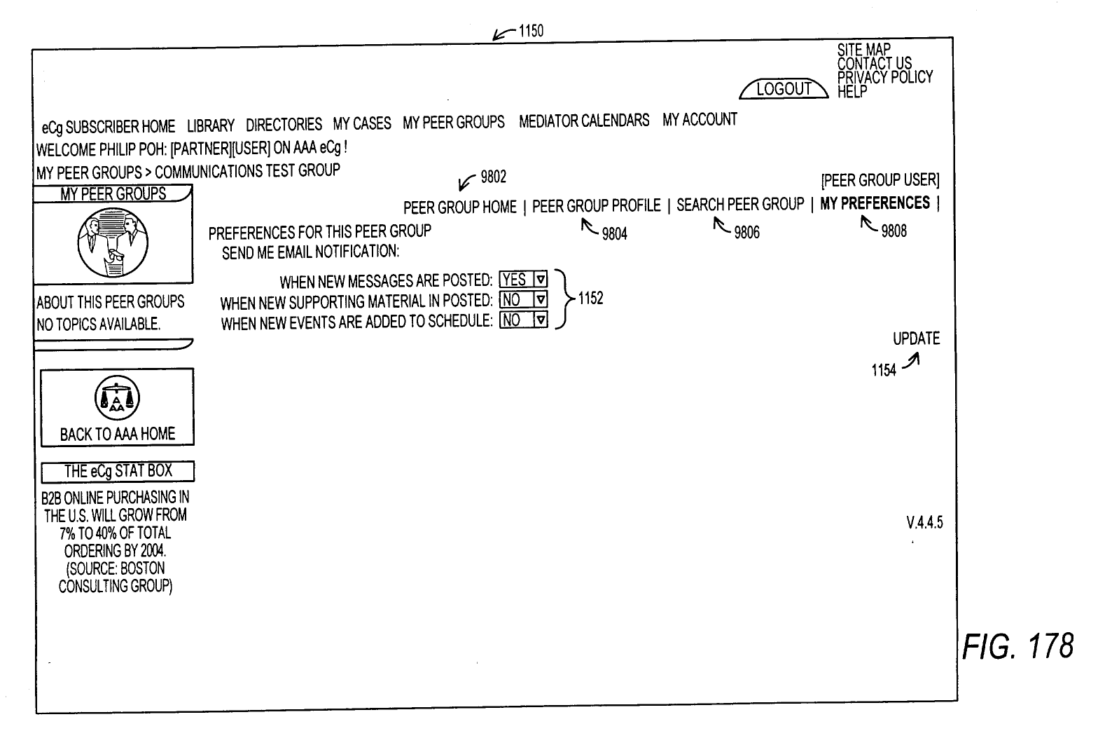

When the user selects tab 9808, the dispute management application may provide the user with a preferences display, such as illustrative peer group preferences display 1150 as shown in FIG. 178. Display 1150 may include a list of preferences and drop-down boxes 1152. The listing may include preferences, such as “Send Me an E-mail Notification when New Messages are Posted?” or any other suitable preferences. The associated drop-down box may allow the user to indicate a response, such as “Yes” or “No.” When the user has completed indicating his or her preferences, the dispute management application may allow the user to submit the user's preferences by, for example, selecting an “Update” button 1154. When the user selects “Update” button 1154, the dispute management application may provide the user with a message informing the user that the user's preferences have been submitted.

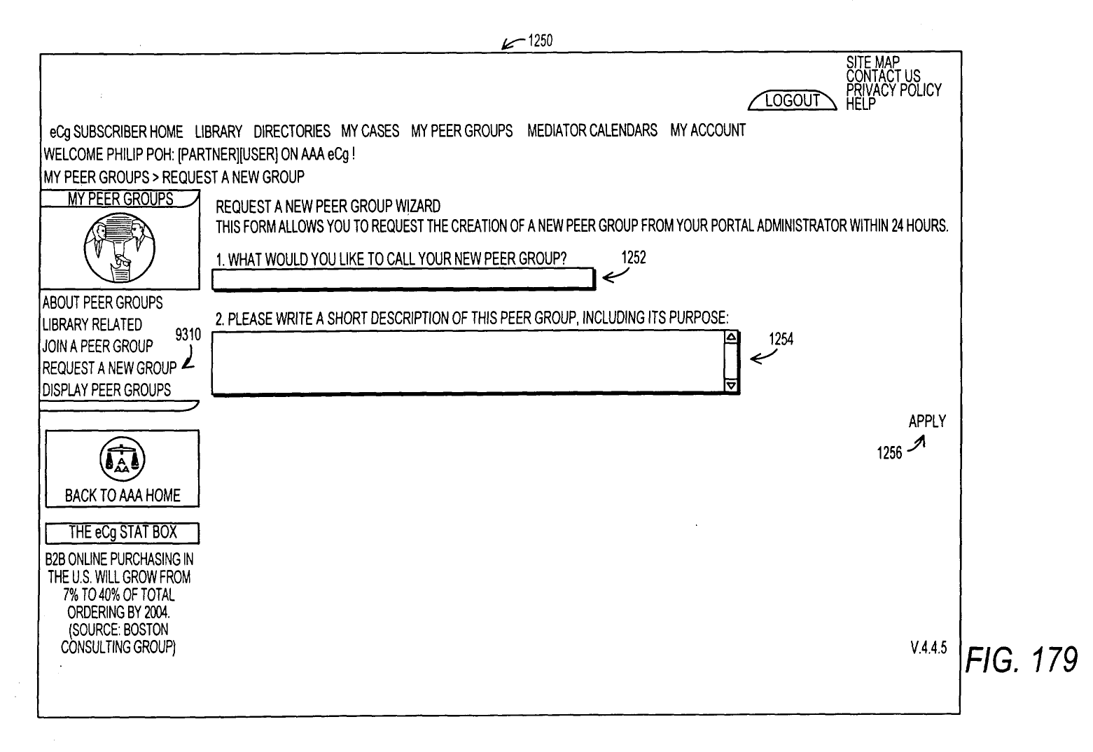

In some embodiments, the dispute management application may allow the user to create or request a new peer group. When the user selects “Request a New Group” link 9310 from side bar 9304, the dispute management application may provide the user with a request display, such as illustrative request display 1250 (FIG. 179). As shown in FIG. 102, display 1250 may include text fields 1252 and 1254. The user may input the name of the new peer group, a description of the new peer group, and any other suitable information relating to the new peer group. When the user has inputted the information relating to the new peer group, the dispute management application may allow the user to apply for the new peer group by, for example, selecting an “Apply” button 1256. In some embodiments, when the user selects “Apply” button 1256, the dispute management application may determine whether or not to create the new peer group. In some embodiments, the dispute management application may allow an administrator or moderator to determine whether or not to create the new peer group.

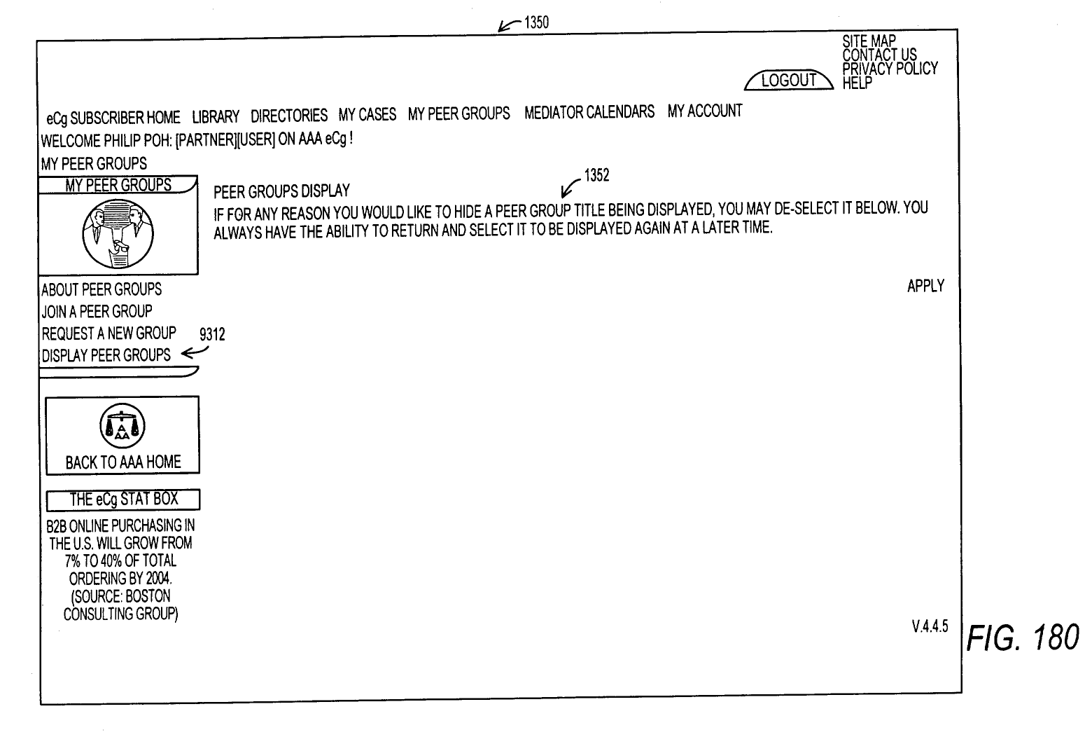

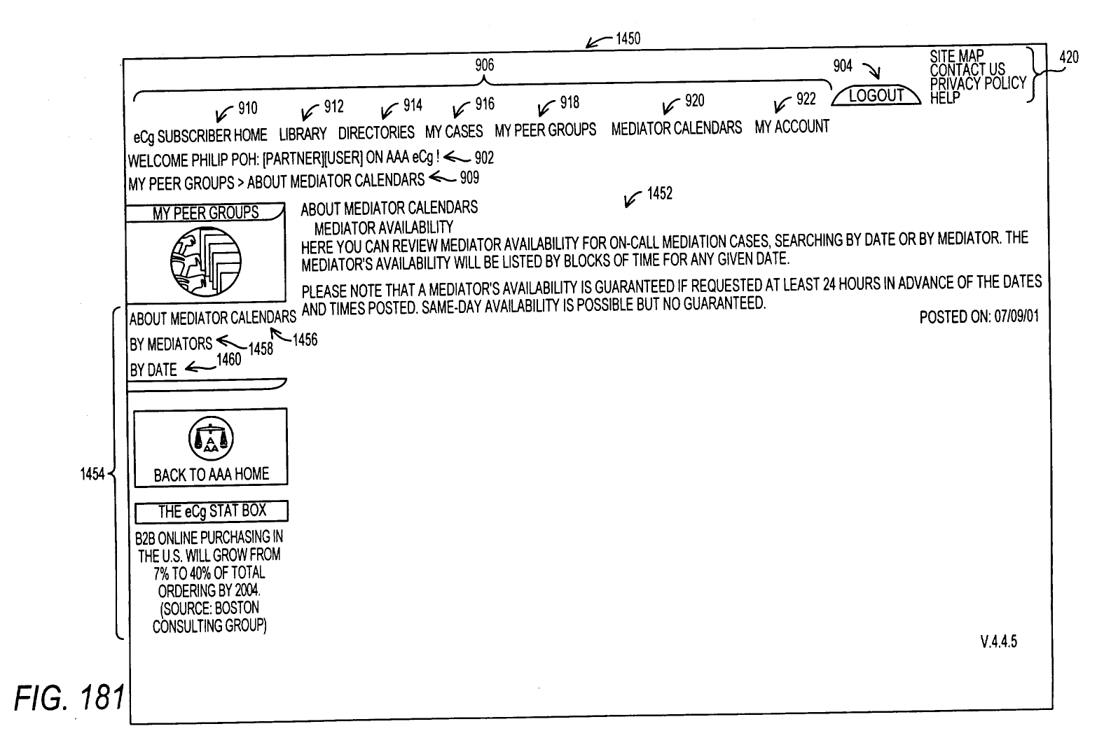

In some embodiments, the dispute management application may allow the user to view peer groups that the user has joined. When the user selects “Display Peer Group” link 9312 from side bar 9304, the dispute management application may provide the user with a peer groups display, such as illustrative peer groups display 1350 (FIG. 180). Display 1350 may include a list of peer groups that the user has joined.

In some embodiments, the dispute management application may provide the user with mediator calendars. Users may desire to review mediator availability for on-call mediation cases. The dispute management application may provide the user with mediator availability by, for example, selecting “Mediator Calendars” link 920 in header portion 906. A mediator availability menu display, such as illustrative mediator availability menu display 1450, is shown in FIC. 181. Display 1450 includes an information area 1452 and a side bar 1454. Information area 1452 may include introductory information to mediator calendars, such as, for example, notifying the user that the dispute management application may provide a user with access to mediator availability for on-call mediation cases, searching by date or by mediator. The user may also access information area 1452 by, for example, selecting a “About Mediator Calendars” link 1456 in side bar 1454.

Side bar 1454 may include links, such as, for example, “About Mediator Calendars” link 1456, a “By Mediators” link 1458, a “By Date” link 1450, and any other suitable link to services related to mediator availability.

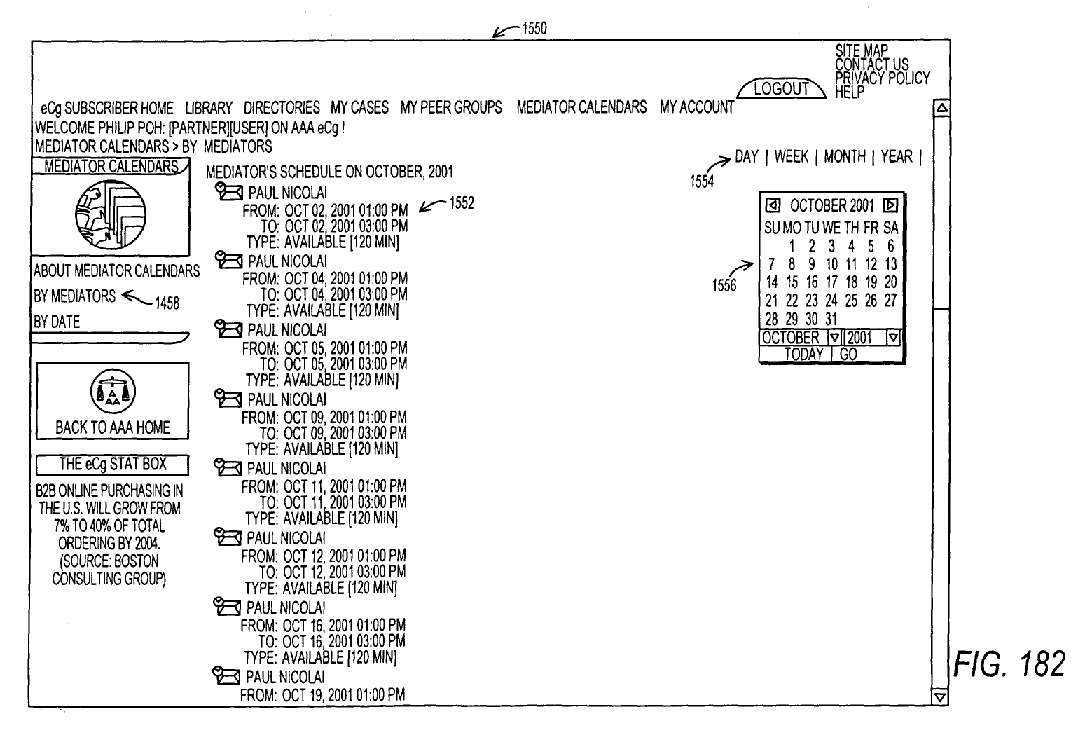

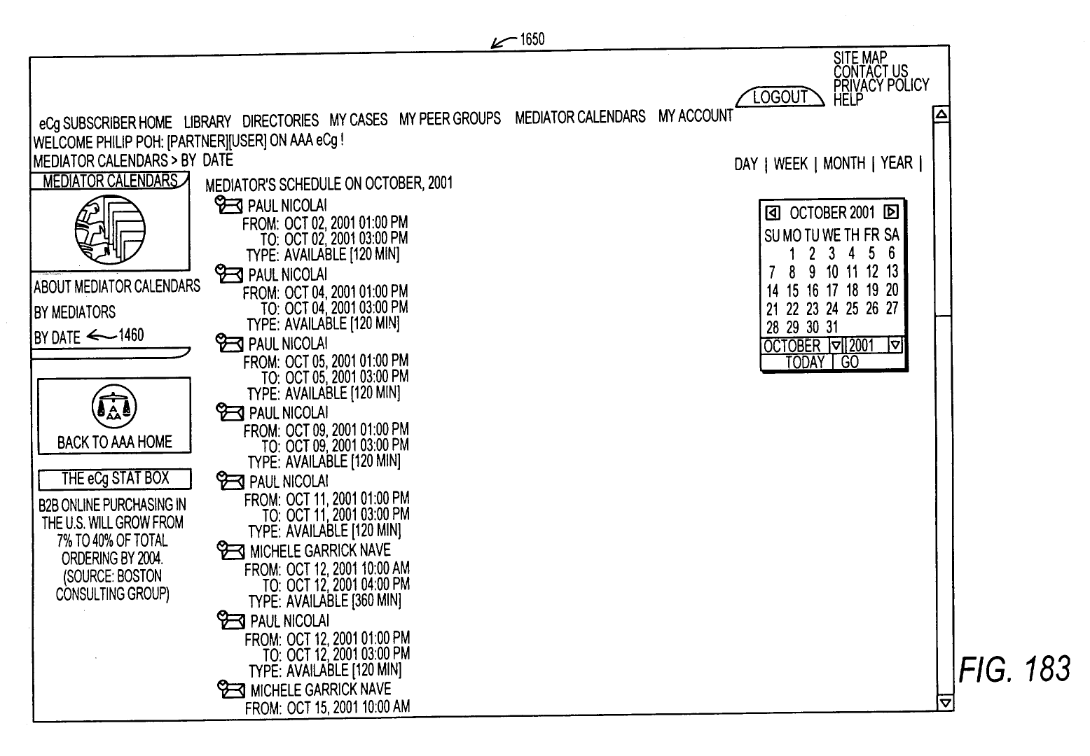

The dispute management application may allow the user to search for mediator availability by mediator or by date. Search displays, such as illustrative mediator search displays 1550 and 1650, are shown in FIGS. 182 and 183, respectively. In FIG. 182, display 1550 includes a listing of available mediators 1552. Display 1550 may also include a calendar interface 1554. The user may indicate whether to view a calendar 1556 by day, week, month, or year. In this example, the user has selected to view a monthly calendar for October 2001.

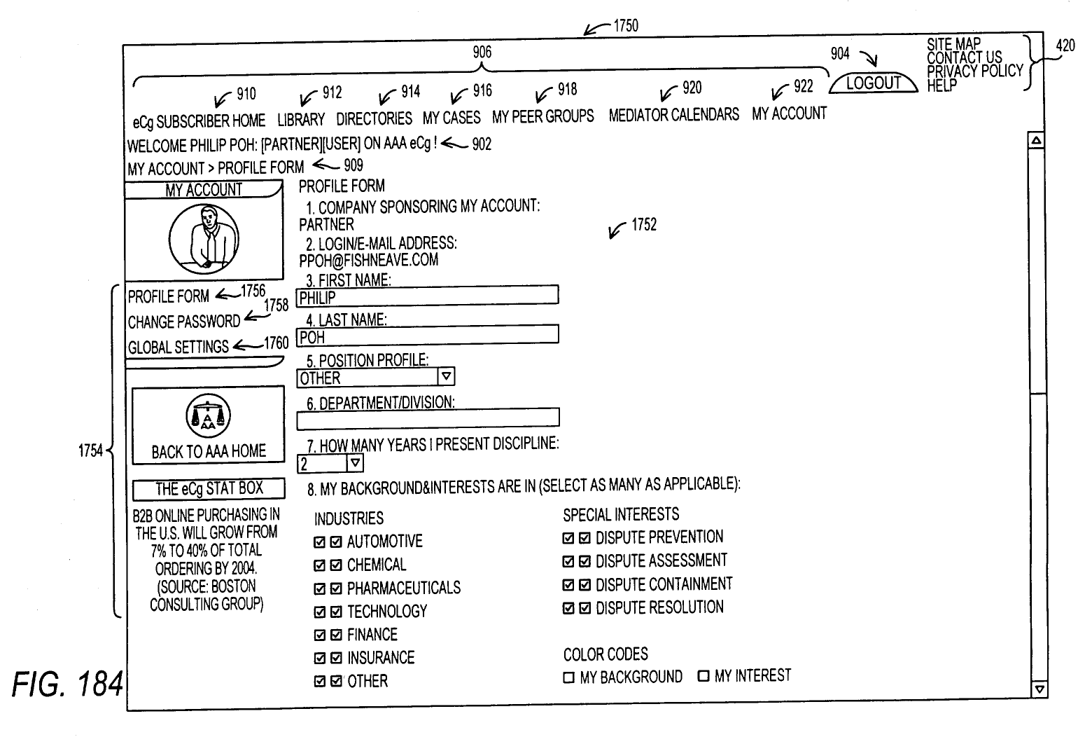

In some embodiments, the dispute management application may allow the user to modify the user's profile. Users may desire to change information in the user's profile, change a password, change global settings, or any other suitable action. The dispute management application may provide the user with account information by, for example, selecting “My Account” link 922 in header portion 906. An account information menu display, such as illustrative account information menu display 1750, is shown in FIG. 184. Display 1750 includes an information area 1752 and a side bar 1754. Information area 1752 may include user information such as, for example, the user's first name, last name, position, department, number of years at the position, interests, background information, and any other suitable information. The user may also access information area 1752 by, for example, selecting a “Profile Form” link 1756 in side bar 1054.

Side bar 1754 may include links, such as, for example, “Profile Form” link 1756, a “Change Password” link 1758, a “Global Settings” link 1760, and any other suitable link to services related to the user profile.

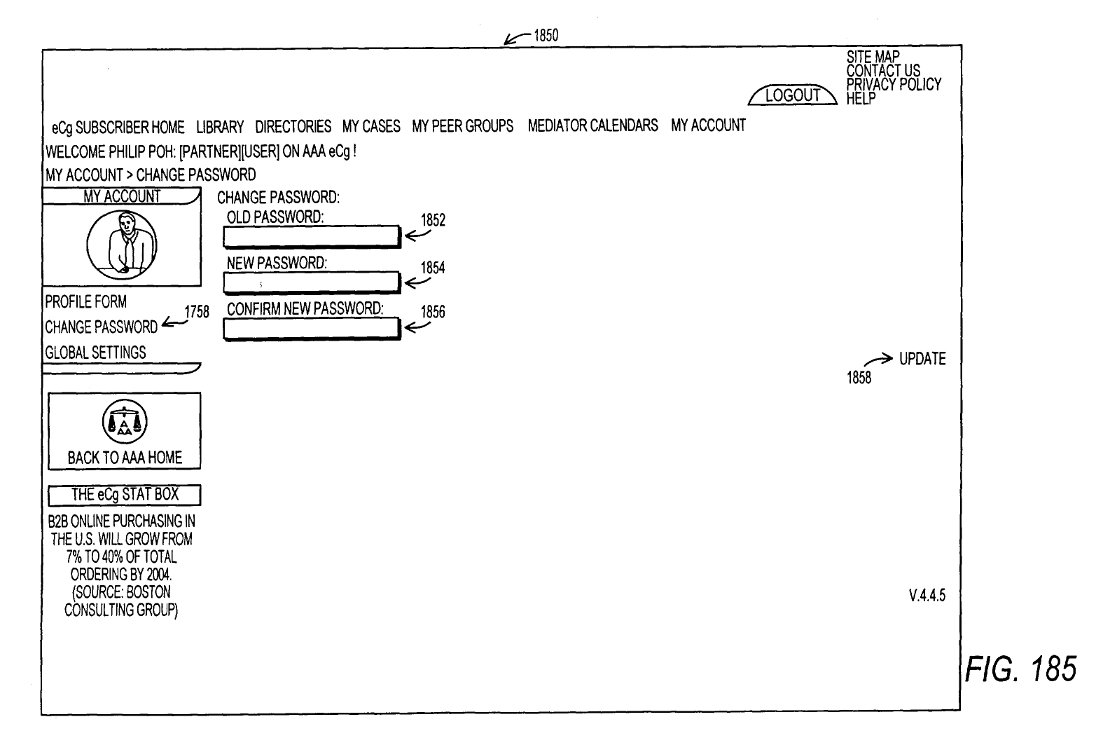

The dispute management application may allow the user to change the user's password. A password display, such as illustrative password display 1850, is shown in FIG. 185. In FIG. 185, display 1850 includes text fields 1852-1856. As shown in FIG. 185, the dispute management application allows the user to input the user's old password into text field 1852, the new password into text field 1854, and a confirmation of the new password into text field 1856. When the user inputs the passwords into text fields 1852-1856, the dispute management application may automatically convert the characters of the password to an indistinguishable form (e.g., replacing the numbers the character with asterisks).

When the user has completed entering the new password into text fields 1854 and 1856, the dispute management application may allow the user to submit the new password by, for example, selecting an “Update” button 1858. When the user selects button 1858, the dispute management application may notify the user that the new password has been entered.

In some embodiments, the dispute management application may allow the user to change global settings in the dispute management application. A settings display, such as illustrative settings display 1950, is shown in FIG. 186. For example, the dispute management application may prompt the user to indicate the user's desired e-mail notification format. Display 1950 includes drop-down field 1952.

When the user has completed inputting the desired global settings (e.g., HTML e-mail notifications), the dispute management application may allow the user to submit the global settings by, for example, selecting an “Update” button 1954.

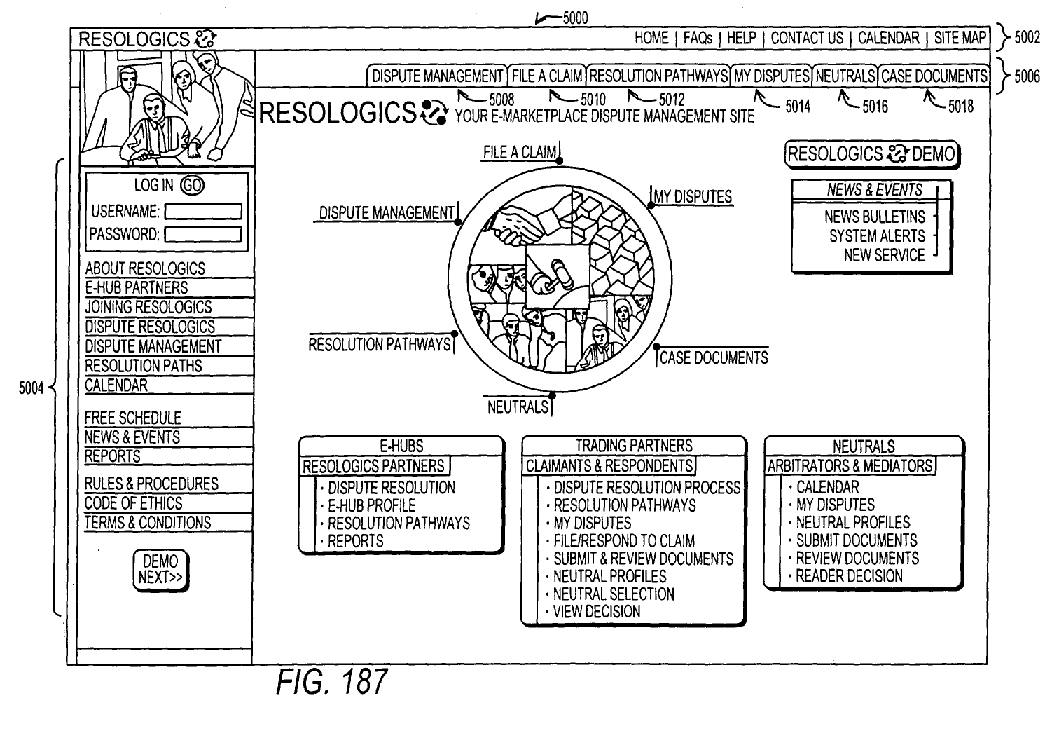

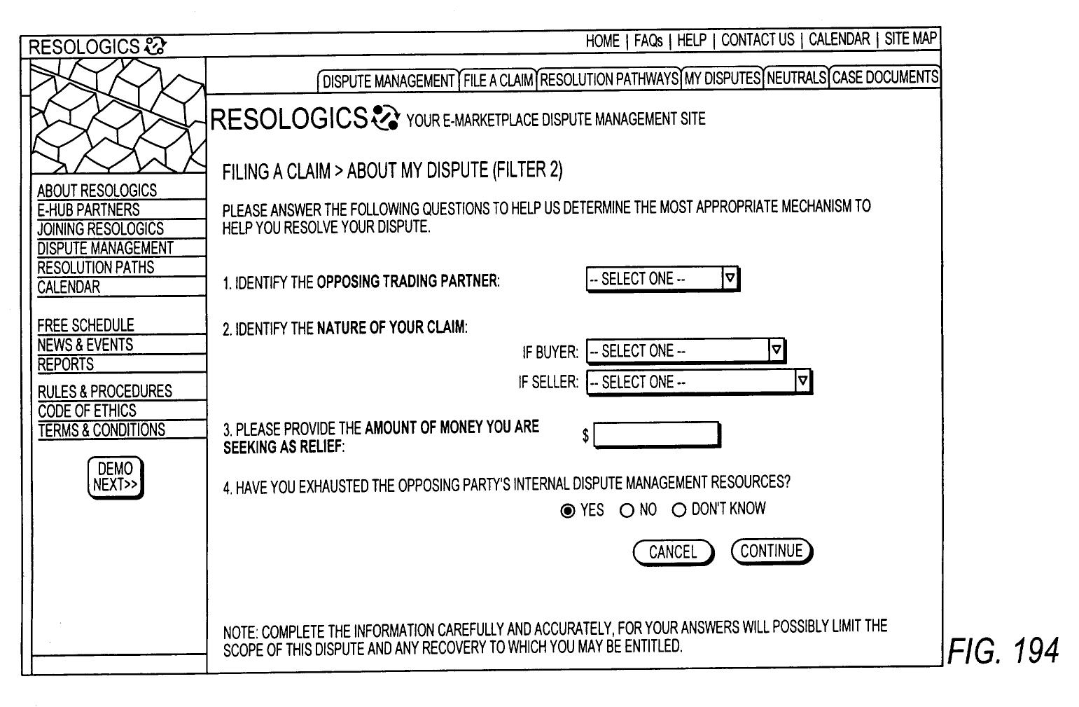

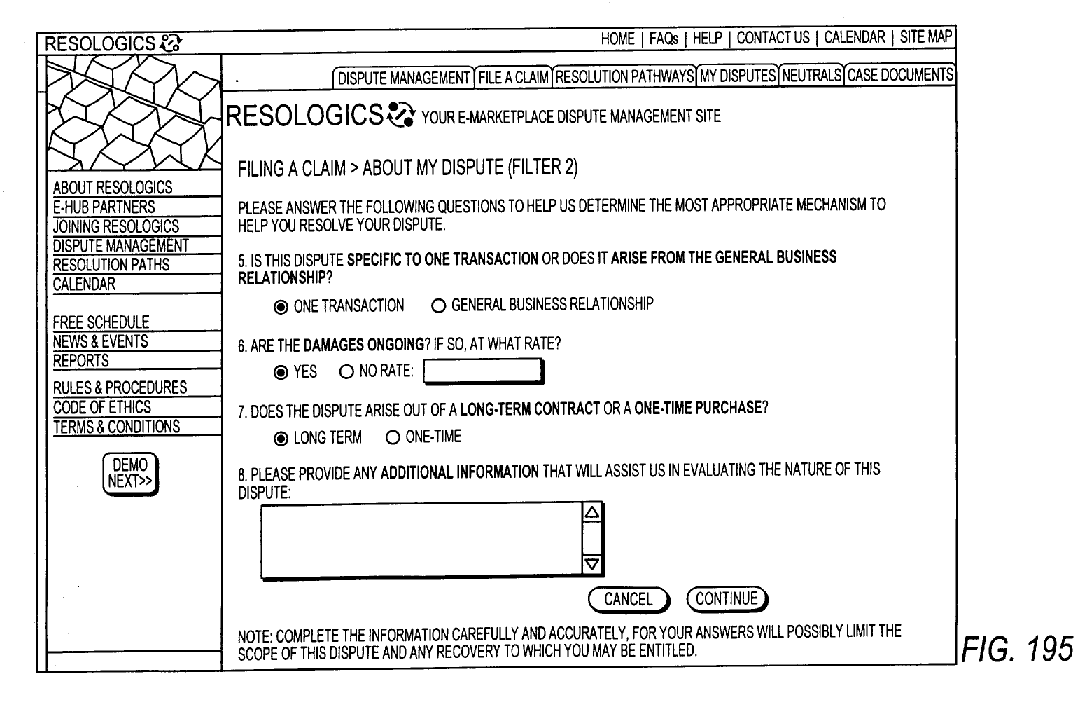

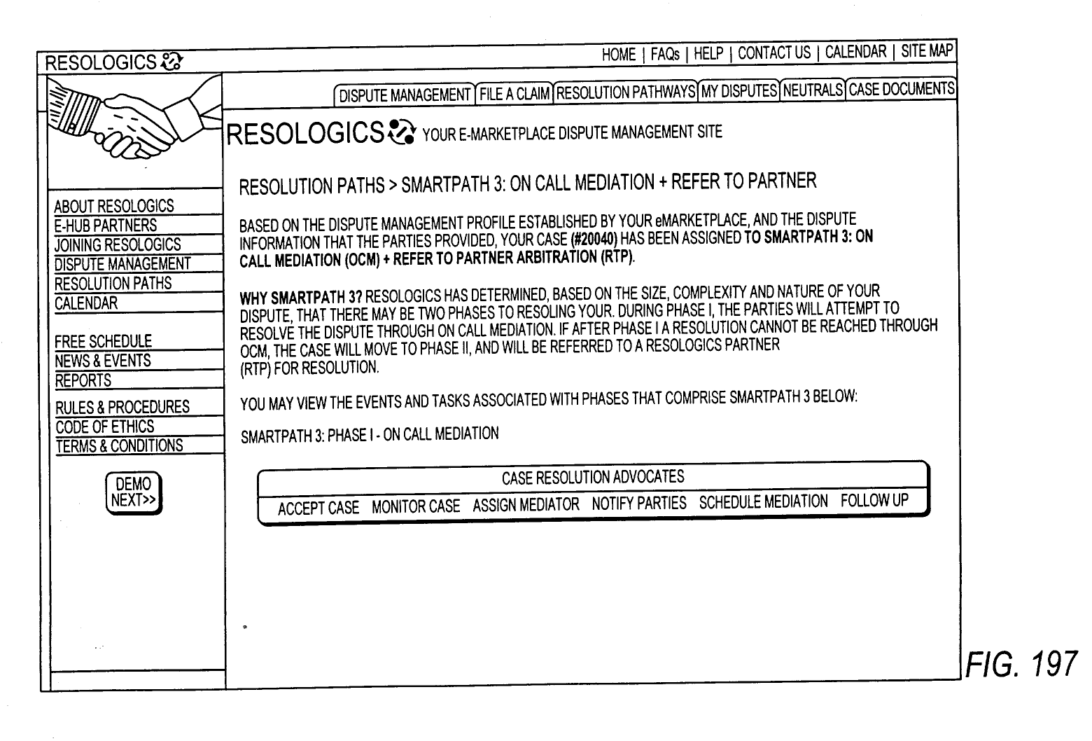

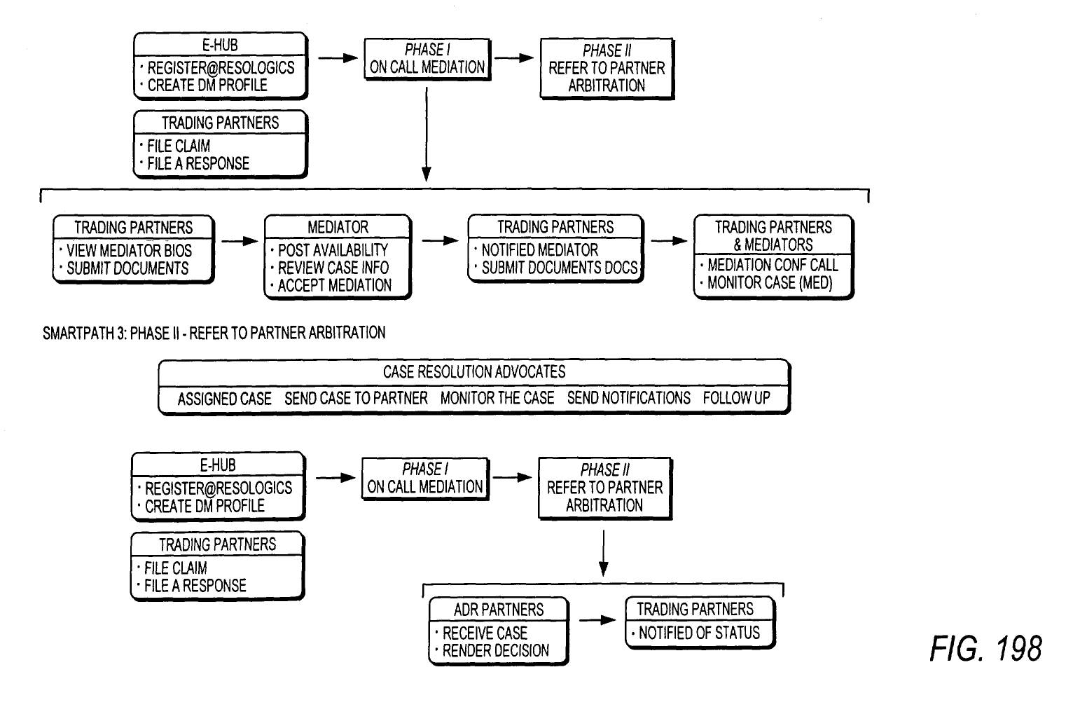

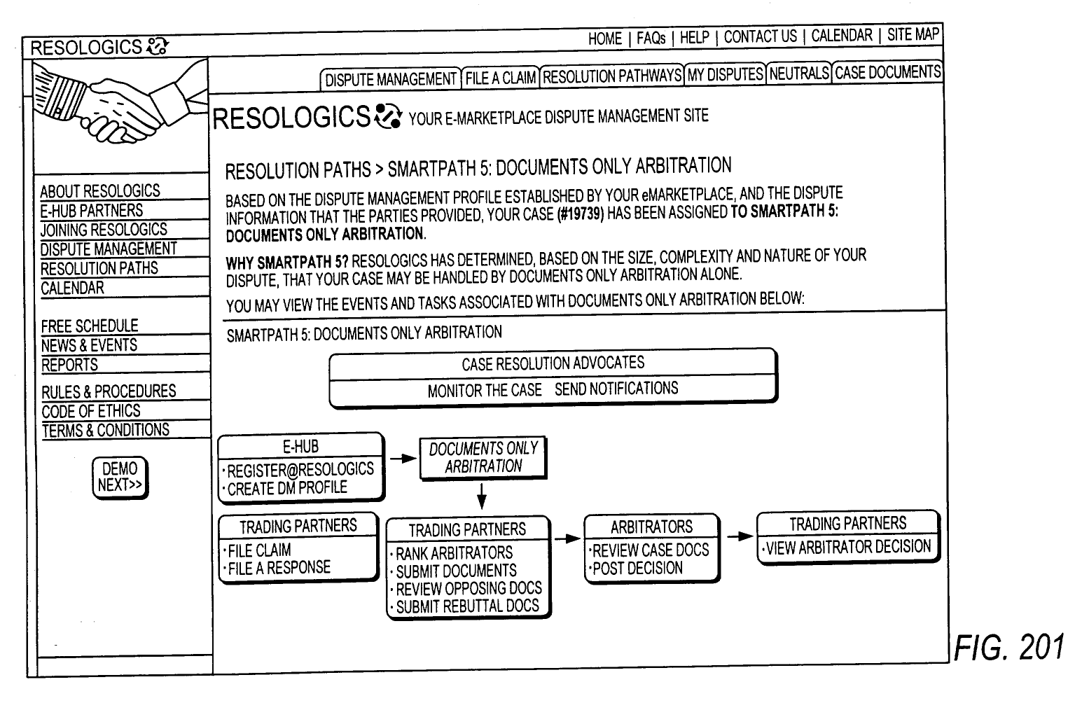

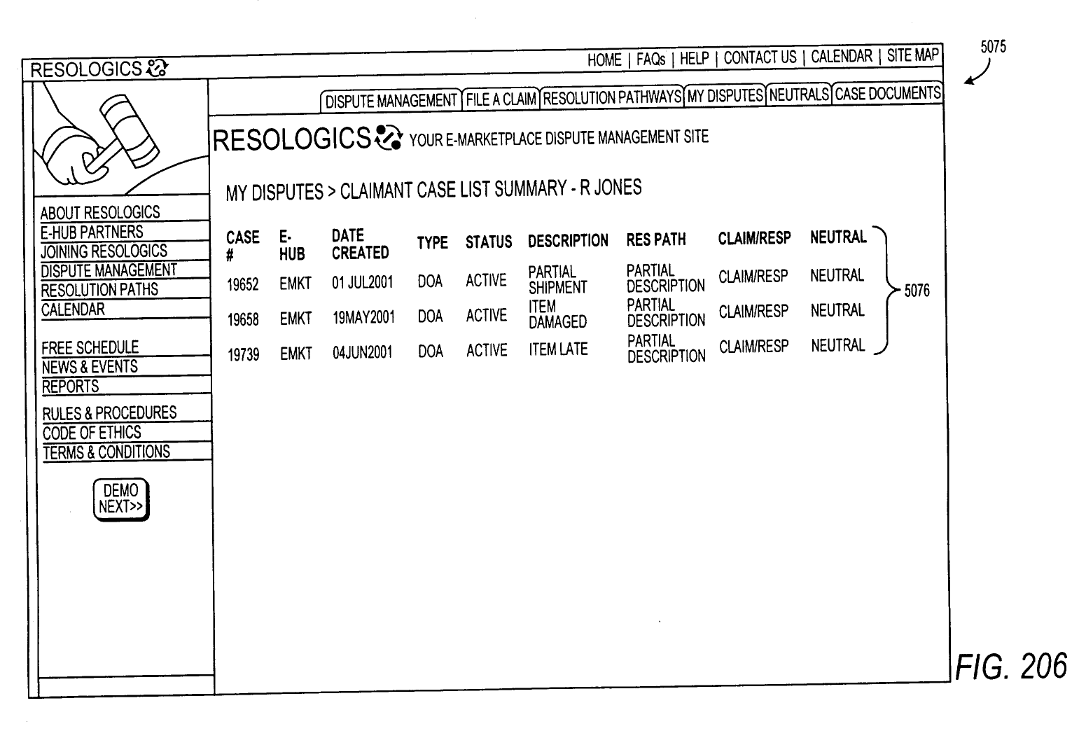

An alternate illustrative user interface approach for dispute management is shown in FIGS. 187-211. The approach shown in FIGS. 187-211 includes some of the same elements of the other approaches described herein. Some of these display elements may have different display characteristics.

In this alternate illustrative user interface, the dispute management application may provide users with displays with advanced dispute management features.

An illustrative main menu display 5000 is shown in FIG. 187. Display 5000, as well as other displays described herein, may include header portion 5002, side frame 5004, and tabs portion 5006. Header portion 5002 may include, for example, the name given to the system by the system provider and links that allow users to navigate through the application to features, such as, for example “Home,” “FAQs,” or any other suitable feature or information. The name may include any suitable passive or interactive text, graphics, audio, video, animation, or other suitable content.

Side frame 5004 may, for example, include one or more selectable links relating to dispute management, such as an “About ResoLogics” link, an “E-Hub Partners” link, a “Joining ResoLogics” link, a “Dispute Management” link, a “Resolution Paths” link, a “Calendar” link, a “Fee Schedule” link, a “News & Events” link, a “Reports” link, a “Rules & Procedures” link, a “Code of Ethics” link, and a “Terms & Conditions” link. However, any other suitable link may also be included, such as, for example, a “File a Claim” link. In some embodiments, a user may indicates his or her selection by selecting one of the selectable links with a mouse or any other suitable user input device.

Tabs portion 5006 may, for example, include one or more selectable tabs relating to dispute management, such as a “Dispute Management” tab 5008, a “File a Claim” tab 5010, a “Resolution Pathway” tab 5012, a “My Disputes” tab 5014, a “Neutrals” tab 5016, and a “Case Documents” tab 5018.

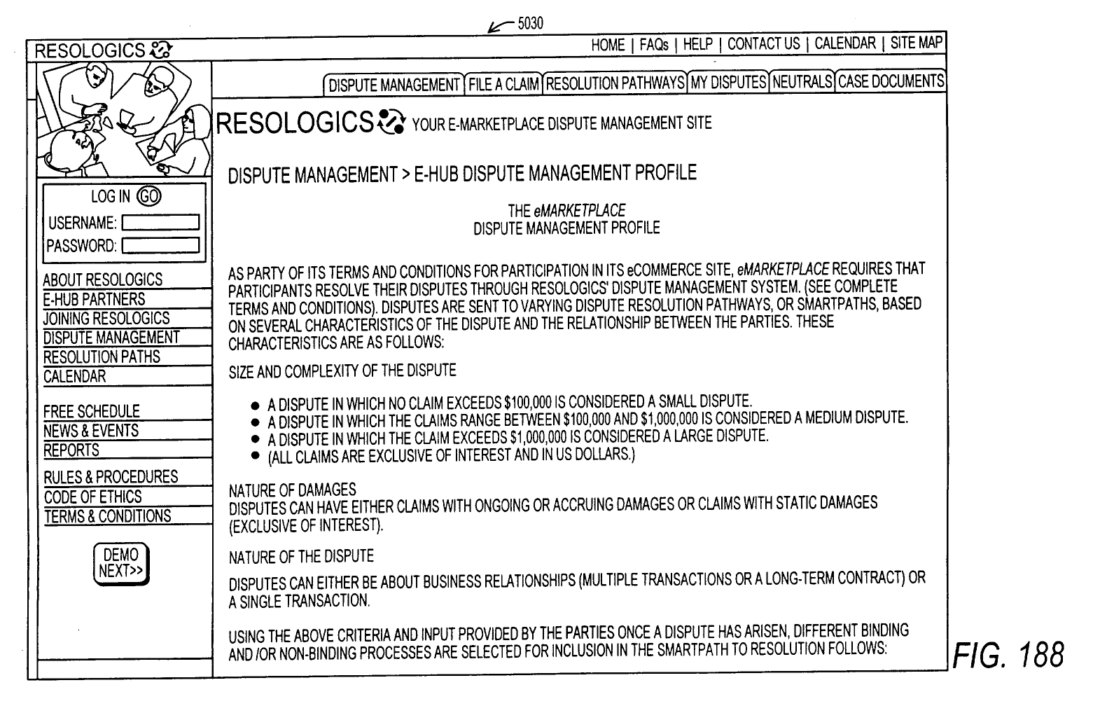

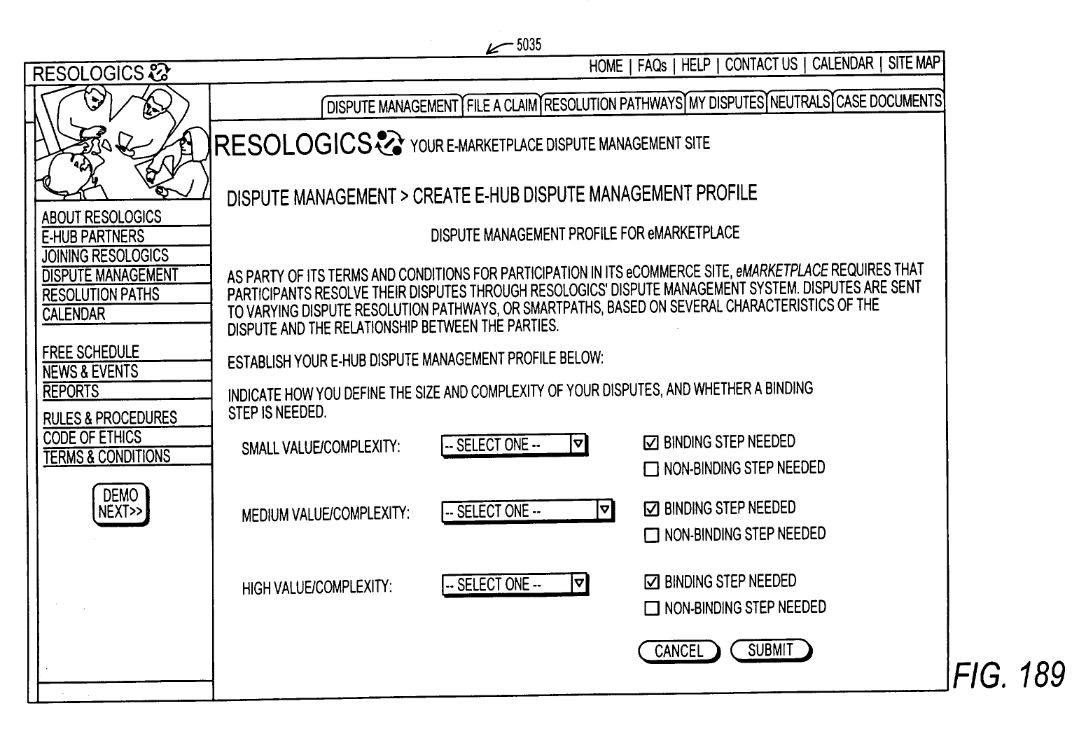

When “Dispute Management” tab 5008 is selected, the dispute management application may provide the user with a profile display, such as illustrative dispute management profile display 5030 as shown in FIG. 188. Display 5030 may include information relating to dispute management profiles. Dispute management profiles may include information such as, for example, references, certification status, links to ratings and reports, trading history, dispute prevention and resolution history, ratings, certification status, industry news, or any other suitable information relating to the user. Such profiles may also include, for example, information links to information resources, both general and specific to a trading partner or other user, which may assist users in their contract decision-making. As shown in an illustrative dispute management profile display 5035 (FIG. 189), the dispute management application may prompt the user to describe how the user prevents and resolves disputes. For example, the dispute management application may prompt the user to define and size of complexity of his or her disputes and determine whether a binding step or non-binding step is required.

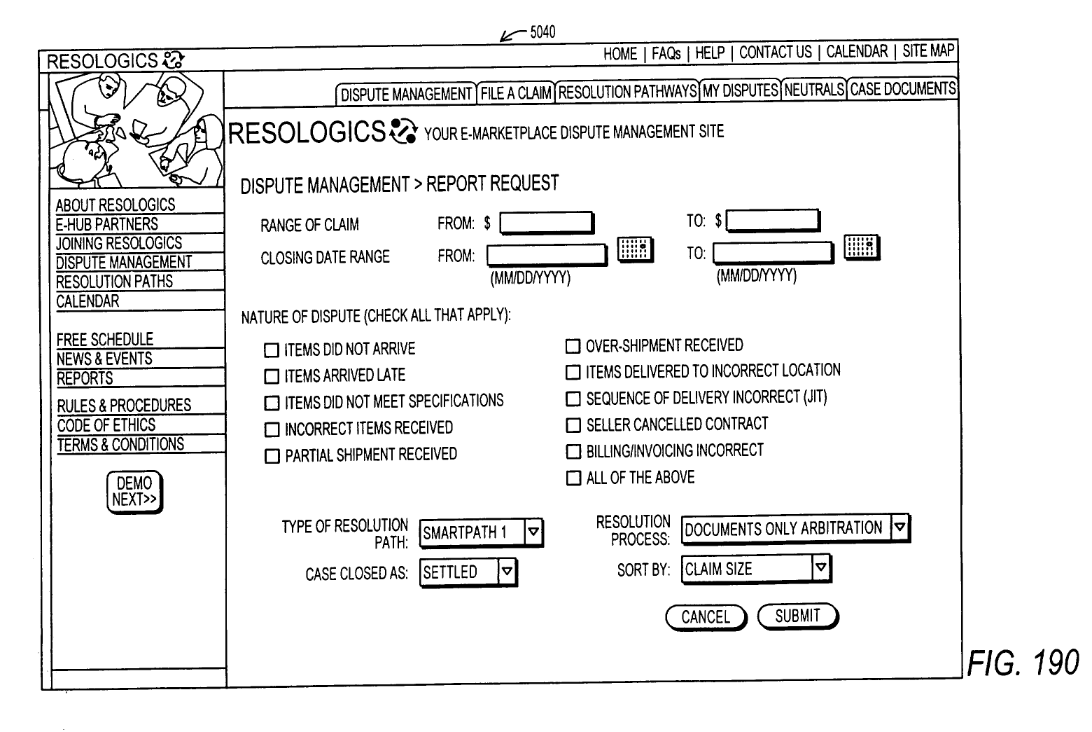

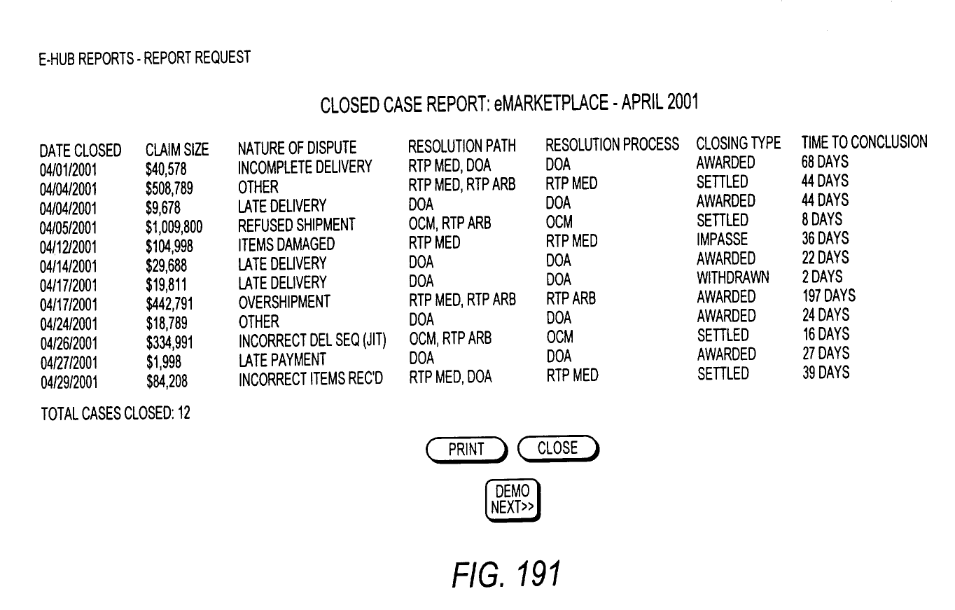

In some embodiments, the user may access profiles of other users. For example, the dispute management application may allow the user to generate reports on dispute management. FIG. 190 shows an illustrative request interface display 5040. In response to the user inputting information, such as the range of the claim, the closing date, the nature of dispute, the resolution process, and any other suitable information, the dispute management application may provide the user with a list of reports as shown in FIG. 191.

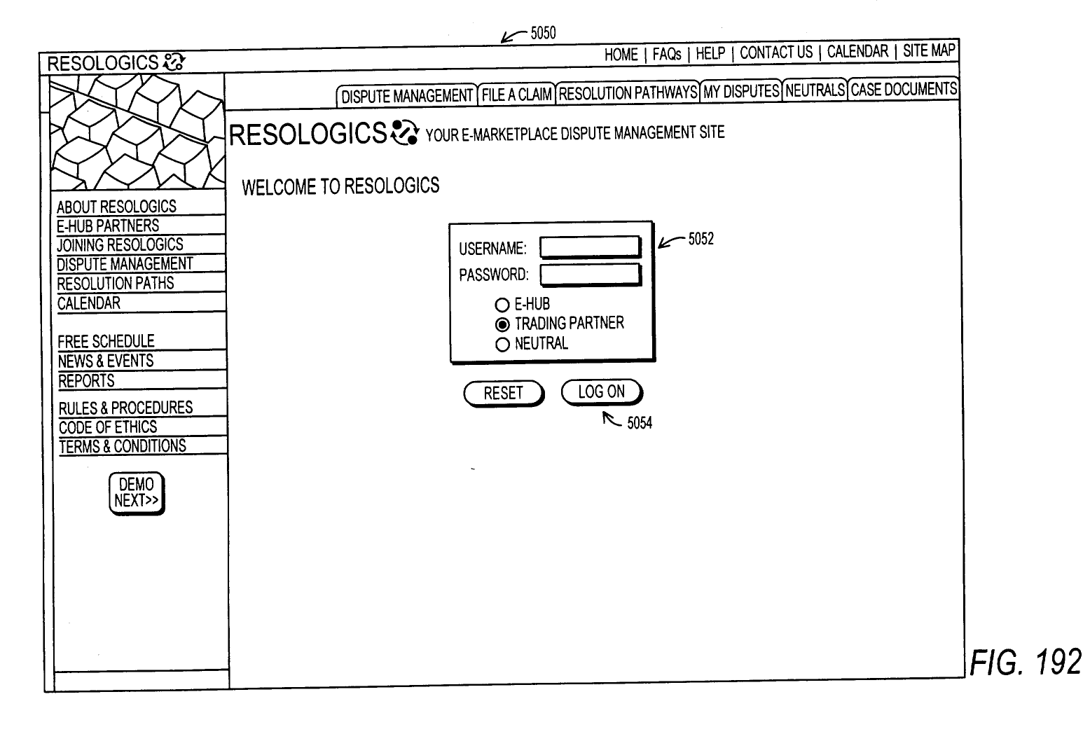

In some embodiments, the dispute management application may allow a user to file a claim. In response to receiving an indication from the user to file a claim (e.g., when “File a Claim” tab 5010 is selected), the dispute management application may provide the user with an illustrative login display 5050 (FIG. 192). Display 5050 may include an interface 5052 for allowing the user to log in. The interface may include text fields for entering a username and password. In some embodiments, the dispute management application may allow the user to indicate whether the user is a trading partner, neutral, or e-hub.

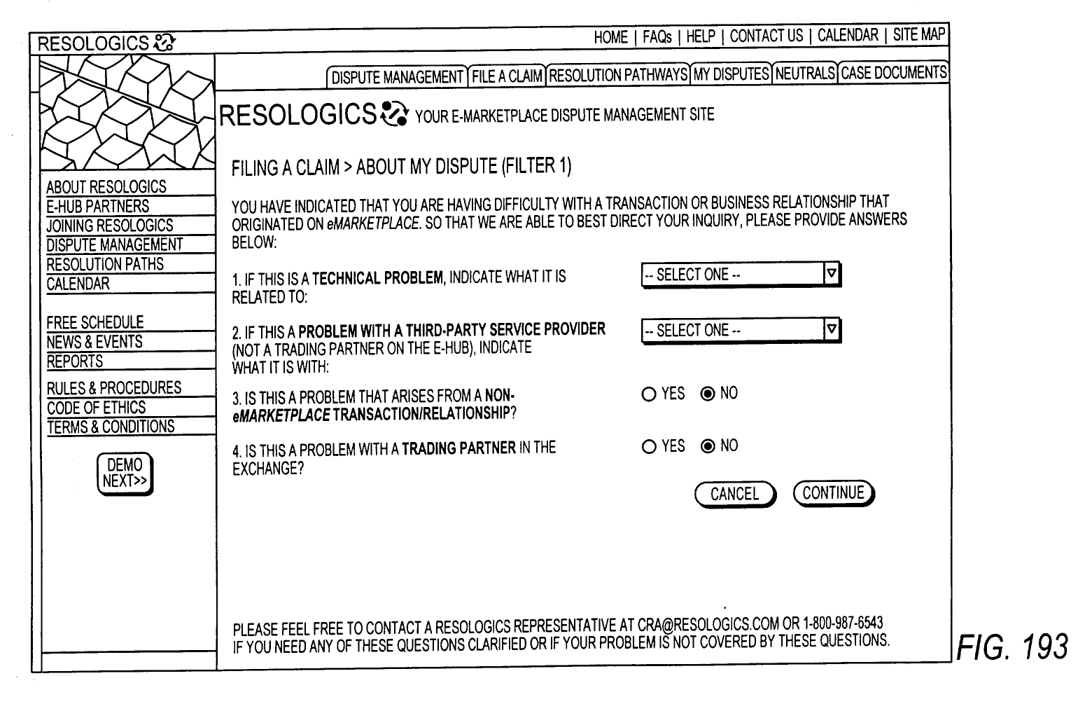

In response to receiving an indication that the user is logging in by, for example, selecting a “Log On” button 5054, the dispute management application may provide the user with a filtering tool. As shown in FIGS. 193-195, the filtering tool may employ a two-step process for screening potential claimants. In one suitable approach, the user may be prompted with a series of questions intended to filter out users. For example, the series of questions may filter users that may have accidentally happened upon the site or users that may require other services. Following the series of questions, the filtering tool may assist the user in selecting a resolution path.

In FIGS. 193-195, the dispute management application may allow the user to answer the questions by using any suitable graphical or audio prompt. Suitable graphical prompts may include, for example, push buttons, check boxes, radio buttons, scroll bars, drop-down menus or lists, input fields or text boxes, or any other suitable graphical user interface construct.

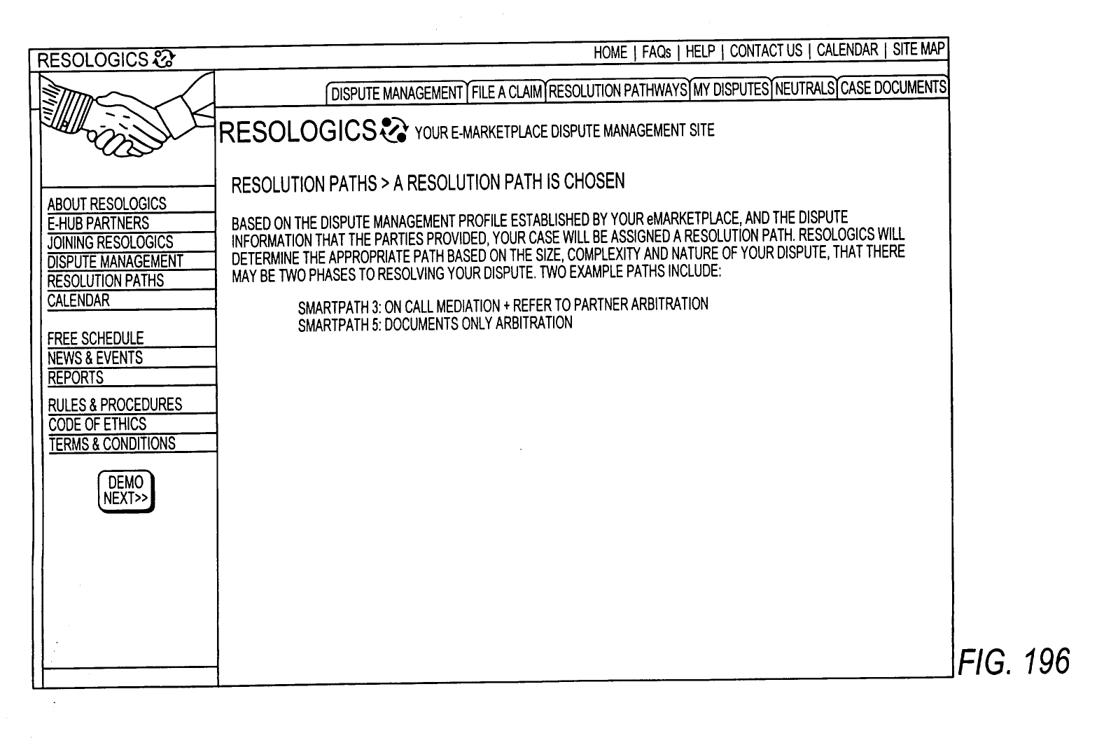

As shown in FIGS. 196-203, based at least in part on the responses to the filtering tool (FIGS. 193-195), the dispute management application may provide the user with multiple dispute resolution options. For example, a user may be provided with an interface showing multiple resolution options (sometimes referred to herein as a “resolution pathway”). The dispute management application may provide the user with the capability of selecting and viewing a resolution pathway.

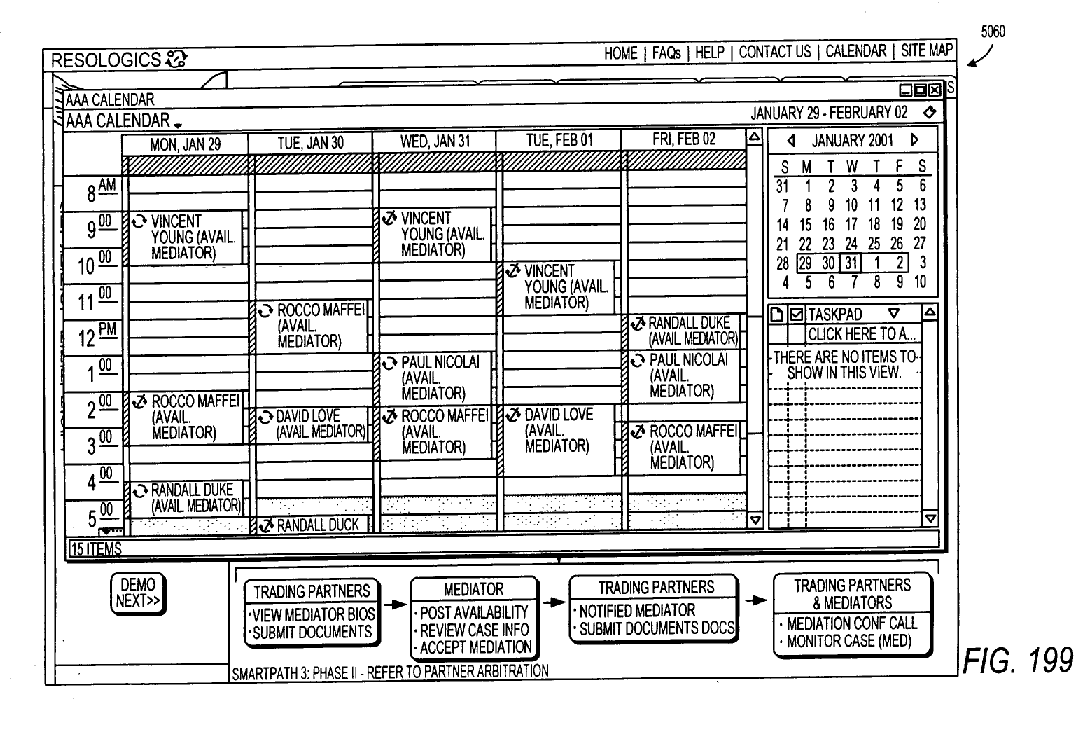

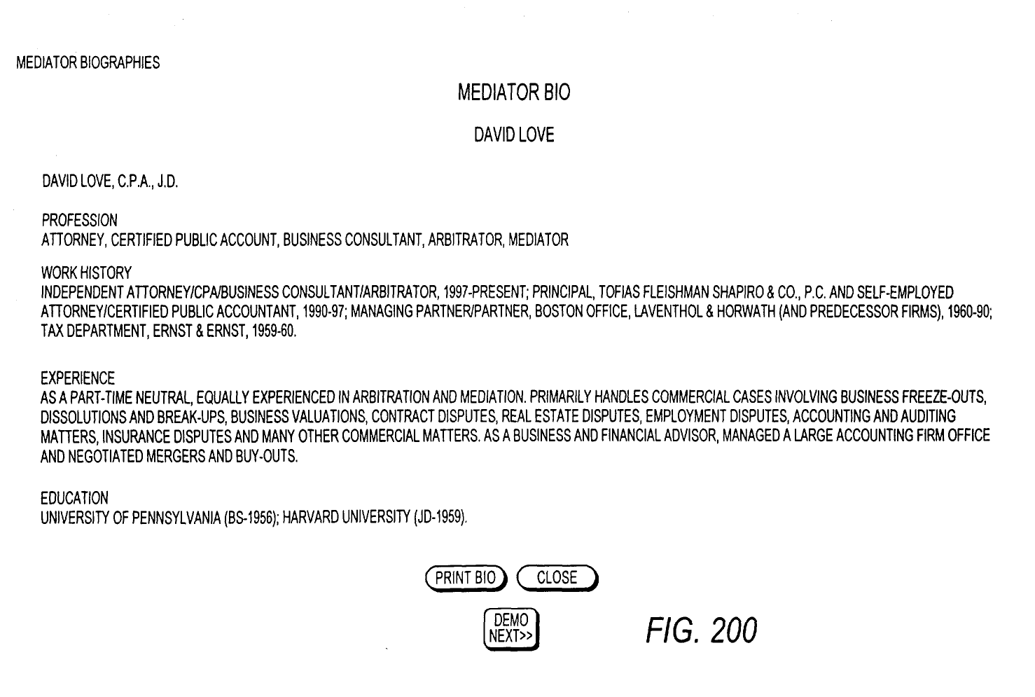

In some embodiments, the dispute management application may provide the user with a selection process for selecting an arbitrator or a mediator. For example, the dispute management application may allow the user to select a preferred mediator (e.g., based on availability). As shown in FIG. 199, the dispute management application may provide the user with an illustrative on-line calendar display 5060. On-line calendar display 5060 may include the names of mediators and their availabilities. In this example, the mediators and their availabilities are shown by the week. In response to a user selecting a mediator, the dispute management application may be provided with a mediator biography as shown in FIG. 200.

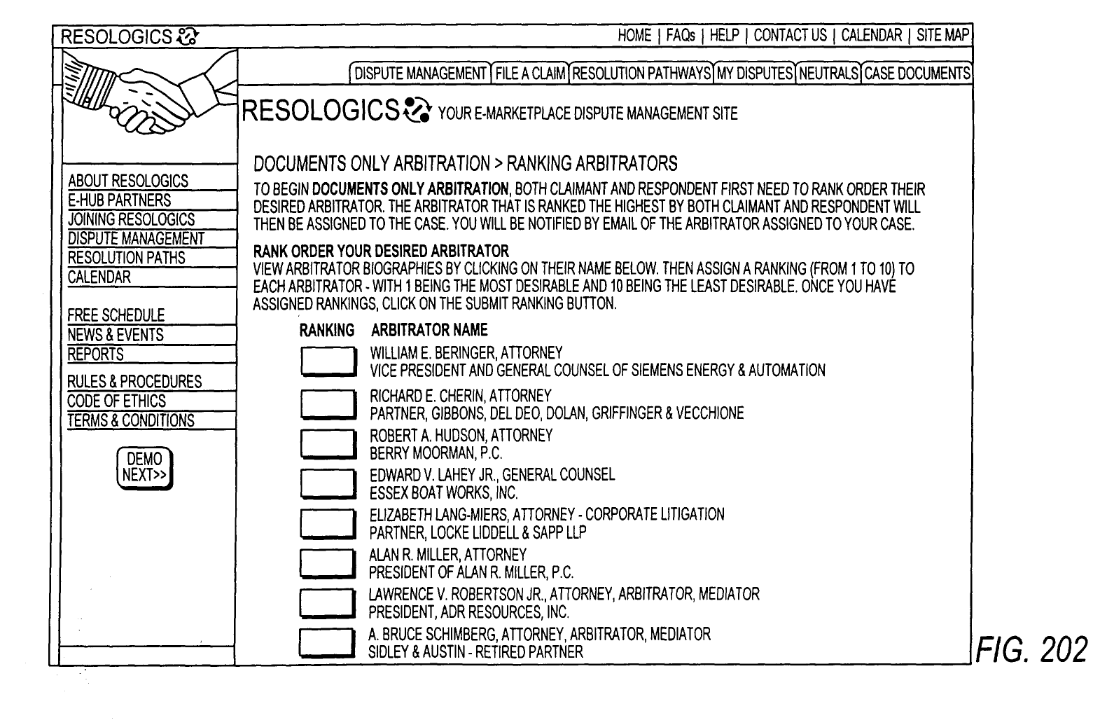

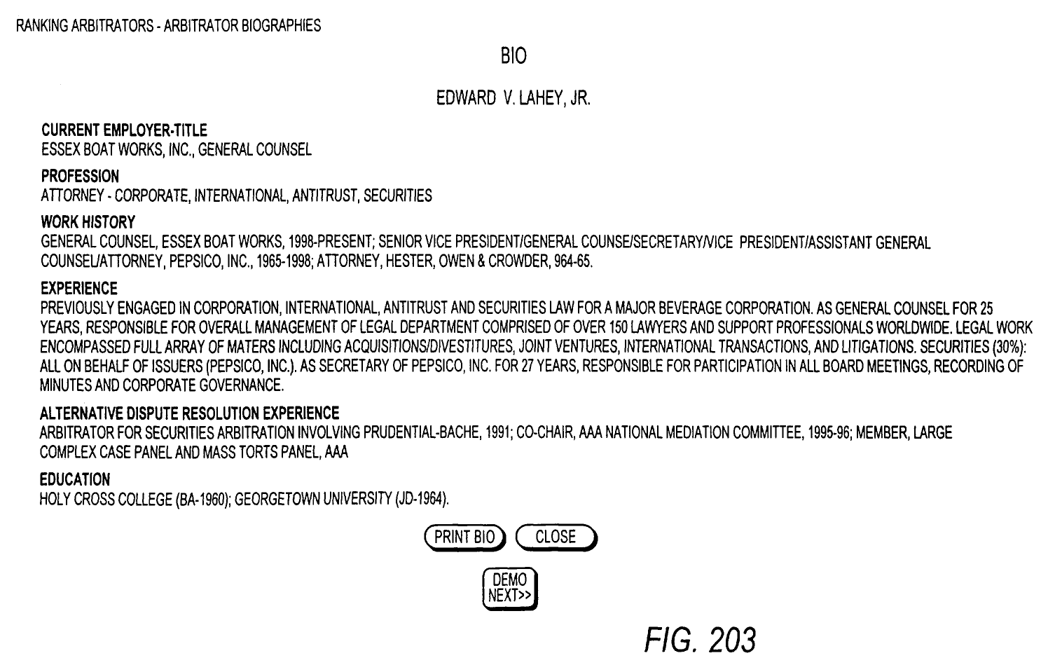

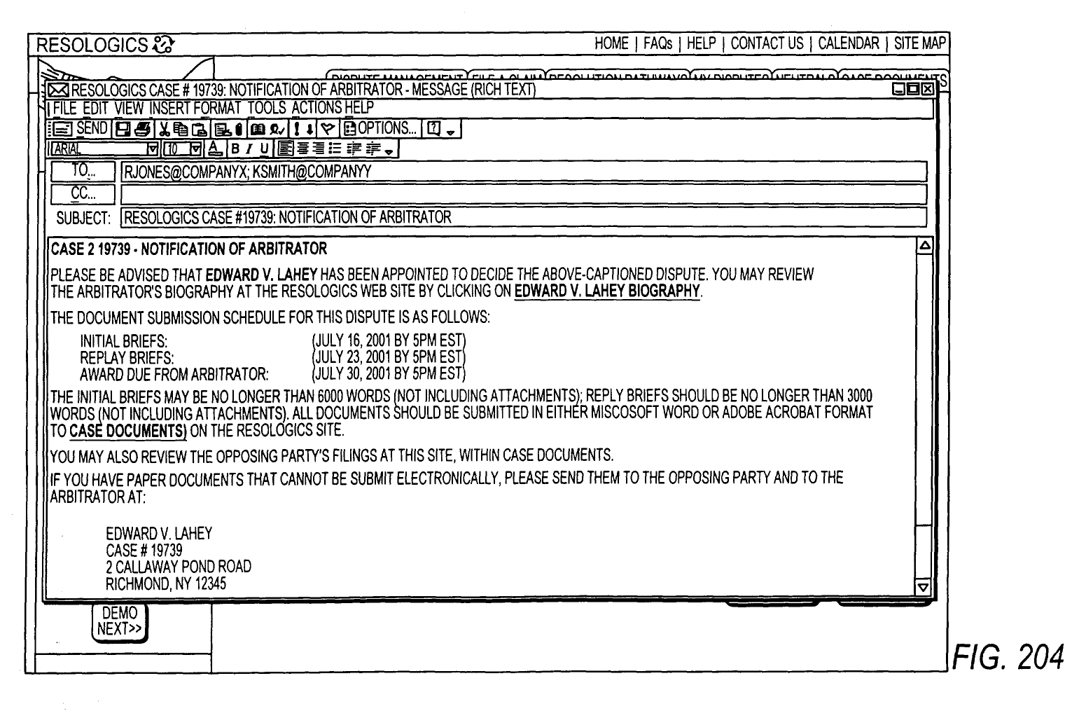

In some embodiments, the dispute management application may allow the disputing parties to rank a list of arbitrators or mediators. In another suitable approach, the dispute management application may provide the user with a list of arbitrators. In some embodiments, the user may assign a ranking to each arbitrator (FIG. 202). In response to the user selecting an arbitrator name, the dispute management application may provide the user with information relating to the selected arbitrator as shown in FIG. 203. In response to a user, such as a case manager, selecting an arbitrator, the dispute management application may notify the selected arbitrator. For example, the dispute management application may send a printed or electronic notification to the arbitrator. FIG. 204 shows an illustrative notification that may be sent to the arbitrator.

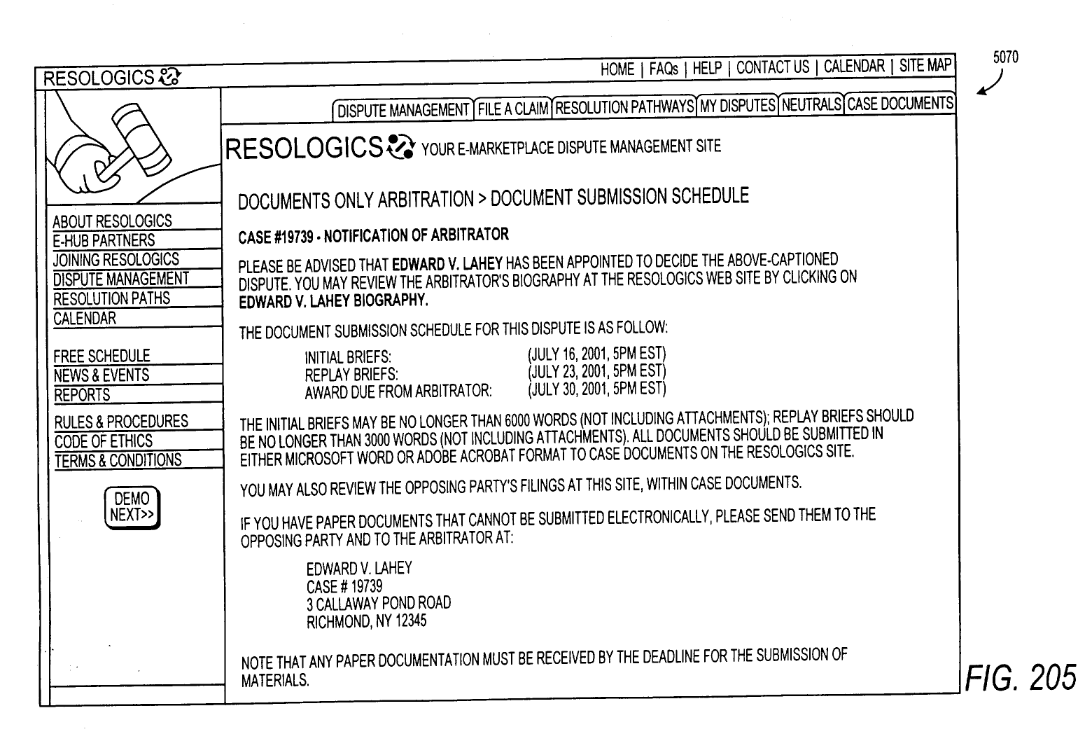

In response to the user selecting “My Disputes” tab 5014, the dispute management application may provide the user with a document submission schedule display 5070. Display 5070 may include a document submission schedule that informs the user when documents may be submitted. In some embodiments, documents may be submitted electronically. An illustrative document submission schedule is shown in FIG. 205.

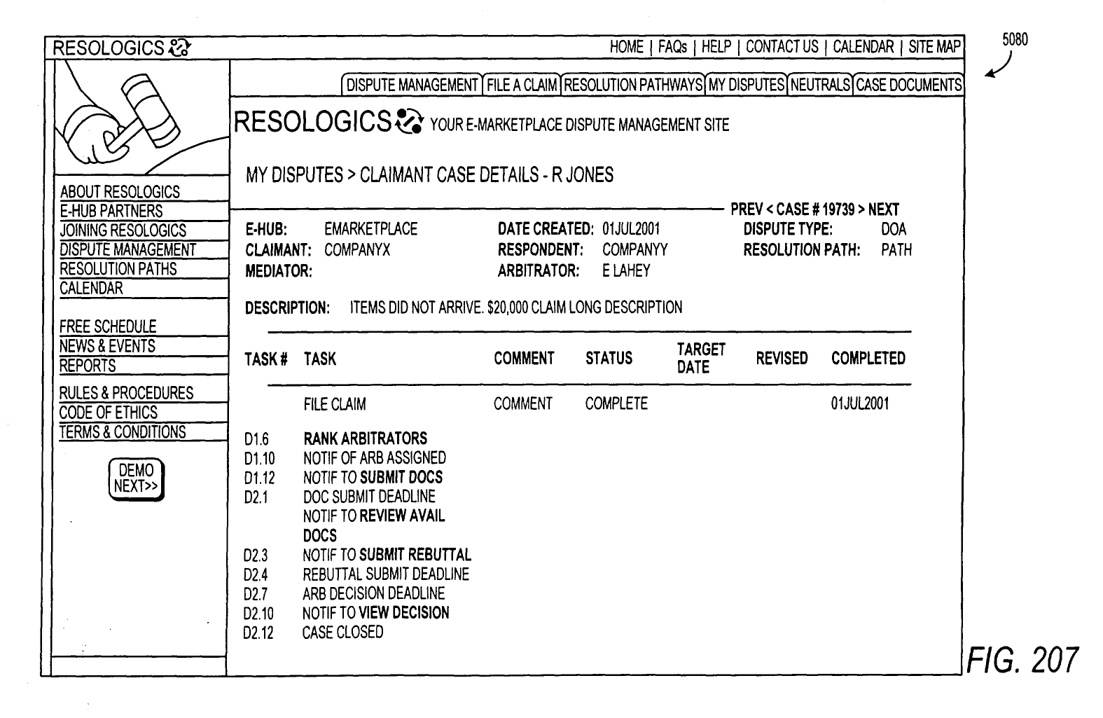

In some embodiments, the dispute management application may provide the user with a summary display, such as illustrative claimant case list summary display 5075 shown in FIG. 23. The summary display may provide the user with information, such as, for example, one or more active cases in which the user is a participant. In response to the user selecting one of the active cases from a case list 5076, the dispute management application may transfer the user to a detailed case display, such as illustrative case details display 5080 shown in FIG. 207. In FIG. 207, display 5080 may include a list of complete and incomplete tasks for the selected case. Display 5080 may also include a summary of the selected case.

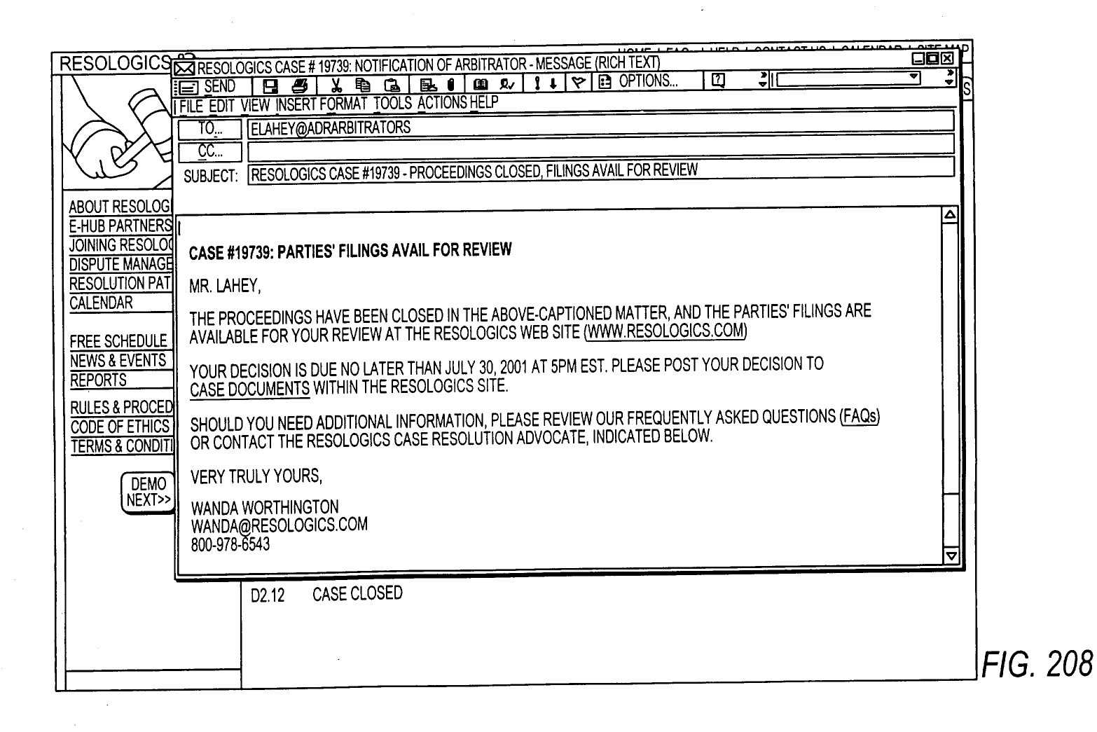

In some embodiments, the dispute management application may notify the arbitrator when the proceedings have been closed. For example, once the proceedings have been closed, the dispute management application may send an e-mail notification to the arbitrator indicating when the arbitrator's decision is due. However, any suitable printed or electronic notification may be sent to the arbitrator. An illustrative notification to the arbitrator is shown in FIG. 208.

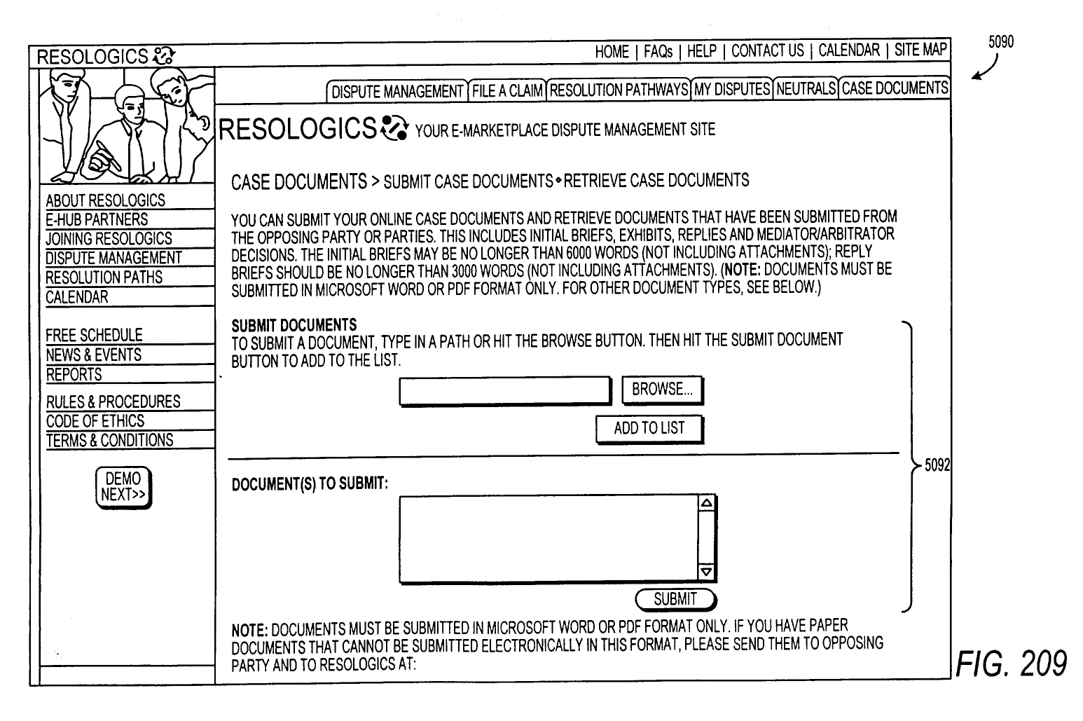

In some embodiments, the dispute management application may allow a user to submit documents using the dispute management application. An illustrative document submission interface display 5090 is shown in FIG. 209. For example, the dispute management application may provide the user with an interface 5092 for submitting documents. Submission interface 5092 may prompt the user to input the location of the document. Submission interface 5092 may include, for example, graphical or audio prompts to the user. Suitable graphical prompts may include, for example, push buttons, check boxes, radio buttons, scroll bars, drop-down menus or lists, input fields or text boxes, or any other suitable graphical user interface construct.

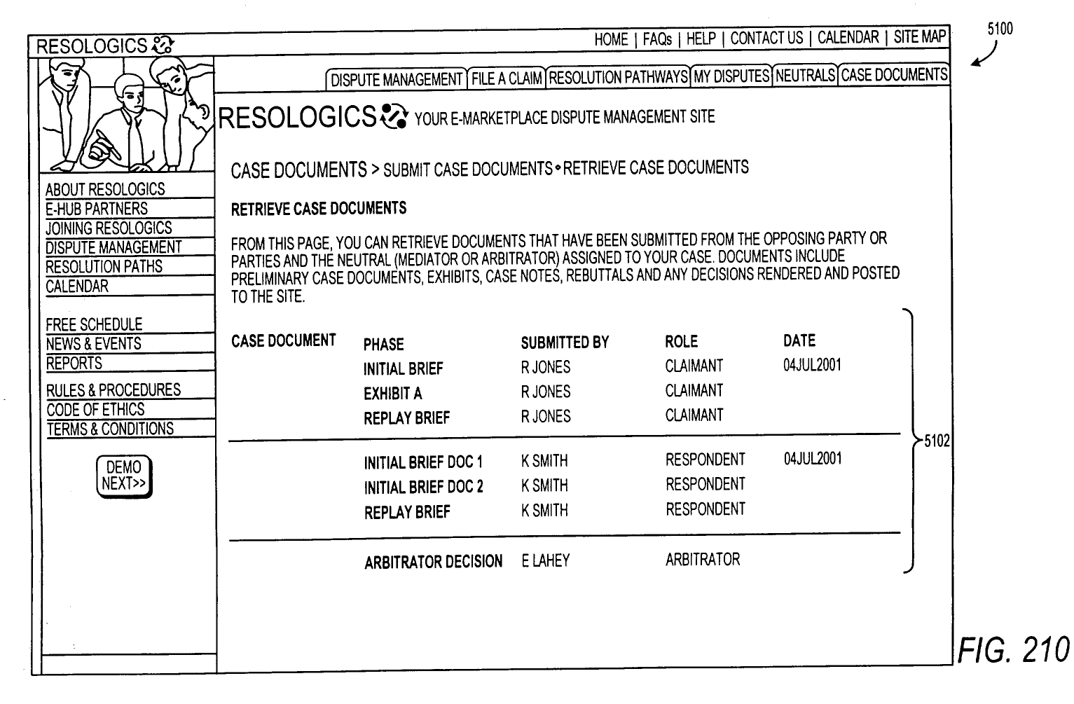

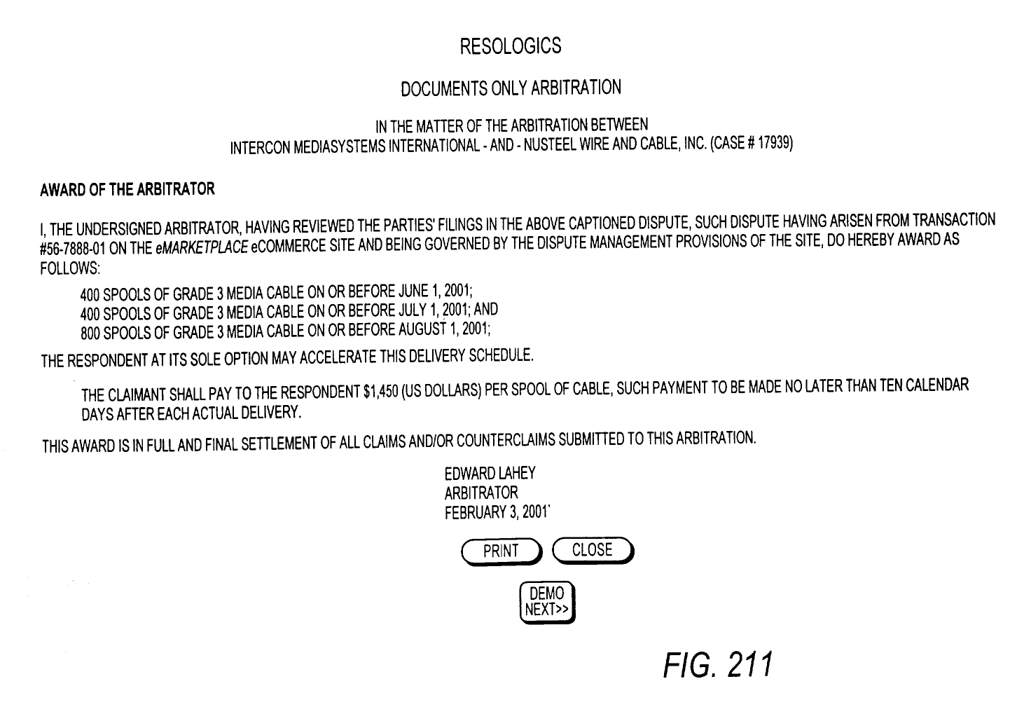

In some embodiments, the dispute management application may allow a user to retrieve documents using the dispute management application. For example, the dispute management application may list submitted documents. An illustrative document retrieval display 5100 is shown in FIG. 210. By selecting a document from a list 5102, the dispute management application may provide the user with the selected document. For example, when the user selects the document titled “Arbitrator Decision” from list 5102, the dispute management application may provide the user with the document in another window (as shown in FIG. 211).

Thus, electronic systems and methods for dispute management are provided. It will be understood that the foregoing is only illustrative of the principles of the invention and that various modifications can be made by those skilled in the art without departing from the scope and spirit of the invention.

What is claimed is:

1. A method for dispute management using a dispute management application comprising:
receiving an indication from a user to file a claim using a first computer, wherein the claim comprises a request for a dispute management process;
providing the user with a plurality of dispute management features in response to receiving the indication at the first computer;
allowing a case manager to manage the dispute management process using a second computer;
receiving an indication from the cage manager of a selected neutral at a third computer; and
allowing the selected neutral to facilitate the dispute management process using a third computer.

2. The method defined in claim 1 wherein the user is a claimant.

3. The method defined in claim 1 wherein the user is respondent.

4. The method defined in claim 1 further comprising providing the user with access to a case filing application in response to receiving the indication from the user to filing a claim.

5. The method defined in claim 4 further comprising:
receiving an indication from the user, wherein the indication indicates a dispute management feature for the dispute management application; and
providing the dispute management feature to the user with the dispute management application in response to receiving the indication.

6. The method defined in claim 1 further comprising providing the user with access to information relating to dispute management.

7. The method defined in claim 6 further comprising allowing the user to electronically search through the information.

8. The method defined in claim 7 wherein allowing the user to electronically search comprises receiving a keyword from the user.

9. The method defined in claim 1 further comprising providing the user with a directory, wherein the directory includes contact information.

10. The method defined in claim 1 wherein the dispute management process is selected from the group consisting of documents-only arbitration and on-call mediation.

11. The method defined in claim 1 further comprising receiving an indication from the user that indicates the desirability of a neutral from a plurality of neutrals at the first computer.

12. The method defined in claim 11 further comprising providing the user with access to additional information relating to the plurality of neutrals.

13. The method defined in claim 1 further comprising receiving an indication from the user at the first computer that indicates the desirability of a neutral from a plurality of neutrals using an on-line calendar.

14. The method defined in claim 13 further comprising indicating the desirability of the neutral based at least in part on the availabilities of the plurality of neutrals.

15. The method defined in claim 1 further comprising receiving an indication from the user to provide submissions relating to the claim.

16. The method defined in claim 1 further comprising receiving an indication from the user to electronically submit at least one document.

17. The method defined in claim 16 further comprising receiving definitions of viewing priorities from the case manager at the second computer.

18. The method defined in claim 16 further comprising providing the neutral at the third computer with access to the at least one document.

19. The method defined in claim 1 further comprising providing the user with a schedule for electronically submitting at least one document.

20. The method defined in claim 1 further comprising providing a notification to the selected neutral at the third computer in response to receiving the indication from the case manager.

21. The method defined in claim 1 further comprising providing the user with a discussion area relating to dispute management.

22. The method defined in claim 1 further comprising allowing the user to create a discussion area relating to dispute management.

23. The method defined in claim 1 further comprising providing the user with access to a case, wherein the case comprises the claim that the user has filed.

24. The method defined in claim 1 further comprising providing the user with access to postings that have been submitted using the dispute management application.

25. The method defined in claim 1 further comprising receiving an indication from the user of users that have a conflict of interest with the claim.

26. The method defined in claim 1 further comprising receiving an indication from the user that the user desires to create a profile.

27. The method defined in claim 26 wherein the profile comprises information relating to dispute prevention.

28. The method defined in claim 26 wherein the profile comprises information relating to dispute resolution.

29. A method for providing dispute management features in a dispute management application comprising:
receiving an indication at a first computer from a user at a second computer to file a claim;
providing the user at the second computer with access to a case filing application in response to receiving the indication;
receiving an indication at the first computer from the user at the second computer, wherein the indication indicates a dispute management feature for a dispute management application; and
providing the dispute management feature to the user using the first computer with the dispute management application in response to receiving the indication.

30. The method defined in claim 29 wherein the user is a claimant.

31. The method defined in claim 29 wherein the user is respondent.

32. The method defined in claim 29 further comprising providing the user with access to user information relating to dispute management.

33. The method defined in claim 32 further comprising allowing the user to electronically search for user information.

34. The method defined in claim 29 further comprising allowing the user to select a dispute management process.

35. The method defined in claim 34 wherein the dispute management process is selected from the group consisting of documents-only arbitration and on-call mediation.

36. The method defined in claim 29 further comprising receiving an indication from the user that indicates the desirability of a neutral from a plurality of neutrals at the second computer.

37. The method defined in claim 36 further comprising providing the user with access to additional information relating to the plurality of neutrals.

38. The method defined in claim 29 further comprising calculating a filing fee for the claim.

39. The method defined in claim 29 further comprising allowing the user to modify the claim.

40. The method defined in claim 29 further comprising receiving an indication from the user to electronically submit at least one document.

41. The method defined in claim 29 further comprising providing the user with a schedule for electronically submitting at least one document.

42. The method defined in claim 29 further comprising providing the user with access to postings that have been submitted using the dispute management application.

43. The method defined in claim 29 further comprising:
receiving an indication from the user to postpone a hearing; and
providing users related to the claim with a notification in response to receiving the indication.

44. The method defined in claim 29 further comprising receiving an indication from the user that the user desires to create a profile.

45. A method for preventing disputes using a dispute management application comprising:
monitoring communications from a first computer;
comparing information from the first computer with dispute management criteria from a database located at a second computer;
determining a dispute-related conclusion based at least in part on the comparison using data mining techniques; and
providing a dispute management process to a user at the first computer.

46. The method defined in claim 45 further comprising determining key fields in the communications.

47. The method defined in claim 45 wherein the dispute management criteria comprises dispute prevention information.

48. The method defined in claim 45 further comprising communicating a notification to the user that indicates the likelihood for a dispute to arise.

49. The method defined in claim 45 further comprising providing the user with statistics relating to dispute management.

50. A method for international dispute management using a dispute management application comprising:
monitoring communications to a first user at a first computer from a second user at a second computer;
identifying the second user at the second computer;
providing the first user with international dispute management information in response to the identification;
determining one or more dispute management rules; and
providing the first user with a plurality of dispute management features in response to determining the dispute management rules.

51. The method defined in claim 50 further comprising providing the first user with access to information relating to international dispute management.

52. The method defined in claim 50 wherein identifying the second user comprising determining the country that the second user is communicating from.

53. The method defined in claim 50 further comprising providing the first user with arbitration clauses relating to the country that the second user is from.

54. The method defined in claim 50 further comprising providing the first user with rules relating to the country that the second user is from.

55. The method defined in claim 50 further comprising determining a dispute management process for resolving an international dispute.

56. The method defined in claim 55 further comprising providing the first user with the dispute management process for resolving the dispute.

57. The method defined in claim 55 wherein the dispute management process is selected from the group consisting of documents-only arbitration and on-call mediation.

58. The method defined in claim 50 further comprising receiving an indication from the first user to create a profile.

59. The method defined in claim 50 further comprising receiving an indication from the second user to create a profile.

60. A system for dispute management using a dispute management application comprising:
means for receiving an indication from a user to file a claim using a first computer, wherein the claim comprises a request for a dispute management process;
means for providing the user with a plurality of dispute management features in response to receiving the indication at the first computer;
means for allowing a case manager to manage the dispute management process using a second computer;
means for receiving an indication from the case manager of a selected neutral at a third computer; and
means for allowing the selected neutral to facilitate the dispute management process using a third computer.

61. The system defined in claim 60 wherein the user is a claimant.

62. The system defined in claim 60 wherein the user is respondent.

63. The system defined in claim 60 further comprising means for providing the user with access to a case filing application in response to receiving the indication from the user to filing a claim.

64. The system defined in claim 63 further comprising:
means for receiving an indication from the user, wherein the indication indicates a dispute management feature for the dispute management application; and
means for providing the dispute management feature to the user with the dispute management application in response to receiving the indication.

65. The system defined in claim 60 further comprising means for providing the user with access to information relating to dispute management.

66. The system defined in claim 65 further comprising means for allowing the user to electronically search through the information.

67. The system defined in claim 66 wherein the means for allowing the user to electronically search comprises means for receiving a keyword from the user.

68. The system defined in claim 60 further comprising means for providing the user with a directory, wherein the directory includes contact information.

69. The system defined in claim 60 wherein the dispute management process is selected from the group consisting of documents-only arbitration and on-call mediation.

70. The system defined in claim 60 further comprising means for receiving an indication from the user that indicates the desirability of a neutral from a plurality of neutrals at the first computer.

71. The system defined in claim 70 further comprising means for providing the user with access to additional information relating to the plurality of neutrals.

72. The system defined in claim 60 further comprising means for receiving an indication from the user at the first computer that indicates the desirability of a neutral from a plurality of neutrals using an on-line calendar.

73. The system defined in claim 72 further comprising means for indicating the desirability of the neutral based at least in part on the availabilities of the plurality of neutrals.

74. The system defined in claim 60 further comprising means for receiving an indication from the user to provide submissions relating to the claim.

75. The system defined in claim 60 further comprising means for receiving an indication from the user to electronically submit at least one document.

76. The system defined in claim 75 further comprising means for receiving definitions of viewing priorities from the case manager at the second computer.

77. The system defined in claim 75 further comprising means for providing the neutral at the third computer with access to the at least one document.

78. The system defined in claim 60 further comprising means for providing the user with a schedule for electronically submitting at least one document.

79. The system defined in claim 60 further comprising means for providing a notification to the selected neutral at the third computer in response to receiving the indication from the case manager.

80. The system defined in claim 60 further comprising means for providing the user with a discussion area relating to dispute management.

81. The system defined in claim 60 further comprising means for allowing the user to create a discussion area relating to dispute management.

82. The system defined in claim 60 further comprising means for providing the user with access to a case, wherein the case comprises the claim that the user has filed.

83. The system defined in claim 60 further comprising means for providing the user with access to postings that have been submitted using the dispute management application.

84. The system defined in claim 60 further comprising means for receiving an indication from the user of users that have a conflict of interest with the claim.

85. The system defined in claim 60 further comprising means for receiving an indication from the user that the user desires to create a profile.

86. The system defined in claim 85 wherein the profile comprises information relating to dispute prevention.

87. The system defined in claim 85 wherein the profile comprises information relating to dispute resolution.

88. A system for providing dispute management features in a dispute management application comprising:
means for receiving an indication at a first computer from a user at a second computer to file a claim;
means for providing the user at the second computer with access to a case filing application in response to receiving the indication;
means for receiving an indication at the first computer from the user at the second computer, wherein the indication indicates a dispute management feature for a dispute management application; and
means for providing the dispute management feature to the user using the first computer with the dispute management application in response to receiving the indication.

89. The system defined in claim 88 wherein the user is a claimant.

90. The system defined in claim 88 wherein the user is respondent.

91. The system defined in claim 88 further comprising means for providing the user with access to user information relating to dispute management.

92. The system defined in claim 91 further comprising means for allowing the user to electronically search for user information.

93. The system defined in claim 88 further comprising means for allowing the user to select a dispute management process.

94. The system defined in claim 93 wherein the dispute management process is selected from the group consisting of documents-only arbitration and on-call mediation.

95. The system defined in claim 88 further comprising means for receiving an indication from the user that indicates the desirability of a neutral from a plurality of neutrals at the second computer.

96. The system defined in claim 95 further comprising means for providing the user with access to additional information relating to the plurality of neutrals.

97. The system defined in claim 88 further comprising means for calculating a filing fee for the claim.

98. The system defined in claim 88 further comprising means for allowing the user to modify the claim.

99. The system defined in claim 88 further comprising means for receiving an indication from the user to electronically submit at least one document.

100. The system defined in claim 88 further comprising means for providing the user with a schedule for electronically submitting at least one document.

101. The system defined in claim 88 further comprising means for providing the user with access to postings that have been submitted using the dispute management application.

102. The system defined in claim 88 further comprising:
means for receiving an indication from the user to postpone a hearing; and
means for providing users related to the claim with a notification in response to receiving the indication.

103. The system defined in claim 88 further comprising means for receiving an indication from the user that the user desires to create a profile.

104. A system for preventing disputes using a dispute management application comprising:
means for monitoring communications from a first computer;
means for comparing information from the first computer with dispute management criteria from a database located at a second computer;
means for determining a dispute-related conclusion based at least in part on the comparison using data mining techniques; and
means for providing a dispute management process to a user at the first computer.

105. The system defined in claim 104 further comprising means for determining key fields in the communications.

106. The system defined in claim 104 wherein the dispute management criteria comprises dispute prevention information.

107. The system defined in claim 104 further comprising means for communicating a notification to the user that indicates the likelihood for a dispute to arise.

108. The system defined in claim 104 further comprising means for providing the user with statistics relating to dispute management.

109. A system for international dispute management using a dispute management application comprising:
means for monitoring communications to a first user at a first computer from a second user at a second computer;
means for identifying the second user at the second computer;
means for providing the first user with international dispute management information in response to the identification;
means for determining one or more dispute management rules; and
means for providing the first user with a plurality of dispute management features in response to determining the dispute management rules.

110. The system defined in claim 109 further comprising means for providing the first user with access to information relating to international dispute management.

111. The system defined in claim 109 wherein the means for identifying the second user comprising means for determining the country that the second user is communicating from.

112. The system defined in claim 109 further comprising means for providing the first user with arbitration clauses relating to the country that the second user is from.

113. The system defined in claim 109 further comprising means for providing the first user with rules relating to the country that the second user is from.

114. The system defined in claim 109 further comprising means for determining a dispute management process for resolving an international dispute.

115. The system defined in claim 114 further comprising means for providing the first user with the dispute management process for resolving the dispute.

116. The system defined in claim 114 wherein the dispute management process is selected from the group consisting of documents-only arbitration and on-call mediation.

117. The system defined in claim 109 further comprising means for receiving an indication from the first user to create a profile.

118. The system defined in claim 109 further comprising means for receiving an indication from the second user to create a profile.

119. A system for dispute management using a dispute management application comprising:
a user input device;
a display device; and
a dispute management application implemented at least partially on control circuitry and programmed to:
receive an indication from a user to file a claim using a first computer, wherein the claim comprises a request for a dispute management process;
provide the user with a plurality of dispute management features in response to receiving the indication at the first computer;
allow a case manager to manage the dispute management process using a second computer;
receive an indication from the case manager of a selected neutral at a third computer; and
allow the selected neutral to facilitate the dispute management process using a third computer.

120. The system defined in claim 119 wherein the user is a claimant.

121. The system defined in claim 119 wherein the user is respondent.

122. The system defined in claim 119 wherein the dispute management application is further programmed to provide the user with access to a case filing application in response to receiving the indication from the user to filing a claim.

123. The system defined in claim 119 wherein the dispute management application is further programmed to:
receive an indication from the user, wherein the indication indicates a dispute management feature for the dispute management application; and
provide the dispute management feature to the user with the dispute management application in response to receiving the indication.

124. The system defined in claim 119 wherein the dispute management application is further programmed to provide the user with access to information relating to dispute management.

125. The system defined in claim 124 wherein the dispute management application is further programmed to allow the user to electronically search through the information.

126. The system defined in claim 125 wherein the dispute management application is further programmed to receive a keyword from the user.

127. The system defined in claim 119 wherein the dispute management application is further programmed to provide the user with a directory, wherein the directory includes contact information.

128. The system defined in claim 119 wherein the dispute management process is selected from the group consisting of documents-only arbitration and on-call mediation.

129. The system defined in claim 119 wherein the dispute management application is further programmed to receive an indication from the user that indicates the desirability of a neutral from a plurality of neutrals at the first computer.

130. The system defined in claim 129 wherein the dispute management application is further programmed to provide the user with access to additional information relating to the plurality of neutrals.

131. The system defined in claim 119 wherein the dispute management application is further programmed to receive an indication from the user at the first computer that indicates the desirability of a neutral from a plurality of neutrals using an on-line calendar.

132. The system defined in claim 131 wherein the dispute management application is further programmed to indicate the desirability of the neutral based at least in part on the availabilities of the plurality of neutrals.

133. The system defined in claim 119 wherein the dispute management application is further programmed to receive an indication from the user to provide submissions relating to the claim.

134. The system defined in claim 119 wherein the dispute management application is further programmed to receive an indication from the user to electronically submit at least one document.

135. The system defined in claim 134 wherein the dispute management application is further programmed to receive definitions of viewing priorities from the case manager at the second computer.

136. The system defined in claim 134 wherein the dispute management application is further programmed to provide the neutral at the third computer with access to the at least one document.

137. The system defined in claim 119 wherein the dispute management application is further programmed to provide the user with a schedule for electronically submitting at least one document.

138. The system defined in claim 119 wherein the dispute management application is further programmed to provide a notification to the selected neutral at the third computer in response to receiving the indication from the case manager.

139. The system defined in claim 119 wherein the dispute management application is further programmed to provide the user with a discussion area relating to dispute management.

140. The system defined in claim 119 wherein the dispute management application is further programmed to allow the user to create a discussion area relating to dispute management.

141. The system defined in claim 119 wherein the dispute management application is further programmed to provide the user with access to a case, wherein the case comprises the claim that the user has filed.

142. The system defined in claim 119 wherein the dispute management application is further programmed to provide the user with access to postings that have been submitted using the dispute management application.

143. The system defined in claim 119 wherein the dispute management application is further programmed to receive an indication from the user of users that have a conflict of interest with the claim.

144. The system defined in claim 119 wherein the dispute management application is further programmed to receive an indication from the user that the user desires to create a profile.

145. The system defined in claim 144 wherein the profile comprises information relating to dispute prevention.

146. The system defined in claim 144 wherein the profile comprises information relating to dispute resolution.

147. A system for providing dispute management features in a dispute management application comprising:
a user input device;
a display device; and
a dispute management application implemented at least partially on control circuitry and programmed to:
receive an indication at a first computer from a user at a second computer to file a claim;
provide the user at the second computer with access to a case filing application in response to receiving the indication;
receive an indication at the first computer from the user at the second computer, wherein the indication indicates a dispute management feature for a dispute management application; and
provide the dispute management feature to the user using the first computer with the dispute management application in response to receiving the indication.

148. The system defined in claim 147 wherein the user is a claimant.

149. The system defined in claim 147 wherein the user is respondent.

150. The system defined in claim 147 wherein the dispute management application is further programmed to provide the user with access to user information relating to dispute management.

151. The system defined in claim 147 wherein the dispute management application is further programmed to allow the user to electronically search for user information.

152. The system defined in claim 147 wherein the dispute management application is further programmed to allow the user to select a dispute management process.

153. The system defined in claim 147 wherein the dispute management process is selected from the group consisting of documents-only arbitration and on-call mediation.

154. The system defined in claim 147 wherein the dispute management application is further programmed to receive an indication from the user that indicates the desirability of a neutral from a plurality of neutrals at the second computer.

155. The system defined in claim 147 wherein the dispute management application is further programmed to provide the user with access to additional information relating to the plurality of neutrals.

156. The system defined in claim 147 wherein the dispute management application is further programmed to calculate a filing fee for the claim.

157. The system defined in claim 147 wherein the dispute management application is further programmed to allow the user to modify the claim.

158. The system defined in claim 147 wherein the dispute management application is further programmed to receive an indication from the user to electronically submit at least one document.

159. The system defined in claim 147 wherein the dispute management application is further programmed to provide the user with a schedule for electronically submitting at least one document.

160. The system defined in claim 147 wherein the dispute management application is further programmed to provide the user with access to postings that have been submitted using the dispute management application.

161. The system defined in claim 147 wherein the dispute management application is further programmed to:
receive an indication from the user to postpone a hearing; and
provide users related to the claim with a notification in response to receiving the indication.

162. The system defined in claim 147 wherein the dispute management application is further programmed to receive an indication from the user that the user desires to create a profile.

163. A system for preventing disputes using a dispute management application comprising:
a user input device;
a display device; and
a dispute management application implemented at least partially on control circuitry and programmed to:
monitor communications from a first computer;
compare information from the first computer with dispute management criteria from a database located at a second computer;
determine a dispute-related conclusion based at least in part on the comparison using data mining techniques; and
provide a dispute management process to a user at the first computer.

164. The system defined in claim 163 wherein the dispute management application is further programmed to determine key fields in the communications.

165. The system defined in claim 163 wherein the dispute management criteria comprises dispute prevention information.

166. The system defined in claim 163 wherein the dispute management application is further programmed to communicate a notification to the user that indicates the likelihood for a dispute to arise.

167. The system defined in claim 163 wherein the dispute management application is further programmed to provide the user with statistics relating to dispute management.

168. A system for dispute management using a dispute management application comprising:
a user input device;
a display device; and
a dispute management application implemented at least partially on control circuitry and programmed to:
monitor communications to a first user at a first computer from a second user at a second computer;
identify the second user at the second computer;
provide the first user with international dispute management information in response to the identification;
determine one or more dispute management rules; and
provide the first user with a plurality of dispute management features in response to determining the dispute management rules.

169. The system defined in claim 168 wherein the dispute management application is further configured to provide the first user with access to information relating to international dispute management.

170. The system defined in claim 168 wherein the dispute management application is further configured to determine the country that the second user is communicating from.

171. The system defined in claim 168 wherein the dispute management application is further configured to provide the first user with arbitration clauses relating to the country that the second user is from.

172. The system defined in claim 168 wherein the dispute management application is further configured to provide the first user with rules relating to the country that the second user is from.

173. The system defined in claim 168 wherein the dispute management application is further configured to determine a dispute management process for resolving an international dispute.

174. The system defined in claim 168 wherein the dispute management application is further configured to provide the first user with the dispute management process for resolving the dispute.

175. The system defined in claim 174 wherein the dispute management process is selected from the group consisting of documents-only arbitration and on-call mediation.

176. The system defined in claim 168 wherein the dispute management application is further configured to receive an indication from the first user to create a profile.

177. The system defined in claim 168 wherein the dispute management application is further configured to receive an indication from the second user to create a profile.
